(19) United States
(12) Patent Application Publication
(10) Pub. No.: US 2002/0065127 A1
(43) Pub. Date: May 30, 2002

(54) Gaming machine

(75) Inventors: Masato Kamimura, Tokyo (JP); Hiroshi Yoshida, Tokyo (JP)

Correspondence Address: Ronald R. Snider, Snider & Associates, P.O. Box 27613, Washington, DC, 20038-7613, US

(73) Assignee: ARUZE CORPORATION, Tokyo (JP)

(21) Appl. No.: 10/043,097

(22) Filed: Jan. 14, 2002

Related U.S. Application Data
(63) Continuation of application No. 09/455,369, filed on Dec. 3, 1999.

(30) Foreign Application Priority Data
Dec. 10, 1998 (JP) 10-351015
Nov. 2, 1999 (JP) 11-312324

(51) Int. Cl. A63F 13/00

(52) U.S. Cl. 463/20

(57) ABSTRACT

In a gaming machine (1) comprising a variable display device (5a to 5c) for variably displaying a plurality of kinds of symbols necessary for gaming, a starting device (20) for starting variably displaying the symbols, and a stopping device (21), disposed so as to be operable by a player, for stopping the symbols being variably displayed, wherein the player is provided with a profit if a combination of symbols displayed when the symbols are stopped constitutes a predetermined winning mode; an image display section (13) for displaying game information to the player is provided.

### RELATED APPLICATIONS

This application claims the priorities of Japanese Patent Application No. 10-351015 filed on Dec. 10, 1998 and Japanese Patent Application No. 11-312324 filed on Nov. 2, 1999, which are incorporated herein by reference.

### BACKGROUND OF THE INVENTION

1. Field of the Invention

The present invention relates to a gaming machine; and, in particular, to a gaming machine in which a player can reliably and effectively recognize game information.

2. Description of the Prior Art

As a gaming machine of this kind, a slot machine 50 shown in FIG. 16, for example, has conventionally been known.

FIG. 16 is a front view of the conventional slot machine 50.

Here, members having functions similar to those of members in a gaming machine 1 in accordance with the present invention, which will be explained later, will be explained with reference to numerals identical to the latter members.

As shown in FIG. 16, the conventional slot machine 50 has a housing 3 whose front side is provided with a front door 2 which is adapted to open and close. The front door 2 is formed with a display window 4 at an upper part near the center of the front face thereof, whereas the respective outer peripheral faces of three reels 5a to 5c disposed within the housing 3 face the display window 4. Also, five winning line indicators 6 for indicating respective effective winning lines are formed across the display window 4 so as to extend to the peripheries thereof.

On the left end side of the respective winning line indicators 6, effective line indicator lamps 7a to 7e for indicating the respective effective winning lines are provided. Disposed on the right side of the winning line indicators 6 are a replay display lamp 8 for indicating that a combination of symbols displayed in their stopped state is in a replay winning mode, a game stop display lamp 9 for indicating the wait time from the starting of the last game until the starting of the next game, a winning display lamp 10 for indicating that a combination of symbols displayed in their stopped state constitutes a predetermined winning mode, a game start display lamp 11 for indicating that a start switch 20 is operable, and a game medal insertion lamp 12 for indicating that game medals are permitted to insert.

Below the above-mentioned display window 4, the front door 2 is provided with display sections such as a credit number display section 51 for indicating the number of game medals stored (hereinafter referred to as credited), a chance display section 52 for indicating that there is a possibility of a special game occurring, a bonus number display section 53 for indicating the number of possible wins and number of playable general games in a special gaming state, a payout number display section 54 for displaying the number of game medals to be paid out at the time of winning, and the like. Also, an upper part on the front face of the housing 3 is provided with a dividend display section 26 for indicating the number of game medals to be paid out in reward for a winning. Further, the uppermost part in the front face of the housing 3 is provided with a decorating section 27 in which a plurality of decorating lamps (not depicted) is arranged.

Below the above-mentioned credit number display section 51 and the like, the front face of the front door 2 is provided with a medal insertion slot 14 for inserting game medals used for gaming, a first bet switch 16 for inserting, one by one, game medals used for gaming within a credited range, a second bet switch 17 for inserting, two by two, game medals used for gaming within the credited range, and a max bet switch 18 for inserting the game medals used for gaming up to the maximum permissible bet number (e.g., three) within the credited range.

Below the above-mentioned medal insertion slot 14 and the like, the front face of the front door 2 is provided with a C/P (credit/payout) switch 19 for changeover between the credit and the payout of the medals acquired by the player, a start switch 20 for starting rotating each of the reels 5a to 5c on condition that a game medal is inserted, and three stop switches 21a to 21c for stopping rotating the respective reels 5a to 5c.

Further, the lowermost part of the front door 2 is provided with a medal tray 22 for receiving the game medals paid out as a prize, and a medal payout slot 23 facing the medal tray 22. A sound transmission hole 24 is formed on the right side of the medal payout slot 23, whereas a speaker (not depicted) is provided within the housing 3 so as to face the sound transmission hole 24.

Such a conventional slot machine 50 can start a game when a game medal is inserted therein. When a player operates the start switch 20 after a game starting condition is set in order, a plurality of reels 5a to 5c rotate, so that a plurality of symbols formed on the surface of each of the reels 5a to 5c move at a high speed. Then, when the player operates the respective stop switches 21a to 21c corresponding to the individual reels 5a to 5c, the latter stop rotating, whereby a plurality of symbols formed on the surfaces of reels 5a to 5c are displayed in their stopped state.

Here, in the case where the symbols thus displayed in their stopped state constitute a predetermined combination, then game medals are paid out as a prize, or a special game known as so-called big bonus or regular bonus can be played.

Here, specific examples of winning modes include, as frequently occurring winning modes in general, so-called small hands such as cherry, orange, bell, and watermelon, and those known as replay by which the next game can be played without game medal insertion. Usually, if no winning occurs in an internally elected game, the established internally elected hand will not be transferred to the next and later games. Also, a relatively small number of game medals, i.e., 15 or less medals, are paid out. On the other hand, there are winning modes which are generated at the time of special games such as big bonuses (e.g., CT-attached big bonuses including games known as challenge time (CT) in which stop control for the reels 5a to 5c by random number sampling is stopped for a predetermined period after the completion of a big bonus game) known as a special winning mode, regular bonuses, and the like, and when combinations of special game starting symbols align on the winning lines, by which games can be played for a predetermined period in a state where winning hands occur at a higher probability than in normal games. Since the internal sampling probability of these winning modes is much lower than that of small hands or replay winning, their internally elected state is configured so as to be transferable to the next and later games even when no winning occurs (no special winning mode is constructed on a winning line) in the internally elected game. Also, a large number of game medals, i.e., on the order of 350 to 450 for a big bonus and about 120 for a regular bonus, can be acquired in one special game.

In the following explanation, “stop mode” refers to the stationary displaying of variably displayed symbols in their stopped state in response to a player's stopping operation regardless of whether winning hands align on a winning line or not, i.e., whether a game is won or not, or the state thereof. Also, “winning mode” refers to, of the stop mode, the stationary displaying of symbols in a state where a winning occurs, or the state thereof. Further, “established flag” or “flag is established” refers to an internal elected state of each winning hand according to a sampled random number and a probability sampling table, or occurrence of this state. In this case, when the player carries out a stopping operation of the stop switches 21a to 21c so as to construct a winning mode corresponding to an established flag, the reels 5a to 5c are regulated to stop so as to construct the winning mode. When the flag is not established, by contrast, even if the player carries out a stopping operation of the stop switches 21a to 21c so as to construct a winning mode, control is made so as not to attain the winning mode.

Notification of Game Information

The above-mentioned conventional slot machine 50, however, has not been able to reliably and effectively transmit game information to the player to be notified of such information.

Namely, for notifying the player of game information in the above-mentioned conventional slot machine 50, a plurality of display sections separately disposed on front face of the slot machine 50 are respectively indicated, a decorating lamp is lit or blinked, or sound effects are generated from the speaker.

However, as mentioned above, the front face of the conventional slot machine 50 is provided with a plurality of display sections and decorating lamps for enhancing the fun of gaming, which are lit or blinked. Further, various sound effects are generated from the speaker. As a consequence, when indications are simply made in a display section which does not particularly stand out from the other display sections, or alarming sounds are generated between various sound effects, it has been difficult for the player to recognize game information reliably and effectively.

Specifically, the following notifications have been made according to the game information to be reported to the player.

Permission to Insert Game Medal

The conventional slot machine 50 permits game medals to be inserted after preparations in a control unit for electrically controlling the slot machine have been completed. For example, when an electric power is supplied to the slot machine 50, after a predetermined initializing process is completed, game medals are permitted to be inserted; and, after starting a game, game medals are permitted to be inserted after the payout process for game medals in the last game and the like are completed.

The permission to insert game medals has been displayed by blinking the game medal insertion lamp 12.

Games in the slot machine 50 can be started not only when game medals are actually inserted, but also when the individual bet switches 16, 17, 18 are operated so as to insert credited game medals. In the latter case, lamps (not shown) disposed within the respective bet switches 16, 17, 18 are blinked so as to indicate that game medals are permitted to be inserted.

However, when the permission to insert game medals is indicated simply by blinking the game medal insertion lamp 12, blinking the lamps disposed within the bet switches 16, 17, 18, or the like, it is difficult to call the attention of the player thereto, whereby the player may not reliably recognize the permission to insert game medals. Therefore, if the player tries to insert a game medal before the insertion is permitted, then the insertion is rejected, and the unaccepted game medal is returned from the medal payout slot 23, thus making it necessary to carry out an inserting operation again. Consequently, the player may feel annoyance and fretfulness, thereby losing the fun of gaming.

Also, when game medals are not inserted while their insertion is permitted, the waste time in which no game is played increases so much that the total number of games to be played by the player per day, i.e., the amount of money to spend, decreases, whereby the fun of gaming cannot fully be enjoyed. On the other hand, the problem of decrease in availability rate of the slot machine 50 occurs on the game parlor side.

In view of the foregoing circumstances, it is an object of the present invention to provide a gaming machine which can reliably notify the player whether bet information is permitted to input or not, whereby the fun of gaming can fully be enjoyed.

Number of Inserted Game Medals

In the conventional slot machine 50, games can be played while one to the maximum permissible bet number of, i.e., three, game medals are inserted. Also, as the number of inserted game medals increases, the number of effective winning lines increases, whereby the probability of winning enhances. For example, the internal sampling rate of winning modes such as big bonus by which a large number of medals can be acquired is 1/700 when two game medals are inserted, and is 1/300 when three game medals are inserted. Therefore, as the number of inserted game medals increases, the player can play games under more advantageous conditions.

The number of inserted game medals has been indicated by lighting the effective line display lamps 7a to 7e and also lighting, in response to the effective winning lines, back lamps (not depicted) for illuminating the respective reels 5a to 5c from therewithin.

However, if the number of inserted game medals is simply indicated by lighting the effective line display lamps 7a to 7e and the back lamps or the like, it is difficult to call the attention of the player thereto, whereby the player may not reliably recognize the number of inserted game medals. Hence, there are cases where, for example, the player starts playing a game while erroneously believing that the number of inserted game medals is three instead of two. As a consequence, the player having failed to obtain a profit to be acquired (a higher sampling probability caused by betting three medals) may lose the fun of gaming.

Also, in the case where the insertion of game medals is not accepted when the number thereof exceeds the maximum permissible bet number of three, game medals will be returned if they are tried to be inserted in addition to three game medals which have already been inserted, so that useless actions will occur in gaming operations, whereby the player may fail to fully enjoy the fun of gaming.

In view of the foregoing circumstances, it is an object of the present invention to provide a gaming machine which can reliably notify the player of bet information input units, whereby the player can fully enjoy the fun of gaming.

Number of Credited Game Medals

The conventional slot machine 50 not only lets game medals to be actually inserted so as to play games, but also allows game medals inserted from the medal insertion slot 14 and those paid out as a prize to be credited up to the maximum creditable number (e.g., 50 medals) so that games can be played within the limits of credited game medals.

The number of thus credited game medals has been displayed at the credit number display section 51 constituted by a seven-segment indicator or the like.

However, when the number of credited medals is simply displayed on the credit number display section 51, it is difficult to call the attention of the player thereto, whereby the player cannot reliably recognize the number of credited game medals. Therefore, if the player operates the bet switches 16, 17, 18 after having used up the credited game medals, the game medals cannot be inserted anymore, whereby the player will feel fretfulness and lose the amusement of games. Also, while no more game medals can be credited after the credited game medals have reached the maximum creditable number, the player may further insert game medals mistakenly. As a consequence, useless actions will occur in gaming operations, whereby the player may fail to fully enjoy the fun of gaming.

In view of the foregoing circumstances, it is an object of the present invention to provide a gaming machine which can reliably notify the player of value information units stored in the gaming machine, whereby the fun of gaming can fully be enjoyed.

Mode of Game Medal Insertion

As mentioned above, the conventional slot machine 50 not only lets game medals to be actually inserted so as to play games, but also allows game medals inserted from the medal insertion slot 14 and those paid out as a prize to be credited up to the maximum creditable number (e.g., 50 medals) so that games can be played within the limits of credited game medals.

In such a slot machine 50, the C/P switch 19 is operated so as to select whether to credit the game medals inserted from the medal insertion slot 14 and those paid out as a prize or not.

This insertion mode of game medals is indicated by whether a display is turned on or off in the credit number display section 51 or not. Namely, turning on the display in the credit number display section 51 indicates the insertion mode for crediting game medals, whereas turning off the display in the credit number display section 51 indicates the insertion mode without crediting game medals.

However, when a game medal insertion mode is simply indicated by whether there is a display in the credit number display section 51 or not, it is difficult to call the attention of the player thereto, whereby the player may not reliably recognize the game medal insertion mode. Therefore, a large number of medals may mistakenly be inserted notwithstanding the fact that the insertion mode where no game medals are creditable is selected, whereby the game medals exceeding the maximum permissible bet number (e.g., three medals) will be returned. As a consequence, useless actions will occur in gaming operations, whereby the player may fail to fully enjoy the fun of gaming. When the insertion mode for crediting game medals is selected, on the other hand, game medals are credited up to the maximum creditable number. As a consequence, in the case where game medals are not actually paid out at the time when a winning mode is attained, the slot machine 50 may erroneously be considered to be out of order, whereby unnecessary troubles may occur.

In view of the foregoing circumstances, it is an object of the present invention to provide a gaming machine which can reliably notify the player of the input mode of bet information, whereby the fun of gaming can fully be enjoyed.

Permission to Start Game and Wait Time

For allowing games to be played soundly without excessively agitating the gambling spirit, and letting the fun of gaming to be fully enjoyed, the conventional slot machine 50 is configured such that, in the case where a predetermined time has not passed after the starting of the last game until the starting of the next game, the starting of the game is delayed for the remaining time so that the next game is permitted to start after the lapse of this wait time.

This permission to start the game and wait time are indicated by turning on/off the game stop display lamp 9 and game start display lamp 11.

Namely, turning on the game stop display lamp 9 while turning off the game start display lamp 11 indicates that it is a wait time, whereas turning off the game stop display lamp 9 while turning on the game start display lamp 11 indicates that a game is permitted to start.

However, when the permission to start a game is simply indicated by turning on/off the game stop display lamp 9 and game start display lamp 11, it is difficult to call the attention of the player thereto, whereby the player cannot reliably recognize the permission to start the game. As a consequence, the player may operate the switch 20 before the game is permitted to start. Then, the player notices that reels 5a to 5c do not rotate, and may wonder why the reels do not rotate, why the stop button does not become effective, and so forth, thus feeling fretfulness and losing the fun of gaming. Also, the player may mistakenly consider that the slot machine 50 is out of order, whereby unnecessary troubles may occur. In the case where the next game is not started although the game is permitted to start, the total number of games decreases, whereby the fun of gaming may not fully be enjoyed.

In view of the foregoing circumstances, it is an object of the present invention to provide a gaming machine which can reliably notify the player whether a game is permitted to start or not, whereby the fun of gaming can fully be enjoyed.

It is also an object of the present invention to provide a gaming machine which can reliably notify the player of the wait time until a game is permitted to start, whereby the amusement of games can fully be enjoyed.

### Making Each Stop Switch Operation Effective

In the conventional slot machine 50, after the symbols within the display window 4 have attained a state of moving at a predetermined speed after the individual reels 5a to 5c started rotating, operations of the respective stop switches 21a to 21c are made effective. Namely, if the operations of stop switches 21a to 21c are made effective before the respective reels 5a to 5c reach a predetermined rotational speed, their stopping operations will be carried out while the reels 5a to 5c rotate at a lower speed, whereby there will be a stronger possibility of desirable symbols being displayed in their stopped state. As a consequence, the fun of gaming may not fully be enjoyed, whereas the profits may not adequately be balanced between the game parlor and the player. Therefore, after the symbols within the display window 4 have attained a state of moving at a higher speed, the operations of stop switches 21a to 21c are made effective.

Whether the individual stop switches 21a to 21c are made effective or not is indicated by illumination lamps (not depicted) disposed within or around the respective stop switches 21a to 21c. Namely, turning off the respective illumination lamps within the stop switches 21a to 21c and the like indicates that their corresponding stop switches 21a to 21c are not made effective, whereas turning on or blinking the respective illumination lamps within the stop switches 21a to 21c and the like indicates that their corresponding stop switches 21a to 21c are made effective.

However, when whether the individual stop switches 21a to 21c are effective or not is indicated simply by these illumination lamps and the like, it is difficult to call the attention of the player thereto, whereby the player may not reliably recognize the effectiveness of stop switches 21a to 21c. Therefore, the player may mistakenly operate the stop switches 21a to 21c before they are made effective, and will notice that the reels 5a to 5c do not rotate. As a consequence, the player may feel fretfulness or erroneously consider that the slot machine 50 is out of order, so unnecessary troubles may occur, whereby the fun of gaming may not fully be enjoyed.

In view of the foregoing circumstances, it is an object of the present invention to provide a gaming machine which can reliably notify the player whether operations of stopping means are effective or not, whereby the fun of gaming can fully be enjoyed.

### Probability of Occurrence of Special Winning Mode

On condition that a combination of symbols displayed at the time when the individual reels 5a to 5c are stopped constitutes a predetermined special winning mode among predetermined winning modes, the conventional slot machine 50 lets the player to start playing a special game which is more advantageous to the player than normal games.

In such a slot machine 50, there occurs a so-called ready state, i.e., a state in which, for example, among the laterally aligning three reels 5a to 5c, two reels 5a, 5b stop rotating while there is a possibility of a special winning mode occurring according to the symbol displayed on the remaining one reel 5c in its stopped state. Upon this ready state, the player feels an expectation for the occurrence of a special thereby being able to enhance the fun of gaming.

However, the conventional slot machine 50 does not indicate the occurrence of the ready state at all or indicates it simply by generating sound effects from a speaker or blinking the lamps in the decorating section 27, thus failing to reliably notify the player of the occurrence of the ready state. Therefore, the player may carelessly stop the remaining reel 5c without recognizing the occurrence of the ready state, thus failing to play a special game, thereby losing the fun of gaming.

In view of the foregoing circumstances, it is an object of the present invention to provide a gaming machine which can reliably notify the player of the possibility of a special winning mode occurring, whereby the fun of gaming can fully be enjoyed.

Possibility of Occurrence of Special Winning Mode and Reliability Thereof

As mentioned above, the conventional slot machine 50 lets the player to play a special game which is more advantageous to the player than normal games. For balancing the profits between the game parlor and the player and enhancing the fun of gaming, the slot machine 50 allowing such a special game to play does not stop the reels 5a to 5c according to the operations of stop switches 21a to 21c alone. Namely, whether to permit a special game to occur or not is sampled beforehand, and the individual reels 5a to 5c are controlled to stop such that a combination of stopped symbols constitutes a special winning mode only when the sampled results permits the special game to occur.

For example, in the case where the sampled result permits the special game to occur, even when the operating timing of the stop switches 21a to 21c slightly deviates from a timing at which symbols constituting the special winning mode are displayed in their stopped state, a rotation control operation for reels 5a to 5c known as so-called draw-in is effected such that the combination of stopped symbols constitutes the special winning mode. In the case where the sampled result does not permit a special game to be played, on the other hand, even when the stop switches 21a to 21c are operated at a timing at which symbols constituting the special winning mode are displayed in their stopped state, a rotation control operation for the reels 5a to 5c known as so-called slip is effected such that the combination of stopped symbols does not constitute the special winning mode.

Therefore, even in the case of a so-called ready state, i.e., a state in which, for example, among the laterally aligning three reels 5a to 5c, two reels 5a, 5b stop rotating while there is a possibility of a special winning mode occurring according to the symbol displayed on the remaining one reel 5c in its stopped state, the combination of stopped symbols does not always constitute the special winning mode. In other words, in the case where the sampled result permits a special game to occur, i.e., in the case where so-called bonus internal election (also known as internal winning) occurs, the possibility of a special winning mode occurring is very strong.

In the case of an internal election, the conventional slot machine 50 lights the back lamps (not depicted) for illuminating the respective reels 5a to 5c from therewithin or blinks the chance display section 52.

However, when the reliability with respect to possibility of occurrence of a special game is indicated by simply lighting back lamps or blinking the chance display section 52, not only it is difficult to call the attention of the player thereto, but also the player may fail to intuitively recognize the reliability. Therefore, the player may carelessly stop the individual reels 5a to 5c even when there is a very strong possibility of a special game occurring, thus failing to play the special game, thereby losing the fun of gaming.

In view of the foregoing circumstances, it is an object of the present invention to provide a gaming machine which can reliably notify the player of the possibility of a special winning mode occurring and the reliability thereof, whereby the fun of gaming can fully be enjoyed.

Occurrence of Normal Winning Mode and Special Winning Mode

When a combination of stopped symbols constitutes a winning mode such as a special winning mode, the conventional slot machine 50 lights the winning display lamp 10 and blinks the effective line display lamp 7a to 7e corresponding to the winning line along which the winning mode is constructed.

Meanwhile, in the case where a combination of stopped symbols constitutes a winning mode such as a special winning mode, game medals can be acquired as a prize. In particular, when the combination of stopped symbols constitutes a special winning mode, there occurs a game state where a greater number of game medals can be acquired than in a normal game, whereby the player can fully enjoy the fun of gaming.

However, when the occurrence of a normal winning mode or special winning mode or the occurrence of a higher-probability sampled state is indicated by simply lighting the winning display lamp 10 or blinking the effective line display lamp 7a to 7e corresponding to the winning line constituting the normal winning mode or special winning mode, it is difficult to call the attention of the player thereto, whereby the joy of winning may not sufficiently be given to the player.

In view of the foregoing circumstances, it is an object of the present invention to provide a gaming machine which can reliably notify the player of the occurrence of a normal winning mode or special winning mode, whereby the fun of gaming can fully be enjoyed.

Game Medal Pavout State

In the conventional slot machine 50, when a combination of stopped symbols constitutes a winning mode such as a special winning mode, so that game medals are paid out as a prize, the number of game medals to be paid out is displayed in the payout number display section 54 constituted by a seven-segment indicator or the like.

As mentioned above, in the case where a combination of stopped symbols constitutes a winning mode such as a special winning mode, game medals can be acquired as a prize. In particular, when the combination of stopped symbols constitutes a special winning mode, a greater number of game medals can be acquired than in a normal game, whereby the player can fully enjoy the fun of gaming.

However, when the payout of game medals is indicated by simply displaying the number of game medals in the payout number display section 54, it is difficult to call the attention of the player thereto, whereby the joy of winning may not fully be given to the player.

In view of the foregoing circumstances, it is an object of the present invention to provide a gaming machine which can reliably notify the player of the state of value information such as game medals and the like supplied to the player, whereby the fun of gaming can fully be enjoyed.

Occurrence of Replay Winning Mode

In the conventional slot machine 50, a replay winning mode is set in addition to normal winning modes, such that, when a combination of stopped symbols constitutes the replay winning mode, a replay is allowed to be performed under the condition similar to that in the last game without requiring game medals to be newly inserted.

In such a slot machine 50, when a combination of stopped symbols constitutes the replay winning mode, the replay display lamp 8 is lit, so as to notify the player that a replay can be performed.

However, when the fact that the replay can be performed is indicated by simply lighting the replay display lamp 8, it is difficult to call the attention of the player thereto, whereby the player may not reliably recognize the fact that the replay winning mode is generated. Therefore, game medals may be newly inserted in vain, whereby the fun of gaming may be lost. Also, if game medals are newly inserted, they will be returned. As a consequence, the slot machine 50 may mistakenly be considered to be out of order, whereby unnecessary troubles may occur.

In view of the foregoing circumstances, it is an object of the present invention to provide a gaming machine which can reliably notify the player of the occurrence of a replay winning mode, whereby the fun of gaming can fully be enjoyed.

Gaming Machine Information in Gaming Machine

When no game is played, display modes of individual display sections and the like do not change at all in the conventional slot machine 50, whereby the display sections and the like are not effectively be utilized.

However, what kinds of games can be played with the slot machine 50, whether the games in the slot machine 50 are advantageous to the player or not, and the like are quite interesting matters to the player.

Therefore, if these information items can be provided by the slot machine 50 while playing no games, the fun of gaming can be enhanced.

In view of the foregoing circumstances, it is an object of the present invention to provide a gaming machine which can display gaming machine information to the player, whereby the fun of gaming can fully be enjoyed.

Dividend Game Medal Number

In the conventional slot machine 50, the dividend game medal number paid out when a winning mode is attained in a normal game and the dividend game medal number paid out when a winning mode is attained in a special game are displayed by the dividend display section 26 disposed at the upper portion of the front face of the housing 3.

These dividend game medal numbers directly relate to the profits of the player, and thus are quite interesting matters to the player.

However, the dividend display section 26 simply indicates these dividend game medal numbers and may fail to call the attention of the player, whereby the player may not reliably recognize the dividend game medal numbers.

In view of the foregoing circumstances, it is an object of the present invention to provide a gaming machine which can reliably notify the player of value information units such as game medals supplied to the player when a winning mode is attained in a normal game or in a special game, or the like, whereby the fun of gaming can fully be enjoyed.

### SUMMARY OF THE INVENTION

For achieving the above-mentioned objects, the gaming machine in accordance with the present invention is configured as follows.

The gaming machine in accordance with the present invention comprises:

variable display means for variably displaying a plurality of kinds of symbols necessary for gaming;

starting means for starting variably displaying the symbols; and

stopping means, disposed so as to be operable by a player, for stopping the symbols being variably displayed;

wherein the player is provided with a profit if a combination of symbols displayed when the symbols are stopped constitutes a predetermined winning mode,

the gaming machine further comprising an image display section for displaying game information to the player.

The gaming machine may be a slot machine comprising:

variable display means comprising a plurality of reels displaying a plurality of symbols necessary for gaming;

starting means comprising a start switch for starting rotating the plurality of reels; and

stopping means comprising a stop switch for individually stopping the plurality of reels;

wherein the player is provided with a predetermined unit of value information if a combination of symbols displayed when the plurality of reels is stopped constitutes a predetermined stop mode.

Here, value information is information by which gaming is allowed in a gaming machine. When it is under the player's hand, it refers to cash, game medals, and information equivalent thereto stored in a prepaid card. When it is stored within a gaming machine, it refers to credited numbers.

The gaming machine in accordance with the present invention may be configured such that:

the predetermined winning mode includes a special winning mode which becomes a starting condition for playing a special game which is more advantageous to the player than a normal game; and

the image display section displays the game information in the normal game.

The gaming machine in accordance with the present invention may be configured such that:

the starting means uses an input of predetermined bet information as an actuating condition; and

the game information displayed in the image display section is game information concerning permission to input the bet information.

Here, the bet information is information concerning whether a bet operation is effected or not.

The input of bet information refers to inserting game medals or operating a bet button within a credited range.

The gaming machine in accordance with the present invention may be configured such that:

the starting means uses an input of predetermined bet information as an actuating condition; and

the game information displayed in the image display section is game information concerning an input unit of the bet information.

The gaming machine in accordance with the present invention may be configured such that:

the game information displayed in the image display section is game information concerning a unit of value information stored in the gaming machine.

The gaming machine in accordance with the present invention may be configured such that:

the game information displayed in the image display section is game information concerning an input mode of the bet information.

The gaming machine in accordance with the present invention may be configured such that:

the game information displayed in the image display section is game information concerning whether a game is permitted to start or not.

The gaming machine in accordance with the present invention may be configured such that:

the game information displayed in the image display section is game information concerning a wait time until a game is permitted to start.

The gaming machine in accordance with the present invention may be configured such that:

the game information displayed in the image display section is game information concerning whether an operation of the stopping means is effective or not.

The gaming machine in accordance with the present invention may be configured such that:

the game information displayed in the image display section is game information concerning a possibility of occurrence of the special winning mode.

The gaming machine in accordance with the present invention may be configured such that:

the game information displayed in the image display section is game information concerning a possibility of occurrence of the special winning mode and reliability thereof.

The gaming machine in accordance with the present invention may be configured such that:

the game information displayed in the image display section is game information for indicating an occurrence of the winning mode.

The gaming machine in accordance with the present invention may be configured such that:

the game information displayed in the image display section is game information for indicating only an occurrence of the special winning mode.

The gaming machine in accordance with the present invention may be configured such that:

the game information displayed in the image display section is game information for indicating a state of provision of value information provided for the player when the winning mode is attained.

The gaming machine in accordance with the present invention may be configured such that:

the game information displayed in the image display section is game information for indicating that a replay winning mode is generated.

The gaming machine in accordance with the present invention may be configured such that:

the game information displayed in the image display section is gaming machine information in the gaming machine.

The gaming machine in accordance with the present invention may be configured such that:

the game information displayed in the image display section is game information concerning a unit of value information provided for the player when the winning mode is attained.

The gaming machine in accordance with the present invention may be configured such that:

the game information displayed in the image display section comprises a game information item concerning a unit of value information provided for the player when the winning mode is attained in the normal game and a game information item concerning a unit of value information provided for the player when the winning mode is attained in the special game; and

the game information items are selectively displayed in the image display section.

The gaming machine in accordance with the present invention may further comprise an indicating section for indicating related game information relating to the game information displayed in the image display section.

The gaming machine in accordance with the present invention may be configured such that:

the game information displayed in the image display section is also displayable while the special game is being played.

The gaming machine in accordance with the present invention may be configured such that:

the game information displayed in the image display section is a moving image.

### BRIEF DESCRIPTION OF THE DRAWINGS

FIG. 1 is a perspective view of a slot machine in accordance with an embodiment of the present invention;

FIGS. 2A to 2D are explanatory views of game information (permission to input bet information and bet information input unit) displayed in an image display section;

FIGS. 3A to 3D are explanatory views of game information (permission to input bet information and bet information input unit) displayed in the image display section;

FIGS. 4A to 4C are explanatory views of game information (stored value information unit) displayed in the image display section;

FIG. 5 is an explanatory view of game information (input mode of bet information) displayed in the image display section;

FIGS. 6A and 6B are explanatory views of game information (input mode of bet information) displayed in the image display section;

FIGS. 7A and 7B are explanatory views of game information (permission to play a game and a wait time) displayed in the image display section;

FIGS. 8A to 8D are explanatory views of game information (effectiveness of operation of stopping means) displayed in the image display section;

FIG. 9 is an explanatory view of game information (possibility of occurrence of a special winning mode) displayed in the image display section;

FIGS. 10A to 10D are explanatory views of game information (possibility of occurrence of a special winning mode and reliability thereof) displayed in the image display section;

FIGS. 11A to 11D are explanatory views of game information (occurrence of a winning mode and providing of value information) displayed in the image display section;

FIGS. 12A to 12D are explanatory views of game information (occurrence of a special winning mode) displayed in the image display section;

FIGS. 13A and 13B are explanatory views of game information (occurrence of a replay winning mode) displayed in the image display section;

FIGS. 14A to 14C are explanatory views of game information (gaming machine information) displayed in the image display section;

FIGS. 15A to 15C are explanatory views of game information (provided value information unit) displayed in the image display section;

FIG. 16 is a front view of a conventional slot machine;

FIG. 17 is a front view of a slot machine in accordance with another embodiment of the present invention;

FIG. 18 is a schematic block diagram of the control unit (main control board) of the slot machine shown in FIG. 17;

FIG. 19 is a schematic block diagram of the control unit (sub-control board and image control board) of the slot machine shown in FIG. 17;

FIG. 20 is a flowchart showing a procedure of selecting flash data and a selection random number value to be transmitted to the sub-control board;

FIG. 21 is a flowchart showing a procedure of an image attraction process;

FIG. 22 is a flowchart showing a procedure of an attraction image selecting process;

FIG. 23 is a flowchart showing a detail of a procedure of selecting a losing appearing symbol in the attraction image selecting process when a ready state is produced;

FIG. 24 is a flowchart showing a procedure of a single character attraction process;

FIG. 25 is a flowchart showing a procedure of an appearing symbol attraction selecting process;

FIG. 26 is a flowchart showing a procedure of a ready-state attraction selecting process;

FIG. 27 is a flowchart showing a procedure of the ready-state attraction selecting process;

FIG. 28 is a flowchart showing a procedure of the ready-state attraction selecting process;

FIGS. 29A to 29D are explanatory charts of appearing symbol selection tables at the time when a ready state is produced;

FIG. 30 is an explanatory chart showing relationships between flash data tables/selection random number values and reel blinking patterns/game-starting sounds;

FIG. 31 is an explanatory chart showing relationships between flash data tables/selection random number values and reel blinking patterns/game-starting sounds;

FIG. 32 is an explanatory chart showing relationships between flash data tables/selection random number values and reel blinking patterns/game-starting sounds;

FIG. 33 is an explanatory chart showing relationships between flash data tables/selection random number values and reel blinking patterns/game-starting sounds;

FIG. 34 is an explanatory chart of reel blinking pattern (1);

FIG. 35 is an explanatory chart of reel blinking pattern (2);

FIG. 36 is an explanatory chart of reel blinking pattern (3);

FIG. 37 is an explanatory chart of reel blinking pattern (4);

FIG. 38 is an explanatory chart of reel blinking pattern (5);

FIG. 39 is an explanatory chart of reel blinking pattern (6);

FIG. 40 is an explanatory chart of reel blinking pattern (7);

FIG. 41 is an explanatory chart of reel blinking pattern (8);

FIG. 42 is an explanatory chart of a ready-state attraction data selection table (normal game: game-starting sound 1);

FIG. 43 is an explanatory chart of a ready-state attraction data selection table (normal game: game-starting sound 2);

FIG. 44 is an explanatory chart of a ready-state attraction data selection table (while a bonus hand being internally elected: game-starting sound 1);

FIG. 45 is an explanatory chart of a ready-state attraction data selection table (while a bonus hand being internally elected: game-starting sound 2);

FIG. 46 is an explanatory chart of a ready-state attraction data selection table (when definition data exist: game-starting sound 1);

FIG. 47 is an explanatory chart of a ready-state attraction data selection table (when definition data exist: game-starting sound 2);

FIGS. 48A and 48B are explanatory charts of single character attraction selection tables;

FIGS. 49A and 49B are explanatory charts of appearing symbol selection tables;

FIG. 50 is an explanatory chart of flash data selection tables and selection random number values;

FIG. 51 is an explanatory chart of transmission commands transmitted from the main control board to the sub-control board;

FIG. 52 is an explanatory view of game information (maker name) displayed in the image display section in accordance with the other embodiment;

FIG. 53 is an explanatory view of game information (maker name) displayed in the image display section in accordance with the other embodiment;

FIG. 54 is an explanatory view of game information (maker name) displayed in the image display section in accordance with the other embodiment;

FIG. 55 is an explanatory view of game information (model name) displayed in the image display section in accordance with the other embodiment;

FIG. 56 is an explanatory view of game information (model name) displayed in the image display section in accordance with the other embodiment;

FIG. 57 is an explanatory view of game information (model name) displayed in the image display section in accordance with the other embodiment;

FIG. 58 is an explanatory view of game information (dividend indication) displayed in the image display section in accordance with the other embodiment;

FIG. 59 is an explanatory view of game information (dividend indication) displayed in the image display section in accordance with the other embodiment;

FIG. 60 is an explanatory view of game information (dividend indication) displayed in the image display section in accordance with the other embodiment;

FIG. 61 is an explanatory view of game information (dividend indication) displayed in the image display section in accordance with the other embodiment;

FIG. 62 is an explanatory view of game information (dividend indication) displayed in the image display section in accordance with the other embodiment;

FIG. 63 is an explanatory view of game information (dividend indication) displayed in the image display section in accordance with the other embodiment;

FIG. 64 is an explanatory view of game information (dividend indication) displayed in the image display section in accordance with the other embodiment;

FIG. 65 is an explanatory view of game information (dividend indication) displayed in the image display section in accordance with the other embodiment;

FIG. 66 is an explanatory view of game information (dividend indication) displayed in the image display section in accordance with the other embodiment;

FIG. 67 is an explanatory view of game information (dividend indication) displayed in the image display section in accordance with the other embodiment;

FIG. 68 is an explanatory view of game information (dividend indication) displayed in the image display section in accordance with the other embodiment;

FIG. 69 is an explanatory view of game information (dividend indication) displayed in the image display section in accordance with the other embodiment;

FIG. 70 is an explanatory view of game information (dividend indication) displayed in the image display section in accordance with the other embodiment;

FIG. 71 is an explanatory view of game information (dividend indication) displayed in the image display section in accordance with the other embodiment;

FIG. 72 is an explanatory view of game information (dividend indication) displayed in the image display section in accordance with the other embodiment;

FIG. 73 is an explanatory view of game information (game explanation) displayed in the image display section in accordance with the other embodiment;

FIG. 74 is an explanatory view of game information (game explanation) displayed in the image display section in accordance with the other embodiment;

FIG. 75 is an explanatory view of game information (game explanation) displayed in the image display section in accordance with the other embodiment;

FIG. 76 is an explanatory view of game information (game explanation) displayed in the image display section in accordance with the other embodiment;

FIG. 77 is an explanatory view of game information (game explanation) displayed in the image display section in accordance with the other embodiment;

FIG. 78 is an explanatory view of game information (game explanation) displayed in the image display section in accordance with the other embodiment;

FIG. 79 is an explanatory view of game information (game explanation) displayed in the image display section in accordance with the other embodiment;

FIG. 80 is an explanatory view of game information (game explanation) displayed in the image display section in accordance with the other embodiment;

FIG. 81 is an explanatory view of game information (game explanation) displayed in the image display section in accordance with the other embodiment;

FIG. 82 is an explanatory view of game information (game explanation) displayed in the image display section in accordance with the other embodiment;

FIG. 83 is an explanatory view of game information (game explanation) displayed in the image display section in accordance with the other embodiment;

FIG. 84 is an explanatory view of game information (game explanation) displayed in the image display section in accordance with the other embodiment;

FIG. 85 is an explanatory view of game information (notice of occurrence of a ready state: ready-state notice 1) displayed in the image display section in accordance with the other embodiment;

FIG. 86 is an explanatory view of game information (notice of occurrence of a ready state: ready-state notice 1) displayed in the image display section in accordance with the other embodiment;

FIG. 87 is an explanatory view of game information (notice of occurrence of a ready state: ready-state notice 1) displayed in the image display section in accordance with the other embodiment;

FIG. 88 is an explanatory view of game information (notice of occurrence of a ready state: ready-state notice 1) displayed in the image display section in accordance with the other embodiment;

FIG. 89 is an explanatory view of game information (notice of occurrence of a ready state: ready-state notice 1) displayed in the image display section in accordance with the other embodiment;

FIG. 90 is an explanatory view of game information (notice of occurrence of a ready state: ready-state notice 2) displayed in the image display section in accordance with the other embodiment;

FIG. 91 is an explanatory view of game information (notice of occurrence of a ready state: ready-state notice 2) displayed in the image display section in accordance with the other embodiment;

FIG. 92 is an explanatory view of game information (notice of occurrence of a ready state: ready-state notice 2) displayed in the image display section in accordance with the other embodiment;

FIG. 93 is an explanatory view of game information (notice of occurrence of a ready state: ready-state notice 2) displayed in the image display section in accordance with the other embodiment;

FIG. 94 is an explanatory view of game information (notice of occurrence of a ready state: ready-state notice 2) displayed in the image display section in accordance with the other embodiment;

FIG. 95 is an explanatory view of game information (notice of occurrence of a ready state: ready-state notice 3) displayed in the image display section in accordance with the other embodiment;

FIG. 96 is an explanatory view of game information (notice of occurrence of a ready state: ready-state notice 3) displayed in the image display section in accordance with the other embodiment;

FIG. 97 is an explanatory view of game information (notice of occurrence of a ready state: ready-state notice 3) displayed in the image display section in accordance with the other embodiment;

FIG. 98 is an explanatory view of game information (notice of occurrence of a ready state: ready-state notice 3) displayed in the image display section in accordance with the other embodiment;

FIG. 99 is an explanatory view of game information (notice of occurrence of a ready state: ready-state notice 3) displayed in the image display section in accordance with the other embodiment;

FIG. 100 is an explanatory view of game information (attraction in a normal game) displayed in the image display section in accordance with the other embodiment;

FIG. 101 is an explanatory view of game information (attraction in the normal game) displayed in the image display section in accordance with the other embodiment;

FIG. 102 is an explanatory view of game information (attraction in the normal game) displayed in the image display section in accordance with the other embodiment;

FIG. 103 is an explanatory view of game information (attraction in the normal game) displayed in the image display section in accordance with the other embodiment;

FIG. 104 is an explanatory view of game information (attraction in the normal game) displayed in the image display section in accordance with the other embodiment;

FIG. 105 is an explanatory view of game information (attraction in the normal game) displayed in the image display section in accordance with the other embodiment;

FIG. 106 is an explanatory view of game information (attraction in the normal game) displayed in the image display section in accordance with the other embodiment;

FIG. 107 is an explanatory view of game information (attraction in the normal game) displayed in the image display section in accordance with the other embodiment;

FIG. 108 is an explanatory view of game information (notification of an internal election) displayed in the image display section in accordance with the other embodiment;

FIG. 109 is an explanatory view of game information (notification of the internal election) displayed in the image display section in accordance with the other embodiment;

FIG. 110 is an explanatory view of game information (notification of the internal election) displayed in the image display section in accordance with the other embodiment;

FIG. 111 is an explanatory view of game information (notification of the internal election) displayed in the image display section in accordance with the other embodiment;

FIG. 112 is an explanatory view of game information (notification of the internal election) displayed in the image display section in accordance with the other embodiment;

FIG. 113 is an explanatory view of game information (notification of the internal election) displayed in the image display section in accordance with the other embodiment;

FIG. 114 is an explanatory view of game information (notification of the internal election) displayed in the image display section in accordance with the other embodiment;

FIG. 115 is an explanatory view of game information (notification of the internal election) displayed in the image display section in accordance with the other embodiment;

FIG. 116 is an explanatory view of game information (notification of the internal election) displayed in the image display section in accordance with the other embodiment;

FIG. 117 is an explanatory view of game information (notification of the internal election) displayed in the image display section in accordance with the other embodiment;

FIG. 118 is an explanatory view of game information (notification of the internal election) displayed in the image display section in accordance with the other embodiment;

FIG. 119 is an explanatory view of game information (notification of the internal election) displayed in the image display section in accordance with the other embodiment;

FIG. 120 is an explanatory view of game information (notification of the internal election) displayed in the image display section in accordance with the other embodiment;

FIG. 121 is an explanatory view of game information (notice of an internally elected hand by a ready-state attraction: ready-state attraction 1) displayed in the image display section in accordance with the other embodiment;

FIG. 122 is an explanatory view of game information (notice of the internally elected hand by the ready-state attraction: ready-state attraction 1) displayed in the image display section in accordance with the other embodiment;

FIG. 123 is an explanatory view of game information (notice of an internally elected hand by a ready-state attraction: ready-state attraction 2) displayed in the image display section in accordance with the other embodiment;

FIG. 124 is an explanatory view of game information (notice of the internally elected hand by the ready-state attraction: ready-state attraction 2) displayed in the image display section in accordance with the other embodiment;

FIG. 125 is an explanatory view of game information (notice of the internally elected hand by the ready-state attraction: ready-state attraction 2) displayed in the image display section in accordance with the other embodiment;

FIG. 126 is an explanatory view of game information (notice of an internally elected hand by a ready-state attraction: ready-state attraction 3) displayed in the image display section in accordance with the other embodiment;

FIG. 127 is an explanatory view of game information (notice of the internally elected hand by the ready-state attraction: ready-state attraction 3) displayed in the image display section in accordance with the other embodiment;

FIG. 128 is an explanatory view of game information (notice of the internally elected hand by the ready-state attraction: ready-state attraction 3) displayed in the image display section in accordance with the other embodiment;

FIG. 129 is an explanatory view of game information (notice of the internally elected hand by the ready-state attraction: ready-state attraction 3) displayed in the image display section in accordance with the other embodiment;

FIG. 130 is an explanatory view of game information (notice of the internally elected hand by the ready-state attraction: ready-state attraction 3) displayed in the image display section in accordance with the other embodiment;

FIG. 131 is an explanatory view of game information (notice of the internally elected hand by the ready-state attraction: ready-state attraction 3) displayed in the image display section in accordance with the other embodiment;

FIG. 132 is an explanatory view of game information (notice of the internally elected hand by the ready-state attraction: ready-state attraction 3) displayed in the image display section in accordance with the other embodiment;

FIG. 133 is an explanatory view of game information (notice of the internally elected hand by the ready-state attraction: ready-state attraction 3) displayed in the image display section in accordance with the other embodiment;

FIG. 134 is an explanatory view of game information (notice of the internally elected hand by the ready-state attraction: ready-state attraction 3) displayed in the image display section in accordance with the other embodiment;

FIG. 135 is an explanatory view of game information (notice of the internally elected hand by the ready-state attraction: ready-state attraction 3) displayed in the image display section in accordance with the other embodiment;

FIG. 136 is an explanatory view of game information (notice of the internally elected hand by the ready-state attraction: ready-state attraction 3) displayed in the image display section in accordance with the other embodiment;

FIG. 137 is an explanatory view of game information (notice of the internally elected hand by the ready-state attraction: ready-state attraction 3) displayed in the image display section in accordance with the other embodiment;

FIG. 138 is an explanatory view of game information (notice of the internally elected hand by the ready-state attraction: ready-state attraction 3) displayed in the image display section in accordance with the other embodiment;

FIG. 139 is an explanatory view of game information (notice of the internally elected hand by the ready-state attraction: ready-state attraction 3) displayed in the image display section in accordance with the other embodiment;

FIG. 140 is an explanatory view of game information (notice of the internally elected hand by the ready-state attraction: ready-state attraction 3) displayed in the image display section in accordance with the other embodiment;

FIG. 141 is an explanatory view of game information (notice of the internally elected hand by the ready-state attraction: ready-state attraction 3) displayed in the image display section in accordance with the other embodiment;

FIG. 142 is an explanatory view of game information (notice of the internally elected hand by the ready-state attraction: ready-state attraction 3) displayed in the image display section in accordance with the other embodiment;

FIG. 143 is an explanatory view of game information (notice of the internally elected hand by the ready-state attraction: ready-state attraction 3) displayed in the image display section in accordance with the other embodiment;

FIG. 144 is an explanatory view of game information (notice of the internally elected hand by the ready-state attraction: ready-state attraction 3) displayed in the image display section in accordance with the other embodiment;

FIG. 145 is an explanatory view of game information (notice of the internally elected hand by the ready-state attraction: ready-state attraction 3) displayed in the image display section in accordance with the other embodiment;

FIG. 146 is an explanatory view of game information (notice of an internally elected hand by a ready-state attraction: ready-state attraction 4) displayed in the image display section in accordance with the other embodiment;

FIG. 147 is an explanatory view of game information (notice of the internally elected hand by the ready-state attraction: ready-state attraction 4) displayed in the image display section in accordance with the other embodiment;

FIG. 148 is an explanatory view of game information (notice of the internally elected hand by the ready-state attraction: ready-state attraction 4) displayed in the image display section in accordance with the other embodiment;

FIG. 149 is an explanatory view of game information (notice of the internally elected hand by the ready-state attraction: ready-state attraction 4) displayed in the image display section in accordance with the other embodiment;

FIG. 150 is an explanatory view of game information (notice of the internally elected hand by the ready-state attraction: ready-state attraction 4) displayed in the image display section in accordance with the other embodiment;

FIG. 151 is an explanatory view of game information (notice of the internally elected hand by the ready-state attraction: ready-state attraction 4) displayed in the image display section in accordance with the other embodiment;

FIG. 152 is an explanatory view of game information (notice of the internally elected hand by the ready-state attraction: ready-state attraction 4) displayed in the image display section in accordance with the other embodiment;

FIG. 153 is an explanatory view of game information (notice of the internally elected hand by the ready-state attraction: ready-state attraction 4) displayed in the image display section in accordance with the other embodiment;

FIG. 154 is an explanatory view of game information (notice of the internally elected hand by the ready-state attraction: ready-state attraction 4) displayed in the image display section in accordance with the other embodiment;

FIG. 155 is an explanatory view of game information (notice of the internally elected hand by the ready-state attraction: ready-state attraction 4) displayed in the image display section in accordance with the other embodiment;

FIG. 156 is an explanatory view of game information (notice of the internally elected hand by the ready-state attraction: ready-state attraction 4) displayed in the image display section in accordance with the other embodiment;

FIG. 157 is an explanatory view of game information (notice of the internally elected hand by the ready-state attraction: ready-state attraction 4) displayed in the image display section in accordance with the other embodiment;

FIG. 158 is an explanatory view of game information (notice of the internally elected hand by the ready-state attraction: ready-state attraction 4) displayed in the image display section in accordance with the other embodiment;

FIG. 159 is an explanatory view of game information (notice of the internally elected hand by the ready-state attraction: ready-state attraction 4) displayed in the image display section in accordance with the other embodiment;

FIG. 160 is an explanatory view of game information (notice of the internally elected hand by the ready-state attraction: ready-state attraction 4) displayed in the image display section in accordance with the other embodiment;

FIG. 161 is an explanatory view of game information (notice of the internally elected hand by the ready-state attraction: ready-state attraction 4) displayed in the image display section in accordance with the other embodiment;

FIG. 162 is an explanatory view of game information (notice of the internally elected hand by the ready-state attraction: ready-state attraction 4) displayed in the image display section in accordance with the other embodiment;

FIG. 163 is an explanatory view of game information (notice of the internally elected hand by the ready-state attraction: ready-state attraction 4) displayed in the image display section in accordance with the other embodiment;

FIG. 164 is an explanatory view of game information (notice of the internally elected hand by the ready-state attraction: ready-state attraction 4) displayed in the image display section in accordance with the other embodiment;

FIG. 165 is an explanatory view of game information (notice of the internally elected hand by the ready-state attraction: ready-state attraction 4) displayed in the image display section in accordance with the other embodiment;

FIG. 166 is an explanatory view of game information (notice of the internally elected hand by the ready-state attraction: ready-state attraction 4) displayed in the image display section in accordance with the other embodiment;

FIG. 167 is an explanatory view of game information (notice of the internally elected hand by the ready-state attraction: ready-state attraction 4) displayed in the image display section in accordance with the other embodiment;

FIG. 168 is an explanatory view of game information (notice of the internally elected hand by the ready-state attraction: ready-state attraction 4) displayed in the image display section in accordance with the other embodiment;

FIG. 169 is an explanatory view of game information (notice of the internally elected hand by the ready-state attraction: ready-state attraction 4) displayed in the image display section in accordance with the other embodiment;

FIG. 170 is an explanatory view of game information (notice of the internally elected hand by the ready-state attraction: ready-state attraction 4) displayed in the image display section in accordance with the other embodiment;

FIG. 171 is an explanatory view of game information (notice of the internally elected hand by the ready-state attraction: ready-state attraction 4) displayed in the image display section in accordance with the other embodiment;

FIG. 172 is an explanatory view of game information (notice of an internally elected hand by a ready-state attraction: ready-state attraction 5) displayed in the image display section in accordance with the other embodiment;

FIG. 173 is an explanatory view of game information (notice of the internally elected hand by the ready-state attraction: ready-state attraction 5) displayed in the image display section in accordance with the other embodiment;

FIG. 174 is an explanatory view of game information (notice of the internally elected hand by the ready-state attraction: ready-state attraction 5) displayed in the image display section in accordance with the other embodiment;

FIG. 175 is an explanatory view of game information (notice of the internally elected hand by the ready-state attraction: ready-state attraction 5) displayed in the image display section in accordance with the other embodiment;

FIG. 176 is an explanatory view of game information (notice of the internally elected hand by the ready-state attraction: ready-state attraction 5) displayed in the image display section in accordance with the other embodiment;

FIG. 177 is an explanatory view of game information (notice of the internally elected hand by the ready-state attraction: ready-state attraction 5) displayed in the image display section in accordance with the other embodiment;

FIG. 178 is an explanatory view of game information (notice of the internally elected hand by the ready-state attraction: ready-state attraction 5) displayed in the image display section in accordance with the other embodiment;

FIG. 179 is an explanatory view of game information (notice of the internally elected hand by the ready-state attraction: ready-state attraction 5) displayed in the image display section in accordance with the other embodiment;

FIG. 180 is an explanatory view of game information (notice of the internally elected hand by the ready-state attraction: ready-state attraction 5) displayed in the image display section in accordance with the other embodiment;

FIG. 181 is an explanatory view of game information (notice of the internally elected hand by the ready-state attraction: ready-state attraction 5) displayed in the image display section in accordance with the other embodiment;

FIG. 182 is an explanatory view of game information (notice of the internally elected hand by the ready-state attraction: ready-state attraction 5) displayed in the image display section in accordance with the other embodiment;

FIG. 183 is an explanatory view of game information (notice of the internally elected hand by the ready-state attraction: ready-state attraction 5) displayed in the image display section in accordance with the other embodiment;

FIG. 184 is an explanatory view of game information (notice of the internally elected hand by the ready-state attraction: ready-state attraction 5) displayed in the image display section in accordance with the other embodiment;

FIG. 185 is an explanatory view of game information (notice of the internally elected hand by the ready-state attraction: ready-state attraction 5) displayed in the image display section in accordance with the other embodiment;

FIG. 186 is an explanatory view of game information (notice of the internally elected hand by the ready-state attraction: ready-state attraction 5) displayed in the image display section in accordance with the other embodiment;

FIG. 187 is an explanatory view of game information (notice of the internally elected hand by the ready-state attraction: ready-state attraction 5) displayed in the image display section in accordance with the other embodiment;

FIG. 188 is an explanatory view of game information (notice of the internally elected hand by the ready-state attraction: ready-state attraction 5) displayed in the image display section in accordance with the other embodiment;

FIG. 189 is an explanatory view of game information (notice of the internally elected hand by the ready-state attraction: ready-state attraction 5) displayed in the image display section in accordance with the other embodiment;

FIG. 190 is an explanatory view of game information (notice of the internally elected hand by the ready-state attraction: ready-state attraction 5) displayed in the image display section in accordance with the other embodiment;

FIG. 191 is an explanatory view of game information (notice of the internally elected hand by the ready-state attraction: ready-state attraction 5) displayed in the image display section in accordance with the other embodiment;

FIG. 192 is an explanatory view of game information (notice of the internally elected hand by the ready-state attraction: ready-state attraction 5) displayed in the image display section in accordance with the other embodiment;

FIG. 193 is an explanatory view of game information (notice of the internally elected hand by the ready-state attraction: ready-state attraction 5) displayed in the image display section in accordance with the other embodiment;

FIG. 194 is an explanatory view of game information (notice of the internally elected hand by the ready-state attraction: ready-state attraction 5) displayed in the image display section in accordance with the other embodiment;

FIG. 195 is an explanatory view of game information (notice of the internally elected hand by the ready-state attraction: ready-state attraction 5) displayed in the image display section in accordance with the other embodiment;

FIG. 196 is an explanatory view of game information (notice of the internally elected hand by the ready-state attraction: ready-state attraction 5) displayed in the image display section in accordance with the other embodiment;

FIG. 197 is an explanatory view of game information (notice of an internally elected hand by a ready-state attraction: ready-state attraction 6) displayed in the image display section in accordance with the other embodiment;

FIG. 198 is an explanatory view of game information (notice of the internally elected hand by the ready-state attraction: ready-state attraction 6) displayed in the image display section in accordance with the other embodiment;

FIG. 199 is an explanatory view of game information (notice of the internally elected hand by the ready-state attraction: ready-state attraction 6) displayed in the image display section in accordance with the other embodiment;

FIG. 200 is an explanatory view of game information (notice of the internally elected hand by the ready-state attraction: ready-state attraction 6) displayed in the image display section in accordance with the other embodiment;

FIG. 201 is an explanatory view of game information (notice of the internally elected hand by the ready-state attraction: ready-state attraction 6) displayed in the image display section in accordance with the other embodiment;

FIG. 202 is an explanatory view of game information (notice of the internally elected hand by the ready-state attraction: ready-state attraction 6) displayed in the image display section in accordance with the other embodiment;

FIG. 203 is an explanatory view of game information (notice of the internally elected hand by the ready-state attraction: ready-state attraction 6) displayed in the image display section in accordance with the other embodiment;

FIG. 204 is an explanatory view of game information (notice of the internally elected hand by the ready-state attraction: ready-state attraction 6) displayed in the image display section in accordance with the other embodiment;

FIG. 205 is an explanatory view of game information (notice of the internally elected hand by the ready-state attraction: ready-state attraction 6) displayed in the image display section in accordance with the other embodiment;

FIG. 206 is an explanatory view of game information (notice of an internally elected hand by a ready-state attraction: ready-state attraction 7) displayed in the image display section in accordance with the other embodiment;

FIG. 207 is an explanatory view of game information (notice of the internally elected hand by the ready-state attraction: ready-state attraction 7) displayed in the image display section in accordance with the other embodiment;

FIG. 208 is an explanatory view of game information (notice of the internally elected hand by the ready-state attraction: ready-state attraction 7) displayed in the image display section in accordance with the other embodiment;

FIG. 209 is an explanatory view of game information (notice of the internally elected hand by the ready-state attraction: ready-state attraction 7) displayed in the image display section in accordance with the other embodiment;

FIG. 210 is an explanatory view of game information (notice of the internally elected hand by the ready-state attraction: ready-state attraction 7) displayed in the image display section in accordance with the other embodiment;

FIG. 211 is an explanatory view of game information (notice of the internally elected hand by the ready-state attraction: ready-state attraction 7) displayed in the image display section in accordance with the other embodiment;

FIG. 212 is an explanatory view of game information (notice of the internally elected hand by the ready-state attraction: ready-state attraction 7) displayed in the image display section in accordance with the other embodiment;

FIG. 213 is an explanatory view of game information (attraction in a special game: the first normal game attraction in a big bonus game) displayed in the image display section in accordance with the other embodiment;

FIG. 214 is an explanatory view of game information (attraction in the special game: the first normal game attraction in the big bonus game) displayed in the image display section in accordance with the other embodiment;

FIG. 215 is an explanatory view of game information (attraction in the special game: the first normal game attraction in the big bonus game) displayed in the image display section in accordance with the other embodiment;

FIG. 216 is an explanatory view of game information (attraction in the special game: the first normal game attraction in the big bonus game) displayed in the image display section in accordance with the other embodiment;

FIG. 217 is an explanatory view of game information (attraction in the special game: the first normal game attraction in the big bonus game) displayed in the image display section in accordance with the other embodiment;

FIG. 218 is an explanatory view of game information (attraction in the special game: the first normal game attraction in the big bonus game) displayed in the image display section in accordance with the other embodiment;

FIG. 219 is an explanatory view of game information (attraction in the special game: the first normal game attraction in the big bonus game) displayed in the image display section in accordance with the other embodiment;

FIG. 220 is an explanatory view of game information (attraction in the special game: the first normal game attraction in the big bonus game) displayed in the image display section in accordance with the other embodiment;

FIG. 221 is an explanatory view of game information (attraction in the special game: the first normal game attraction in the big bonus game) displayed in the image display section in accordance with the other embodiment;

FIG. 222 is an explanatory view of game information (attraction in the special game: the first normal game attraction in the big bonus game) displayed in the image display section in accordance with the other embodiment;

FIG. 223 is an explanatory view of game information (attraction in the special game: the second normal game attraction in the big bonus game) displayed in the image display section in accordance with the other embodiment;

FIG. 224 is an explanatory view of game information (attraction in the special game: the second normal game attraction in the big bonus game) displayed in the image display section in accordance with the other embodiment;

FIG. 225 is an explanatory view of game information (attraction in the special game: the second normal game attraction in the big bonus game) displayed in the image display section in accordance with the other embodiment;

FIG. 226 is an explanatory view of game information (attraction in the special game: the second normal game attraction in the big bonus game) displayed in the image display section in accordance with the other embodiment;

FIG. 227 is an explanatory view of game information (attraction in the special game: the third normal game attraction in the big bonus game) displayed in the image display section in accordance with the other embodiment;

FIG. 228 is an explanatory view of game information (attraction in the special game: the third normal game attraction in the big bonus game) displayed in the image display section in accordance with the other embodiment;

FIG. 229 is an explanatory view of game information (attraction in the special game: the third normal game attraction in the big bonus game) displayed in the image display section in accordance with the other embodiment;

FIG. 230 is an explanatory view of game information (attraction in the special game: the third normal game attraction in the big bonus game) displayed in the image display section in accordance with the other embodiment;

FIG. 231 is an explanatory view of game information (attraction in the special game: an ending attraction for the big bonus game) displayed in the image display section in accordance with the other embodiment;

FIG. 232 is an explanatory view of game information (attraction in the special game: the ending attraction for the big bonus game) displayed in the image display section in accordance with the other embodiment;

FIG. 233 is an explanatory view of game information (attraction in the special game: the ending attraction for the big bonus game) displayed in the image display section in accordance with the other embodiment;

FIG. 234 is an explanatory view of game information (attraction in the special game: the ending attraction for the big bonus game) displayed in the image display section in accordance with the other embodiment;

FIG. 235 is an explanatory view of game information (attraction in the special game: the ending attraction for the big bonus game) displayed in the image display section in accordance with the other embodiment;

FIG. 236 is an explanatory view of game information (attraction in the special game: the ending attraction for the big bonus game) displayed in the image display section in accordance with the other embodiment;

FIG. 237 is an explanatory view of game information (attraction in the special game: the ending attraction for the big bonus game) displayed in the image display section in accordance with the other embodiment;

FIG. 238 is an explanatory view of game information (attraction in the special game: the ending attraction for the big bonus game) displayed in the image display section in accordance with the other embodiment;

FIG. 239 is an explanatory view of game information (attraction in the special game: the ending attraction for the big bonus game) displayed in the image display section in accordance with the other embodiment;

FIG. 240 is an explanatory view of game information (attraction in the special game: the ending attraction for the big bonus game) displayed in the image display section in accordance with the other embodiment;

FIG. 241 is an explanatory view of game information (attraction in the special game: the ending attraction for the big bonus game) displayed in the image display section in accordance with the other embodiment;

FIG. 242 is an explanatory view of game information (attraction in the special game: the first JAC game attraction) displayed in the image display section in accordance with the other embodiment;

FIG. 243 is an explanatory view of game information (attraction in the special game: the first JAC game attraction) displayed in the image display section in accordance with the other embodiment;

FIG. 244 is an explanatory view of game information (attraction in the special game: the first JAC game attraction) displayed in the image display section in accordance with the other embodiment;

FIG. 245 is an explanatory view of game information (attraction in the special game: the first JAC game attraction) displayed in the image display section in accordance with the other embodiment;

FIG. 246 is an explanatory view of game information (attraction in the special game: the first JAC game attraction) displayed in the image display section in accordance with the other embodiment;

FIG. 247 is an explanatory view of game information (attraction in the special game: the first JAC game attraction) displayed in the image display section in accordance with the other embodiment;

FIG. 248 is an explanatory view of game information (attraction in the special game: the first JAC game attraction) displayed in the image display section in accordance with the other embodiment;

FIG. 249 is an explanatory view of game information (attraction in the special game: the first JAC game attraction) displayed in the image display section in accordance with the other embodiment;

FIG. 250 is an explanatory view of game information (attraction in the special game: the first JAC game attraction) displayed in the image display section in accordance with the other embodiment;

FIG. 251 is an explanatory view of game information (attraction in the special game: the first JAC game attraction) displayed in the image display section in accordance with the other embodiment;

FIG. 252 is an explanatory view of game information (attraction in the special game: the first JAC game attraction) displayed in the image display section in accordance with the other embodiment;

FIG. 253 is an explanatory view of game information (attraction in the special game: the first JAC game attraction) displayed in the image display section in accordance with the other embodiment;

FIG. 254 is an explanatory view of game information (attraction in the special game: the first JAC game attraction) displayed in the image display section in accordance with the other embodiment;

FIG. 255 is an explanatory view of game information (attraction in the special game: the first JAC game attraction) displayed in the image display section in accordance with the other embodiment;

FIG. 256 is an explanatory view of game information (attraction in the special game: the first JAC game attraction) displayed in the image display section in accordance with the other embodiment;

FIG. 257 is an explanatory view of game information (attraction in the special game: the first JAC game attraction) displayed in the image display section in accordance with the other embodiment;

FIG. 258 is an explanatory view of game information (attraction in the special game: the first JAC game attraction) displayed in the image display section in accordance with the other embodiment;

FIG. 259 is an explanatory view of game information (attraction in the special game: the first JAC game attraction) displayed in the image display section in accordance with the other embodiment;

FIG. 260 is an explanatory view of game information (attraction in the special game: the first JAC game attraction) displayed in the image display section in accordance with the other embodiment;

FIG. 261 is an explanatory view of game information (attraction in the special game: the second JAC game attraction) displayed in the image display section in accordance with the other embodiment;

FIG. 262 is an explanatory view of game information (attraction in the special game: the second JAC game attraction) displayed in the image display section in accordance with the other embodiment;

FIG. 263 is an explanatory view of game information (attraction in the special game: the second JAC game attraction) displayed in the image display section in accordance with the other embodiment;

FIG. 264 is an explanatory view of game information (attraction in the special game: the second JAC game attraction) displayed in the image display section in accordance with the other embodiment;

FIG. 265 is an explanatory view of game information (attraction in the special game: the second JAC game attraction) displayed in the image display section in accordance with the other embodiment;

FIG. 266 is an explanatory view of game information (attraction in the special game: the second JAC game attraction) displayed in the image display section in accordance with the other embodiment;

FIG. 267 is an explanatory view of game information (attraction in the special game: the second JAC game attraction) displayed in the image display section in accordance with the other embodiment;

FIG. 268 is an explanatory view of game information (attraction in the special game: the second JAC game attraction) displayed in the image display section in accordance with the other embodiment;

FIG. 269 is an explanatory view of game information (attraction in the special game: the second JAC game attraction) displayed in the image display section in accordance with the other embodiment;

FIG. 270 is an explanatory view of game information (attraction in the special game: the third JAC game attraction) displayed in the image display section in accordance with the other embodiment;

FIG. 271 is an explanatory view of game information (attraction in the special game: the third JAC game attraction) displayed in the image display section in accordance with the other embodiment;

FIG. 272 is an explanatory view of game information (attraction in the special game: the third JAC game attraction) displayed in the image display section in accordance with the other embodiment;

FIG. 273 is an explanatory view of game information (attraction in the special game: the third JAC game attraction) displayed in the image display section in accordance with the other embodiment;

FIG. 274 is an explanatory view of game information (attraction in the special game: the third JAC game attraction) displayed in the image display section in accordance with the other embodiment;

FIG. 275 is an explanatory view of game information (attraction in the special game: the third JAC game attraction) displayed in the image display section in accordance with the other embodiment;

FIG. 276 is an explanatory view of game information (attraction in the special game: the third JAC game attraction) displayed in the image display section in accordance with the other embodiment;

FIG. 277 is an explanatory view of game information (attraction in the special game: the third JAC game attraction) displayed in the image display section in accordance with the other embodiment;

FIG. 278 is an explanatory view of game information (attraction in the special game: the third JAC game attraction) displayed in the image display section in accordance with the other embodiment;

FIG. 279 is an explanatory view of game information (attraction in the special game: the third JAC game attraction) displayed in the image display section in accordance with the other embodiment;

FIG. 280 is an explanatory view of game information (attraction in the special game: the third JAC game attraction) displayed in the image display section in accordance with the other embodiment;

FIG. 281 is an explanatory view of game information (attraction in the special game: the third JAC game attraction) displayed in the image display section in accordance with the other embodiment;

FIG. 282 is an explanatory view of game information (attraction in the special game: the third JAC game attraction) displayed in the image display section in accordance with the other embodiment;

FIG. 283 is an explanatory view of game information (attraction in the special game: the third JAC game attraction) displayed in the image display section in accordance with the other embodiment;

FIG. 284 is an explanatory view of game information (error indication) displayed in the image display section in accordance with the other embodiment;

FIG. 285 is an explanatory view of game information (error indication) displayed in the image display section in accordance with the other embodiment;

FIG. 286 is an explanatory view of game information (error indication) displayed in the image display section in accordance with the other embodiment;

FIG. 287 is an explanatory view of game information (error indication) displayed in the image display section in accordance with the other embodiment;

FIG. 288 is an explanatory view of game information (error indication) displayed in the image display section in accordance with the other embodiment;

FIG. 289 is an explanatory view of game information (error indication) displayed in the image display section in accordance with the other embodiment;

FIG. 290 is an explanatory view of a variable display area for appearing symbols displayed in the image display section;

FIGS. 291A to 291G are explanatory views of single characters used for noticing internally elected hands; and

FIGS. 292A to 292H are charts showing relationships between the overall flows of game information displayed in the image display section of the slot machine in accordance with the other embodiment and the drawings used for their explanations.

### DESCRIPTION OF THE PREFERRED EMBODIMENTS

In the following, embodiments of the gaming machine in accordance with the present invention will be explained.

By way of example, a slot machine will be explained as a typical gaming machine in the following.

Slot Machine

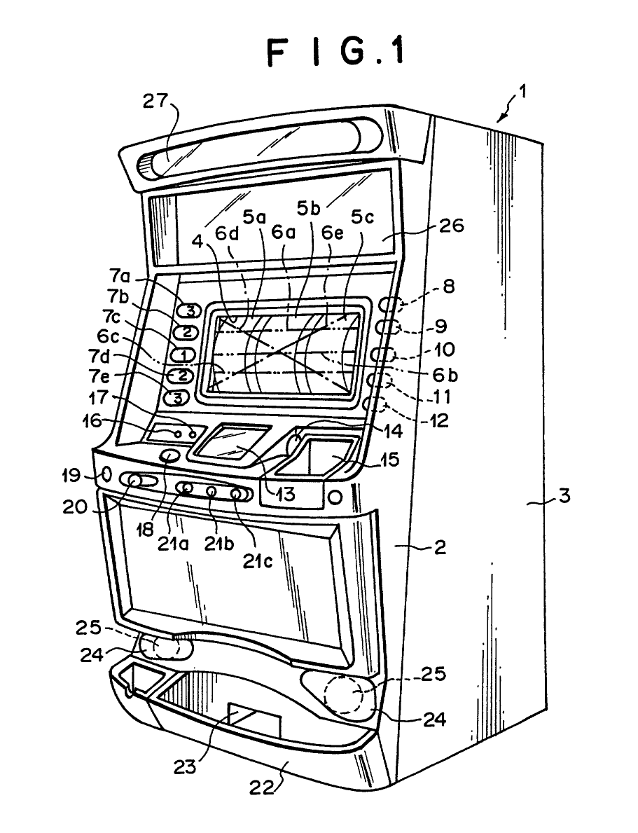

FIG. 1 is a perspective view showing an embodiment of the slot machine in accordance with the present invention.

As shown in FIG. 1, the slot machine 1 in accordance with the present invention has a housing 3 whose front side is provided with a front door 2 which is adapted to open and close. The front door 2 is formed with a display window 4 located above near the center of the front face thereof, whereas the respective outer peripheral surfaces of three reels 5a to 5c disposed within the housing 3 face the display window 4. Also, winning line indicators 6a to 6e for indicating respective effective winning lines are formed across the display window 4 so as to extend to the peripheries thereof. Here, five winning line indicators 6a to 6e in total constituted by three horizontal ones and two oblique ones crossing the horizontal ones are provided. Also, on the left end side of the respective winning line indicators 6a to 6e, effective line indicator lamps 7a to 7e for indicating the respective effective winning lines are provided.

Though the three reels 5a to 5c are disposed within one display window 4 in the embodiment shown in FIG. 1, discrete display windows may be provided so as to correspond to the respective reels 5a to 5c. Also, though five effective winning lines are provided here, they may have any number, such as seven, nine, and so forth.

Disposed on the right end side of the winning line indicators 6a to 6e are a replay display lamp 8 which is lit at the time of a replay winning, a game stop display lamp 9 for displaying a wait time from the starting of the last reel rotation until the next reel rotation is permitted to start, a winning display lamp 10 for indicating that a winning is generated, a game start display lamp 11 for indicating that a start switch 20 is made effective, and a game medal insertion lamp 12 for indicating that game medals are permitted to insert.

Disposed in the front face of the front door 2 nearly at the center thereof below the display window 4 is an image display section 13 for displaying game information. The image display section 13 is made of, for example, a liquid-crystal display, a plasma display, an EL display, a CRT display, a dot-matrix indicator, or the like, and is capable of displaying each game information item which will be explained later in detail.

Though the reels 5a to 5c, which are variable display means, and the image display section 13 are constructed as devices separate from each other, both of them may be displayed in the same display device by use of a CRT display having a size of about 17 inches, or the like. In this case, simulated reels can be displayed on the CRT in place of the reels 5a to 5c.

Disposed on the right side of the image display section 13 are a medal insertion slot 14 for inserting, one by one, game medals used for gaming; and a collective medal insertion slot 15 for simultaneously inserting a plurality of game medals used for gaming. Disposed on the left side of the image display section 13 are a first bet switch 16 for inserting, one by one, game medals used for gaming within a credited range; a second bet switch 17 for inserting, two by two, game medals used for gaming within the credited range; and a max bet switch 18 for inserting game medals used for gaming up to a maximum bet number (three in this embodiment) within the credited range.

Though not depicted, a card unit may be attached to the slot machine 1 so as to form a card type slot machine which accepts a valued medium such as a prepaid card or the like for loaning out game medals, so that credit can be made in a credit section as in the case where the game medals are inserted into the slot machine 1. Also, the card type slot machine may be configured such that, while the card unit is attached to the slot machine 1, a hopper of the slot machine main body is actuated upon a game medal loan-out operation, so as to loan out a predetermined number of game medals to a medal tray 22.

Below the image display section 13, the front face of the front door 2 is provided with a C/P switch 19 for changeover between the credit and the payout of the medals acquired by the player, the start switch 20 for starting rotating each of the reels 5a to 5c on condition that a game medal is inserted, and three stop switches 21a to 21c for stopping rotating the respective reels 5a to 5c.

Further provided in the lower part of the front door 2 is the medal tray 22 for receiving the game medals paid out as a prize, and a medal payout slot 23 facing the medal tray 22. Above the medal tray 22, the front face of the front door 2 is provided with a pair of right and left sound transmission holes 24, 24, whereas speakers 25, 25 are provided within the housing 3 so as to face the respective sound transmission holes 24, 24.

The upper part of the front face of the housing 3 is provided with a dividend display section 26 for displaying the number of dividend game medals to be paid out in reward for a winning, whereas a decorating section 27 provided with a plurality of decorating lamps (not depicted) is disposed above the dividend display section 26. The decorating section 27 is divided into a plurality of (e.g., 8) lateral sections, each section including a decorating lamp therewithin which is lit or blinked according to the state of gaming, thus being able to enhance the fun of gaming.

Within the housing 3, the reels 5a to 5c are rotatably disposed at their respective positions where their outer peripheral surfaces face the display window 4, whereas a hopper (not depicted) for paying out game medals as a prize is disposed at a position communicating with the medal payout slot 23. Also, a control unit (not depicted) for electrically controlling the slot machine 1 is disposed within the housing 3.

A light-transparent reel tape having a plurality of kinds of symbols displayed thereon at predetermined intervals is attached to the outer peripheral surface of each of the reels 5a to 5c. The kinds of symbols include “7,” “BAR,” “watermelon,” “cherry,” “plum,” and the like, for example, and each of the reels 5a to 5c displays 21 symbols. Here, the kinds of symbols and the number of symbols displayed in each of the reels 5a to 5c can be changed as appropriate. For example, the kinds of symbols may include, in addition to those mentioned above, “bell,” “orange,” “person,” “animal,” “fish,” “JAC,” and the like. Further, a plurality of colors may be applied to each symbol, such that the symbols are distinguishable from each other.

Disposed inside each of the reels 5a to 5c are three back lamps (not depicted) in a vertical row for illuminating from inside the respective reel 5a to 5c in a transmitting manner the symbols seen through the display window 4. As the back lamps are lit, each of the reels 5a to 5c can be illuminated from inside, whereby the symbols displayed in their stopped state on effective winning lines can be highlighted.

Game in Gaming Machine

To begin with, for playing a game with the slot machine 1, game medals are actually inserted into the medal insertion slot 14, 15, or any of the bet switches 16, 17, 18 is operated such that game medals used for gaming are inserted within the credited range. Here, effective winning lines are determined according to the number of inserted game medals, and their corresponding effective line indicator lamps 7a to 7e are lit. For example, one horizontal line in the middle becomes effective when one game medal is inserted; three horizontal lines in the upper, middle, and lower parts become effective when two game medals are inserted; and five lines in total consisting of three horizontal lines in the upper, middle, and lower parts and two oblique lines become effective when three game medals, which constitute the maximum permissible bet number, are inserted.

Subsequently, when the player operates the start switch 20, all the reels 5a to 5c start rotating at once, whereby a plurality of kinds of symbols formed on the respective outer peripheral surfaces of the reels 5a to 5c are displayed while vertically moving within the display window 4. When the rotation of each reel 5a to 5c reaches a predetermined speed, its corresponding stop switch 21a to 21c is made effective. Then, as the player operates each stop switch 21a to 21c , its corresponding reel 5a to 5c stops rotating.

Here, in the case where the combination of the symbols displayed on an effective winning line in their stopped state constitutes a predetermined winning mode, the number of game medals corresponding to this winning mode are paid out as a prize or added as a credit.

Winning Mode Predetermined winning modes include normal winning modes, and special winning modes to become a starting condition for special games which are more advantageous to the player than normal games. Further, the special winning modes include those of so-called big bonus and those of so-called regular bonus.

The normal winning modes include, for example, the cases where the combination of the symbols displayed on an effective winning line in their stopped state is constituted by “watermelon,” “watermelon,” and “watermelon”; where “cherry” is displayed in its stopped state on the left side of the display window; and the like, whereby a predetermined number of, e.g., 2 to 10, game medals are paid out. In this embodiment, 10 game medals are paid out when the combination of the symbols displayed on an effective winning line in their stopped state is constituted by “watermelon,” “watermelon,” and “watermelon”; 2 game medals are paid out when “cherry” is displayed in its stopped state on the left side of the display window; and so forth.

In addition, replay winning modes are set, so as to allow the player to play a game again under the same condition as that of the last game when the combination of the symbols displayed on an effective winning line in their stopped state is constituted by “plum,” “plum,” and “plum.”

Big Bonus

The winning modes of big bonus are concerned with games started on condition that the combination of symbols displayed on an effective winning line in their stopped state is constituted by “7,” “7,” and “7,” for example, whereby a predetermined number of, e.g., 15, game medals are paid out, and then a big bonus game in which the player can advantageously acquire a greater number of game medals than in a normal game can be played.

In this big bonus game, games similar to a normal game with a raised sampling probability of small hands, i.e., normal games in a big bonus game (normal games in BB), can be played up to 30 times. While this game similar to a normal game is being played, if the combination of symbols displayed on an effective winning line in their stopped state is constituted by “watermelon,” “watermelon,” and “watermelon,” then 10 game medals are paid out; if “cherry” is displayed on the left side of the display window in its stopped state, then 2 game medals are paid out; and, if the combination of symbols displayed on an effective winning line in their stopped state is constituted by “plum,” “plum,” and “plum,” then 5 game medals are paid out and JAC games are allowed to play up to 3 times.

JAC Game

In a JAC game, with insertion of a predetermined number of game medals, e.g., one game medal, the start switch 20 is operated so as to start rotating the reels 5a to 5c, and then the stop switches 21a to 21c are operated so as to stop rotating the respective reels 5a to 5c.

If a combination of stopped symbols constitutes a predetermined combination, e.g., “plum,” “plum,” and “plum,” then a predetermined number of, e.g., 15, game medals are paid out.

In the JAC game, the maximum number of games and the maximum number of winnings are restricted. For example, when the above-mentioned game similar to a normal game is played 12 times, which constitute the maximum game number, or the number of the above-mentioned winnings reaches 8, which is the maximum winning number, then the JAC game ends.

Regular Bonus

In addition to the above-mentioned big bonus, there are special game modes known as so-called regular bonus.

The winning modes of regular bonus are concerned with games started on condition that the combination of symbols displayed on an effective winning line in their stopped state is constituted by “BAR,” “BAR,” and “BAR,” for example, whereby a predetermined number of, e.g., 15, game medals are paid out, and then regular bonus games are allowed to be played.

In a regular bonus game, the acquirable profit is smaller than that in the above-mentioned big bonus game. For example, the above-mentioned JAC game is allowed to be played only once.

The foregoing series of gaming operations are controlled by the control unit disposed within the housing 3.

Notification of Game Information

The game information displayed by the image display section 13 during games in the slot machine 1 will now be explained specifically with reference to drawings.

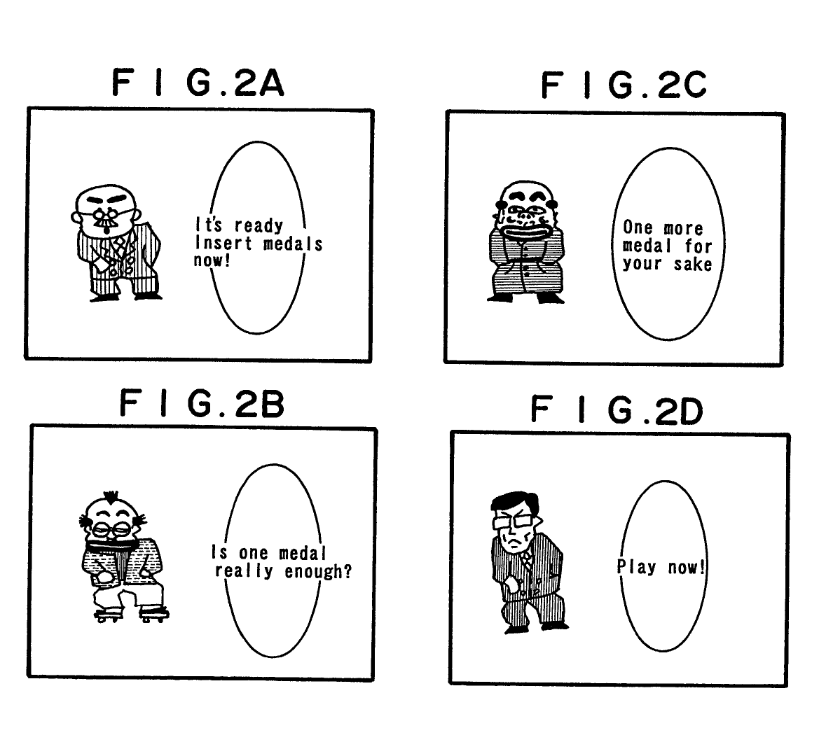

FIGS. 2A to 15 are explanatory views for explaining the game information displayed by the image display section 13 during games in the slot machine 1.

Permission to Insert Game Medal

The above-mentioned slot machine 1 permits game medals to be inserted after the preparation in the control unit is completed. For example, when the electric power is supplied to the slot machine 1 at the time of opening the parlor, game medals are permitted to be inserted after a predetermined initializing process is completed. After starting a game, game medals are permitted to be inserted after the game medal payout process and the like in the last game are completed.

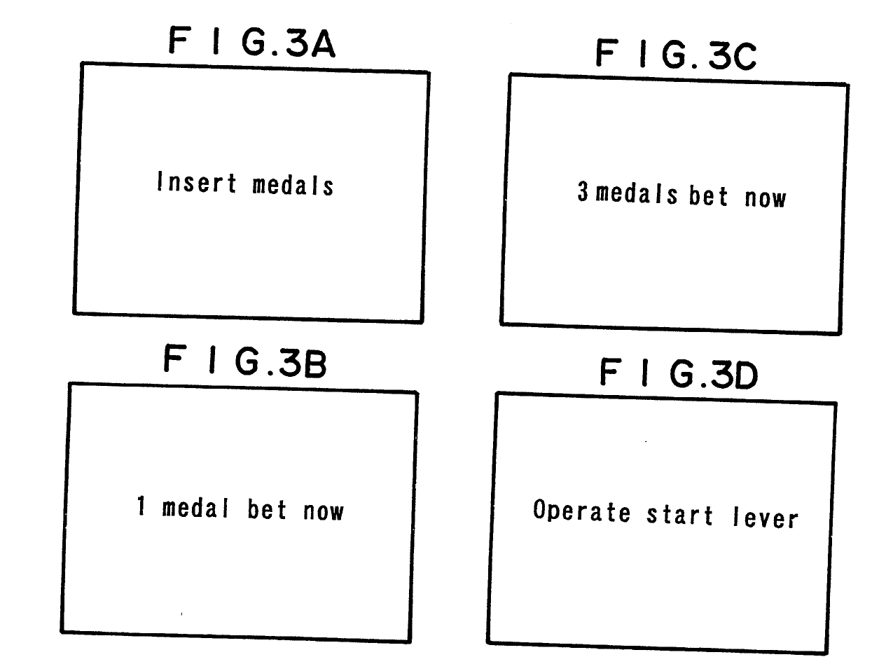

When the control unit permits game medals to be inserted, then the permission to insert game medals is displayed in the image display section 13 as shown in FIGS. 2A to 2D or 3A to 3D, so as to urge the player to insert game medals.

Namely, in the example shown in FIGS. 2A to 2D, characters and messages are displayed in the display section 13 so as to indicate the permission to insert game medals. First, a male character is posed, and a message is displayed so as to indicate that the insertion of game medals is permitted (FIG. 2A). Subsequently, other male characters are posed, and the number of currently inserted medals is displayed (FIGS. 2B and 2C). Further, when the maximum permissible bet number of (e.g., three) game medals are inserted, or a predetermined time has passed, a male character is posed, and a message is displayed so as to urge the player to start a game (FIG. 2D).

The example shown in FIGS. 3A to 3D indicates the permission to insert game medals by displaying messages alone in the image display section 13. First, a message is displayed so as to indicate that game medals are permitted to insert (FIG. 3A). Subsequently, the number of currently inserted medals is displayed (FIGS. 3B and 3C). Then, when the maximum permissible bet number of (e.g., three) game medals are inserted, or a predetermined time has passed, a message is displayed so as to urge the player to start a game (FIG. 3D).

The foregoing display of permission to insert game medals can be effected in any of the payout mode in which game medals are actually inserted into the medal insertion slots 14, 15 and the credit mode in which the individual bet switches 16, 17, 18 are operated so as to insert game medals within a credited range.

Also, when the maximum permissible bet number of game medals are inserted by operating the max bet switch 18 while the credit mode is selected, the display of the number of inserted game medals (FIGS. 2B, 2C, 3B, and 3C) can be omitted since it is clear that the maximum permissible bet number is attained.

For indicating the permission to insert game medals by the image display section 13, only one of the examples shown in FIGS. 2A to 2D and in FIGS. 3A to 3D may be displayed, or both of them may be displayed alternately.

Also, while the foregoing display by the image display section 13 is being effected, the game medal insertion lamp 12 may be blinked, or the lamps (not depicted) disposed within the respective bet switches 16, 17, 18 may be blinked.

Number of Inserted Game Medals

In the above-mentioned slot machine 1, game medals are inserted into the medal insertion slots 14, 15, or the bet switches 16, 17, 18 are operated, so as to insert game medals for playing games, whereby games can be played.

The maximum number of game medals which can be inserted in one game has been determined beforehand as the maximum permissible bet number. For example, when the maximum permissible bet number is three, then one, two, or three game medals can be inserted so as to play a game.

When game medals for playing a game are inserted, then the number of inserted game medals for playing the game is displayed in the image display section 13 as shown in FIGS. 2A to 2D or 3A to 3D.

Namely, in the example shown in FIGS. 2A to 2D, characters and messages are displayed in the image display section 13, so as to indicate the number of inserted game medals, such that, in a series of messages relating to the permission to insert game medals, the number of currently inserted game medals is displayed, and the player is urged to insert game medals up to the maximum permissible bet number (FIGS. 2B and 2C).

Here, the player is urged to insert the maximum permissible number of game medals since, as the number of inserted game medals increases, the number of effective winning lines increases, thus enhancing the probability of winning. For example, the probability of winning is 1/700 when two game medals are inserted, and 1/300 when three game medals are inserted. Therefore, as the number of inserted game medals increases, the player can play games under more advantageous conditions. Also, as the number of inserted game medals increases, the game parlor makes a greater profit.

In the example shown in FIGS. 3A to 3D, messages are displayed alone in the image display section 13, such that, in a series of messages relating to the permission to insert game medals, the number of currently inserted game medals is displayed (FIGS. 3B and 3C).

For indicating the number of inserted medals in the image display section 13, only one of the examples shown in FIGS. 2A to 2D and in FIGS. 3A to 3D may be displayed, or both of them may be displayed alternately.

Also, while the foregoing display by the image display section 13 is being effected, the effective line indicator lamps 7a to 7e may be lit, or the back lamps (not depicted) for illuminating the respective reels 5a to 5c from inside may be lit so as to correspond to the effective winning lines. Further, the example shown in FIGS. 2A to 2D may be constituted by character displays alone with no messages. Also, messages may be expressed by voices.

Thus, as different characters and messages are displayed according to the progress of a game so as to indicate the permission to accept game medals, the number of inserted game medals, the urge to start a game, and so forth, which step the current gaming state is in can easily be recognized.

Number of Credited Game Medals

The above-mentioned slot machine 1 allows game medals inserted from the medal insertion slot 14, 15 and those paid out as a prize to be credited up to the maximum creditable number (e.g., 50 medals) so that games can be played within the limits of credited game medals.

Whether to play a game in such a credit mode or in a payout mode, in which game medals are inserted in each game and those paid out as a prize are actually paid out from the medal payout slot 23 to the medal tray 22, can be selected by operating the C/P switch 19. The C/P switch 19 is a cyclic switch by which the credit mode and the payout mode can be changed over therebetween.

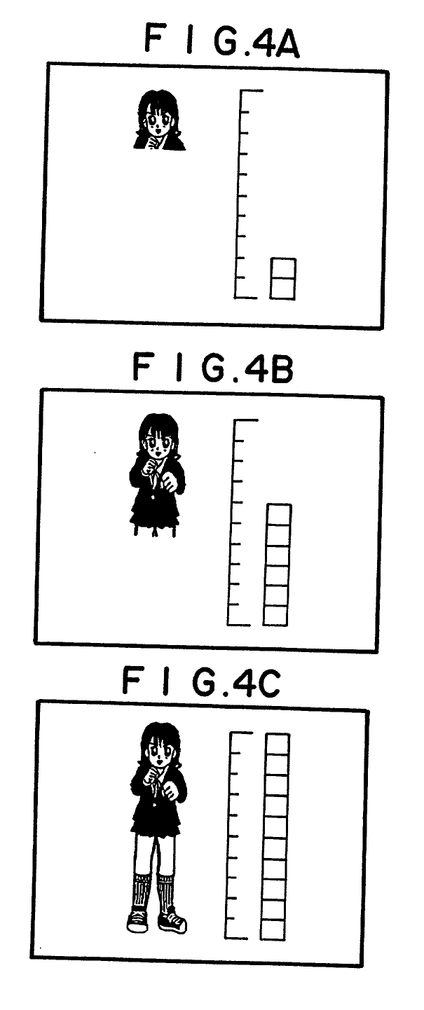

In the case where the game in the credit mode is selected, the outline of number of credited game medals is displayed in the image display section 13 as shown in FIGS. 4A to 4C.

Namely, in the example shown in FIGS. 4A to 4C, as the number of credited game medals increases, a female character is displayed successively from head to feet, and the indicator scales up.

For example, in the case where the number of credited game medals is 10, the face of the female character is shown, while 2 units of the indicator are displayed (FIG. 4A). In the case where the number of credited game medals is 30, the upper half of the female character is shown, while 6 units of the indicator are displayed (FIG. 4B). In the case where the number of credited game medals is 50, the whole body of the female character is shown, while 10 units of the indicator are displayed (FIG. 4C). In this case, either the character or indicator may be displayed alone.

Further, the front face of the front door 2 may be provided with a credit number display section made of a seven-segment indicator or the like, so as to display the number of credited game medals, while carrying out the above-mentioned display by the image display section 13.

Game Medal Insertion Mode

As mentioned above, the insertion modes of game medals can be altered as selected by the player in the slot machine 1, while each game mode has its own merits.

Namely, when a game is played in a payout mode, game medals are inserted into the medal insertion slot 14, 15 for each game, whereby each game can be enjoyed wholeheartedly. Also, when a winning mode such as a special winning mode is attained, then the joy of winning can fully be appreciated since the medals paid out as a prize are actually paid out from the medal payout slot 23 to the medal tray 22.

When a game is played in a credit mode, on the other hand, the labor of inserting the game medals into the medal insertion slot 14, 15 for each game can be omitted. Also, when the max bet switch 18 is operated so as to insert the maximum permissible bet number of (e.g., 3) game medals, the single switch operation allows the player to play a game with a higher winning probability advantageous to the player.

However, if the current game mode cannot be recognized, then a game matching each player's taste may not be played, whereby the player may feel fretfulness, thus losing the fun of gaming.

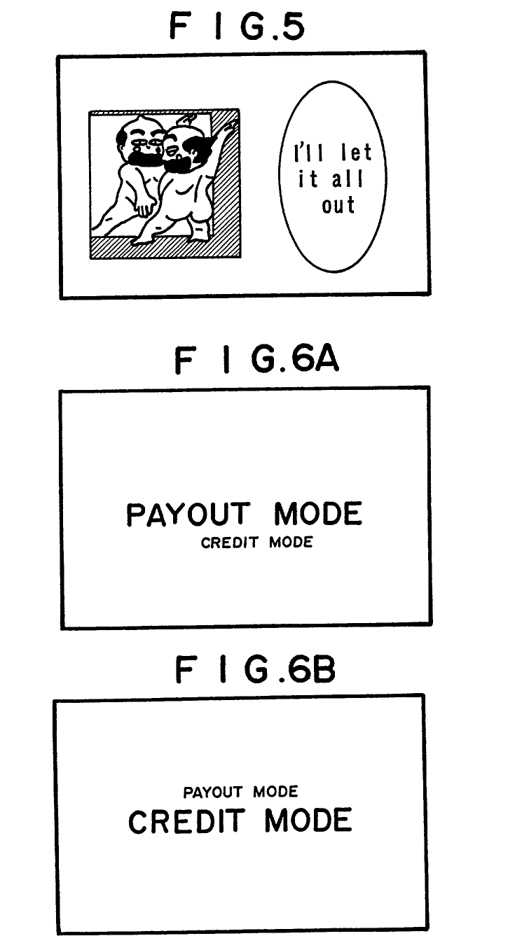

Therefore, as shown in FIGS. 5, 6A, and 6B, the above-mentioned slot machine 1 displays which game mode of the credit mode and payout mode is selected in the image display section 13.

Namely, the example shown in FIG. 5 indicates the insertion mode of game medals by displaying a character and a message in the image display section 13. Here, a male character is posed, and a message is displayed so as to indicate that it is in the payout mode. If the credit mode is selected, another character and another message display the same.

The example shown in FIGS. 6A and 6B indicates the insertion mode of game medals by displaying messages alone in the image display section 13. If the payout mode is selected, then larger letters of “PAYOUT MODE” are displayed while smaller letters of “CREDIT MODE” are displayed (FIG. 6A). If the credit mode is selected, then larger letters of “CREDIT MODE” are displayed while smaller letters of “PAYOUT MODE” are displayed (FIG. 6B).

The display concerning the insertion mode of game medals is effected when the C/P switch 19 is operated, when there is a predetermined period of time or more from the end of one game until the start of the next game, and so forth.

For indicating the insertion mode of game medals in the image display section 13, only one of the examples shown in FIG. 5 and in FIGS. 6A and 6B may be displayed, or both of them may be displayed alternately.

Also, in the case where the above-mentioned credit number display section is provided, the insertion mode of game medals may be indicated by whether there is a display in the credit number display section or not, while the display in the image display section 13 is effected.

Permission to Start Game and Wait Time

In the above-mentioned slot machine 1, for allowing games to be played soundly without excessively agitating the gambling spirit, and letting the fun of gaming to be fully enjoyed, a predetermined wait time is set from the starting of the last game until the starting of the next game, and the next game is permitted to start after the lapse of the wait time. The wait time is set to 4.1 seconds, for example. Until after 4.1 seconds from the starting of rotation of the reels 5a to 5c in the last game, the next game cannot be started even if the start switch 20 is operated.

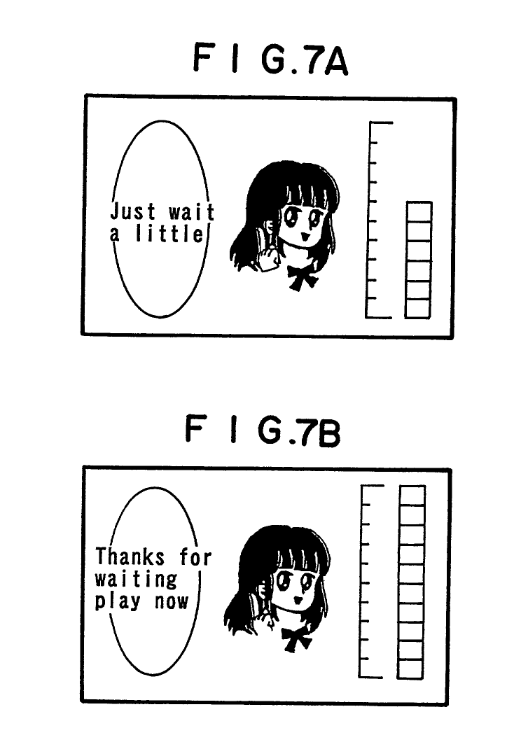

During such a wait time, as shown in FIGS. 7A and 7B, the image display section 13 indicates that it is a wait time, and the state of progress of wait time.

Namely, the example shown in FIGS. 7A and 7B indicates the progress of wait time by displaying a character and messages, so that, when the wait time has not completely passed, the face of a female character and a message indicating that it is a wait time are displayed, while an indicator is displayed by the amount corresponding to the lapse of wait time (FIG. 7A). For example, in FIG. 7A, 6 units out of 10 units of the indicator are displayed, so as to indicate that 60% of the wait time has passed. When the wait time is over, the face of the female character and a message indicating that the wait time is over are displayed, while 10 units of the indicator are displayed, so as to indicate that the wait time is over (FIG. 7B).

Since the image is changed according to the progress of wait time, it can easily seen when the wait time is over. Also, in this case, either the character or the indicator may be displayed alone.

The above-mentioned display of the permission to start a game and the wait time is not effected if the predetermined time has already been consumed in the last game.

Also, while the above-mentioned display by the image display section 13 is effected, the game stop display lamp 9 and the game start display lamp 11 may be turned on/off, so as to indicate the wait time and the permission to start a game.

Namely, being in a wait time may be indicated by turning on the game stop display lamp 9 while turning off the game start display lamp 11, and the permission to start a game may be indicated by turning off the game stop display lamp 9 while turning on the game start display lamp 11.

Effectiveness of Each Stop Switch Operation

In the above-mentioned slot machine 1, after the symbols within the display window 4 have attained a state where they are displayed while being moved at a predetermined speed after the individual reels 5a to 5c started rotating, operations of the respective stop switches 21a to 21c are made effective. It is because of the fact that, if the operations of the respective stop switches 21a to 21c are made effective before the moving display of symbols within the display window 4 attains a predetermined speed, then stopping operations can be carried out while the symbols displayed on the individual reels 5a to 5c are moving at a lower speed, so that winning modes are more likely to occur, whereby not only the profit of the game parlor may be lost, but also the fun of gaming may decrease. Hence, when individual symbols are permitted to stop after the moving display of the symbols within the display window 4 has reached a predetermined speed, it becomes possible for the player to exert a so-called see-and-push technique in which each of the stop switches 21a to 21c is operated so as to display a desirable symbol in its stopped state, thereby enhancing the fun of gaming, and balancing the profits between the game parlor and the player.

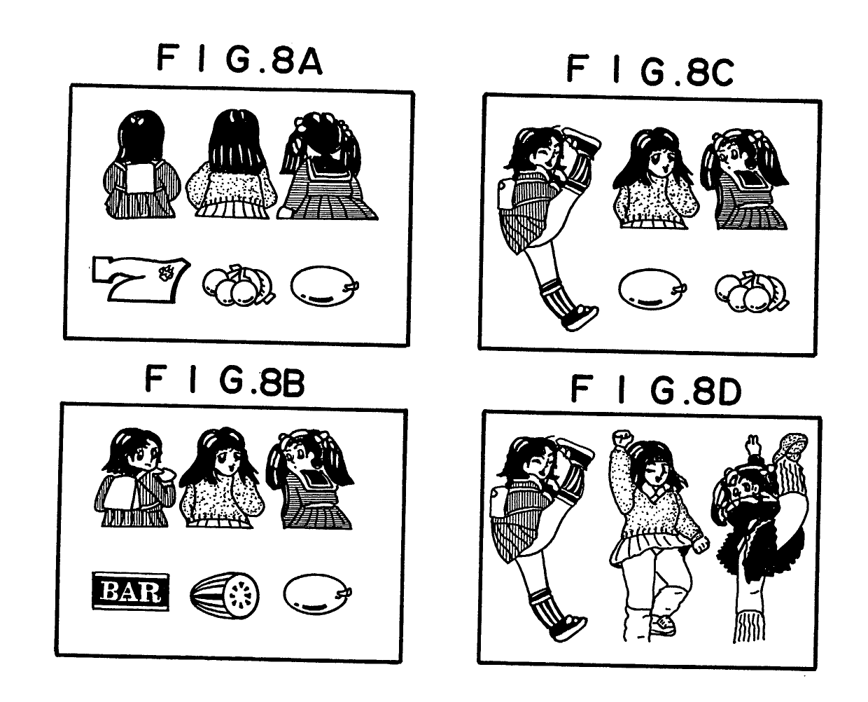

When the start switch 20 is operated, so that all the reels 5a to 5c start rotating at once, whether the individual stop switches 21a to 21c are effective or not is displayed in the image display section 13 as shown in FIGS. 8A to 8D.

Namely, in the example shown in FIGS. 8A to 8D, characters are displayed, so as to indicate whether the individual stop switches 21a to 21c are effective or not. Immediately after the start switch 20 is operated, so that the reels 5a to 5c start rotating, three female characters corresponding to the respective reels 5a to 5c are displayed so as to show their backs, thereby indicating that none of operations of the stop switches 21a to 21c are made effective (FIG. 8A). When the individual reels 5a to 5c have attained a predetermined rotational speed, their corresponding three female characters turn around so as to indicate that the respective stop switches 21a to 21c are made effective (FIG. 8B).

Subsequently, when the stop switch 21a corresponding to the left reel 5a is operated, the left female character raises a foot, so as to indicate that the reel 5a is stopped (FIG. 8C). Thus, when all the stop switches 21a to 21c are operated, then all the female characters raise a foot, so as to indicate that all the reels 5a to 5c have stopped (FIG. 8D).

When the individual reels 5a to 5c are rotating, the symbols passing on the center horizontal line may be displayed below the above-mentioned characters (FIGS. 8A to 8C). When the symbols passing on the center horizontal line are thus displayed, the moving display of symbols can be seen in the image display section 13 in addition to the moving display of symbols by the reels 5a to 5c themselves. Hence, it becomes easier for the player to exert the so-called see-and-push technique in which each of the stop switches 21a to 21c is operated so as to display a desirable symbol in its stopped state, thereby enhancing the fun of gaming. Since the display of characters is changed as the stop switches 21a to 21c are made effective, the player can grasp the effectiveness more reliably.

Here, while the above-mentioned display is carried out by the image display section 13, the illumination lamps (not depicted) disposed within or around the respective stop switches 21a to 21c may be turned on, so as to indicate that the stop switches 21a to 21c are made effective.

Possibility of Occurrence of Special Winning Mode

On condition that a combination of symbols displayed when the individual reels 5a to 5c are stopped constitutes a predetermined special winning mode, the above-mentioned slot machine 1 lets the player to play a special game which is more advantageous to the player than normal games.

In the case where a special winning mode occurs, as the stop switches 21a , 21b are operated, there initially occurs a state where, for example, the left and center reels 5a, 5b stop rotating, with a possibility of the special winning mode being generated depending on the symbol displayed on the remaining right reel 5c , i.e., a so-called ready state. In the case where the ready state is attained, the player can feel an expectation for the occurrence of a special game, thereby being able to enhance the fun of gaming.

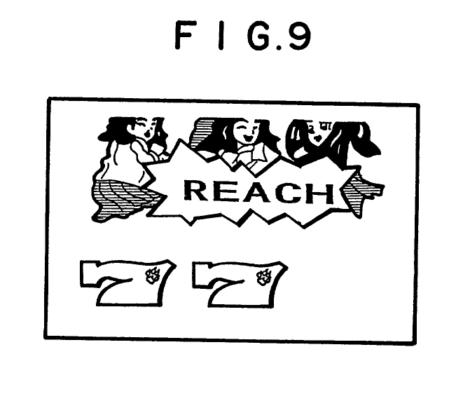

When such a ready state is attained, the image display section 13 indicates that the ready state is generated as shown in FIG. 9.

Namely, the example shown in FIG. 9 displays characters and a message so as to indicate that the ready state is generated. Here, the three female characters corresponding the respective reels 5a to 5c turn around, while letters of “REACH” are displayed, thereby indicating that it is the ready state.

Also, below the female characters, the stopped symbols of the respective reels 5a, 5b constituting the ready state may be displayed. When the stopped symbols constituting the ready state are displayed, it can be seen what mode of special game may occur.

The above-mentioned display concerning the possibility of occurrence of special winning modes by the image display section 13 can be effected in either one or both of the ready state for big bonus and the ready state for regular bonus.

Also, while the above-mentioned display by the image display section 13 is effected, sound effects may be generated from the speakers 25, or the lamps of the decorating section 27 may be blinked, so as to indicate the possibility of occurrence of the special winning mode.

Possibility of Occurrence of Special Winning Mode and Reliability Thereof

In the above-mentioned slot machine 1, for balancing the profits between the game parlor and the player, and enhancing the fun of gaming, the reels 5a to 5c are not stopped solely depending on the operations of stop switches 21a to 21c. Namely, whether to permit a special game to occur or not is sampled beforehand in the control unit, and the reels 5a to 5c are controlled to stop so as to constitute a special winning mode only if the result of sampling permits the special game to occur.

For example, in the case where the sampled result permits the special game to occur, even when the operating timing of the stop switches 21a to 21c slightly deviates from a timing at which symbols constituting the special winning mode are displayed in their stopped state, a rotation control operation for reels 5a to 5c known as so-called draw-in is effected so as to stop the reels 5a to 5c such that the combination of stopped symbols constitutes the special winning mode. In the case where the sampled result does not permit the special game to occur, on the other hand, even when the stop switches 21a to 21c are operated at a timing at which symbols constituting the special winning mode are displayed in their stopped state, a rotation control operation for the reels 5a to 5c known as so-called slip is effected so as to stop the reels 5a to 5c such that the combination of stopped symbols does not constitute the special winning mode. As a consequence, even in the case of the ready state, the combination of stopped symbols does not always constitute the special winning mode.

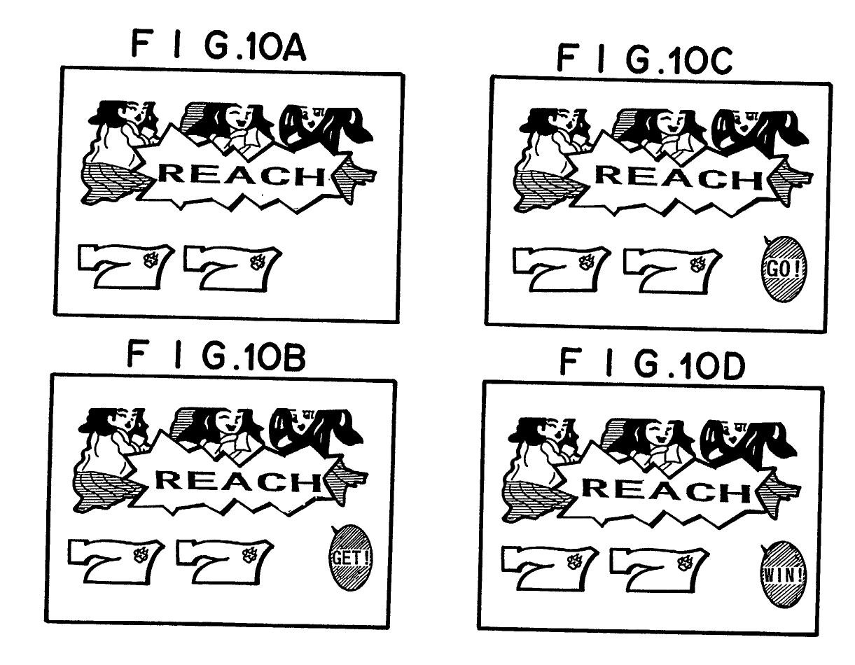

Therefore, when the ready state is generated, while the possibility of occurrence of the special winning mode is indicated as mentioned above, the reliability of possibility of occurrence of the special winning mode is displayed in the image display section 13 as shown in FIGS. 10A to 10D.

Namely, the example shown in FIGS. 10A to 10D displays characters and messages, so as to indicate the possibility of occurrence of the special winning mode in four steps, such that, while the three female characters corresponding to the respective reels 5a to 5c are posed, letters of “REACH” are displayed, and letters corresponding to respective degrees of reliability are further displayed (FIGS. 10A to 10D). For example, the reliability is the lowest in the case where no letters concerning the reliability is displayed as shown in FIG. 10A, the reliability is 15% in the case where the letters shown in FIG. 10B are displayed, the reliability is 50% in the case where the letters shown in FIG. 10C are displayed, and the reliability is 100% in the case where the letters shown in FIG. 10D are displayed.

Also, below the female characters, the stopped symbols of the respective reels 5a, 5b constituting the ready state may be displayed. When the stopped symbols constituting the ready state are displayed, it can be seen what mode of special game may occur.

The above-mentioned display concerning the reliability of possibility of occurrence of the special winning mode by the image display section 13 can be effected in either one or both of the ready state for big bonus and the ready state for regular bonus.

Also, the front face of the front door 2 may be provided with a chance display section for indicating that the result of sampling permits a special game to occur; and, while the above-mentioned display by the image display section 13 is effected, sound effects may be generated from the speakers 25, back lamps (not depicted) for illuminating the respective reels 5a to 5c from inside may be lit, or the chance display section may be blinked, so as to indicate the reliability of possibility of occurrence of the special winning mode.

Occurrence of Normal Winning Mode or Special Winning Mode and Payout of Game Medal

When a combination of stopped symbols constitutes a winning mode such as a special winning mode, the above-mentioned slot machine 1 allows the player to play a game in which game medals can be acquired as a prize. In particular, when the combination of stopped symbols constitutes a special winning mode, the player can play a game in which a greater number of game medals can be obtained than in a normal game.

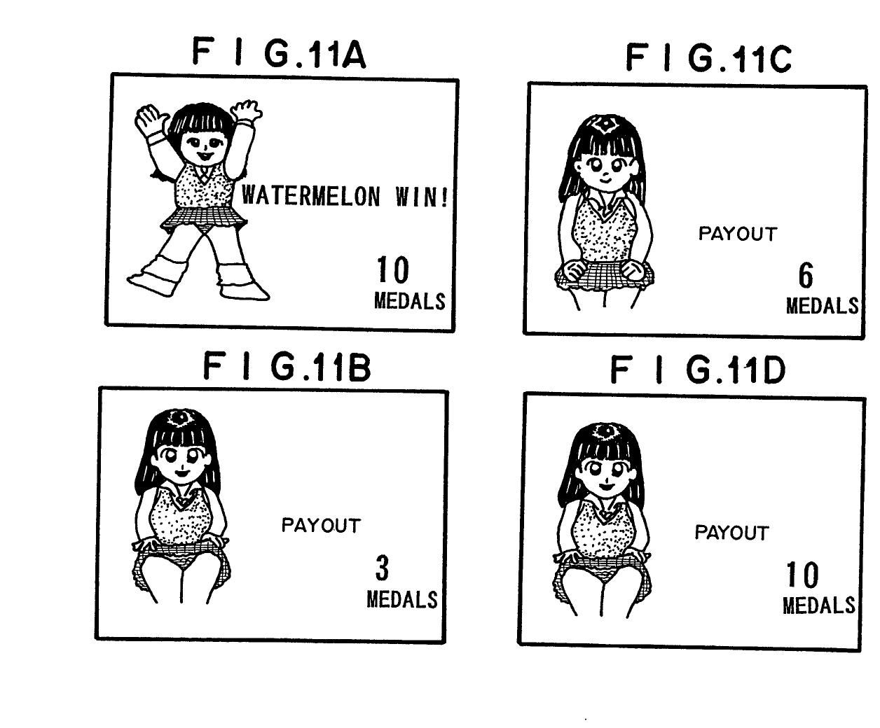

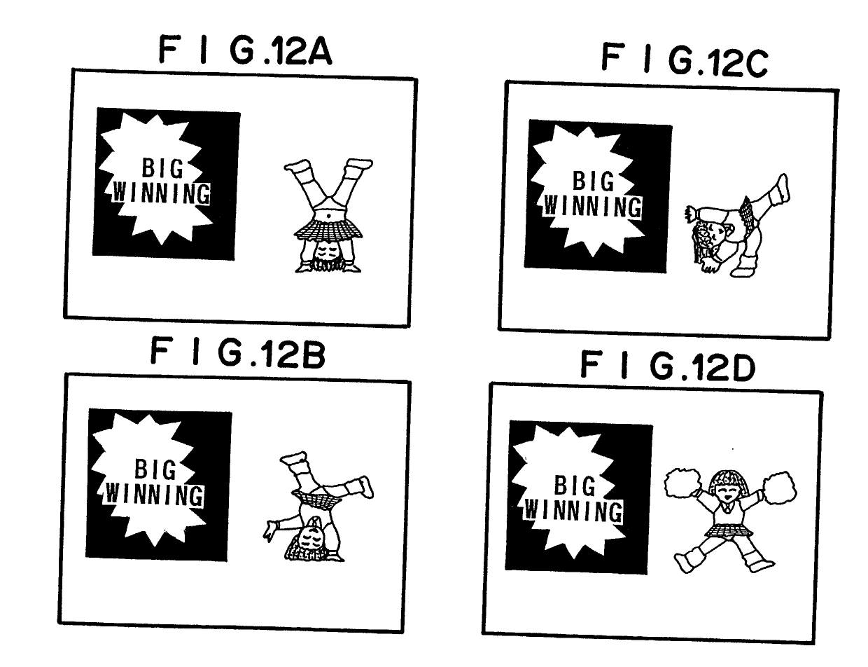

When a combination of stopped symbols thus constitutes a normal winning mode or special winning mode, as shown in FIGS. 11A to 11D and 12A to 12D, the image display section 13 indicates that the normal winning mode or special winning mode is generated.

Namely, the example shown in FIGS. 11A to 11D displays a character and messages, so as to indicate that a combination of stopped symbols constitutes a normal winning mode. First, a female character is posed, and it is indicated that the winning mode is composed of “watermelon,” “watermelon,” and “watermelon” in which 10 game medals are to be paid out (FIG. 11A). Then, while the female character successively changes her pose, the numbers of paid-out game medals are displayed (FIGS. 11B to 11D). FIGS. 11B to 11D indicate that 3, 6, and 10 game medals are paid out, respectively.

Though the example shown in FIGS. 11A to 11D indicates that it is the winning mode of “watermelon,” “watermelon,” and “watermelon,” similar displays can be effected for other normal winning modes as well.

The example shown in FIGS. 12A to 12D displays a character and a message, so as to indicate that a combination of stopped symbols constitutes a special winning mode, such that a female character is displayed with successively changing poses, while letters of “BIG WINNING” indicating the occurrence of the special winning mode are displayed (FIGS. 12A to 12D).

Though the kind of special winning mode and the number of paid-out game medals are not displayed in the example shown in FIGS. 12A to 12D, whether it is a big bonus or a regular bonus may be displayed, and the number of paid-out game medals may be displayed as in the example shown in FIGS. 11A to 11D.

Also, while the above-mentioned display by the image display section 13 is effected, the winning display lamp 10 may be lit, or the effective line indicator lamp 7a to 7e corresponding to the winning line constituting the normal or special winning mode may be blinked, so as to indicate that the normal winning mode or special winning mode is generated.

Further, the front face of the front door 2 may be provided with a payout number display section comprising a seven-segment indicator or the like for displaying the number of game medals to be paid out as a prize; and, while the above-mentioned display by the image display section 13 is effected, the number of paid-out game medals may be displayed in the payout number display section.

As a consequence of such a configuration, the player can visually be impressed with the fact that game medals are paid out upon the election in the sampling in the control unit. Also, since an animated display is made as the game medals are paid out, the joy at the time of game medal payout can be enhanced.

Occurrence of Replay Winning Mode

When the combination of stopped symbols is composed of “plum,” “plum,” and “plum,” for example, the above-mentioned slot machine 1 allows a replay under a condition similar to that in the last game.

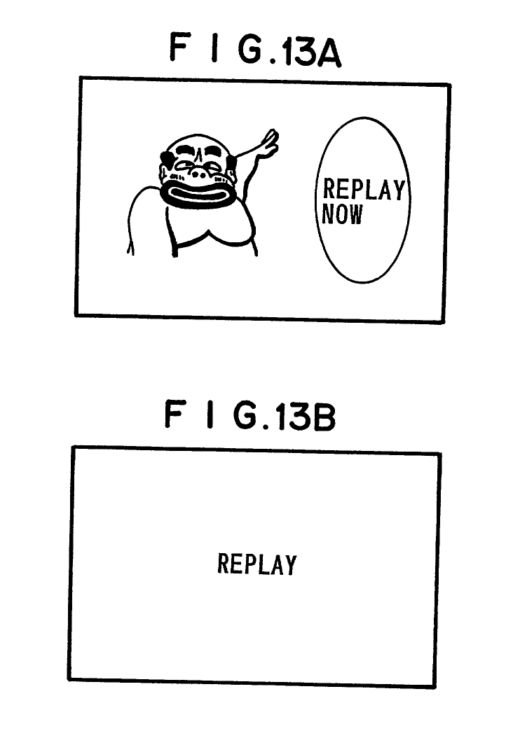

When such a combination of stopped symbols for a replay is attained, the image display section 13 indicates that a replay winning mode is generated as shown in FIGS. 13A and 13B.

Namely, the example shown in FIG. 13A displays a character and a message, so as to indicate that a replay winning mode is generated. Here, a male character is posed, and a message is displayed so as to indicate that it is a replay winning mode. On the other hand, the example shown in FIG. 13B displays a message alone, so as to indicate that a replay winning mode is generated, i.e., letters of “REPLAY” are displayed.

When the occurrence of replay winning mode is displayed in the image display section 13, any of the examples shown in FIGS. 13A and 13B may be displayed alone, or both of them may be displayed alternately.

Also, while the above-mentioned display by the image display section 13 is effected, the replay display lamp 8 may be lit, so as to indicate that the replay winning mode is generated.

Gaming Machine Information in Slot Machine

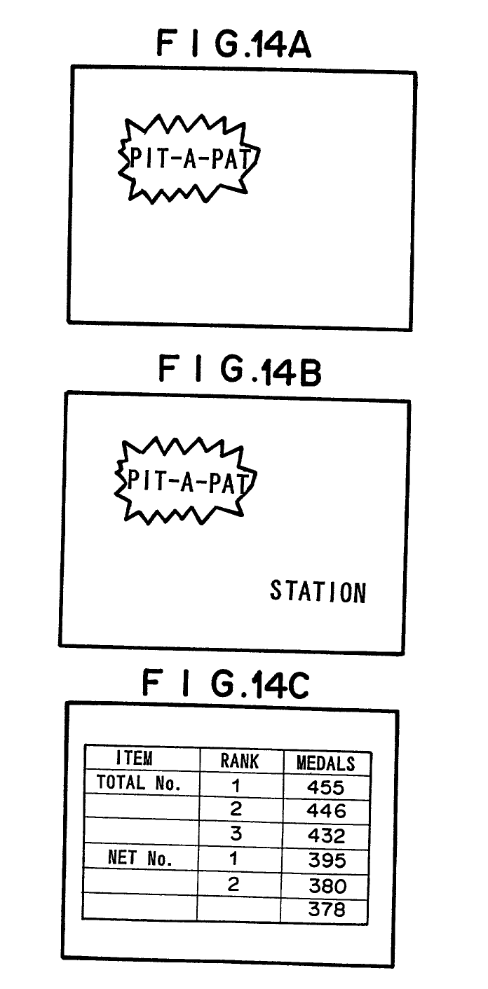

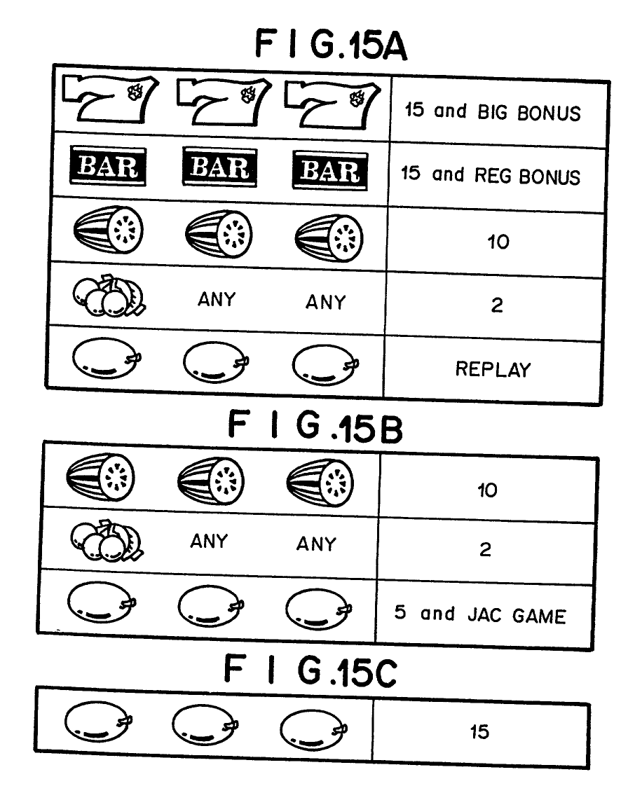

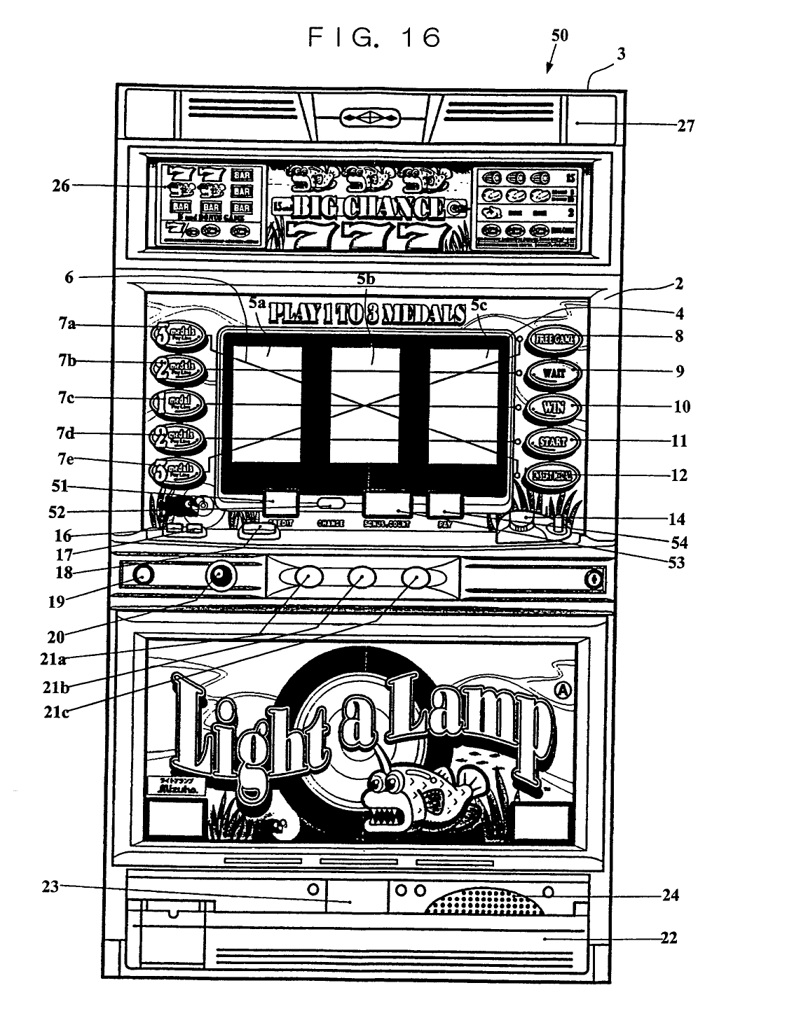

While no game is being played, the above-mentioned slot machine 1 displays a demonstration, which is gaming machine information, in the image display section 13 as shown in FIGS. 14A to 14C.

Namely, when no game medal is inserted during a period of 30 seconds after ending a game, the example shown in FIGS. 14A to 14C alternately displays two kinds of title logos (FIGS. 14A and 14B) and the ranking of the number of acquired medals in big bonus (FIG. 14C).

The ranking of the number of acquired medals in big bonus displays, as shown in FIG. 14C, the first to third places in each of the total number of acquired game medals and the net number of acquired game medals in the slot machine 1 on the same day, which the player can refer to in order to determine if this slot machine 1 is advantageous to the player or not. Here, the total number of acquired game medals refers to the total number of game medals paid out as a prize in a big bonus game, whereas the net number of acquired game medals refers to the number obtained when the number of game medals used for gaming is subtracted from the total number of acquired game medals.

The gaming machine information displayed in the image display section 13 is not limited to that mentioned above. For example, how to play games in the slot machine 1, the ranking of the number of acquired game medals including those in normal games, information from the game parlor, and the like may be displayed as well.

Also, without being restricted to the timing mentioned above, the gaming machine information may be displayed at any timing.

Number of Dividend Game Medals

As shown in FIGS. 15A to 15C, at a predetermined timing, in the above-mentioned slot machine 1, the image display section 13 displays the number of dividend game medals to be paid out as a prize when a combination of stopped symbols constitutes a predetermined winning mode.

The display of the number of dividend game medals is constituted by the numbers of dividend game medals to be paid out when winning modes are attained in a normal game (FIG. 15A) and the numbers of dividend game medals to be paid out when winning modes are attained in special games (FIGS. 15B and 15C), which are selectively displayed according to the state of each game. Here, FIG. 15C displays the number of dividend game medals to be paid out when a winning mode is attained in a JAC game during a special game.

As a consequence of such a configuration, the dividend display varies in synchronization with changes in the combination of symbols constituting a winning mode and in the number of dividend game medals along with changes in the state of gaming, the player can easily grasp which winning modes should be targeted in the current game, or how many the dividend game medals are.

The numbers of dividend game medals can be displayed at any timing. For example, all the dividend game medal numbers may be successively displayed together with the above-mentioned gaming machine information, the dividend game medal number concerning a special game may be displayed when a special winning mode is attained, and the dividend game medal number concerning the JAC game may be displayed when the winning mode for the JAC game is attained.

As mentioned above, the dividend game medal numbers are also displayed in the dividend display section 26.

Indicating Section

While each game information is displayed by the image display section 13 as mentioned above, an indicating section for indicating related game information relating to the game information displayed in the image display section 13 may be provided, so as to indicate the related game information.

This indicating section is constituted, for example, by the effective line indicator lamps 7a to 7e, the replay display lamp 8, the game stop lamp 9, the winning display lamp 10, the game start display lamp 11, the game medal insertion lamp 12, the speakers 25, a plurality of lamps disposed in the decorating section 27, and the like. Further, though not depicted, the lamps disposed inside the respective bet switches 16, 17, 18, the illumination lamps disposed within the respective stop switches 21a to 21c , the illumination lamps disposed around the respective stop switches 21a to 21c , the back lamps for illuminating the respective reels 5a to 5c from inside, the credit number display section, the chance display section, the payout number display section, and the like may constitute the indicating section as well.

Any one of these indicating sections or a combination of a plurality of indicating sections may indicate the related game information. Also, one indicating section may indicate a plurality of related game information items.

Display in Special Game

Though the above-mentioned embodiment explains the display of each game information in the image display section 13 in the case where a normal game is played, the above-mentioned display of each game information can also be effected in the case where a special game is played.

Slot Machine of Another Embodiment

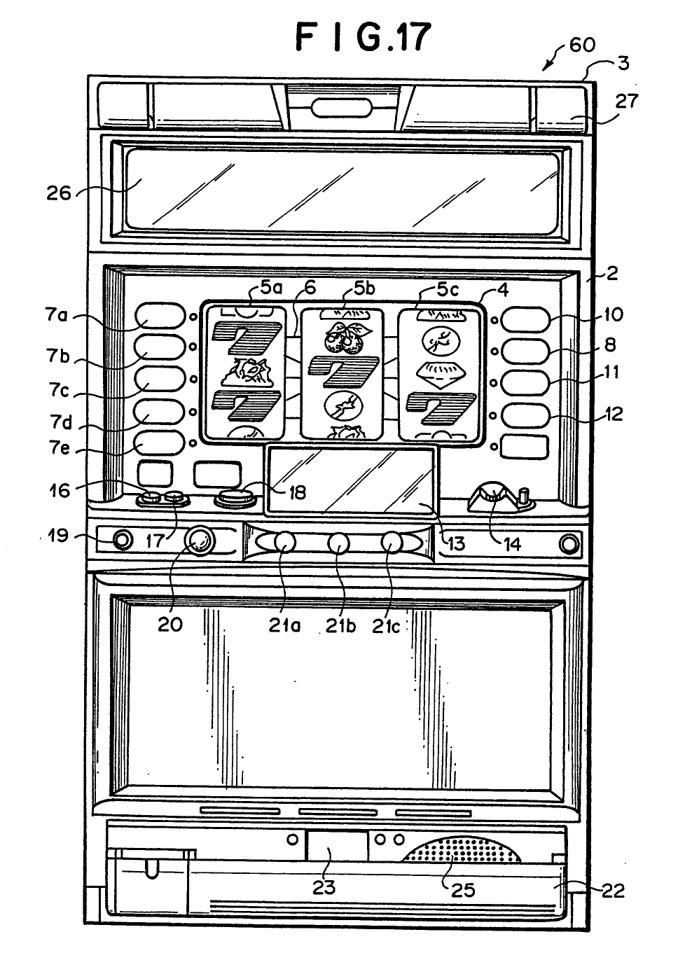

A slot machine 60 in accordance with another embodiment will now be explained. FIG. 17 is a front view of the slot machine in accordance with this embodiment.

As shown in FIG. 17, this slot machine 60 has a configuration substantially similar to that of the above-mentioned slot machine 1, and the front face of its housing 3 is provided with an image display section 13 made of a liquid crystal display device for displaying game information.

In FIG. 17, members having functions similar to those of the above-mentioned slot machine 1 will be referred to with numerals or letters identical to the latter, without repeating their detailed explanations.

In the slot machine 60, symbols such as “cherry,” “diamond,” “ball,” “dragon,” “EXTRA,” white “7,” red “7,” and the like are displayed on each of reels 5a to 5c; and, a combination of these symbols constitutes a winning mode or special winning mode.

Control Unit

Gaming operations in the slot machine 60 is controlled by a control unit.

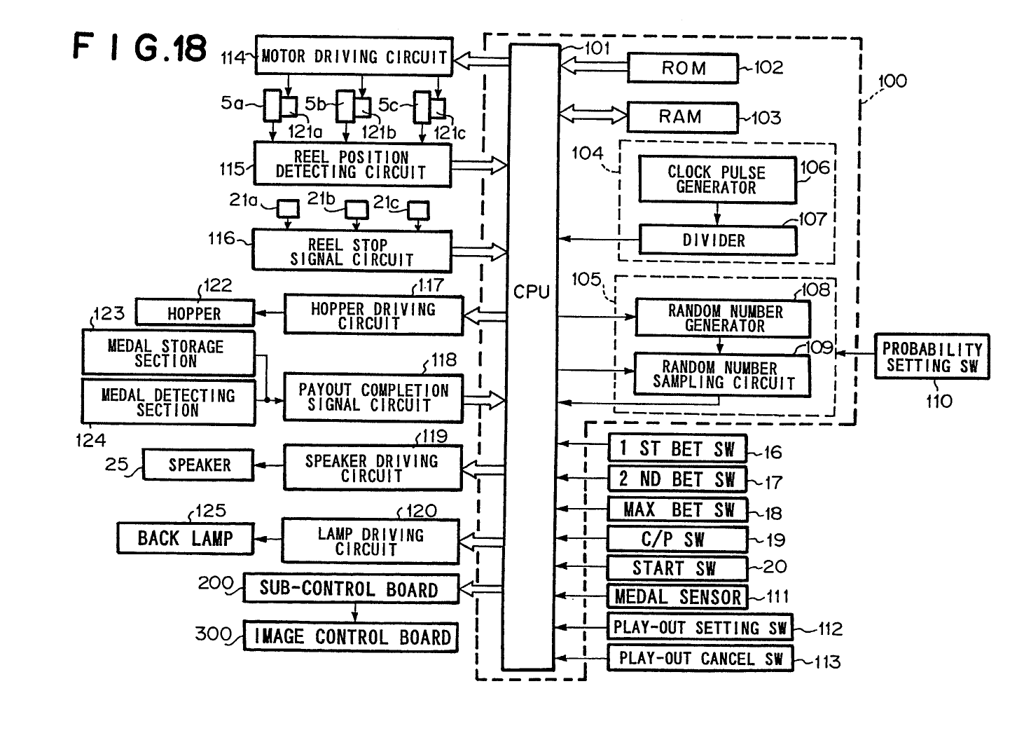

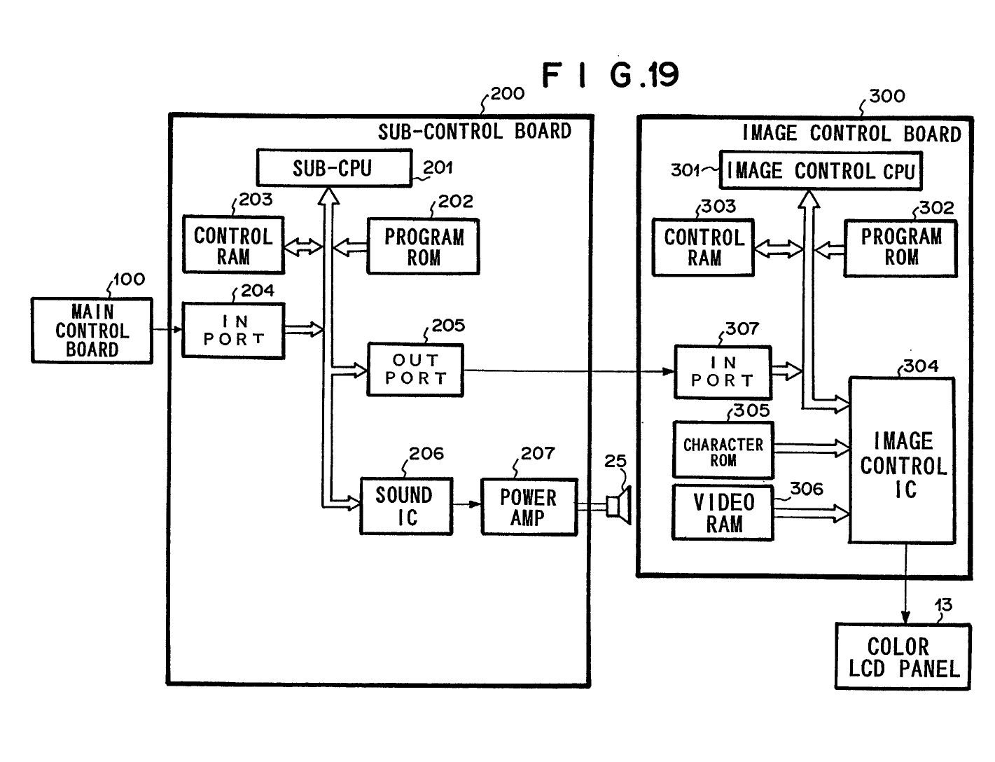

This control unit will be explained with reference to FIGS. 18 and 19.

As shown in FIGS. 18 and 19, the control unit comprises a main control board 100, a sub-control board 200, and an image control board 300.

As shown in FIG. 18, the main control board 100 is a board for carrying out the main control of gaming operations in the slot machine; and comprises a CPU 101, a ROM 102, a RAM 103, a clock circuit 104 for generating an operating clock signal for the CPU 101, and a probability setting section 105 for setting the probability of election of big bonus and the like.

The ROM 102 stores therein not only the procedure of processing in games of the slot machine 60 as a sequence program but also data such as a winning probability table for determining the probability of sampling, internally elected hands, a stop control table for controlling the reels 5a to 5c to stop according to the state of gaming, and the like. As the CPU 101 and the like operate according to the sequence program, games in the slot machine 60 are controlled.

The clock circuit 104 comprises a clock pulse generator 106 for generating a reference clock at a predetermined frequency, and a divider 107 for generating an operating clock signal for the CPU 101 by dividing the reference clock signal.

The probability setting section 105 comprises a random number generator 108 for generating random numbers within a predetermined range under the control of the CPU 101, and a random number sampling circuit 109 for extracting a given random number from the random numbers generated in the random number generator 108 and transmitting thus extracted random number to the CPU 101. Also, a setting switch 110 for setting the probability of occurrence of big bonus is connected to the probability setting section 105.

The probability setting section 105 generates random numbers used for normal games, big bonus, and the like. In a specific process, the random number value extracted at the instant when the start switch 20 is operated and the winning probability table stored in the ROM 102 are compared with each other, and whether there is an internal election or not, i.e., whether there is an internally elected hand or not, and the winning hand are determined according to the result of comparison. Internally elected bonus hands, which are the results of internal election of big bonus or regular bonus, can be transferred to the next and later games, whereas small hands and internally elected replay hands are only valid in the game in which they are internally elected.

Connected to a plurality of I/O ports provided with the CPU 101 are the first bet switch 16, the second bet switch 17, the max bet switch 18, the C/P switch 19, the start switch 20, a medal sensor 111 for detecting game medals inserted from the medal insertion slot 14 or collective medal insertion slot 15, a play-out setting switch 112 for selecting whether to effect a play-out process or not, a play-out cancel switch 113 for canceling the play-out state, a motor driving circuit 114, a reel position detecting circuit 115, a reel stop signal circuit 116, a hopper driving circuit 117, a payout completion signal circuit 118, a speaker driving circuit 119, and a lamp driving circuit 120.

In the following, the individual circuits mentioned above will be explained in detail.

Connected to the motor driving circuit 114 are stepping motors 121a to 121c for driving the respective reels 5a to 5c to rotate. As driving pulses are supplied or stopped being supplied to the individual stepping motors 121a to 121c under the control of the CPU 101, the respective reels 5a to 5c are caused to start or stop rotating.

The reel position detecting circuit 115 is provided with a position detecting sensor (not depicted) comprising an optical sensor or the like for detecting the rotating position of each of the reels 5a to 5c , so that the position detection signals concerning the reels 5a to 5c detected by the position detecting sensor are transmitted to the CPU 101.

Connected to the reel stop signal circuit 116 are stop switches 21a to 21c . As the player operates the stop switches 21a to 21c , the operation is detected, and the resulting stop switch detection signal is transmitted to the CPU 101. In a specific control operation, after the individual reels 5a to 5c attain a constant-speed rotation after the start switch 20 was operated, operations of the respective stop switches 21a to 21c are permitted. When each of the stop switches 21a to 21c is pressed, seven frames in total extending to the fourth frame from the shortest stoppable position are inspected according to the stop switch detection signal, the position detection signal, and the stop control table stored in the ROM 102. If there exists a symbol corresponding to the internally elected hand, the individual reels 5a to 5c are stopped so as to carry out a draw-in control operation such that this symbol aligns on the effective winning line, while carrying out a kick control operation so as not to establish any other winning hands which are not internally elected. In the case of losing in which there is no internally elected hand, the individual reels 5a to 5c are stopped such that no internally elected hand is established. Also, in a game in an internally elected bonus game to which the internally elected bonus hand has been transferred, internally elected hands other than the internally elected bonus hand are sampled; and, if a small hand or replay is internally elected, then a draw-in control operation is carried out so as to preferentially attain the small hand or replay.

Connected to the hopper driving circuit 117 is a hopper 122 for storing game medals.

Connected to the payout completion signal circuit 118 are a medal storage section 123 and a medal detecting section 124. The medal storage section 123 is a section for storing the game medals inserted from the medal insertion slot 14 or collective medal insertion slot 15 or the game medals to be paid out as a prize, and is adapted to store the game medals until they reach a predetermined maximum permissible storage number. The maximum permissible storage number is 50, for example, so that up to 50 game medals are stored, whereas the 51st and later game medals are actually paid out from the hopper 122 to the medal tray 22. The actually paid-out medals are counted by the medal detecting section 124 at the time when being paid out from the hopper 122 to the medal tray 22. In the operation of paying out game medals at the time of winning, if the sum value stored in the medal storage section 123 in an adding fashion or the counted value in the medal detecting section 124 reaches a predetermined payout number, then a payout completion signal is transmitted from the payout completion signal circuit 118 to the CPU 101.

Connected to the lamp driving circuit 120 are back lamps 125 for illuminating from inside the reels 5a to 5c in a transmitting manner the symbols seen through the display window 4. Three back lamps 125 in a vertical row are provided for each of the reels 5a to 5c , whereby nine back lamps 125 in total illuminate the reels 5a to 5c from inside in a transmitting manner.

The sub-control board 200 and the image control board 300 are mainly used for controlling the image display section 13; and, while receiving a signal from the main control board 100 so as to generate sound effects and the like out of the speaker 25, carry out image display operations in the image display section 13.

As shown in FIG. 19, the sub-control board 200 is mounted with a sub-CPU 201, a program ROM 202, and a control RAM 203; and receives a signal from the main control board 100 at the sub-CPU 201 by way of an IN port 204. Further, according to the data received from the main control board 100, selection tables stored in the program ROM 202, and the like, the sub-CPU 201 determines various attraction images for an attraction image selecting process, an appearing symbol attraction selecting process, and the like which will be explained later, and sends out a signal to the image control board 300 by way of an OUT port 205. Also, the sub-control board 200 is mounted with a sound IC 206, whereby sound effects and the like are generated from the speaker 25 by way of a power amplifier 207.

As shown in FIG. 19, the image control board 300 is mounted with an image control CPU 301, a program ROM 302, a control RAM 303, an image control IC 304, a character ROM 305, and a video RAM 306. The image control board 300 receives a signal from the sub-control board 200 by way of an IN port 307, and transmits a driving signal to the image control IC 304. Under the control of the image control CPU 301, the image control IC 304 receives signal inputs from the character ROM 305 and video RAM 306, and controls the image display section 13 (e.g., color liquid crystal panel), thereby effecting image displays.

Indication of Game Information

Another embodiment of game information displayed by the image display section 13 during gaming of the above-mentioned slot machine 60 will now specifically be explained with reference to drawings.

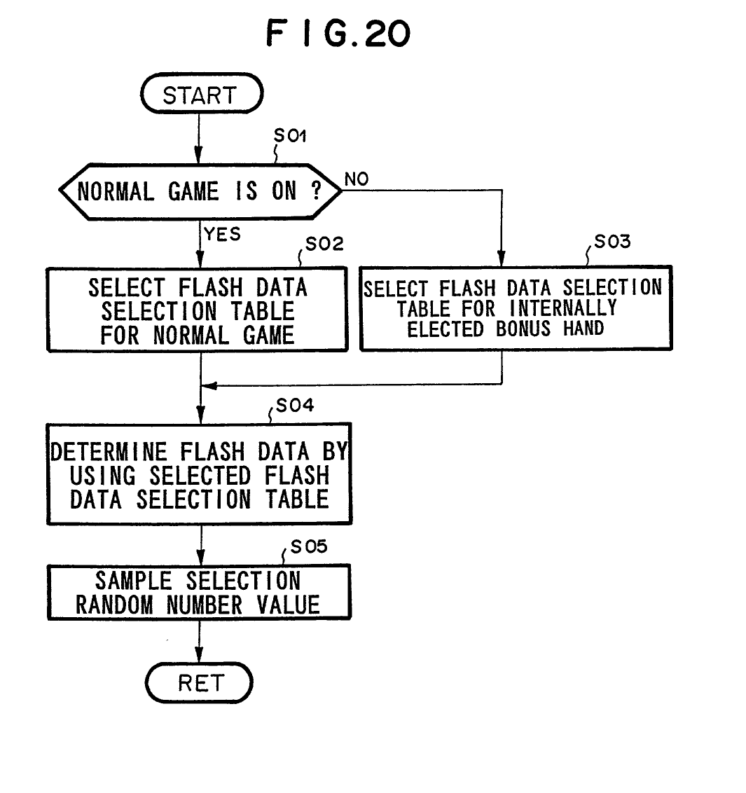

FIG. 20 is a flowchart showing a procedure of selecting flash data and a selection random number value to be transmitted to the sub-control board 200. Here, flash data refers to data for determining combinations between a pattern for blinking the back lamps 125, the sound effects generated from the speaker 25, and whether or not to light a definition lamp for notifying the player of the fact that a bonus hand (BB or RB) is internally elected, in order to foretell the player, under a predetermined condition, which winning hand is internally elected now.

As shown in FIG. 20, the main control board 100 determines whether a normal game is being played or not (SO1). If the normal game is being played, i.e., no internally elected hand for permitting a special winning mode to occur is established, then a flash data table for normal game is selected (S02). If the normal game is not being played, i.e., if a big bonus, a regular bonus, or the like is internally elected, on the other hand, then a flash data table for internally elected bonus hand is selected (S03). Further, thus selected flash data table is used, so as to determine flash data to be transmitted to the sub-control board 200 according to the internally elected hand (S04). Finally, a flash data selecting random number value to be transmitted to the sub-control board 200 together with thus determined flash data is sampled (S05).

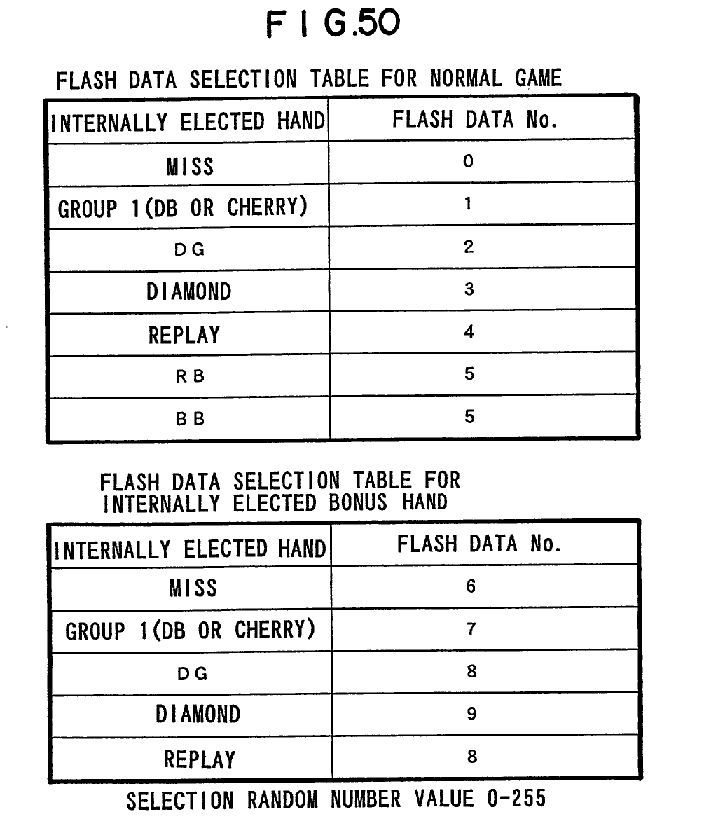

With reference to FIG. 50, the flash data selection table and flash data selecting random number value will now be explained.

As shown in FIG. 50, the flash data selection table comprises two kinds of tables, i.e., a flash data selection table for normal game and a flash data selection table for internally elected bonus.

In the flash data selection table for normal game, any of “0” to “5” in the flash data selection table corresponds to each of seven patterns of internally elected hands constituted by “miss,” group 1 (group election of “DB” or “cherry”),” “DG,” “diamond,” “replay,” “RB,” and “BB.” In the flash data selection table for internally elected bonus hand, any of “6” to “9” in the flash data selection table corresponds to each of five patterns of internally elected hands constituted by “miss,” “DB,” “DG,” “diamond,” and “replay.”

The flash date selecting random number value is selected from 256 random number values from 0 to 255.

Here, “miss” refers to the case where no winning hands are internally elected, i.e., no winning hands are permitted to occur; “group 1 (group election of “DB (dragon break)” or “cherry”)” refers to the case where the winning hand composed of “dragon,” “dragon,” and “EXTRA,” or the winning hand of “cherry” is internally elected, i.e., the case where the winning mode in which symbols of “dragon,” “dragon,” and “EXTRA” are displayed in their stopped state is permitted to occur, or the winning mode in which “cherry” is stopped at any of the upper, center, and lower stages of the left reel is permitted to occur; “DG (dragon)” refers to the case where the winning hand composed of “dragon,” “dragon,” and “dragon” is internally elected, i.e., the case where the winning mode in which symbols of “dragon,” “dragon,” and “dragon” are displayed in their stopped state is permitted to occur; “diamond” refers to the case where the winning hand composed of “diamond,” “diamond,” and “diamond” is internally elected, i.e., the case where the winning mode in which symbols of “diamond,” “diamond,” and “diamond” are displayed in their stopped state is permitted to occur; “replay” refers to the case where the winning hand composed of “ball,” “ball,” and “ball” is internally elected, i.e., the case where the winning mode in which symbols of “ball,” “ball,” and “ball” are displayed in their stopped state is permitted to occur; “RB” refers to the case where the winning hand composed of “EXTRA,” “EXTRA,” and “EXTRA” is internally elected; “EXTRA” refers to the case in which a regular bonus winning mode in which symbols of “EXTRA,” “EXTRA,” and “EXTRA” are displayed in their stopped state is permitted to occur; and “BB” refers to the state where the winning hand composed of “red 7,” “red 7,” and “red 7” or the winning hand composed of “white 7,” “white 7,” and “white 7” is internally elected, i.e., a big bonus winning mode in which symbols of “red 7,” “red 7,” and “red 7” or symbols of “white 7,” “white 7,” and “white 7” are displayed in their stopped mode is permitted to occur.

Here, the reel blinking pattern refers to a pattern by which nine in total of the back lamps 125 arranged in a vertical row of three within each reel are turned on/off or blinked.

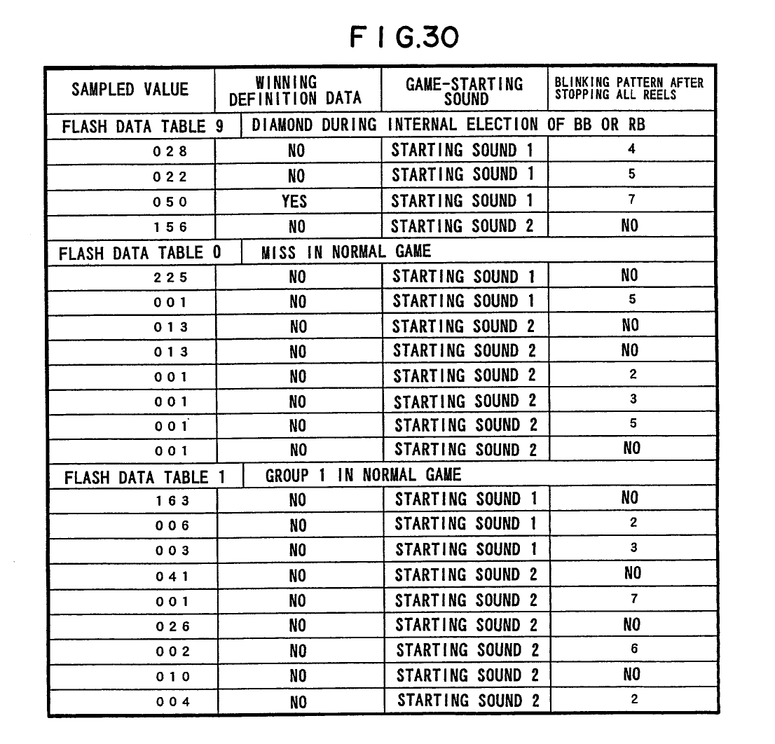

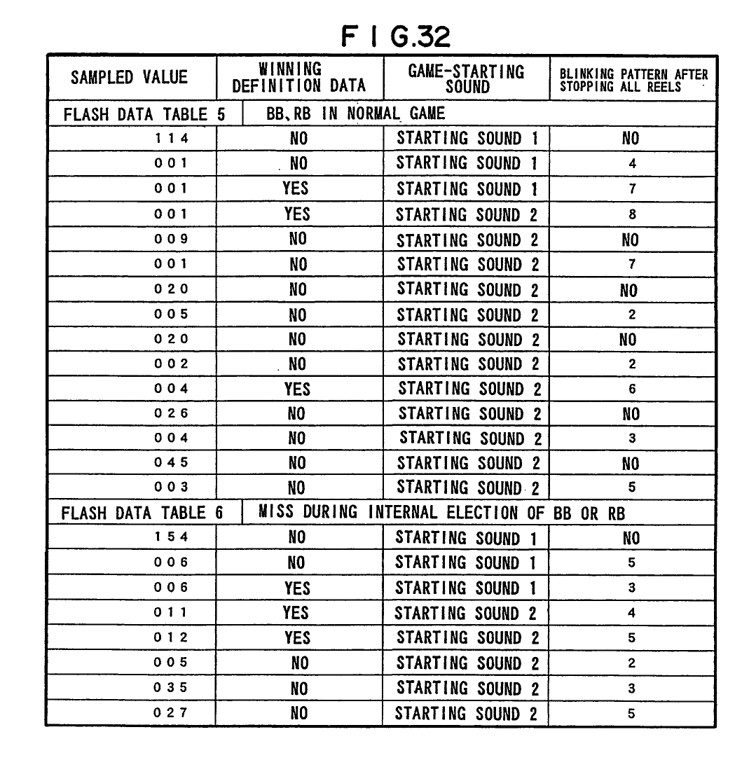

With reference to FIGS. 30 to 33, relationships between flash data tables/selection random number values and reel blinking patterns/attraction sounds (game-starting sounds) will now be explained.

As shown in FIGS. 30 to 33, flash data are classified into 10 kinds of flash data tables from “0” to “9.” Each flash data table is selected according to the state of gaming and internally elected hand in the slot machine 60. More specifically, the flash data table “9” is selected when “diamond” occurring during internal election of a big bonus (BB) or regular bonus (RB) is internally elected; the flash data table “0” is selected when a miss is elected (no winning hands are elected) in a normal game; the flash data table “1” is selected when group 1 is internally elected in a normal game; the flash data “2” is selected when “dragon” is internally elected in a normal game; the flash data “3” is selected when “diamond” is internally elected in a normal game; the flash data “4” is selected when a replay is internally elected in a normal game; the flash data “5” is selected when a big bonus (BB) or regular bonus (RB) is internally elected in a normal game; the flash data table “6” is selected when a miss is internally elected (no winning hands are elected) during internal election of a big bonus (BB) or regular bonus (RB); the flash data table “7” is selected when group 1 is internally elected during internal election of a big bonus (BB) or regular bonus (RB); and the flash data table “8” is selected when “dragon” or “replay” is internally elected during internal election of a big bonus (BB) or regular bonus (RB).

Further, from thus selected flash data table, each flash data selects, according to the flash data selecting random number value, a combination of whether there is a winning definition data or not (whether the definition lamp is lit or not), one of two kinds of game-starting sounds constituted by “game-starting sound 1” and “game starting sound 2,” and one of nine kinds of reel blinking patters constituted by “1” to “8” and “no blinking.” Here, the definition data is data concerning whether to definitely display that a bonus hand is internally elected (i.e., the bonus hand is always internally elected if this display is effected) or not. In addition, there are various modes of indicating the internal election. For example, without directly indicating the internally elected hand, even when a big bonus is internally elected, it may be kept from being indicated (the internal election may be indicated at a predetermined probability). Conversely, even when no big bonus is internally elected, an indication pattern emerging when a big bonus is internally elected may be executed (the internal election may be indicated at a predetermined reliability). Alternatively, a plurality of internal elections may be provided with a common indication pattern.

In a specific example, as shown in FIG. 30, in the flash data table “9,” when the flash data selecting random number is 25, “no” for the winning definition data, “game-starting sound 1,” and reel blinking pattern “4” are selected. In the flash data table “0,” when the flash data selecting random number is 255, “no” for the winning definition data, “game-starting sound 1,” and “no” for the reel blinking pattern are selected.

Here, the game-starting sound refers to sound effects generated from the speaker at the time when a game is started. In this embodiment, there are two kinds of different game-starting sound, i.e., game-starting sound 1 and game-starting sound 2.

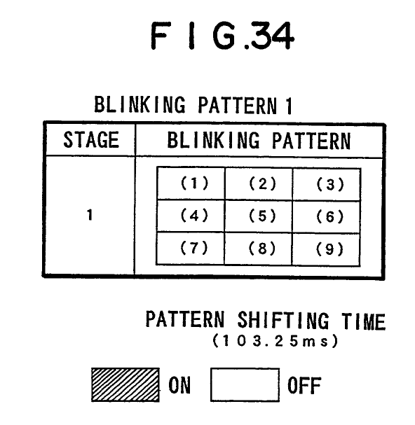

The above-mentioned reel blinking patterns will now be explained with reference to FIGS. 34 to 41.

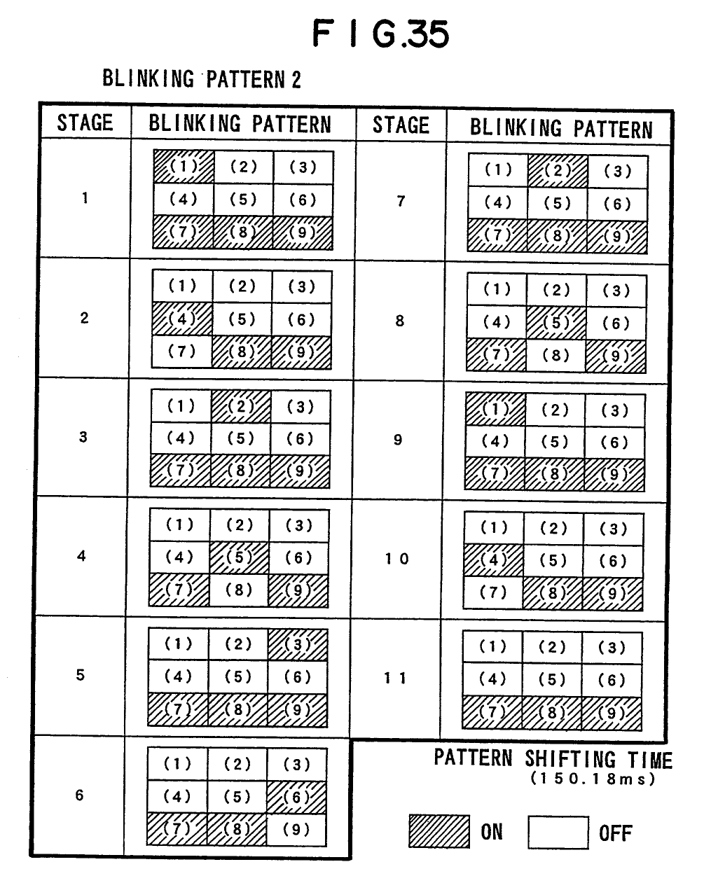

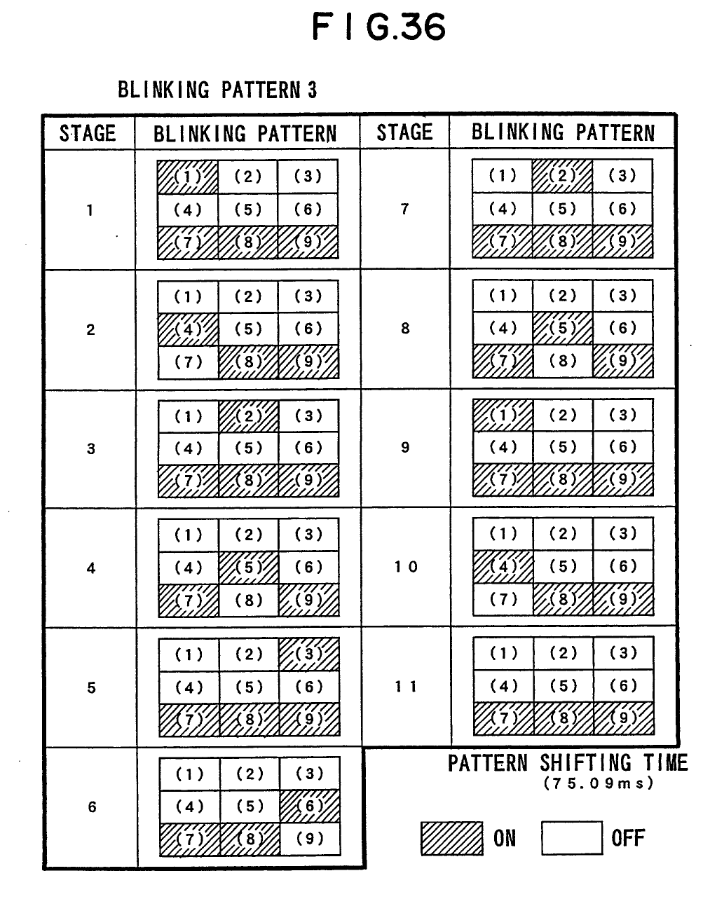

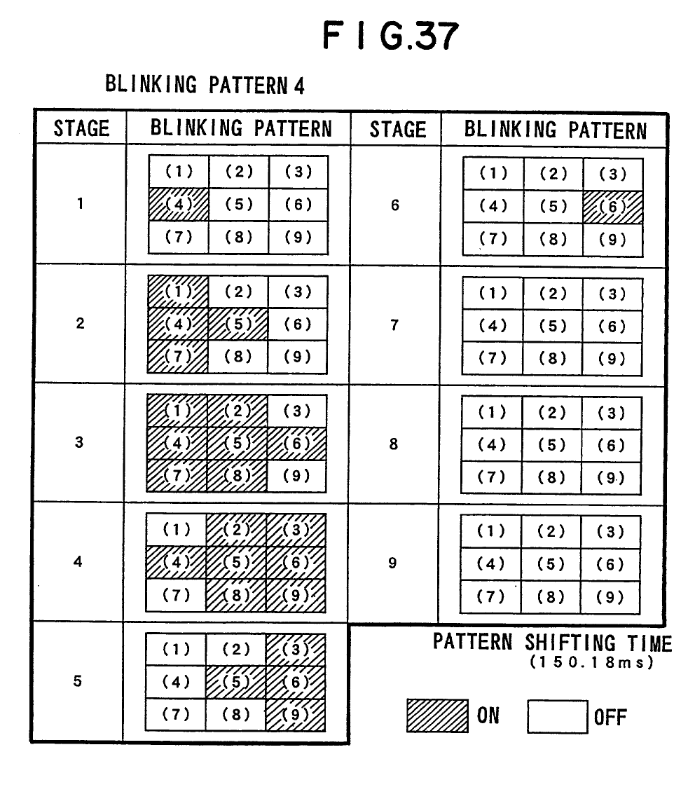

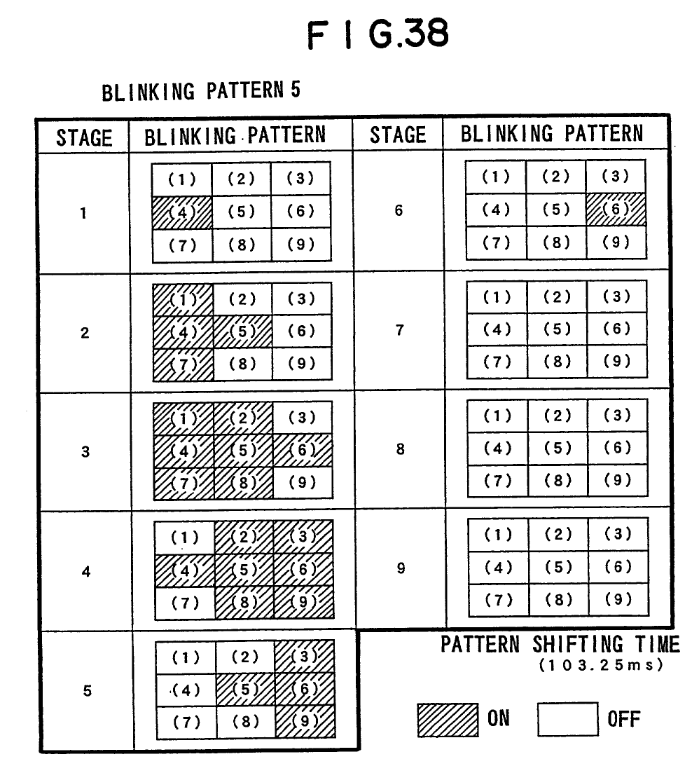

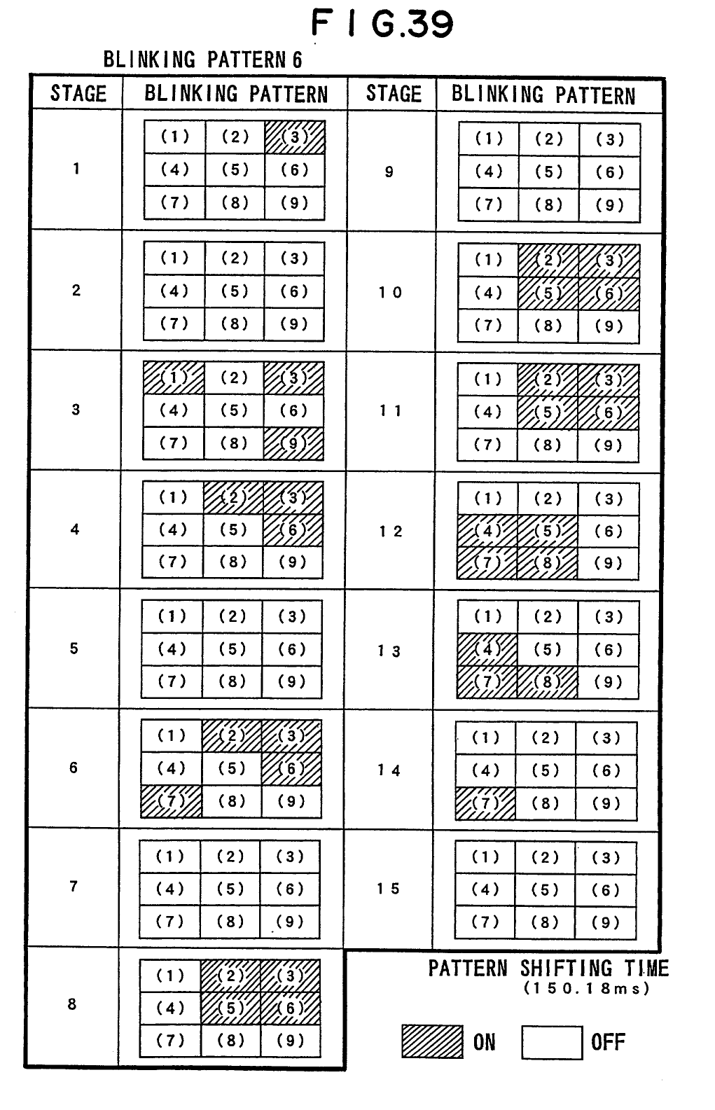

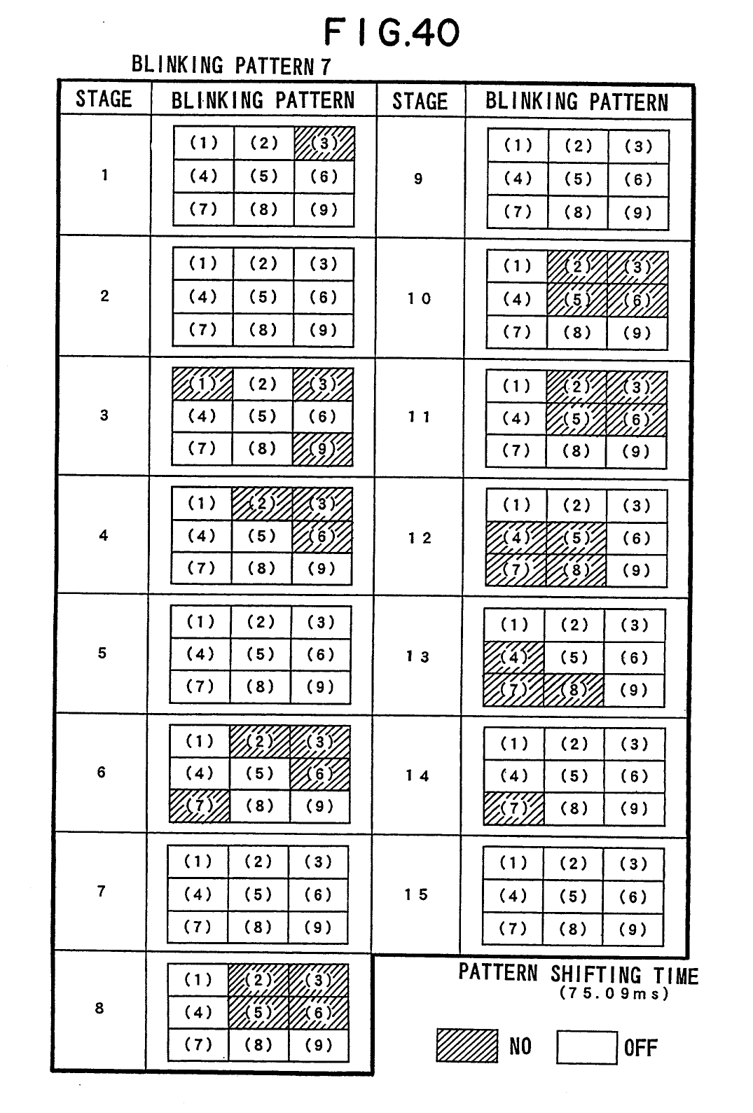

As shown in FIGS. 34 to 41, all the back lamps 125 are turned off during a period of 103.25 ms in the reel blinking pattern “1” (FIG. 34); the back lamps 125 are blinked such that 11 kinds of blinking patterns are successively repeated with a shifting time of 150.18 ms in the reel blinking pattern “2” (FIG. 35); the back lamps 125 are blinked such that 11 kinds of blinking patterns are successively repeated with a shifting time of 75.09 ms in the reel blinking pattern “3” (FIG. 36); the back lamps 125 are blinked such that 9 kinds of blinking patterns are successively repeated with a shifting time of 150.18 ms in the reel blinking pattern “4” (FIG. 37); the back lamps 125 are blinked such that 9 kinds of blinking patterns are successively repeated with a shifting time of 103.25 ms in the reel blinking pattern “5” (FIG. 38); the back lamps 125 are blinked such that 15 kinds of blinking patterns are successively repeated with a shifting time of 150.18 ms in the reel blinking pattern “6” (FIG. 39); the back lamps 125 are blinked such that 15 kinds of blinking patterns are successively repeated with a shifting time of 75.09 ms in the reel blinking pattern “7” (FIG. 40); and the back lamps 125 are blinked such that 15 kinds of blinking patterns are successively repeated with a shifting time of 103.25 ms in the reel blinking pattern “8” (FIG. 41). In addition, there is “no blinking” pattern in which no back lamps 125 are blinked, i.e., their lit state is kept.

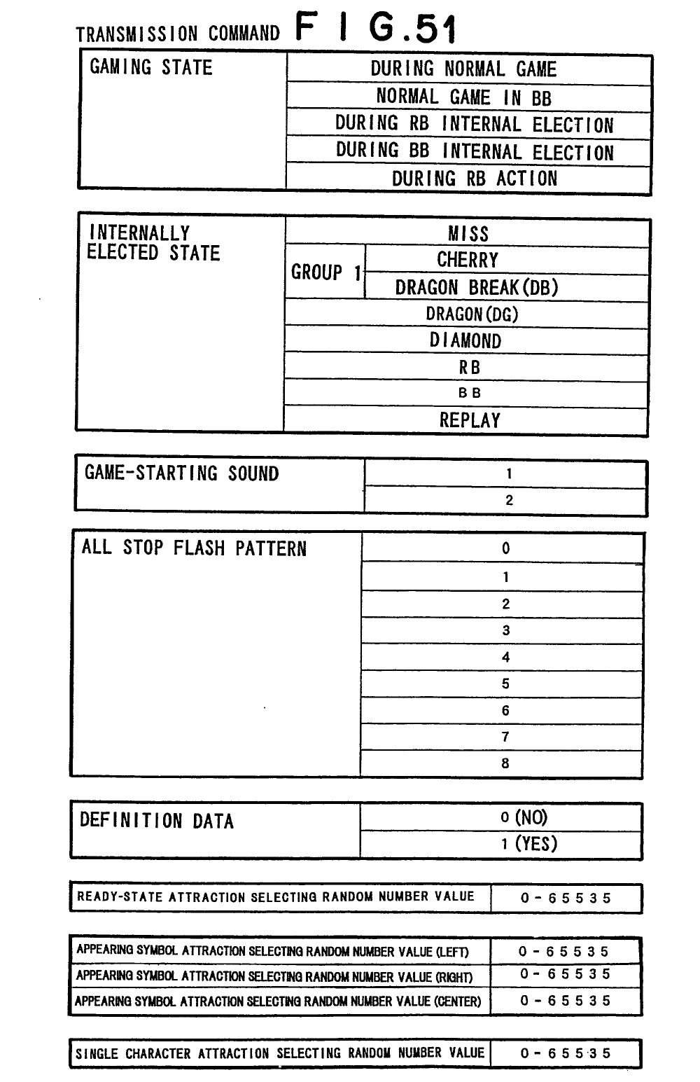

With reference to FIG. 51, transmission commands transmitted from the main control board 100 to the sub-control board 200 will now be explained.

As shown in FIG. 51, there are eight kinds of transmission commands transmitted from the main control board 100 to the sub-control board 200, which are constituted by a command concerning the state of gaming, a command concerning internally elected hands, a command concerning the game-starting sound, a command concerning the all stop flash pattern, a command concerning definition data, a random number value for selecting a ready-state attraction, random number values (left, right, and center) for selecting appearing symbol attractions, and a random number value for selecting a single character attraction.

The command concerning the state of gaming indicates whether the state is during a normal game, during a normal game in a big bonus (BB), during internal election of a regular bonus (RB), during internal election of a big bonus (BB), or during the action of a regular bonus (RB).

The command concerning internally elected hands indicates any of the internally elected hands of “miss,” “group 1 (“cherry” or “dragon break” (DB: “dragon,” “dragon,” and “EXTRA”)),” “diamond,” “regular bonus (RB),” “big bonus (BB),” and “replay.”

The command concerning the game-starting sound indicates whether the sound effects generated from the speaker 25 at the time of starting a game is game-starting sound 1 or game-starting sound 2.

The command concerning the all stop flash pattern indicates that the blinking pattern of the back lamps 125 effected when all the reels are stopped is any of nine patterns comprising the patterns from “1” to “8” and no blinking pattern (“0”).

The command concerning definition data indicates whether to turn on or off the definition lamp for notifying the player of the fact that BB or RB is internally elected (“1” when turning on, and “0” when turning off).

The random number value for selecting a ready-state attraction, random number values (left, right, and center) for selecting appearing symbol attractions, and random value for selecting a single character attraction are random numbers to be used for selecting the ready-state attraction, selecting appearing symbol attractions, and selecting a single character attraction, which will be explained later in detail, each being selected from 65536 random number values from 0 to 65535.

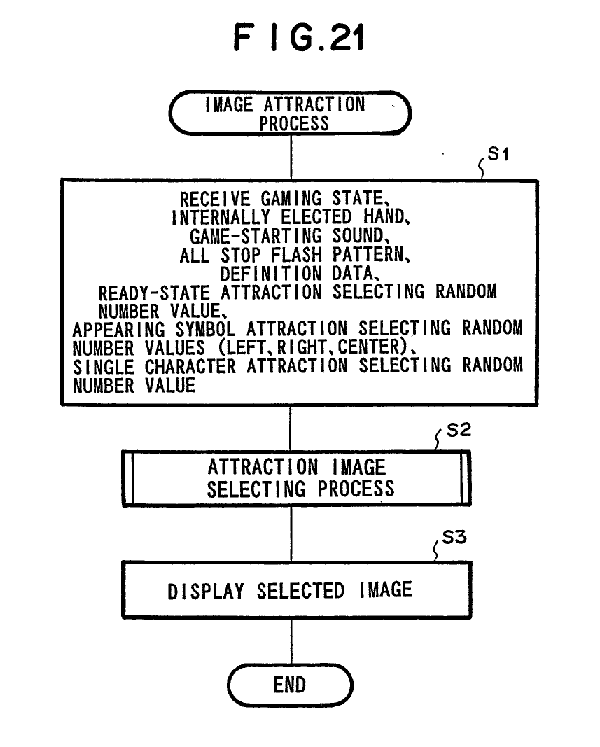

The procedure of display control of game information in the sub-control board 200 will now be explained with reference to FIGS. 21 to 28.

As shown in FIG. 21, the image attraction process in the image display section 13 is carried out in the sub-control board 200. First, in this image attraction process, the commands concerning the gaming state, internally elected hands, game-starting sound, all stop flash pattern, definition data, ready-state attraction selecting random number, appearing symbol attraction selecting random numbers (left, right, and center), and single character attraction selecting random number value are received (S1), an attraction image selecting process (S2) for selecting an attraction image is carried out, and the selected image is displayed in the image display section 13 (S3).

The attraction image selecting process (S2) is a process for selecting whether to carry out a ready-state attraction or not, and determining which mode of attraction is to be carried out.

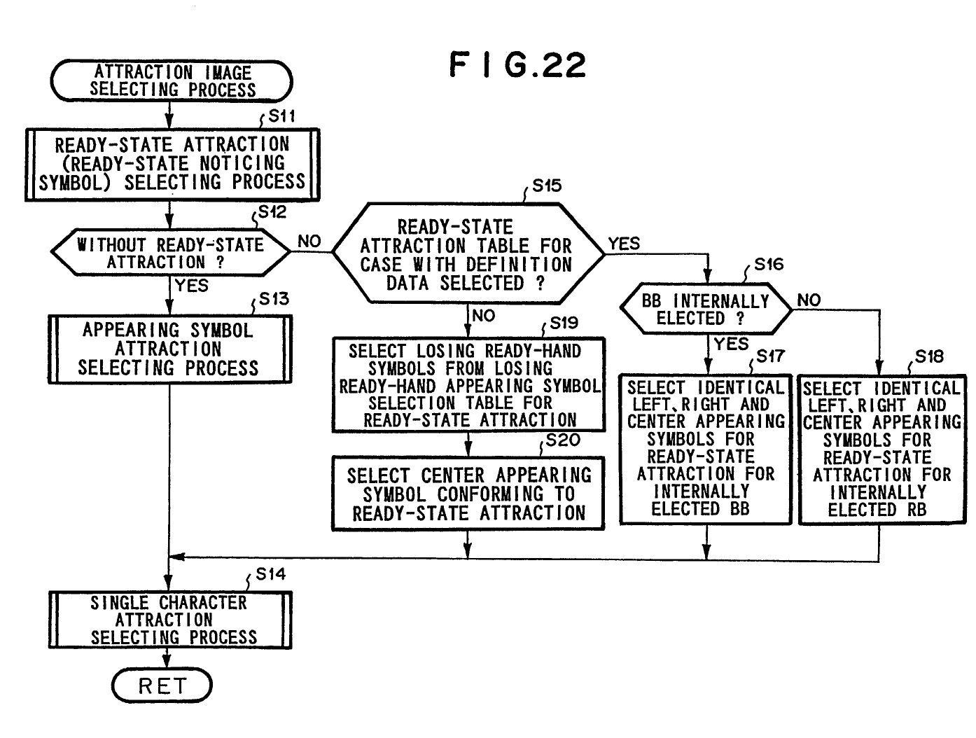

Namely, in the attraction image selecting process (S2), as shown in FIG. 22, a ready-state attraction (ready-state attraction noticing symbol) selecting process is initially carried out (S11). Then, it is determined whether to carry out a ready-state attraction or not (S12). If no ready-state attraction is carried out, then an appearing symbol attraction selecting process (S13) is to be carried out, and a single character attraction selecting process (S14) is further carried out.

If the ready-state attraction is to be carried out, on the other hand, it is further determined whether a ready-state attraction data selection table for the case where with the definition data is selected or not (S15). If the ready-state attraction data selection table for the case where with the definition data is selected, then it is further determined whether a big bonus (hereinafter referred to as BB) is internally elected or not (S16).

If BB is internally elected, then appearing symbols are selected from an identical left, center, and right appearing symbol selection table for ready-state attraction for the internally elected big bonus (S17), and the flow shifts to the single character attraction selecting process (S14). If BB is not internally elected, on the other hand, appearing symbols are selected from an identical left, center, and right appearing symbol selection table for ready-state attraction for the internally elected regular bonus (S18), and the flow shifts to the single character attraction selecting process (S14).

If the ready-state attraction data selection table for the case with definition data is not selected, then ready-hand appearing symbols at the time of losing are selected from a losing ready-hand appearing symbol selection table for ready-state attraction (S19), a losing center appearing symbol in conformity to the ready-state attraction is selected (S20), and the flow shifts to the single character attraction selecting process (S14).

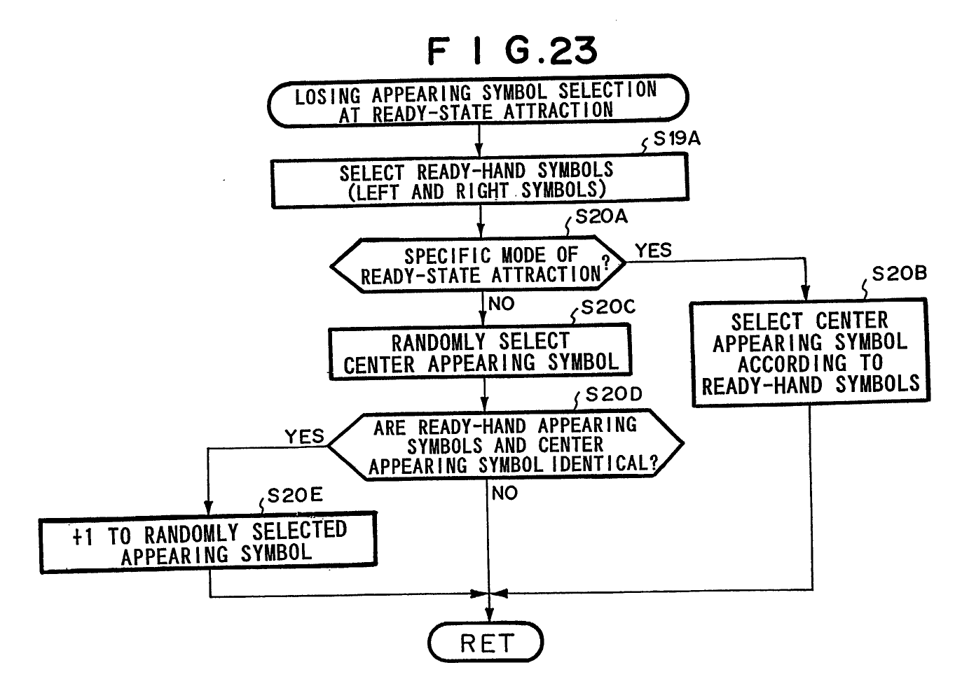

The losing appearing symbol selecting process at the ready-state attraction in the attraction image selecting process (S2) will further be explained in detail with reference to FIG. 23.

As mentioned above, in the attraction image selecting process (S2), if the ready-state attraction data selection table for the case with definition data is not selected, then the losing appearing symbol selecting process for the ready-state attraction (S19, S20) is carried out.

In the losing appearing symbol selecting process for the ready-state attraction, as shown in FIG. 23, ready-hand appearing symbols (left and right appearing symbols) are initially selected (S19A). The ready-hand symbols refer to a combination of appearing symbols in which, of the laterally-aligning three appearing symbols, those on the left and right sides are identical appearing symbols, so as to indicate a so-called ready-hand state.

Subsequently, it is determined whether it is a ready-state attraction of a specific mode or not (S20A). The specific mode of ready-state attraction refers to a specific mode of ready-state attraction selected beforehand from a plurality of ready-state attractions. For example, in this embodiment, three kinds of ready-hand attractions from “f” to “h” among nine kinds of ready-state attractions from “a” to “i” are defined as specific modes of ready-state attractions.

Here, the specific mode of ready-state attraction is a ready-state attraction including such a mode of an appearing symbol attraction that one frame each on the plus side and minus side of the reference appearing symbol is displayed so as to fluctuate in a reciprocating manner. Specific examples thereof include a ready-state attraction in which a leading character balances itself on a ball as shown in FIG. 149 and later. In such a case, if the center appearing symbol, which is the last-stopping appearing symbol, is separated from the left and right appearing symbols displayed in their stopped state in terms of arrangement of symbols, they will not match each other in terms of attraction. Hence, in the case of such a specific mode of ready-state attraction, a losing center appearing symbol selection table for specific mode of ready-state attraction is used, so as to select the appearing symbol at the center (hereinafter referred to as center appearing symbol) corresponding to the ready-state appearing symbol (S20B). If it is not a specific mode of ready-state attraction, then the center appearing symbol is randomly selected (S20C), and it is further determined whether the ready-hand appearing symbols and the center appearing symbol are identical or not (S20D). If the ready-hand appearing symbols and the center appearing symbol are identical, i.e., all of the left, center, and right appearing symbols are the same, the randomly selected appearing symbol (center appearing symbol) is processed to shift by one frame (S20E). As the center appearing symbol is shifted by one frame, all the three appearing symbols are prevented from becoming identical.

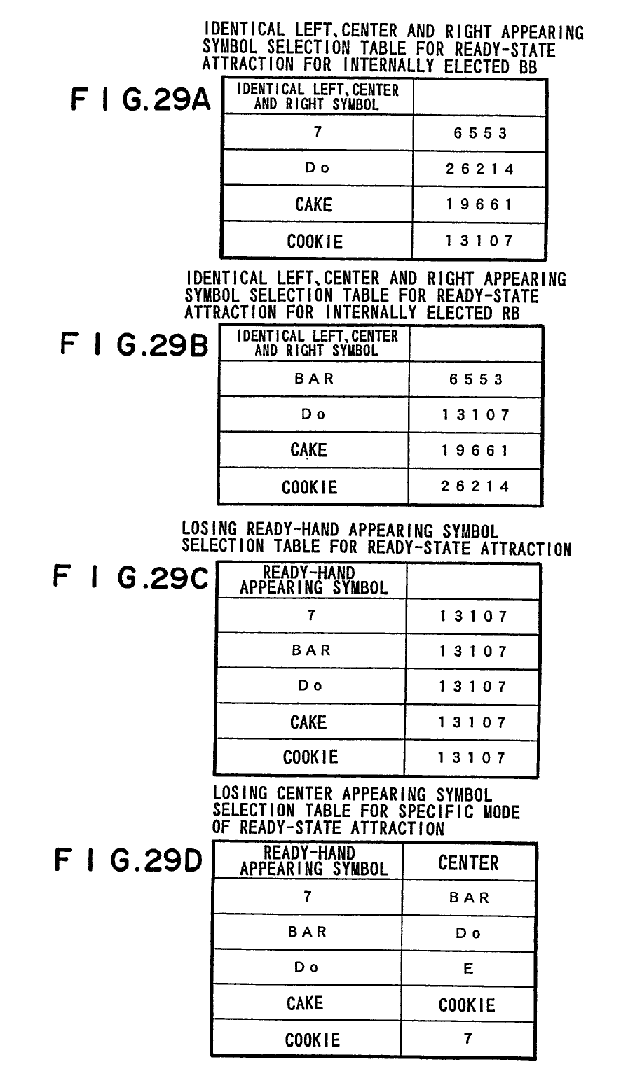

With reference to FIGS. 29A to 29D, the identical left, center, and right appearing symbol selection table for ready-state attraction for the internally elected big bonus; identical left, center, and right appearing symbol selection table for ready-state attraction for the internally elected regular bonus; losing ready-hand appearing symbol selection table for ready-state attraction; and losing center appearing symbol selection table for specific mode of ready-state attraction used in the above-mentioned attraction image selecting process (S2) will be explained.

In the identical left, center, and right appearing symbol selection table for ready-state attraction for the internally elected big bonus, identical left, center, and right appearing symbols are stored in order to indicate that a big bonus is internally elected. Specifically, four kinds of identical left, center, and right appearing symbols constituted by “7,” “Do,” “cake,” and “cookie” exist, and the center appearing symbol is selected therefrom according to a random number value.

In the identical left, center, and right appearing symbol selection table for ready-state attraction for the internally elected regular bonus, identical left, center, and right appearing symbols are stored in order to indicate that a big bonus is internally elected. Specifically, four kinds of identical left, center, and right appearing symbols constituted by “BAR,” “Do,” “cake,” and “cookie” exist, and the center appearing symbol is selected therefrom according to a random number value. As the random number, the appearing symbol attraction selecting random number value (left) shown in FIG. 51 is used.

In the losing ready-hand appearing symbol selection table for ready-state attraction, there are five kinds of ready-hand appearing symbols constituted by “7,” “BAR,” “Do,” “cake,” and “cookie,” and each ready-hand symbol is selected therefrom according to a random number value. As the random number, the appearing symbol attraction selecting random number value (left) shown in FIG. 51 is used.

For selecting the center appearing symbol in the case where the ready-state attraction is that of losing (S20C), the losing ready-hand appearing symbol selection table for ready-state attraction is used. Here, for the random number, the appearing symbol attraction selecting random number value (center) shown in FIG. 51 is used.

In the losing center appearing symbol selection table for specific mode of ready-state attraction, there are five kinds of ready-hand appearing symbols constituted by “7,” “BAR,” “Do,” “cake,” and “cookie,” whereas the center appearing symbols of “BAR,” “Do,” “E,” “cookie,” and “7” correspond to the respective ready-hand appearing symbols.

In the identical left, center, and right appearing symbol selection table for ready-state attraction for the internally elected big bonus; identical left, center, and right appearing symbol selection table for ready-state attraction for the internally elected regular bonus; losing ready-hand appearing symbol selection table for ready-state attraction; and losing center appearing symbol selection table for specific mode of ready-state attraction shown in FIGS. 29A to 29D, the numbers indicated in the columns of identical left, center, and right appearing symbol and ready-hand appearing symbol show reference values to be compared with random number values. According to the comparison of the reference values with random number values, the identical left, center, and right appearing symbols and the ready-hand appearing symbols are determined.

For example, in the identical left, center, and right appearing symbol selection table for ready-state attraction for the internally elected big bonus, the first identical left, center, and right appearing symbol “7” is selected when any random number value from 0 to 6553 is sampled. When any random number from 6554 to 32767 is sampled, then the second identical left, center, and right appearing symbol “Do” is selected. When any random number from 32777 to 52428 is sampled, then the third identical left, center, and right appearing symbol “cake” is selected. When any random number from 52429 to 65535 is sampled, then the fourth identical left, center, and right appearing symbol “cookie” is selected.

In a specific method of computing, a first computation result is initially determined by subtracting the reference value on the first line, 6553, from the sampled random number value. If this first computation result is 0 or less, then the identical left, center, and right appearing symbol on the first line, “7,” is selected. If the first computation result is a positive value, then a second computation result is determined by subtracting the reference value on the second line, 26214, from the first computation result. If this second computation result is 0 or less, then the identical left, center, and right appearing symbol on the second line, “Do,” is selected. If the second computation result is a positive value, then a third computation result is determined by subtracting the reference value on the third line, 19661, from the second computation result. If this third computation result is 0 or less, then the identical left, center, and right appearing symbol on the third line, “cake,” is selected. Similar computations are successively carried out, so as to select the identical left, center, and right appearing symbols and ready-hand appearing symbols according to random number values up to 65535.

The above-mentioned ready-state attraction (ready-state attraction noticing symbol) selecting process (S11) is a process for displaying the possibility of occurrence of a winning mode to the player before all the reels 5a to 5c stop, in which whether a normal game is being played or not or whether definition data exist or not is determined, and whether to carry out a ready-state attraction or not or what ready-state attraction is carried out is determined depending on each case.

Namely, in the ready-state attraction (ready-state attraction noticing symbol) selecting process (S11), as shown in FIG. 26, it is initially determined whether a normal game is being played or not (S301). If the normal game is being played, then a ready-state attraction data selection table group for normal game is selected (S302), and it is further determined whether the command concerning the game-starting sound transmitted from the main control board 100 indicates game-starting sound 1 or not (S303). If game-starting sound 1 is indicated, then the ready-state attraction data selection table for normal game (starting sound 1) is selected (S304). If game-starting sound 2 is indicated, then the ready-state attraction data selection table for normal game (starting sound 2) is selected (S305).

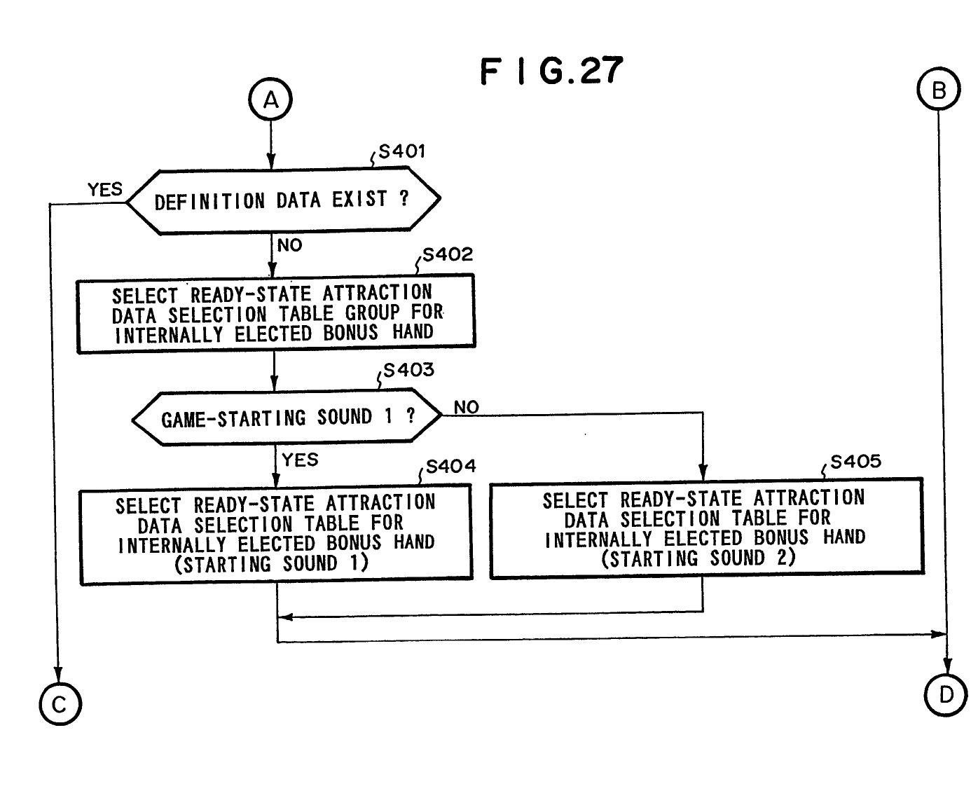

When no normal game is being played, as shown in FIG. 27, according to the command concerning definition data transmitted from the main control board 100, it is determined whether definition data exist or not (S401). If there are no definition data, then a ready-state attraction data selection table group for internally elected bonus hand is selected (S402), and it is further determined whether the command concerning the game-starting sound transmitted from the main control board 100 indicates game-starting sound 1 or not (S403). If game-starting sound 1 is indicated, then the ready-state attraction data selection table for internally elected bonus hand (starting sound 1) is selected (S404). If game-starting sound 2 is indicated, then the ready-state attraction data selection table for internally elected bonus hand (starting sound 2) is selected (S405).

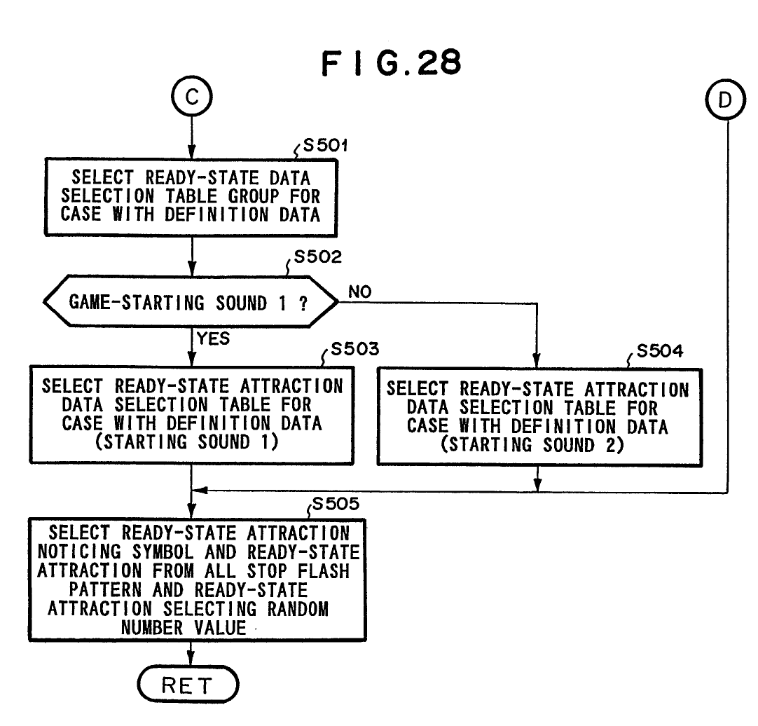

When there are definition data according to the command concerning definition data transmitted from the main control board 100, as shown in FIG. 28, a ready-state attraction data selection table group for the case with definition data is selected (S501), and it is further determined whether the command concerning the game-starting sound transmitted from the main control board 100 indicates game-starting sound 1 or not (S502). If game-starting sound 1 is indicated, then the ready-state attraction data selection table for the case with definition data (starting sound 1) is selected (S503). If game-starting sound 2 is indicated, then the ready-state attraction data selection table for the case with definition data (starting sound 2) is selected (S504).

Then, by using the ready-state attraction data selection table group selected by the foregoing process (S301 to S504), a ready-state noticing symbols and a ready-state attraction noticing pattern are selected according to the all stop flash pattern and ready-state attraction selecting random number value (S505).

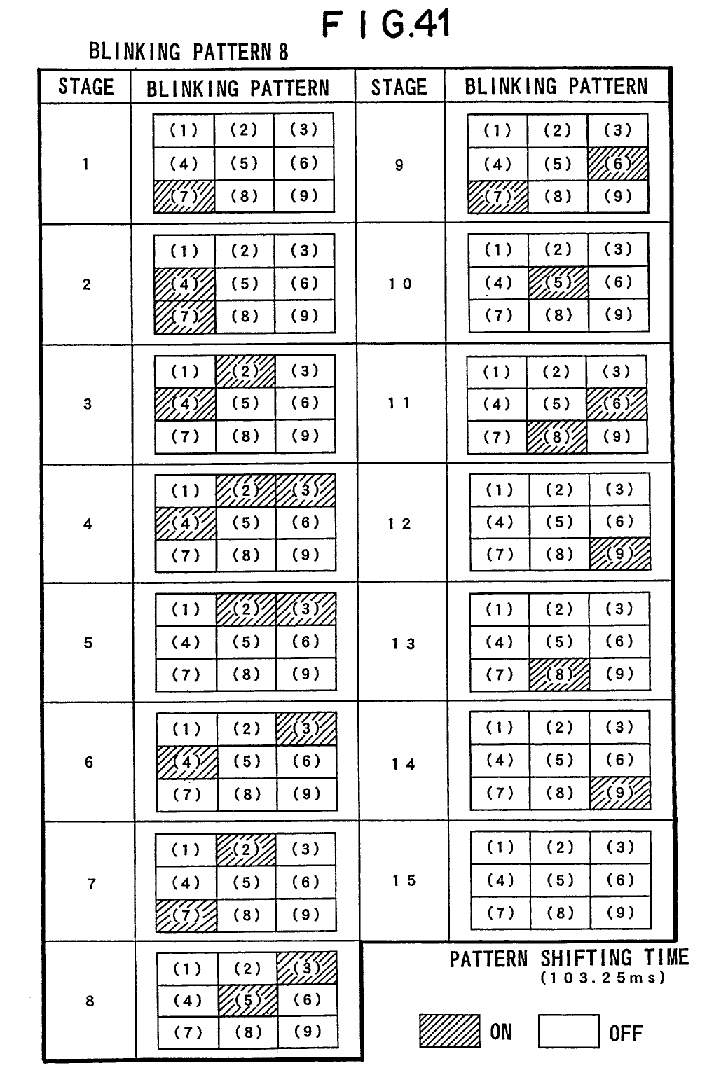

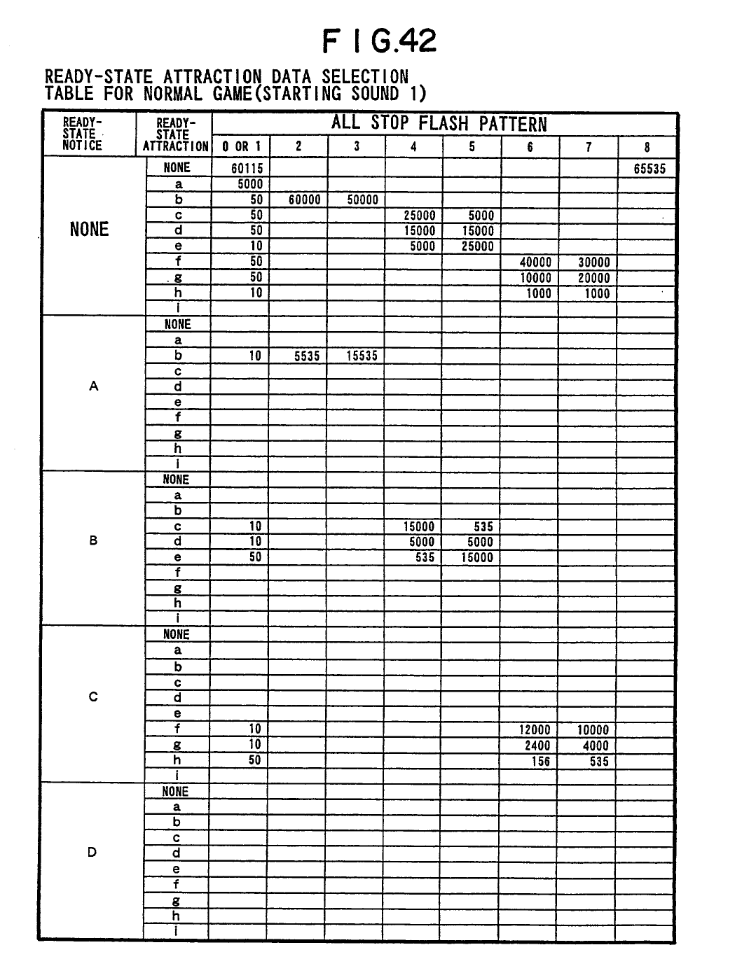

With reference to FIGS. 42 to 47, the above-mentioned ready-state attraction data selection table groups will be explained.

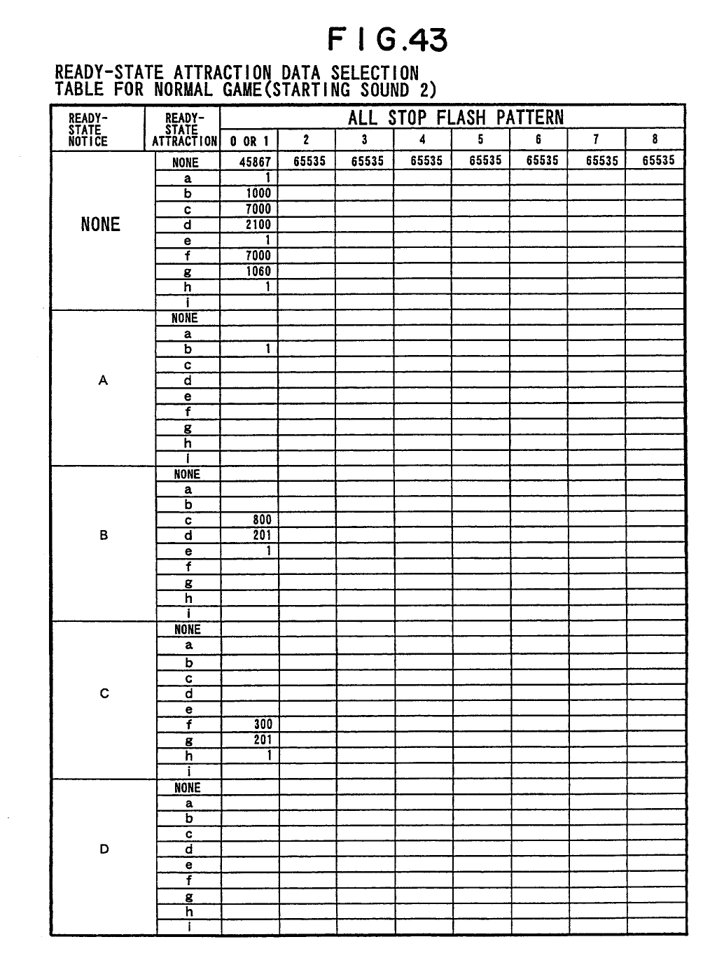

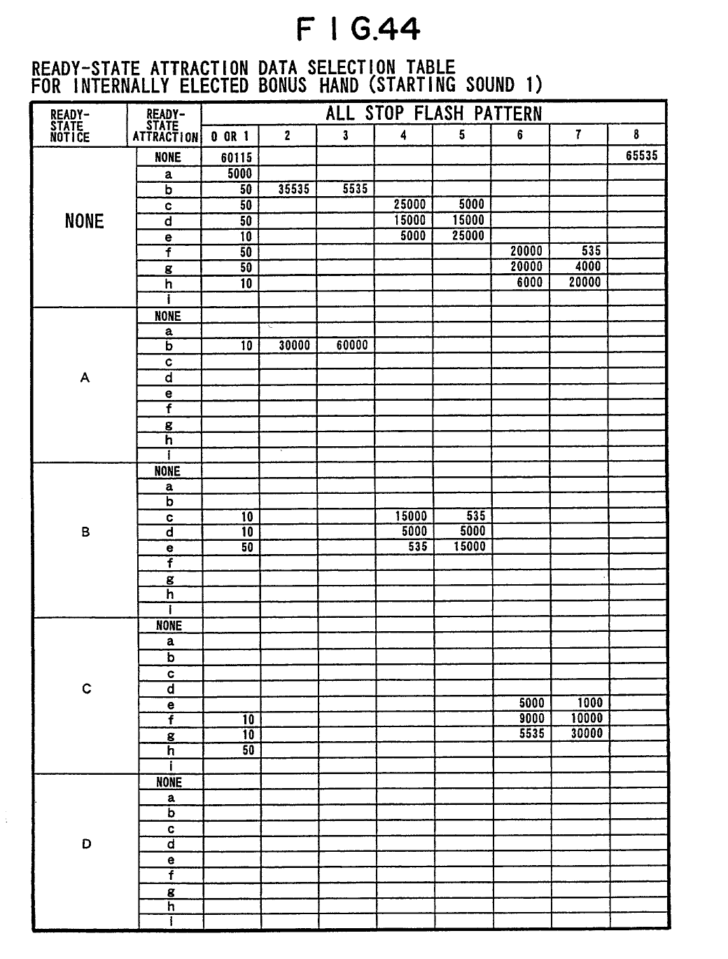

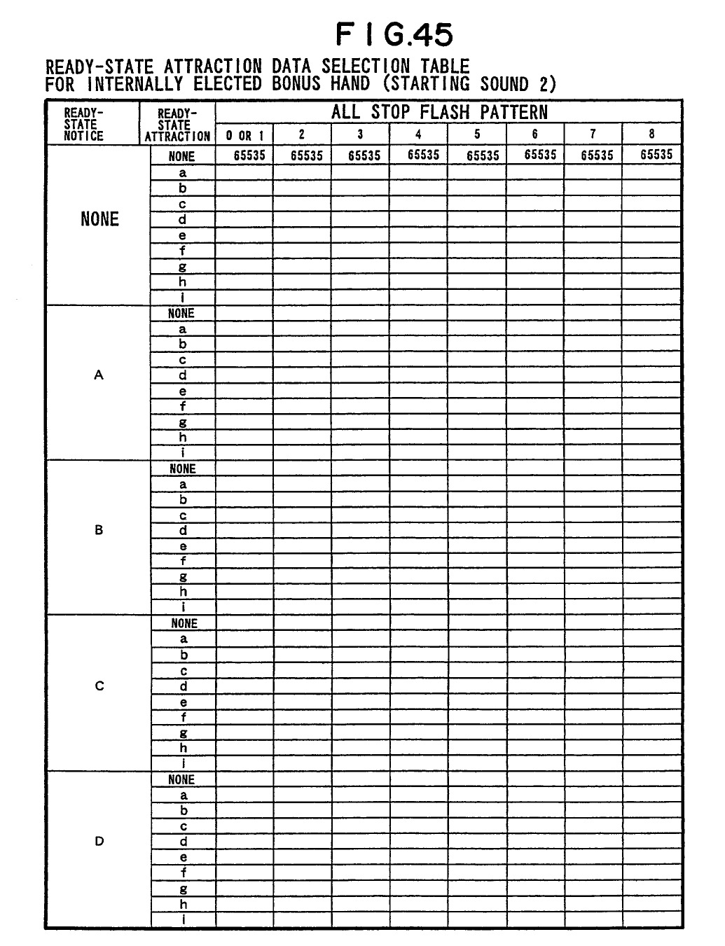

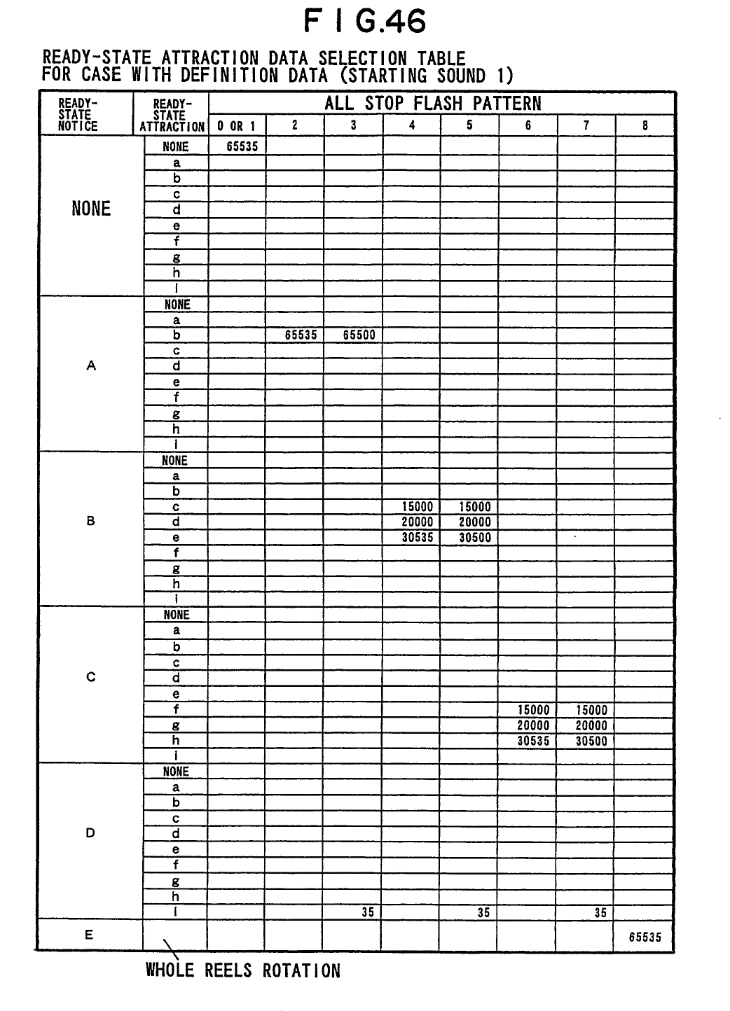

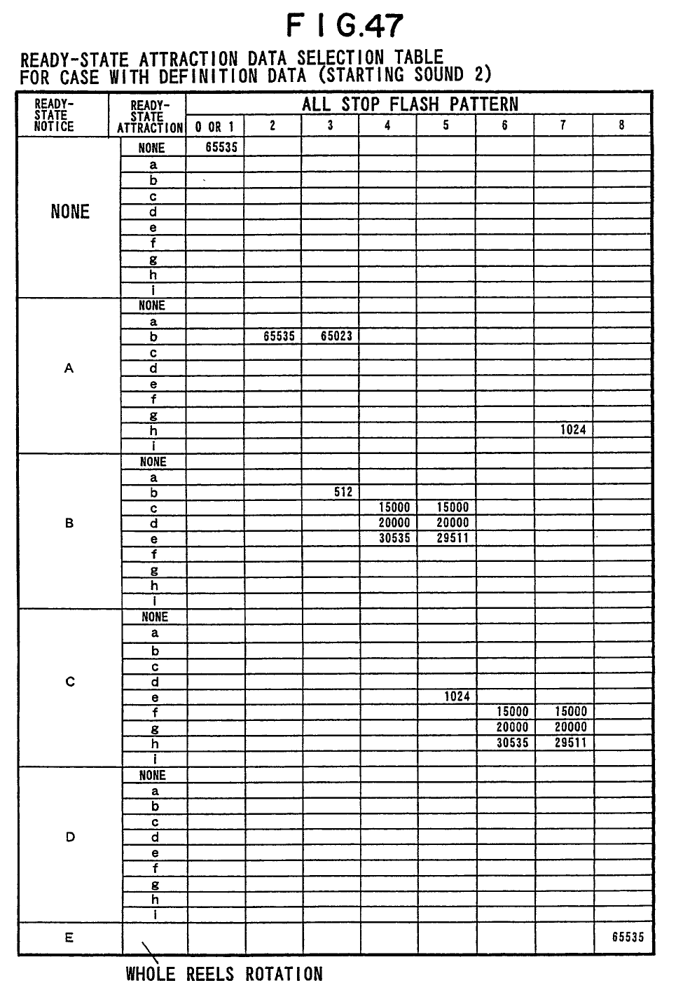

FIGS. 42 to 47 show the ready-state attraction data selection table groups used in the above-mentioned ready-state attraction (ready-state attraction noticing symbol) selecting process (S11), which are constituted by three kinds of ready-state attraction data selection table groups, i.e., the ready-state attraction data selection table group for normal game (FIGS. 42 and 43), the ready-state attraction data selection table group for internally elected bonus hand (FIGS. 44 and 45), and the ready-state attraction data selection table group for the case with definition data (FIGS. 46 and 47). Further, each data table group is composed of two kinds of data tables for starting sound 1 and starting sound 2, respectively.

In each data table, there are 5 kinds of ready-state attraction noticing pattern data constituted by “none” and “A” to “D.” Further, in each ready-state attraction noticing pattern data, there are 10 kinds of ready-state attraction pattern data constituted by “none” and “a” to “i.” Each ready-state attraction pattern data corresponds to any of the all stop flash patterns “0” to “8.”

In the ready-state attraction data selection table group for the case with definition data, as shown in FIGS. 46 and 47, there are six kinds of ready-state attraction noticing pattern data constituted by “none” and “A”to “E.”

A method of selecting the ready-state attraction noticing symbol and ready-state attraction according to the all stop flash pattern and ready-state attraction selecting random number value by using these ready-state attraction data selection tables will be explained with reference to the ready-state attraction data selection table (starting sound 1) for normal game shown in FIG. 42.

As shown in FIG. 42, the number listed on the column of each all stop flash pattern indicates the reference values to be compared with ready-state attraction selecting random number values. According to the comparison of the reference values with ready-state attraction selecting random number values, the ready-state attraction noticing pattern and ready-state attraction pattern are determined.

For example, on the first column of all stop flash pattern (flash pattern 0 or 1,” if any random number value from 0 to 60115 is sampled, then the first ready-state attraction noticing pattern “none” and the first line of ready-state attraction pattern “none” in this ready-state attraction noticing pattern are selected. If any random number value from 60116 to 65115 is sampled, then the first ready-state attraction noticing pattern “none” and the second line of ready-state attraction pattern “a” in this ready-state attraction noticing pattern are selected. Further, if any random number value from 65116 to 65165 is sampled, then the first ready-state attraction noticing pattern “none” and the third line of ready-state attraction pattern “b” in this ready-state attraction noticing pattern are selected. Similarly, according to the random number values up to 65535, ready-state attraction noticing patterns and ready-state attraction patterns are selected.

On each all stop flash pattern column, the ready-state attraction noticing patterns and ready-state attraction patterns corresponding to lines without reference values are not selected.

In a specific method of computing, when the first all stop flash pattern column “flash pattern 0 or 1” is selected, then a first computation result is initially determined by subtracting the reference value on the first line, 60115, from the sampled random number value. If this first computation result is 0 or less, then the ready-state attraction noticing pattern “none” and ready-state attraction pattern “none” on the first line are selected. If the first computation result is a positive value, then a second computation result is determined by subtracting the reference value on the second line, 5000, from the first computation result. If this second computation result is 0 or less, then the ready-state attraction noticing pattern “none” and ready-state attraction pattern “a” on the second line are selected. If the second computation result is a positive value, then a third computation result is determined by subtracting the reference value on the third line, 50, from the second computation result. If this third computation result is 0 or less, then the ready-state attraction noticing pattern “none” and ready-state attraction pattern “b” on the third line are selected. Similar computations are successively carried out, so as to select ready-state attraction noticing patterns and ready-state attraction patterns according to the random number values up to 65535.

The above-mentioned appearing symbol attraction selecting process (S13) is a process executed when no ready-state attraction is carried out (S12: Yes) in the above-mentioned ready-state attraction selecting process (S11), so as to carry out an attraction concerning whether the respective stop modes of reels 5a to 5c permit a predetermined winning mode to occur or not, i.e., whether each winning hand is internally elected or not.

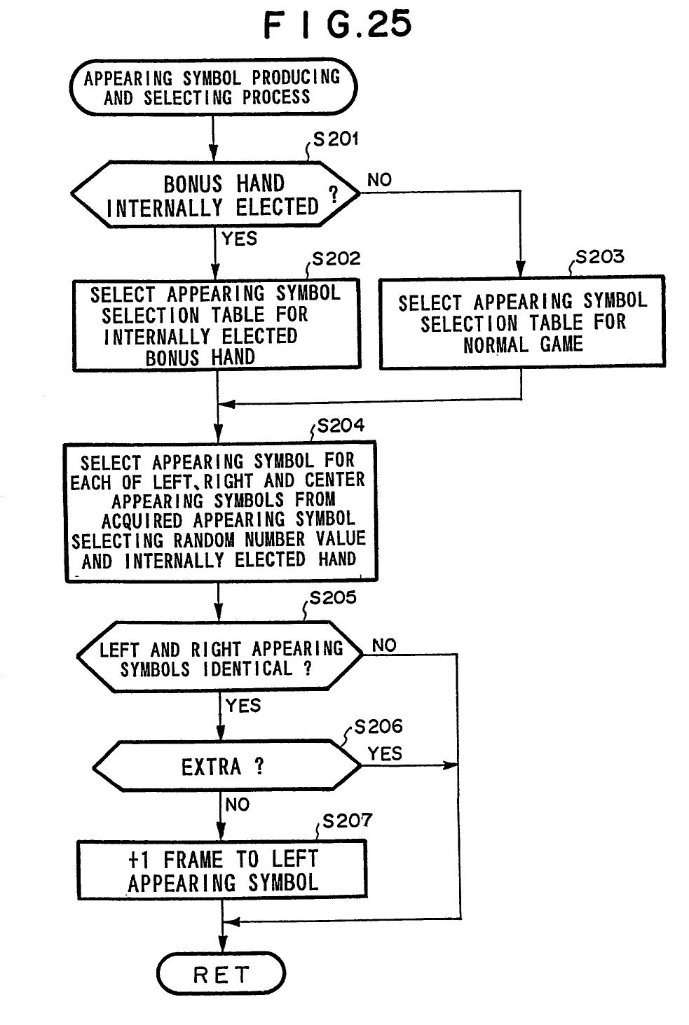

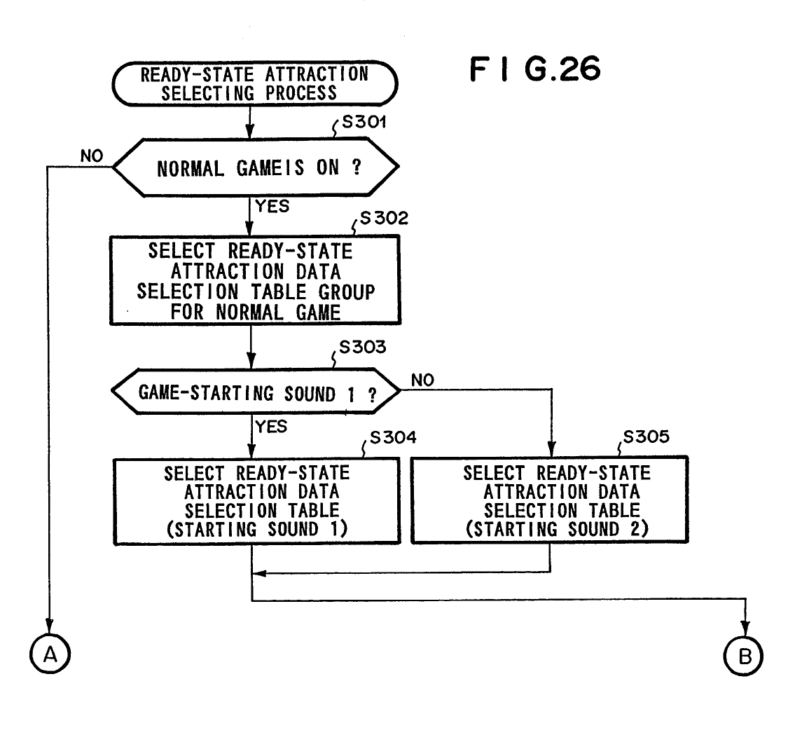

Namely, in the appearing symbol attraction selecting process (S13), as shown in FIG. 25, it is initially determined whether the internal sampling results in internally electing BB or RB or not (S201). If BB or RB is internally elected, then the appearing symbol selection table for internally elected bonus hand is selected (S202). If not, then the appearing symbol selection table for normal game is selected (S203).

Then, thus selected appearing symbol selection table is used, so as to select the respective appearing symbols for the left, right, and center reels according to the appearing symbol attraction selecting random number value and internally elected hand transmitted from the main control board 100 (S204).

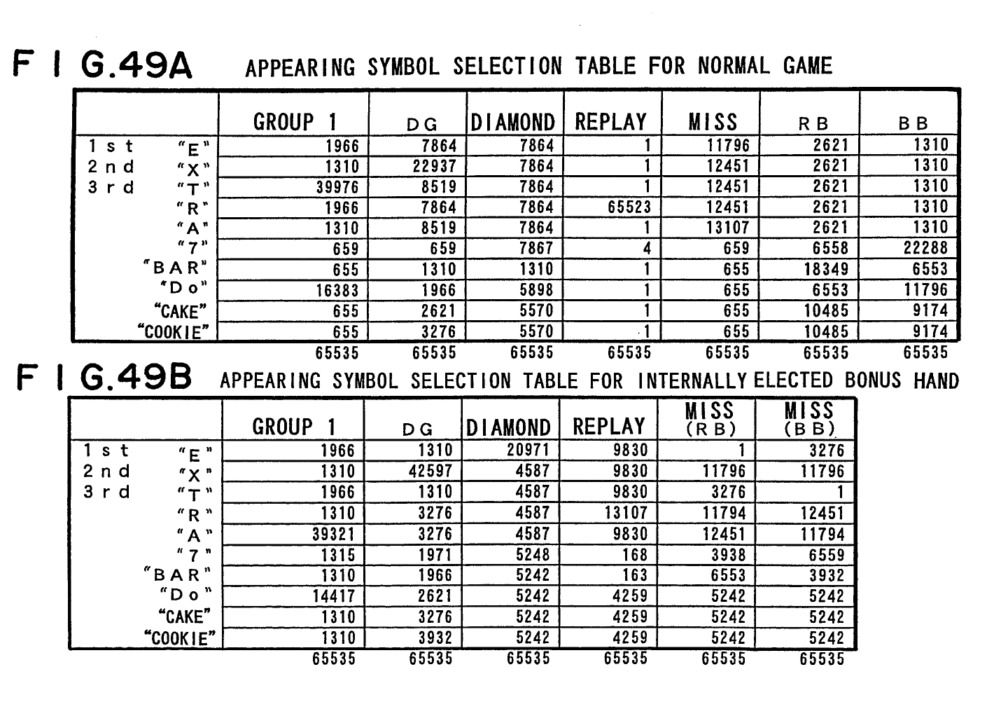

With reference to FIGS. 49A and 49B, the above-mentioned appearing symbol selection tables will be explained.

FIGS. 49A and 49B show the appearing symbol selection tables used in the above-mentioned appearing symbol attraction selecting process (S13). There are two kinds of appearing symbol selection tables, i.e., the appearing symbol selection table for normal game (FIG. 49A) and the appearing symbol selection table for internally elected bonus (BB or RB) hand (FIG. 49B).

In the appearing symbol selection table for normal game, there are 10 kinds of appearing symbols constituted by “E,” “X,” “T,” “R,” “A,” “7,” “BAR,” “cake” “cookie,” and “Do.” Basically, 7 kinds of internally elected hands constituted by “group 1 (“cherry” or “DB”),” “DG,” “diamond,” “replay,” “RB,” “BB,” and “miss (none of internally elected hands being elected)” correspond to each of the above-mentioned appearing symbols. Also, in the appearing symbol selection table for internally elected bonus hand, there are 10 kinds of appearing symbols constituted by “E,” “X,” “T,” “R,” “A,” “7,” “BAR,” “cake,” “cookie,” and “Do.” Six kinds of internally elected hands constituted by “group 1 (“cherry” or “DB”),” “DG,” “diamond,” “replay,” “miss (not being internally elected except for BB),” and “miss (not being internally elected except for RB)” basically correspond to each of the above-mentioned appearing symbols.

Here, “basically correspond” indicates that, though a specific appearing symbol is more likely to be selected for each internally elected hand since the width of random number value for determining the selection of each appearing symbol is biased, the specific appearing symbol is not always selected when the internally elected hand is determined, and appearing symbols other than the specific appearing symbol may be selected.

A method of selecting appearing symbols according to internally elected hands by using these appearing symbol selection tables will be explained with reference to the appearing symbol selection table for normal game shown in FIG. 49A.

As shown in FIG. 49A, the numbers listed on each column of internally elected hands indicate reference values to be compared with appearing symbol attraction selecting random number values. According to the comparison of the reference values with the appearing symbol attraction selecting random number values, appearing symbols are determined.

Namely, for example, on the first internally elected hand pattern column “group 1 (“cherry” or “DB”),” the first line of appearing symbol “E” is selected if any random number value from 0 to 1966 is sampled. If any random number value from 1967 to 3276 is sampled, then the second line of appearing symbol “X” is selected. Further, if any random number value from 3277 to 43252 is sampled, then the third line of appearing symbol “T” is selected.

In a specific method of computing, when the first internally elected hand pattern column “group 1 (“cherry” or “DB”)” is selected, then a first computation result is initially determined by subtracting the reference value on the first line, 1966, from the sampled random number value. If this first computation result is 0 or less, then the first line of appearing symbol “E” is selected. If the first computation result is a positive value, then a second computation result is determined by subtracting the reference value on the second line, 1310, from the first computation result. If this second computation result is 0 or less, then the second line of appearing symbol “X” is selected. Further, if the second computation result is a positive value, then a third computation result is determined by subtracting the reference value on the third line, 39976, from the second computation result. If this third computation result is 0 or less, then the third line of appearing symbol “T” is selected. Similar computations are successively carried out, so as to select appearing symbols according to the random number values up to 65535.

After the above-mentioned selection of appearing symbols, it is determined whether the left and right appearing symbols are identical or not (S205). If both appearing symbols are identical, then it is further determined whether both appearing symbols are appearing symbols other than a specific appearing symbol or not. Namely, in this case, the specific appearing symbol is any of “7,” “BAR,” “cake,” “cookie,” and “Do,” and it is determined whether both appearing symbols are any of the other appearing symbols “E,” “X,” “T,” “R,” and “A” or not (S206). If both appearing symbols are a specific appearing symbol, i.e., any of the appearing symbols other than “E,” “X,” “T,” “R,” and “A,” one frame is added to the left appearing symbol (S207). That is, since the case where the appearing symbols are set to a predetermined specific appearing symbol (any of appearing symbols for internally elected bonus hands: 7, BAR, Do, cake, and cookie) has been subjected to S12 of the attraction image selecting process, particular appearing symbols must not be set in a ready-hand state, whereby a process is carried out so as not to form the ready-hand state. In the case of normal appearing symbols (E, X, T, R, and A), even if a ready-hand is attained, it will not develop to a ready-state attraction, whereby appearing symbols may accidentally form a ready hand or a set when the left, center, and right appearing symbols are selected. Therefore, in the next step, in the case where both appearing symbols differ from each other, or they are not a specific appearing symbol though being identical to each other, i.e., they are any of appearing symbols of “E,” “X,” “T,” “R,” and “A,” then the process of S207 will not be carried out.

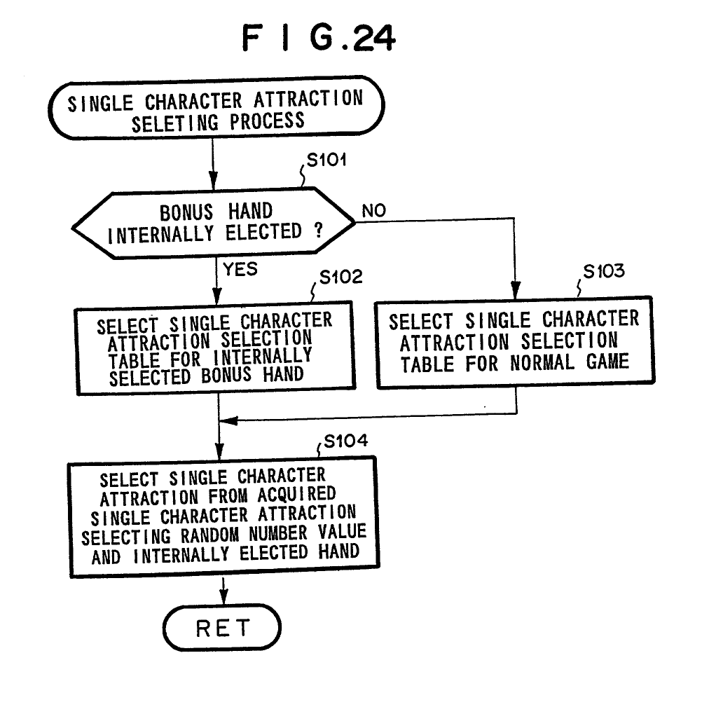

In the single character attraction selecting process (S14), as shown in FIG. 24, it is initially determined whether BB or RB is internally elected or not (S101). If BB or RB is internally elected, then a single character attraction selection table for internally elected bonus hand is selected (S102). If not, then a single character attraction selection table for normal game is selected (S103).

Subsequently, thus selected single character attraction selection table is used for selecting a single character attraction according to the single character attraction selecting random number value and internally elected hand transmitted from the main control board 100 (S104).

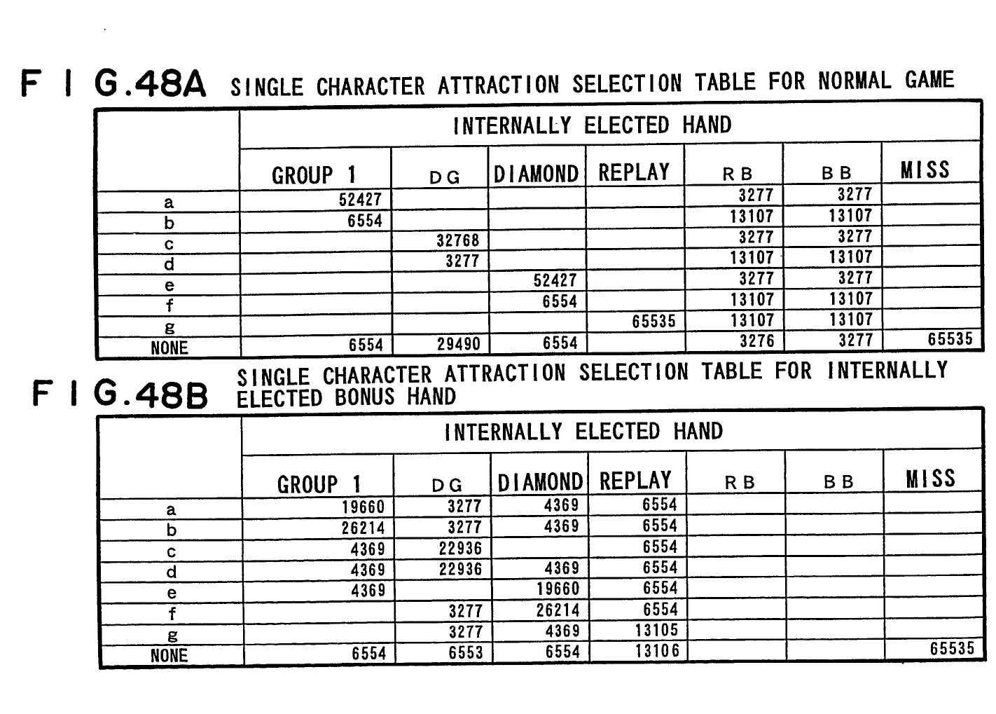

The above-mentioned single character attraction selection tables will be explained with reference to FIGS. 48A and 48B.

FIGS. 48A and 48B show the single character attraction selection tables used in the above-mentioned single character attraction selecting process (S14). There are two kinds of single character attraction selection tables, i.e., the single character attraction selection table for normal game (FIG. 48A) and the single character attraction selection table for internally elected bonus hand (FIG. 48B).

In each table, there are eight kinds of single characters constituted by “a” to “g” and “none.” Seven kinds of internally elected hands constituted by “group 1 (“cherry” or “DB”),” “DG,” “diamond,” “replay,” “RB,” “BB,” and “miss” basically correspond to each single character.

Here, “basically correspond” indicates that, though a specific single character is more likely to be selected for each internally elected hand since the width of random number value for determining the selection of each single character is biased, the specific appearing symbol is not always selected when the internally elected hand is determined, and single characters other than the specific single character may be selected.

As can be seen from the tables shown in FIGS. 48A and 48B, in the single character attraction selection table for normal game, three internally elected hands constituted by the internally elected BB hand, the internally elected RB hand, and another internally elected hand correspond to each internally elected hand noticing pattern; whereas, in the single character attraction selection table for internally elected bonus character, three or more internally elected hands other than the internally elected BB hand and the internally elected RB hand correspond to each internally elected hand noticing pattern.

As a consequence, the single characters selected according to each internally elected hand are limited in normal games, whereas the kinds of single characters to be selected enhance during internal election of bonus hands. By utilizing this fact, the player can appreciate changes in the state of gaming.

A method of selecting single characters according to internally elected hands will be explained with reference to the single character attraction selection table for normal game shown in FIG. 48A.

As shown in FIG. 48A, the numbers listed on each column of internally elected hand patterns indicate reference values to be compared with single character attraction selecting random number values. According to the comparison of the reference values with the single character attraction selecting random number values, single characters are determined.

Namely, for example, on the first internally elected hand pattern column “group 1 (“cherry” or “DB”),” the first appearing symbol noticing pattern “a” is selected if any random number value from 0 to 52427 is sampled. If any random number value from 52428 to 58981 is sampled, then the second appearing symbol noticing pattern “b” is selected. Further, if any random number value from 58982 to 65535 is sampled, then the third appearing symbol noticing pattern “none” is selected.

On each internally elected hand pattern column, the single characters corresponding to lines in which no reference values are indicated would not be selected.

In a specific method of computing, when the first internally elected hand pattern column “group 1 (“cherry” or “DB”)” is selected, then a first computation result is initially determined by subtracting the reference value on the first line, 52427, from the sampled random number value. If this first computation result is 0 or less, then the first line of single character “a” is selected. If the first computation result is a positive value, then a second computation result is determined by subtracting the reference value on the second line, 6554, from the first computation result. If this second computation result is 0 or less, then the second line of single character “b” is selected. Further, if the second computation result is a positive value, then the remaining single character, i.e., the eighth line of single character “none” is selected. Similar computations are successively carried out for the other internally elected hands, so as to select single characters according to the random number values up to 65535. Though random number values for selecting various attractions are extracted on the main control board 100 side and transmitted to the sub-control board 200 side in this embodiment, random numbers may be extracted on the sub-control board 200 side as well.

Specific Examples of Indication of Game Information

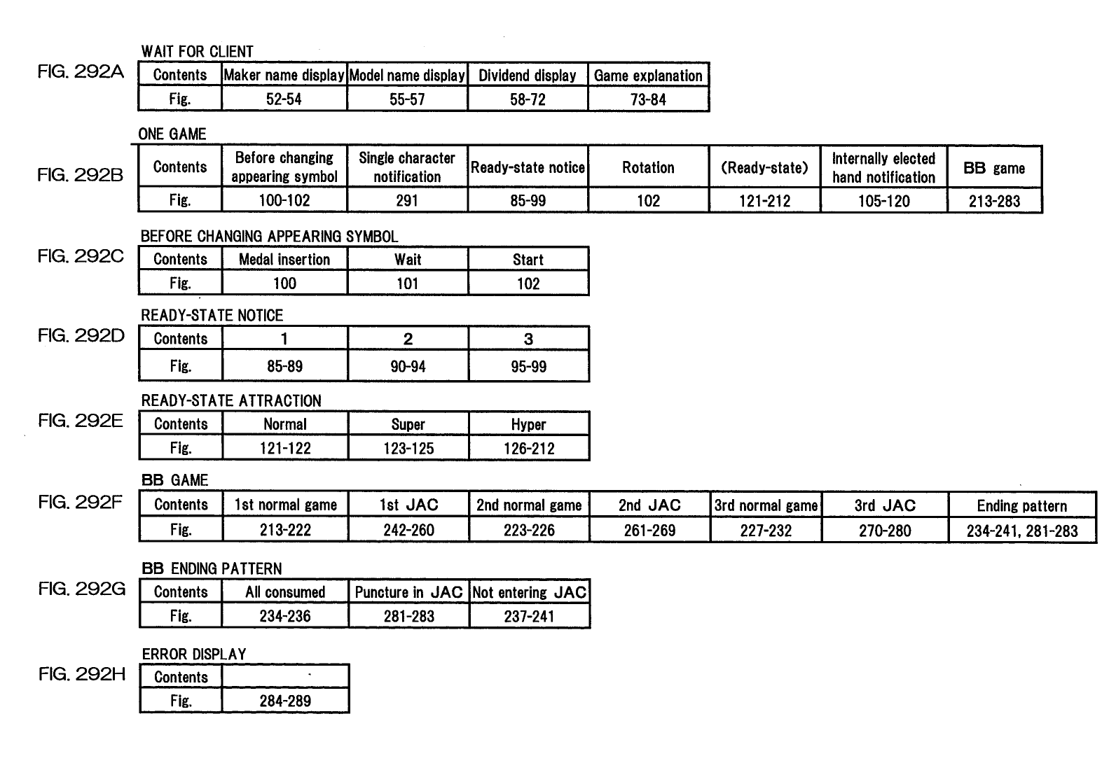

First, FIGS. 292A to 292H are charts showing relationships between the overall flows of game information displayed in the image display section 13 of the above-mentioned slot machine and the drawings used for their explanations.

The overall flows shown in FIGS. 292A to 292H will be explained in brief.

In FIG. 292A, “wait for client” indicates the contents displayed when no game is being played. In FIG. 292B, “one game” explains the flow from starting gaming until one game is consumed and the flow in the case entering a big bonus (BB) FIGS. 292C to 292G further fragmentally show the flows shown in FIG. 292B. In FIG. 292H, “error display” lists the contents displayed when errors have occurred.

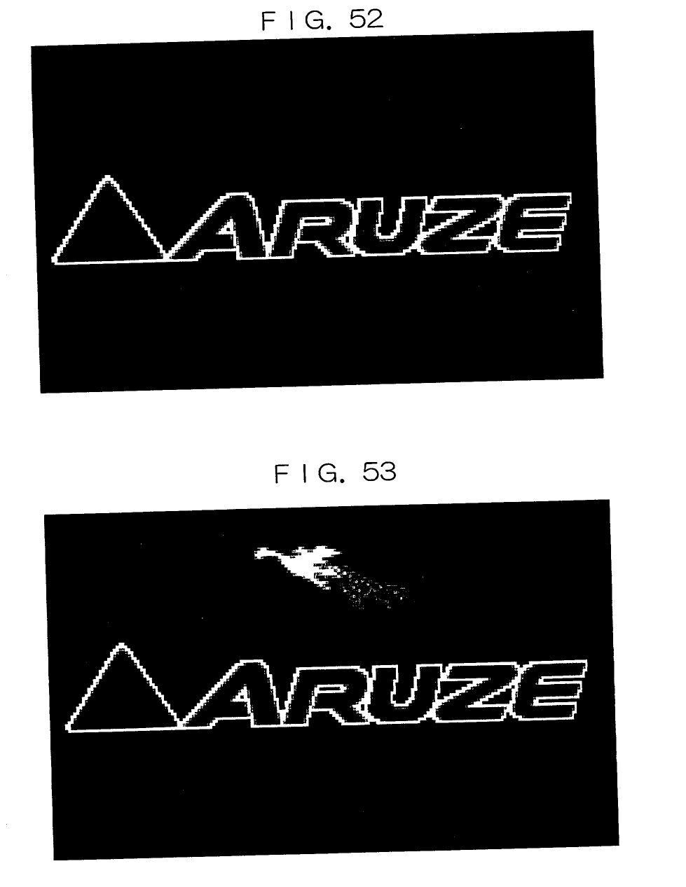

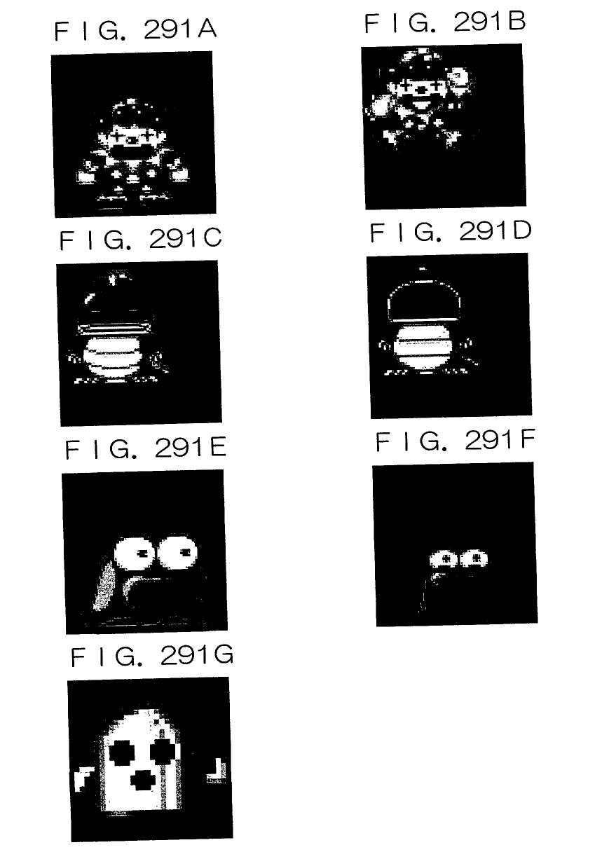

With reference to FIGS. 52 to 291F, the other embodiment of specific game information displayed in the image display section 13 in the above-mentioned slot machine (overall flows shown in FIGS. 292A to 292H) will now be explained in detail.

The game information displayed in the image display section 13 in this slot machine is expressed by a series of moving images, such that various kinds of game information are displayed as a story progresses along with the progress of gaming.

Maker Name

While no game is being played, the maker name is initially displayed.

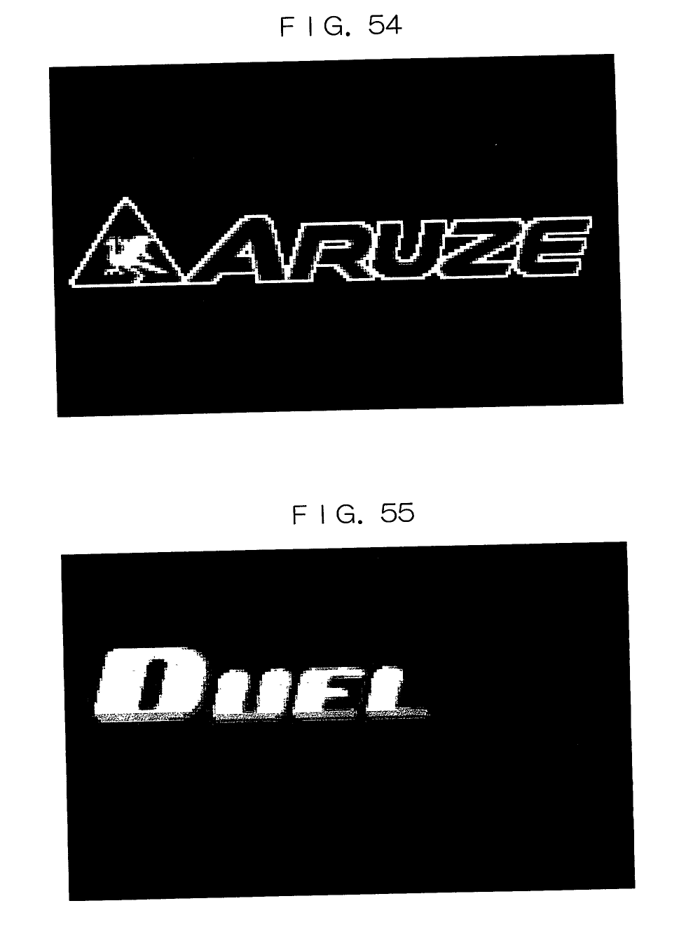

In the display of maker name, a designed maker name is initially displayed (FIG. 52), a bird appears on the screen (FIG. 53), and this bird is trapped in the maker name, whereby a logo of the maker name is completed (FIG. 54).

Model Name

Subsequent to the maker name, the model name of the slot machine is displayed.

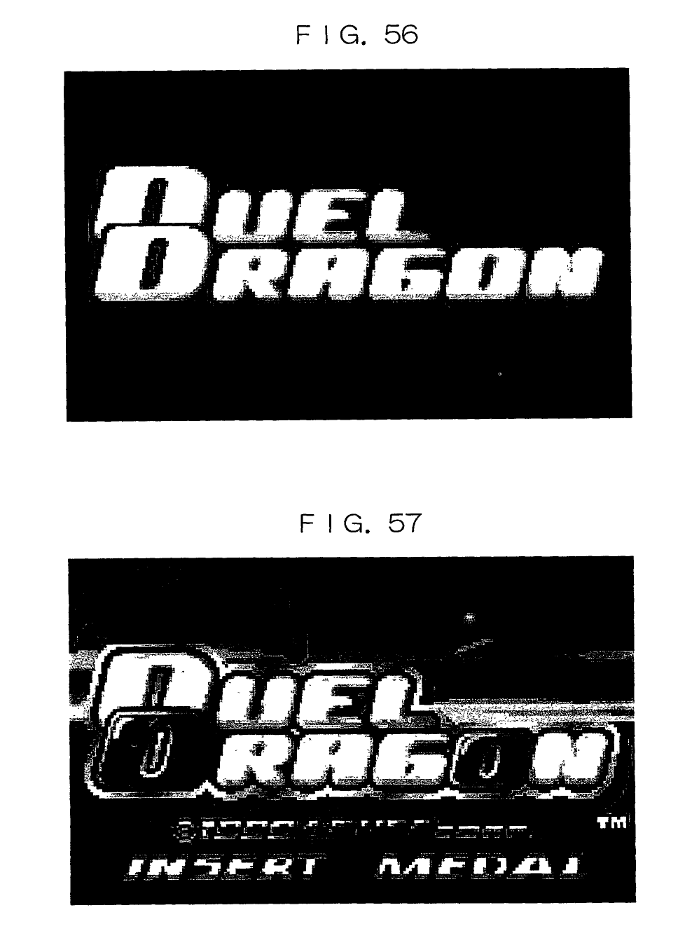

In the display of model name, two lines of the model name are successively displayed from the upper line to the lower line (FIGS. 55 and 56), and a symbol identifying the model name eventually appears, thus completing the display of model name (FIG. 57).

Dividend Display

Subsequent to the display of model name, the dividend display indicating the numbers of game medals to be paid out to the player according to stop modes of the reels 5a to 5c are displayed.

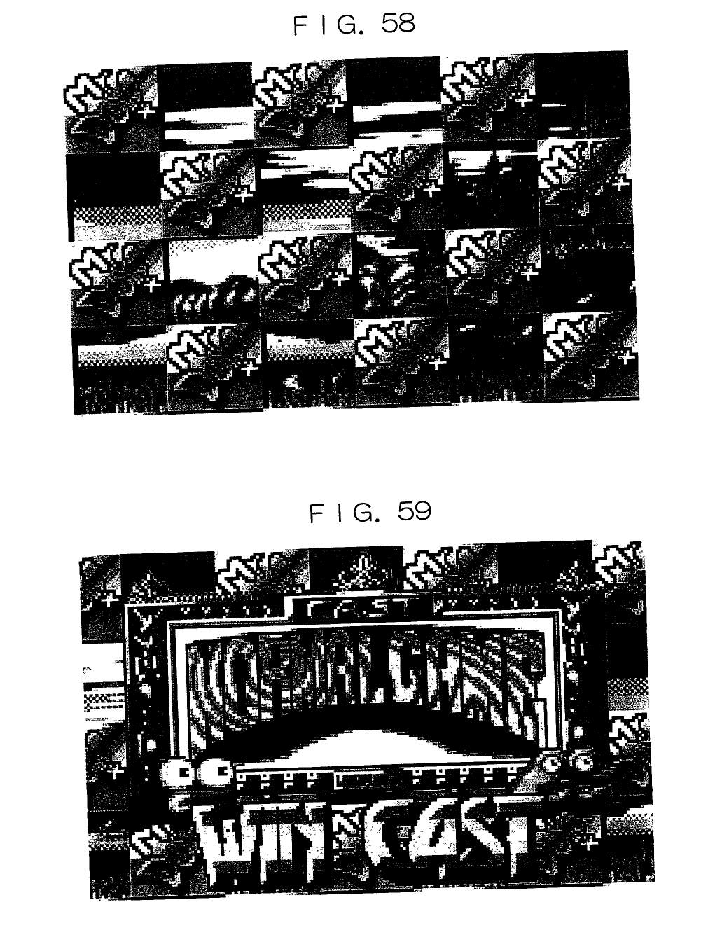

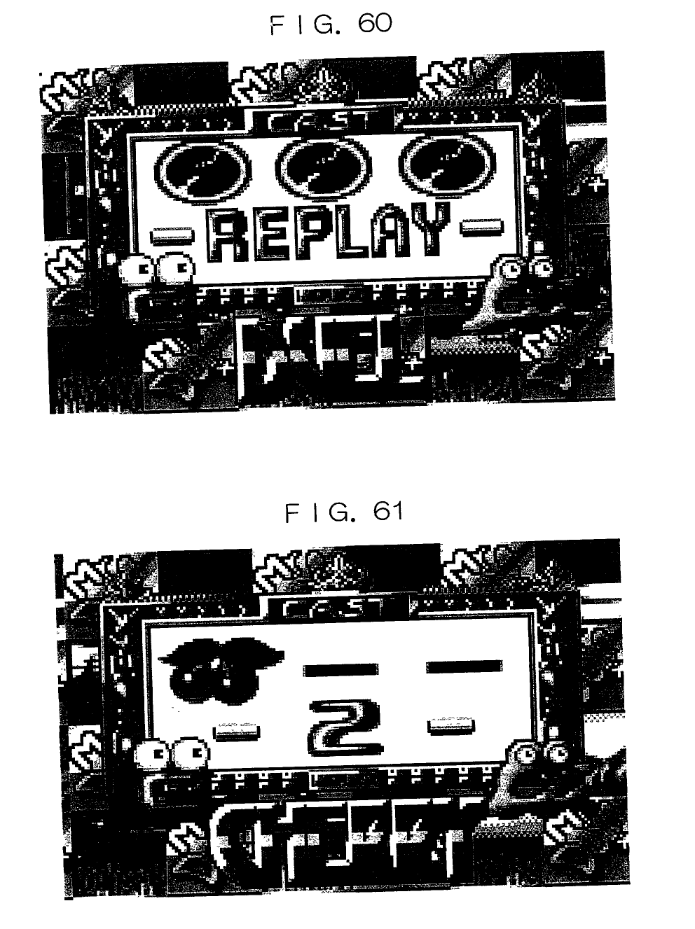

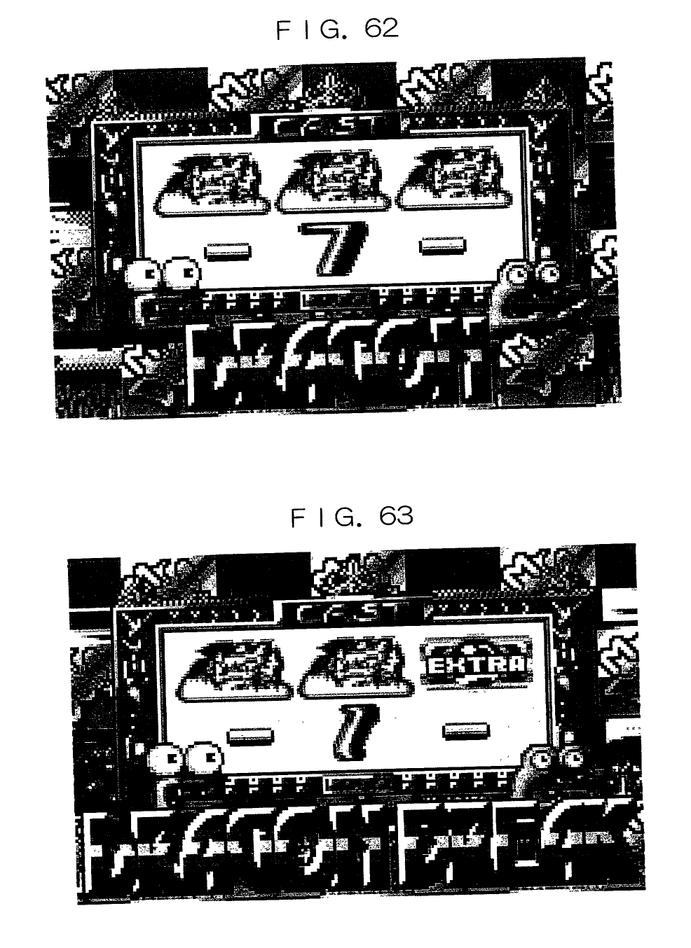

In this dividend display, a background is initially displayed (FIG. 58), it is indicated that the following dividends are for a normal game (FIG. 59), and then the stop mode in which a replay in this normal game is attained (FIG. 60), the stop mode in which 2 game medals are paid out (FIG. 61), the stop mode in which 7 game medals are paid out (FIG. 62), the stop mode in which 1 game medal is paid out (FIG. 63), and the stop mode in which 15 game medals are paid out (FIG. 64) are successively displayed.

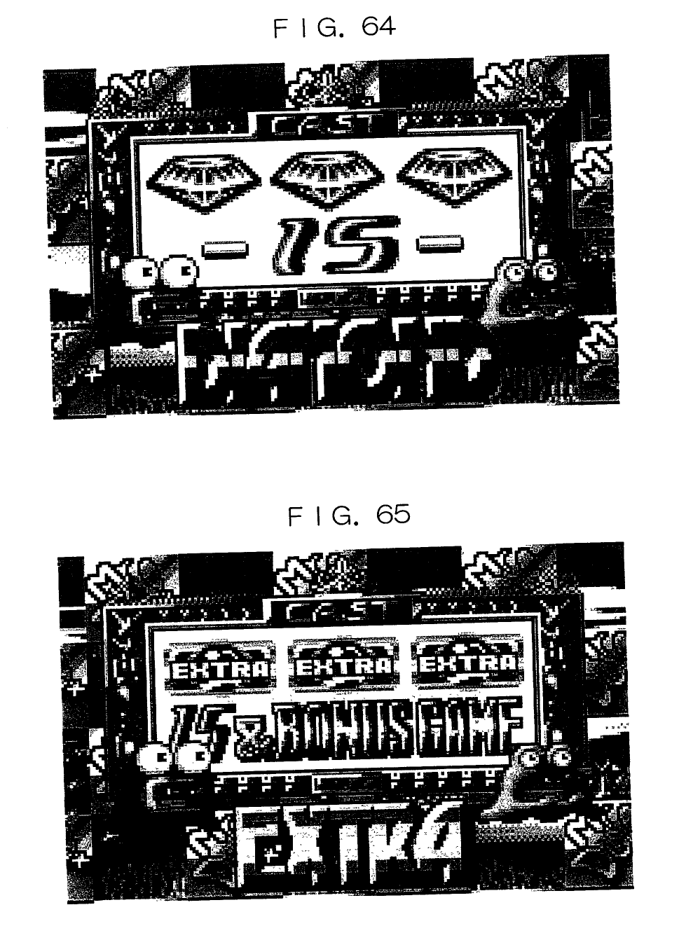

Subsequently, the stop mode for shifting to a regular bonus game and its number of game medals to be paid out (FIG. 65), the first stop mode for shifting to a big bonus game and its number of game medals to be paid out (FIG. 66), and the second stop mode for shifting to a big bonus game and its number of game medals to be paid out (FIG. 67) are successively displayed.

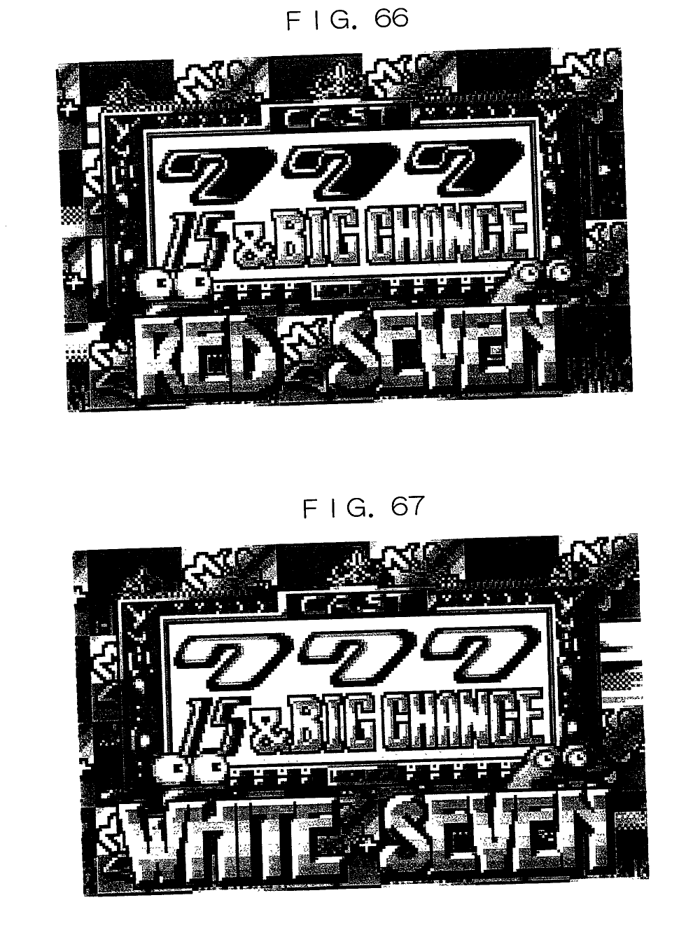

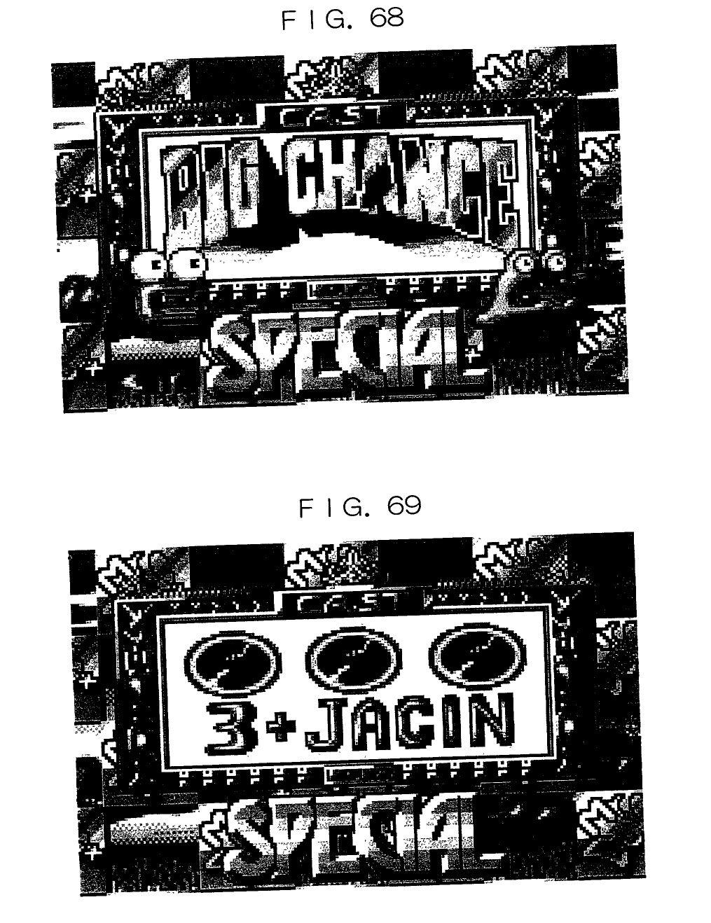

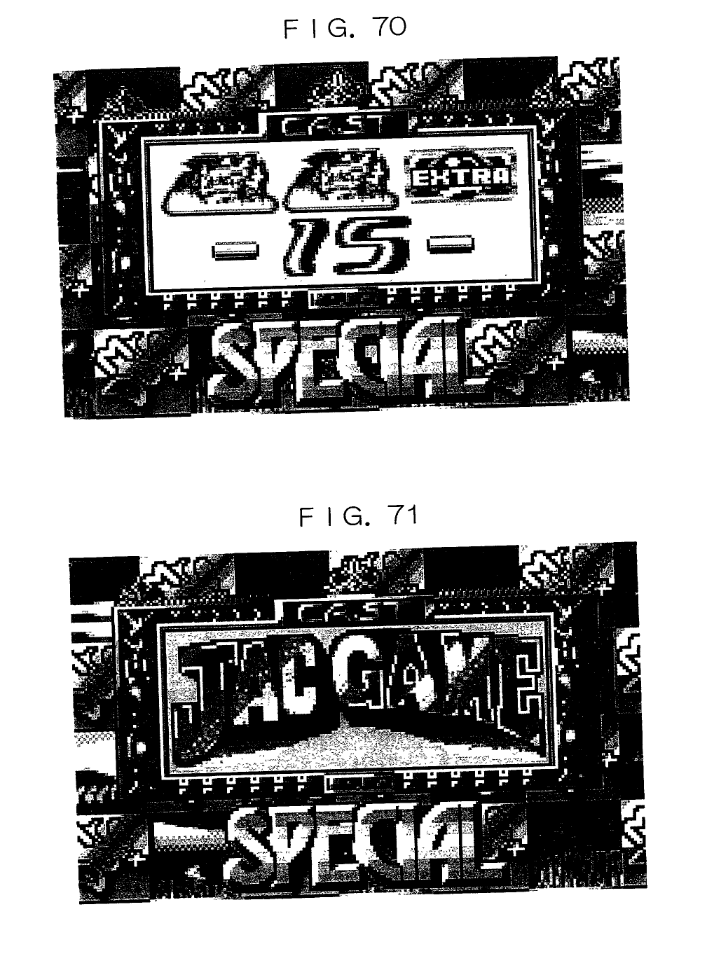

Then, it is indicated that the following dividends are for a normal game in a big bonus game (FIG. 68), and then the stop mode for shifting to a JAC game in the big bonus game and its number of game medals to be paid out (FIG. 69), and the stop mode in which 15 game medals are paid out (FIG. 70) are successively displayed.

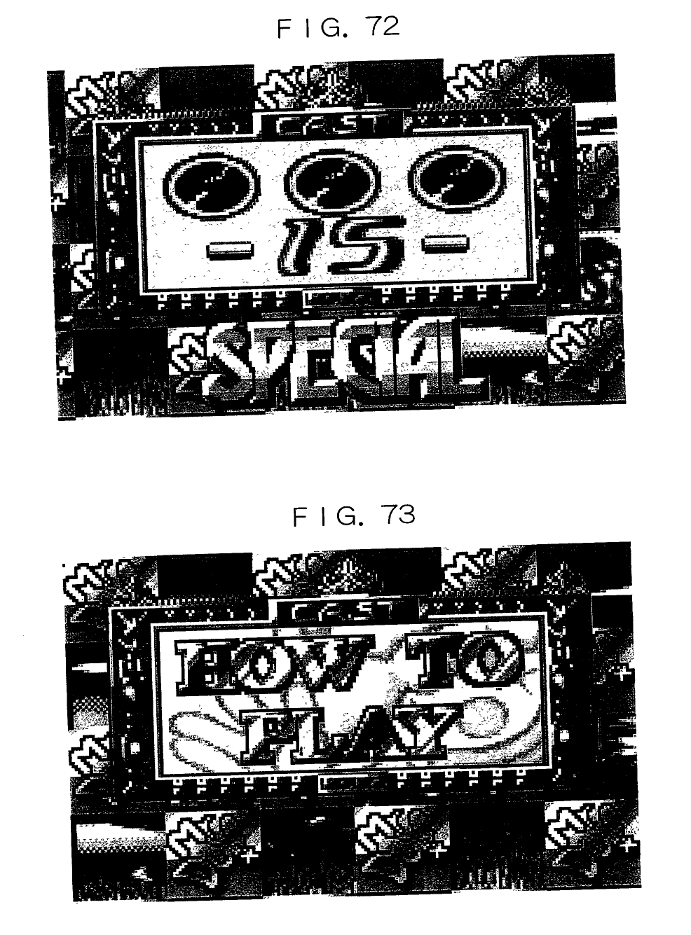

Then it is indicated that the following dividends are for a JAC game (FIG. 71), and then the stop mode of win in the JAC game and its number of game medals to be paid out (FIG. 72) are successively displayed.

Conventionally, a dividend table has simply been printed on a panel in the upper part of the housing or the like. Such a printed display has exhibited a lower degree of visual impact. Also, in the case where dividends vary depending on the state of gaming even in similar winning modes or the like, it has been difficult for the player to understand from the printed display at which timing the reels 5a to 5c should be stopped. When the dividends are explained by an animated display and the like in the image display section 13 as mentioned above, then not only the degree of visual impression on the player enhances, but also the dividends are easier to understand since they are explained in sequence for each gaming state or each winning mode.

Game Explanation

Subsequent to the dividend display, an explanation of games in this slot machine is displayed.

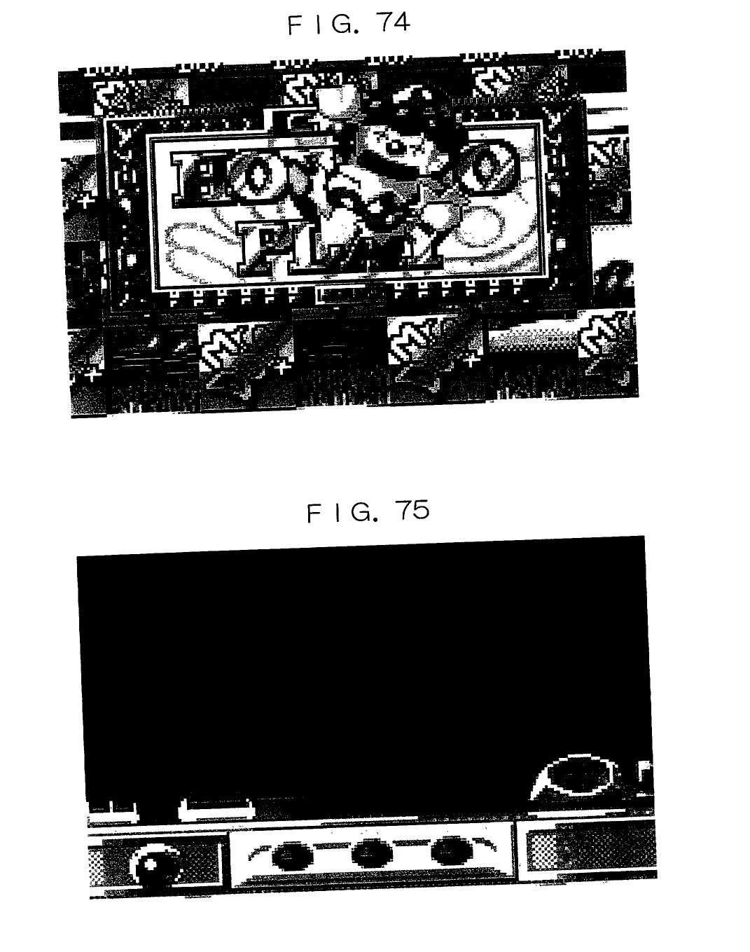

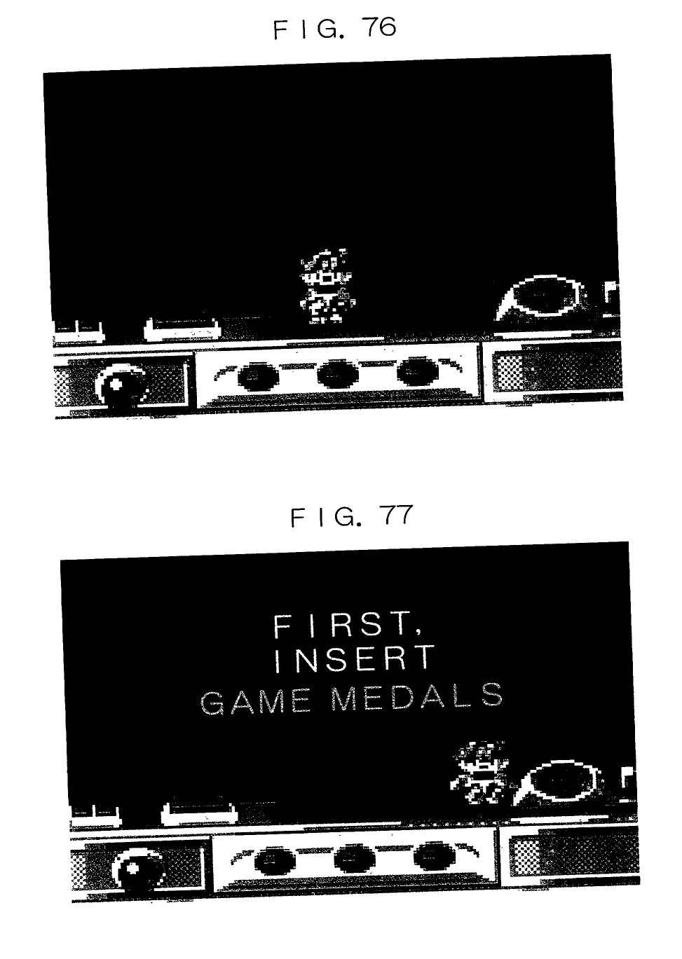

In this display of explanation, it is initially indicated that the following is the game explanation (FIG. 73), a character which acts as a leading character for displaying the game information emerges (FIG. 74), and an explanatory view for operations of the start switch 20, stop switches 21a to 21c , and the like is displayed (FIG. 75). Subsequently, the leading character emerges in a slightly scaled-down state (FIG. 76), and a specific game explanation begins.

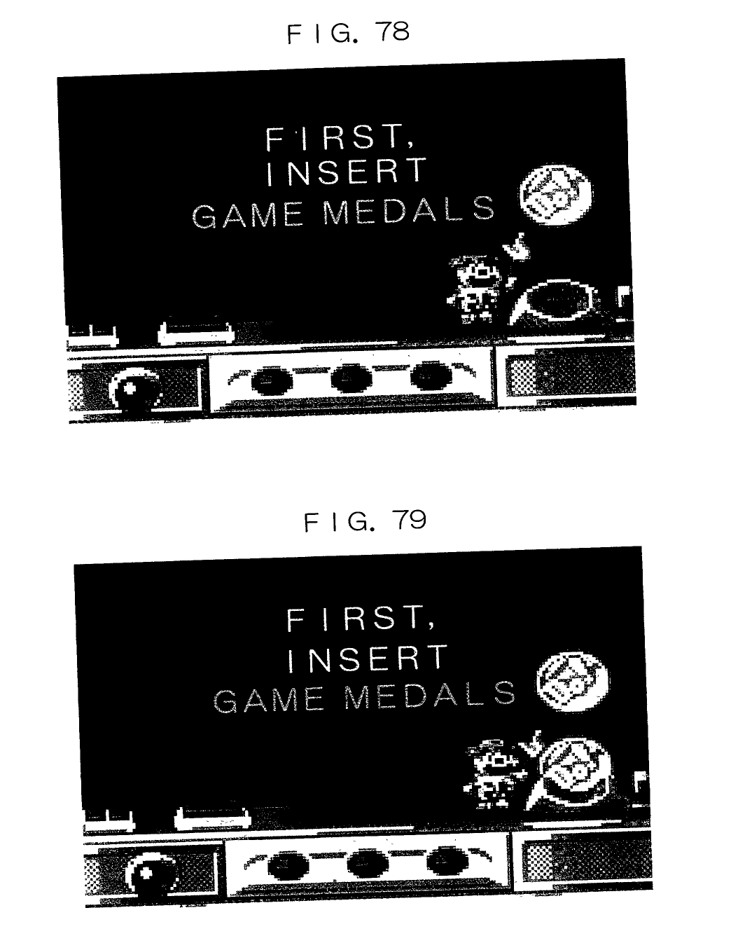

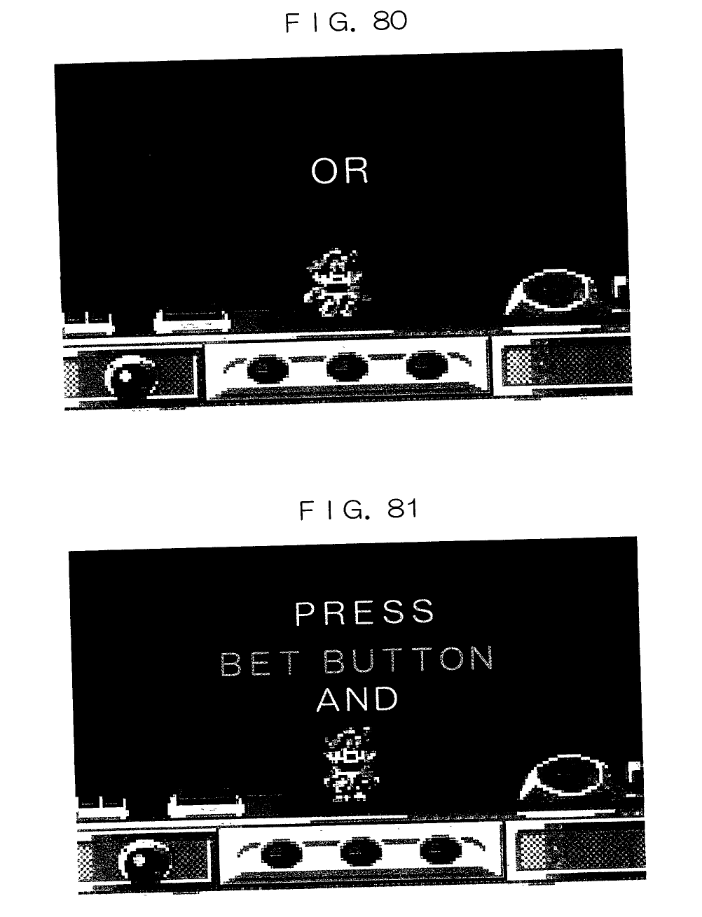

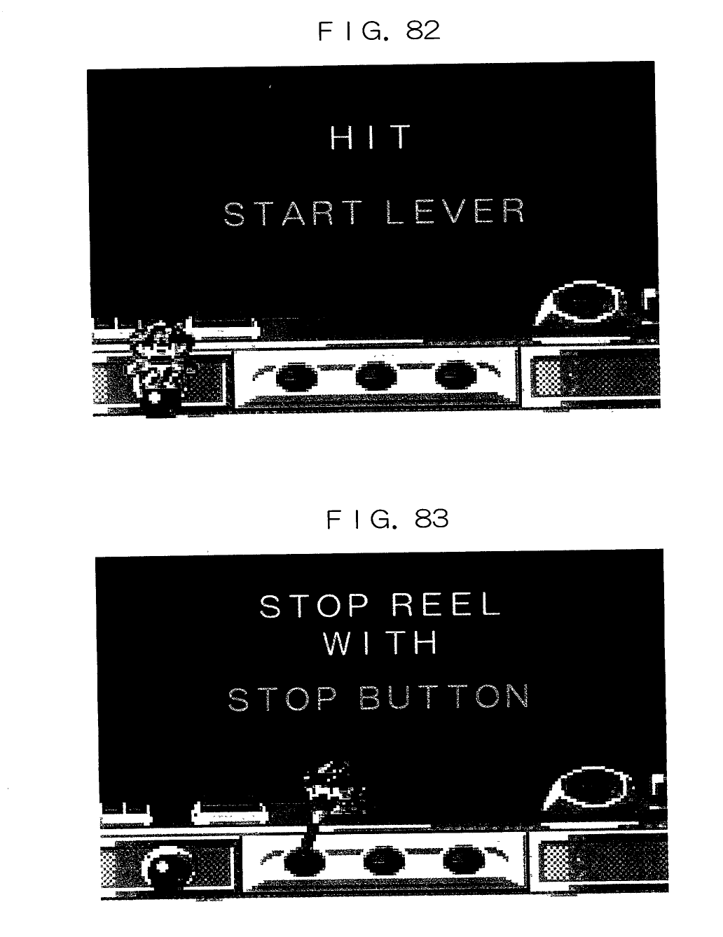

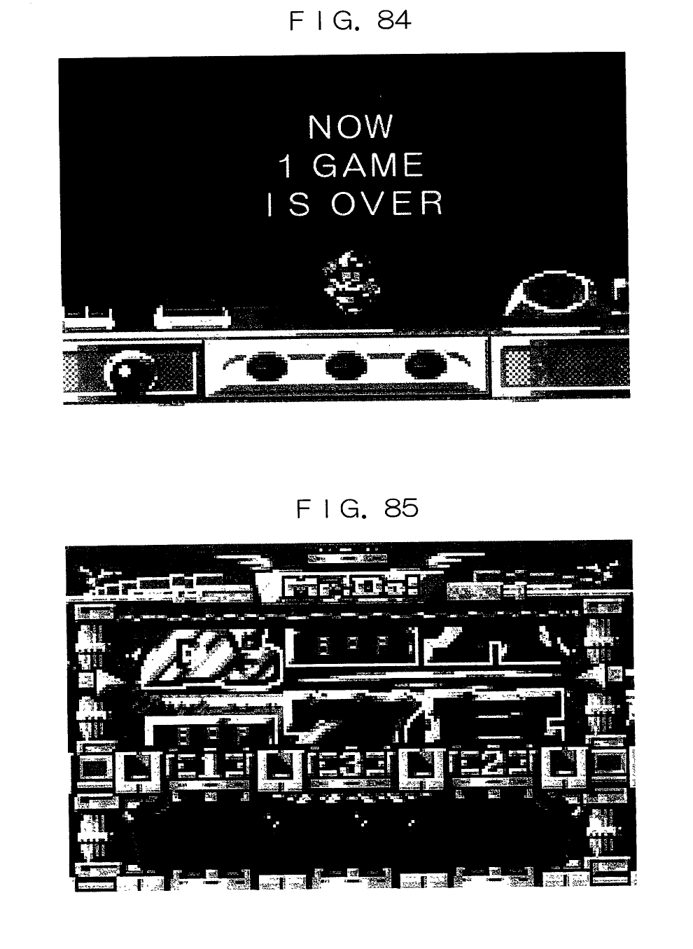

The specific game explanation is successively carried out for how to insert medals (FIGS. 77 to 79) or how to operate the bet switches 16, 17, and 18 (FIGS. 80 and 81), how to operate the start switch 20 (FIG. 82), and how to operate the stop switches 21a to 21c (FIG. 83), whereby the game explanation for one game ends (FIG. 84). Conventionally, a game explanation sheet attached to the housing or the like is used for the game explanation. In a dim parlor or the like, it has been difficult or impossible for the player to read the contents of explanation. Also, the player may have failed to notice the game explanation sheet attached to the housing. When the game explanation is carried out by an animated display using a character or the like, texts of the explanation are displayed in the image display section 13, whereby the contents of explanation can clearly be seen even in a dim parlor. Also, since the explanation is carried out by an animated display, even a novice player can reliably grasp the flow of gaming.

Attraction in Normal Game

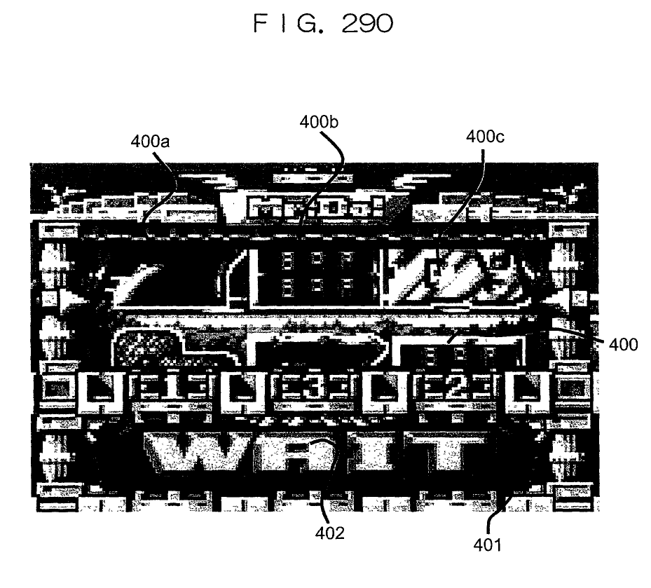

FIG. 290 is an enlarged view of the image display section. In the upper part of the screen, there is an appearing symbol variable display area 400, in which a left appearing symbol 400a, a center appearing symbol 400b, and a right appearing symbol 400c are displayed. Each appearing symbol is any of “E,” “X,” “T,” “R,” “A,” “7,” “BAR,” “cake,” and “cookie” as shown on the left-end column of the appearing symbol selection tables of FIGS. 49A and 49B. These symbols are displayed in a scrolling manner from the upper side to the lower side upon the starting operation by the player, and then are displayed in their stopped state according to the stopping operation by the player.

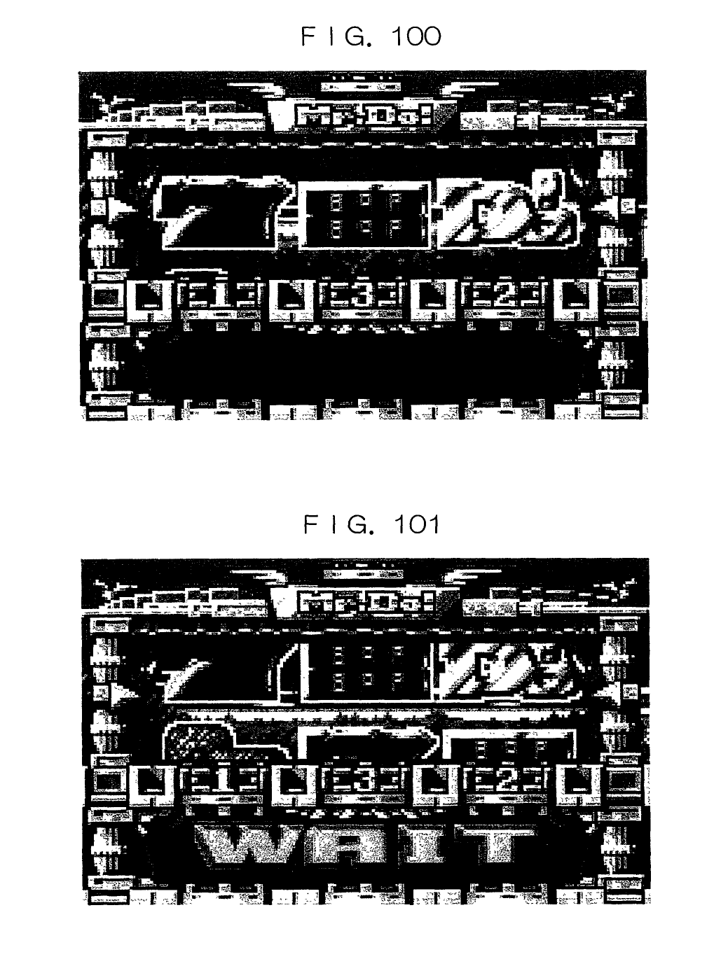

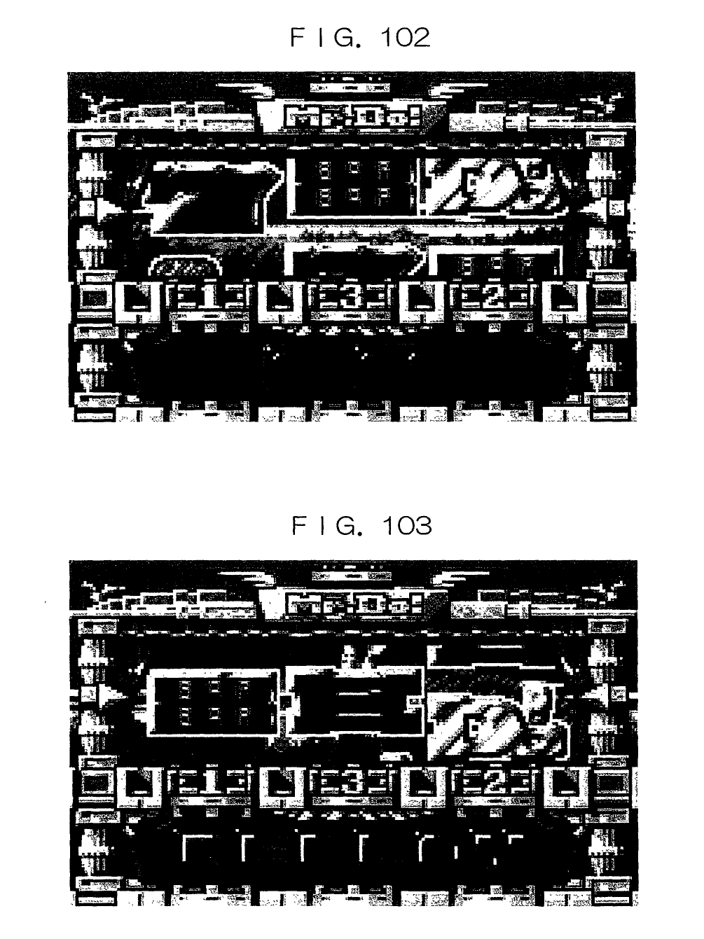

When game medals are inserted into the medal insertion slot 14 or the bet switches 16, 17, and 18 are operated, so that a game is ready to start, then the start switch 20 is made effective, whereby the game is started. Then, attractions in the game are carried out in the image display section 13. In attractions in a normal game, three appearing symbols are initially displayed from side to side in their stopped state (FIG. 100), letters of “WAIT” are displayed on the lower side of the screen so as to indicate that it is a wait time until the start switch 20 is made effective (FIG. 101), and then, while letters of “GO” emerge on the lower side of the screen, the appearing symbols begin to change along with rotations of the reels 5a to 5c (FIG. 102).

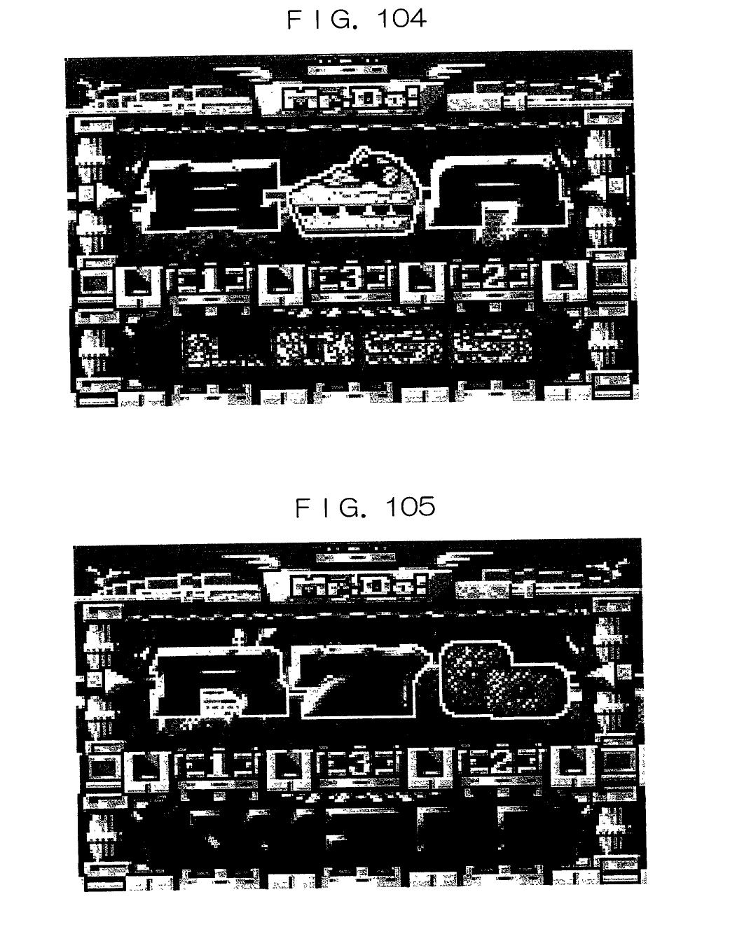

Then, in response to timings at which the reels 5a to 5c stop as the stop switches 21a to 21c are operated, the appearing symbols stop changing. If a winning mode is actually constructed on a winning line, e.g., a replay is won, then letters of “REPLAY” is displayed (FIG. 103). If no winning mode is constructed, then letters of “LOSS” are displayed (FIG. 104).

Also, as an attraction in the case where an actual stop mode in the reels 5a to 5c constructs a winning mode, letters of “WIN” indicating a winning are displayed notwithstanding the fact that no winning mode is constructed by the appearing symbols displayed in the image display section 13 (FIG. 105). Namely, the display of “WIN” or “LOSS” indicates whether each winning mode is constructed on the effecting winning line or not.

Though the variable display of appearing symbols is started at the timing at which the variable display of reels 5a to 5c is started in the above-mentioned embodiment, without being restricted thereto, it may be started at any timing, for example, when the insertion of game medals is detected, when the first stopping operation for the stop switches 21a to 21c is effected, when all the reels 5a to 5c are displayed in their stopped state, or at a totally random timing using a random number.

Also, though the appearing symbols being variably displayed are stopped at stopping timings of the reels 5a to 5c , without being restricted thereto, they may be stopped at any timing, for example, after the lapse of a predetermined time from the starting of the variable display, when the first stopping operation for the stop switches 21a to 21c is effected, when all the reels 5a to 5c are displayed in their stopped state, or at a totally random timing using a random number.

Conventionally, displays such as “WAIT,” “WIN,” and the like have been indicated to the player by lighting their corresponding lamps and the like which are separately provided. When all items of game information are displayed by the image display section 13 as mentioned above, the player can appreciate the information without moving the viewing point, whereby the current state is easier to grasp.

Conventionally, though the display of “WIN” has been effected (by lighting a lamp or the like), “LOSS” has not been displayed, whereby it has been difficult to discern whether it is won or not. When any of “WIN” or “LOSS” is displayed as mentioned above, whether it is won or not can be clearly discerned.

Notification of Internallv Elected Hand in Appearing Symbol Attraction

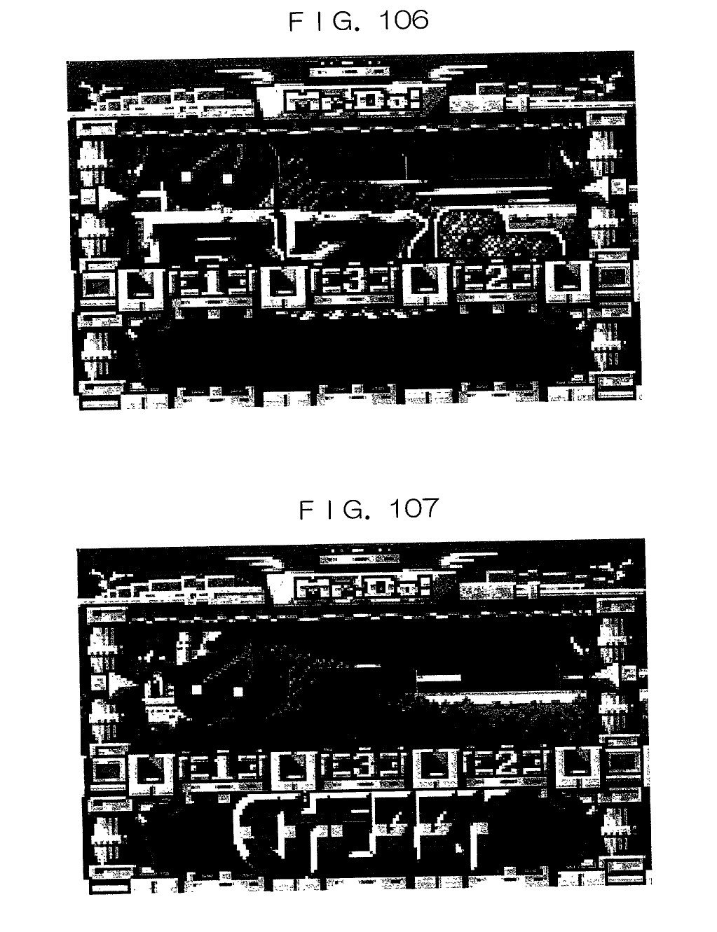

In this notification of internal election, three appearing symbols are once stopped in their disordered state as shown in FIG. 105, and then changing is restarted (FIG. 106). Subsequently, they are stopped again while constructing a winning mode (FIG. 107). FIG. 107 shows a case where the winning hand “cherry” is internally elected, and letters of “CHERRY” and the winning mode are displayed, whereby the internally elected hand (“CHERRY” indicating that group 1 including “DB” is internally elected) is indicated. Nothing is displayed when there is no internally elected hand (i.e., a miss).

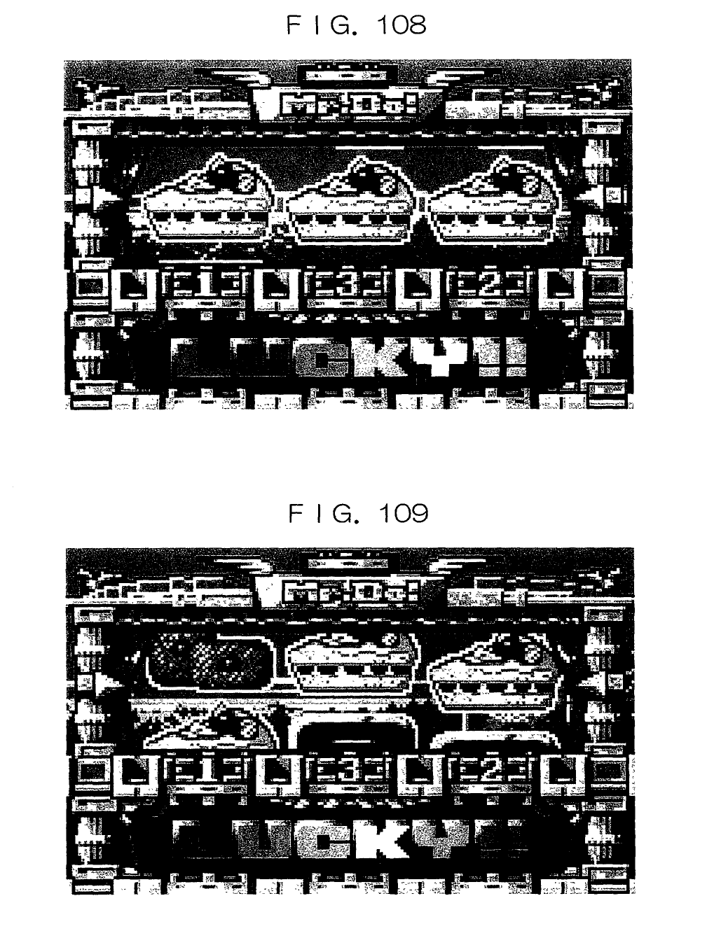

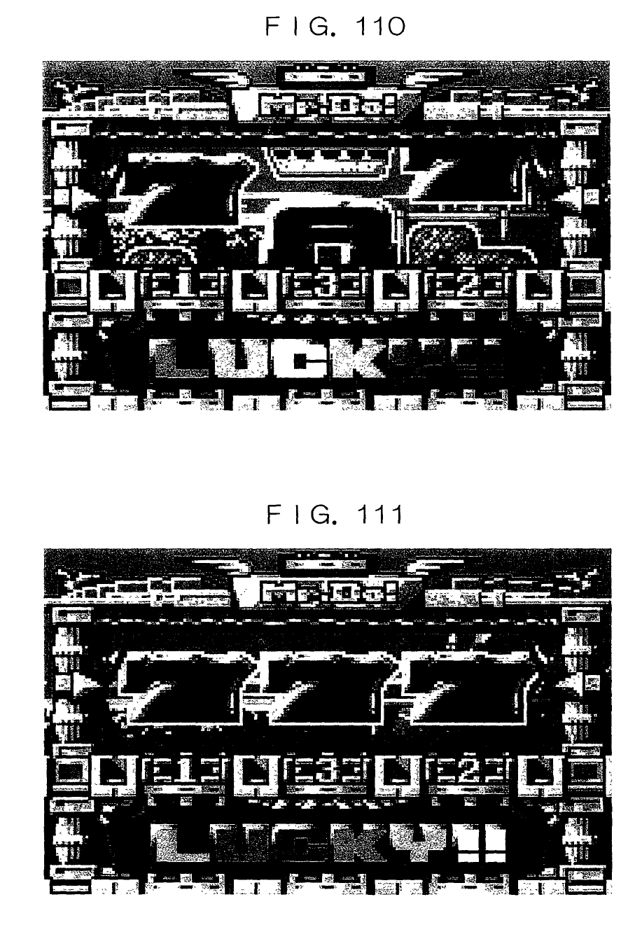

In another mode of notification, three appearing symbols are once stopped in the state where identical symbols align from side to side (FIG. 108), and then they are changed again (FIGS. 109 to 110), so as to start displaying what the internally elected hand is (FIG. 111).

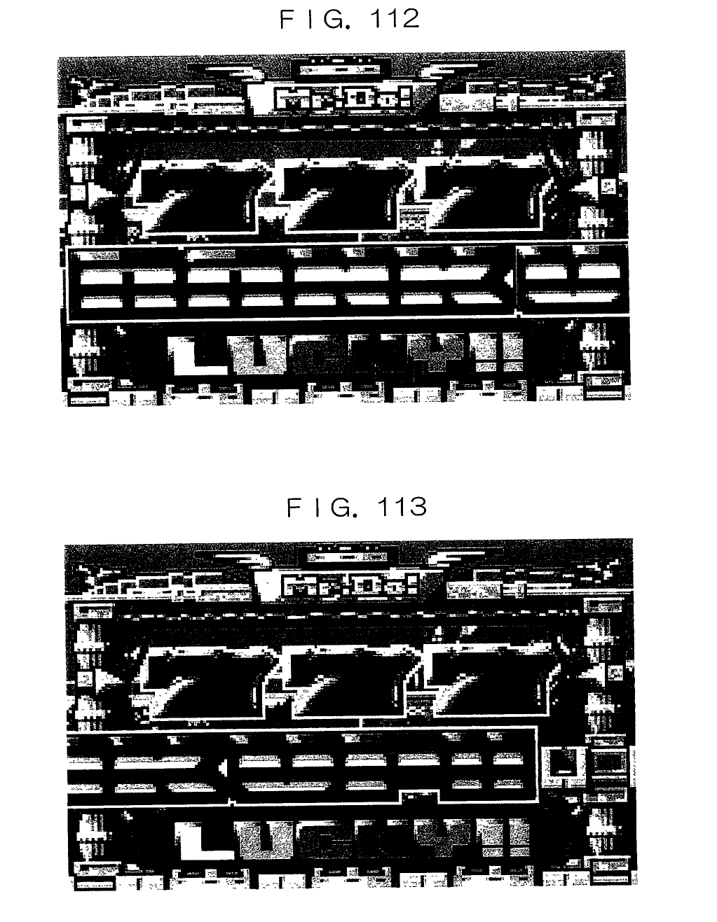

In the display of internally elected hand in this case, for example, letters of “RANK UP” are displayed in a laterally flowing manner (FIGS. 112 and 113), and then three frames of “7” are displayed from side to side in their stopped state, so as to indicate that a big bonus has been internally elected (FIG. 114).

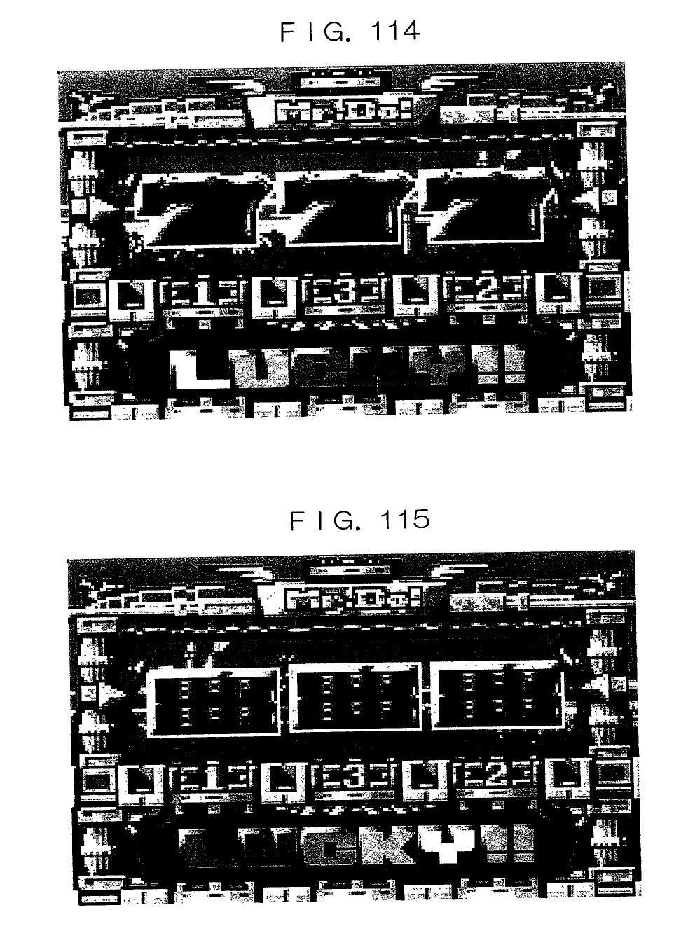

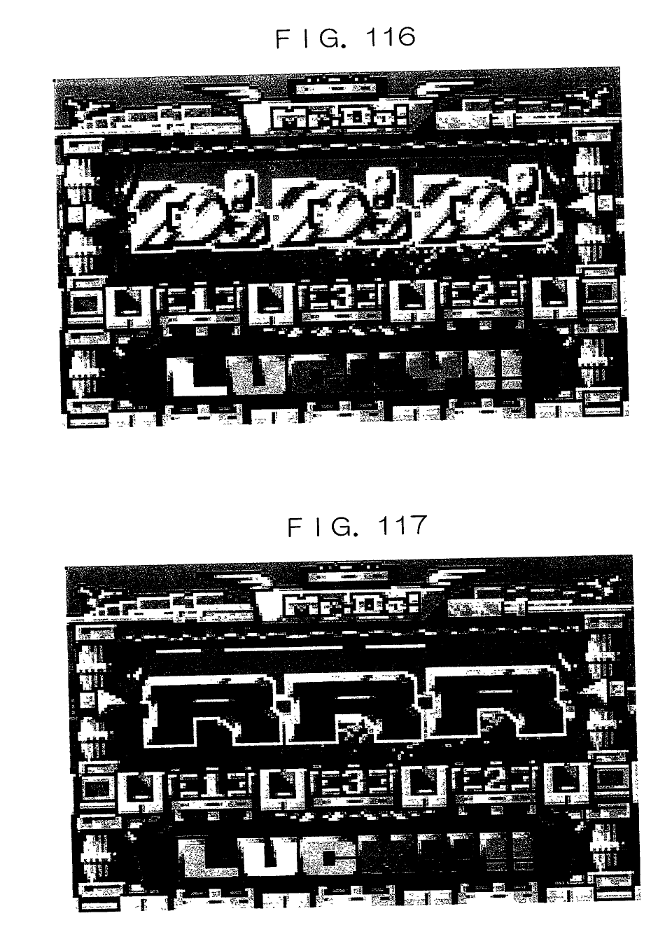

In other examples of display, three frames of “BAR” are displayed from side to side in their stopped state, so as to indicate that a regular bonus has been internally elected (FIG. 115); three frames of “Do!” are displayed from side to side in their stopped state, so as to indicate that a big bonus or regular bonus has been internally elected (FIG. 116); three frames of “R” are displayed from side to side in their stopped state, so as to indicate that a replay winning mode has been internally elected (FIG. 117); three frames of “X” are displayed from side to side in their stopped state, so as to indicate that a so-called small hand winning mode has been internally elected (FIG. 118); three frames of “cake” are displayed from side to side in their stopped state, so as to indicate that a big bonus or regular bonus has been internally elected (FIG. 119); and three frames of “cookie” are displayed from side to side in their stopped state, so as to indicate that a big bonus or regular bonus has been internally elected (FIG. 120).

Thus, when indicating an internally elected hand, if it is displayed in two separate stages, the enjoyment of the player can further be enhanced.

Though the ranking of appearing symbols is raised from the BB/ RB common appearing symbols to the BB definition appearing symbols in the above-mentioned embodiment it may be conversely lowered from the BB definition appearing symbols to the BB/RB common appearing symbols.

Notice of Internally Elected Hand by Ready-State Attraction In addition to the above-mentioned attractions in normal games, a ready-state attraction, which is one of attractions concerning whether a big bonus or regular bonus is internally elected or not, is carried out. In this embodiment, broadly-classified seven modes of ready-state attraction will be explained. Here, the possibility of internal election of the big bonus or regular bonus is noticed with a predetermined reliability, and the noticed bonus hand is not always internally elected.

Ready-State Attraction 1

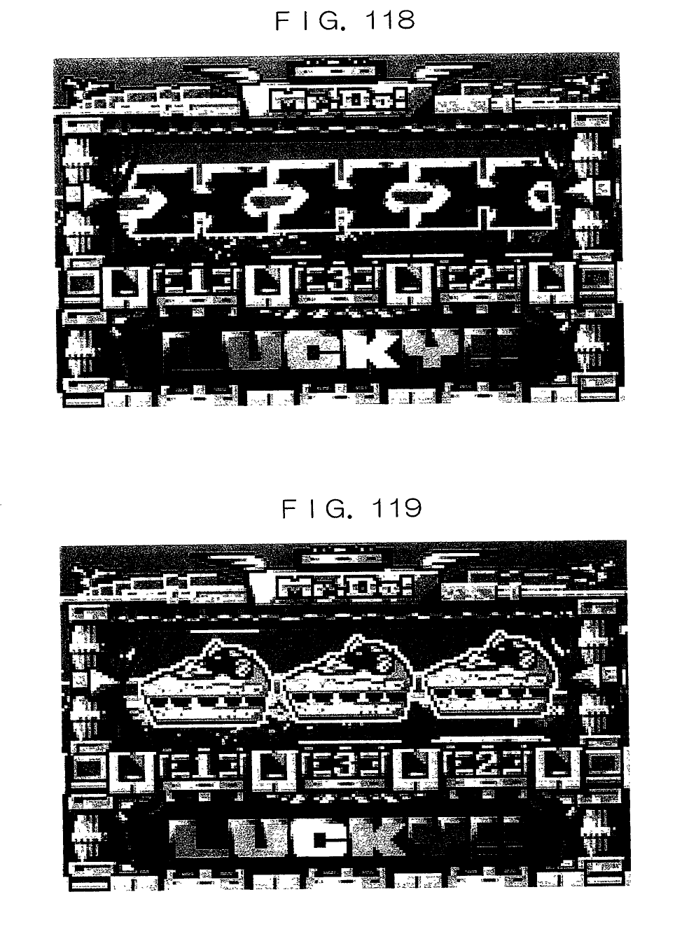

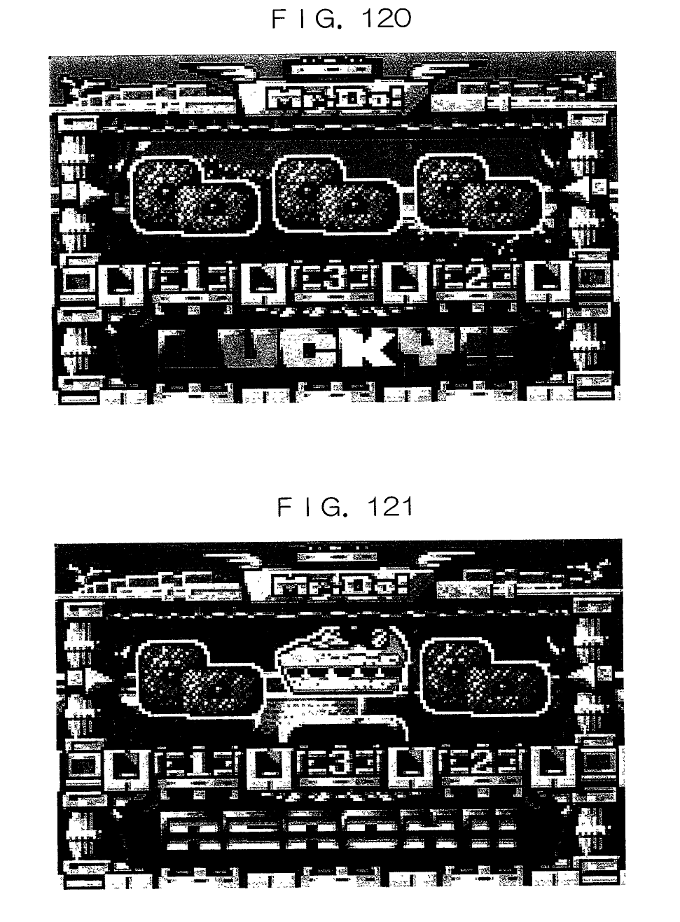

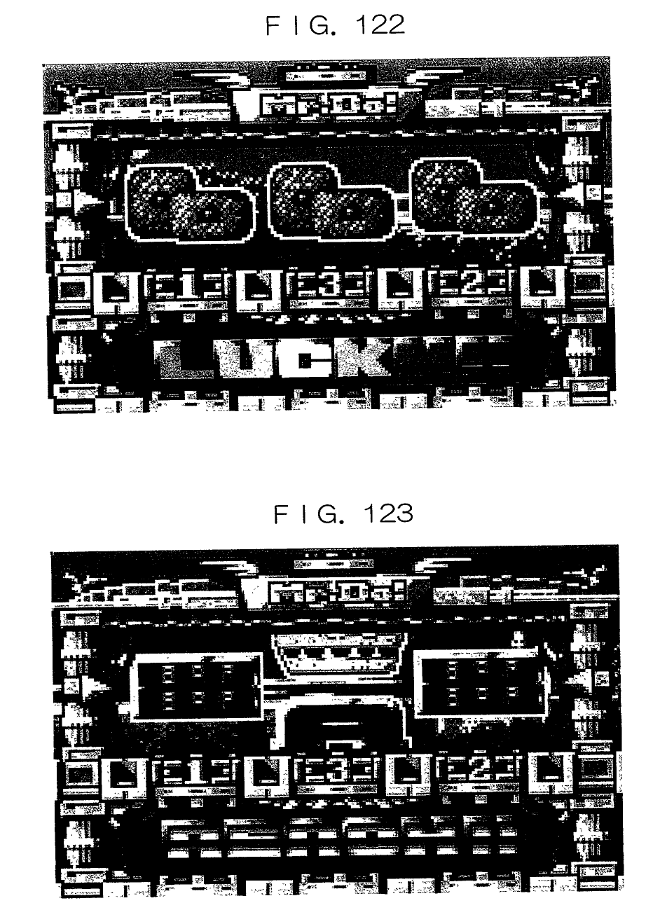

In ready-state attraction 1, of three appearing symbols displayed from side to side, identical appearing symbols “cookie” are initially displayed on the left and right sides in their stopped state, and then, while the appearing symbol “cookie” identical to the left and right is displayed at the center in its stopped state, letters of “REACH” are displayed on the lower side of the screen (FIG. 121), so as to indicate that there is a possibility of a bonus hand being internally elected (FIG. 122).

Ready-State Attraction 2

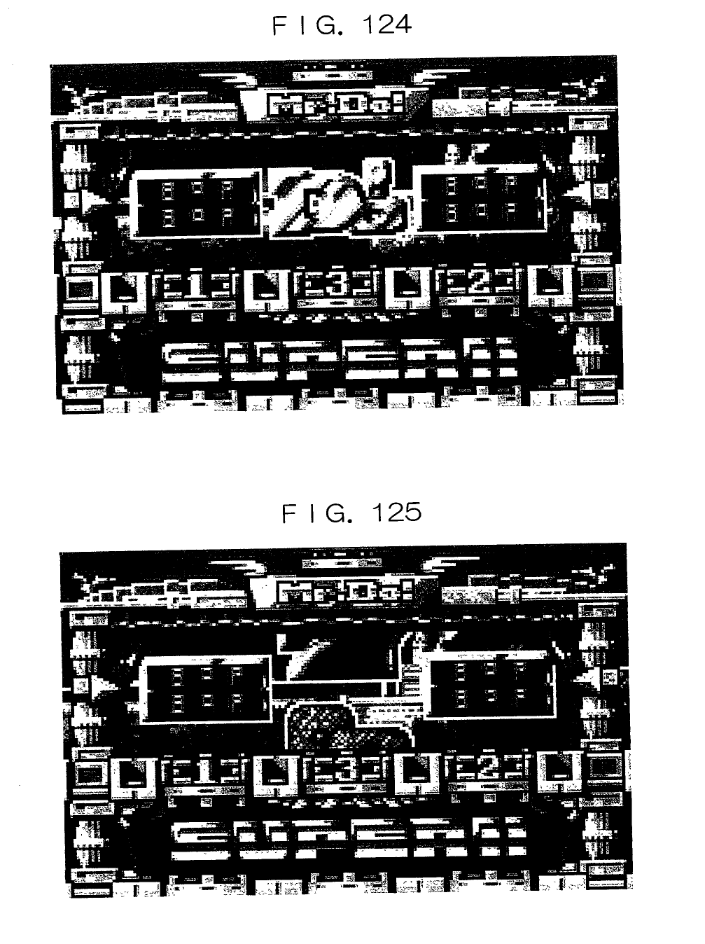

In ready-state attraction 2, of three appearing symbols displayed from side to side, identical appearing symbols “BAR” are initially displayed on the left and right sides in their stopped state, and then, while the appearing symbol “BAR” identical to the left and right is displayed at the center in its stopped state, letters of “REACH” are displayed on the lower side of the screen, so as to indicate that it is a ready state (FIG. 123). Further, after letters of “SUPER” are displayed on the lower side of the screen (FIG. 124), the gaming state shifts to a so-called super ready state in which the reliability is higher than that in the normal ready state (FIG. 125), so as to effect a display similar to the above-mentioned ready-state attraction 1, thereby indicating that there is a possibility of a bonus hand being internally elected.

Ready-State Attraction 3

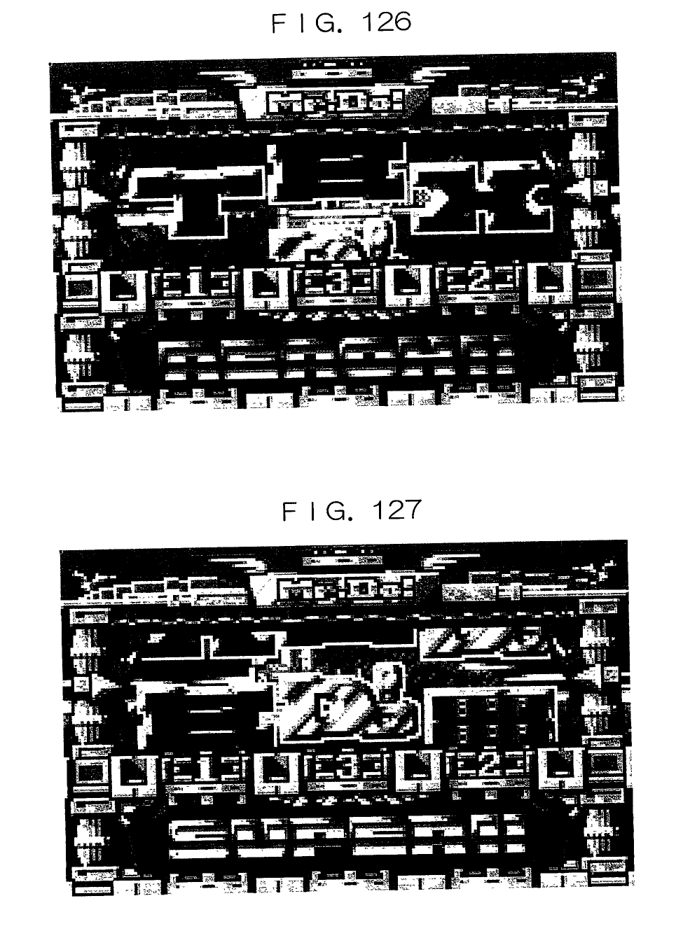

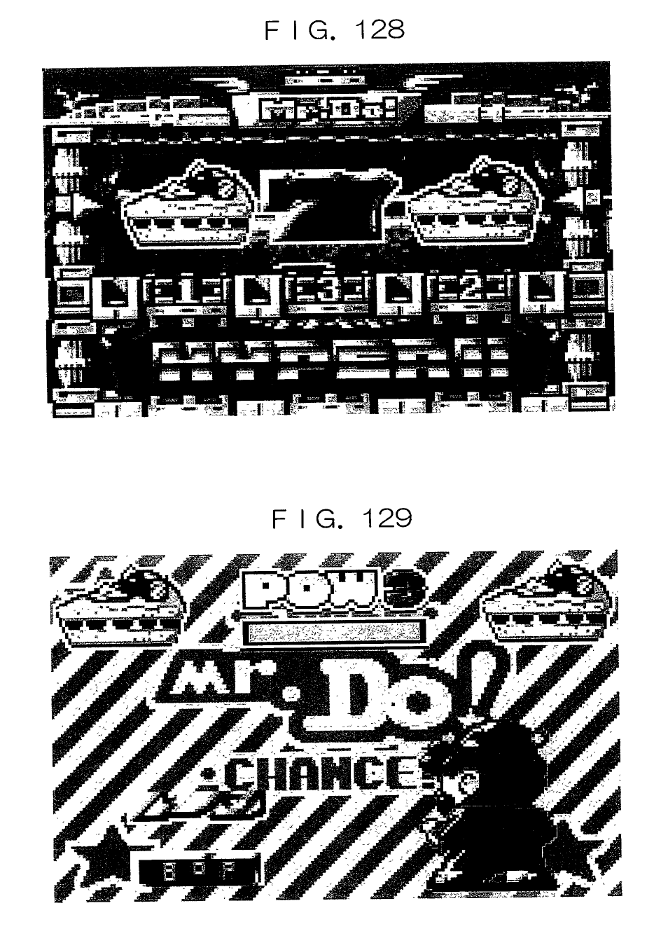

In ready-state attraction 3, letters of “REACH” are displayed on the lower side of the screen, so as to indicate that it is a ready state (FIG. 126). Then, letters of “SUPER” are displayed on the lower side of the screen, so as to indicate that the gaming state has shifted to a so-called super ready state in which the reliability is higher than that in the normal ready state (FIG. 127). Further, letters of “HYPER” are displayed on the lower side of the screen, so as to indicate that the gaming state has shifted to a so-called hyper ready state in which the reliability is higher than that in the super ready state (FIG. 128).

This hyper ready state include three patterns.

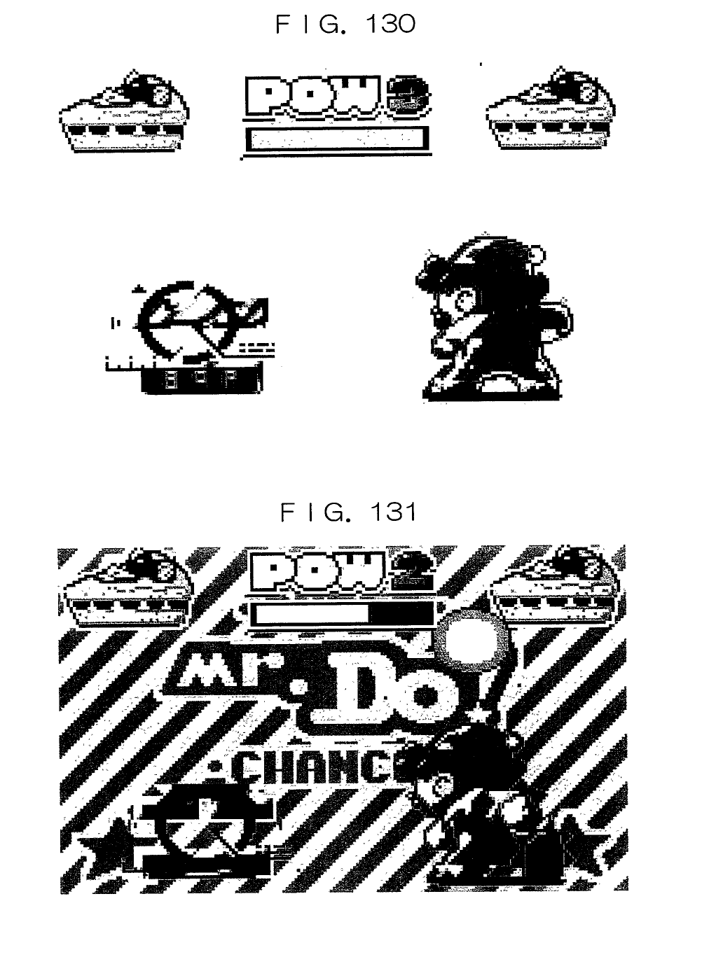

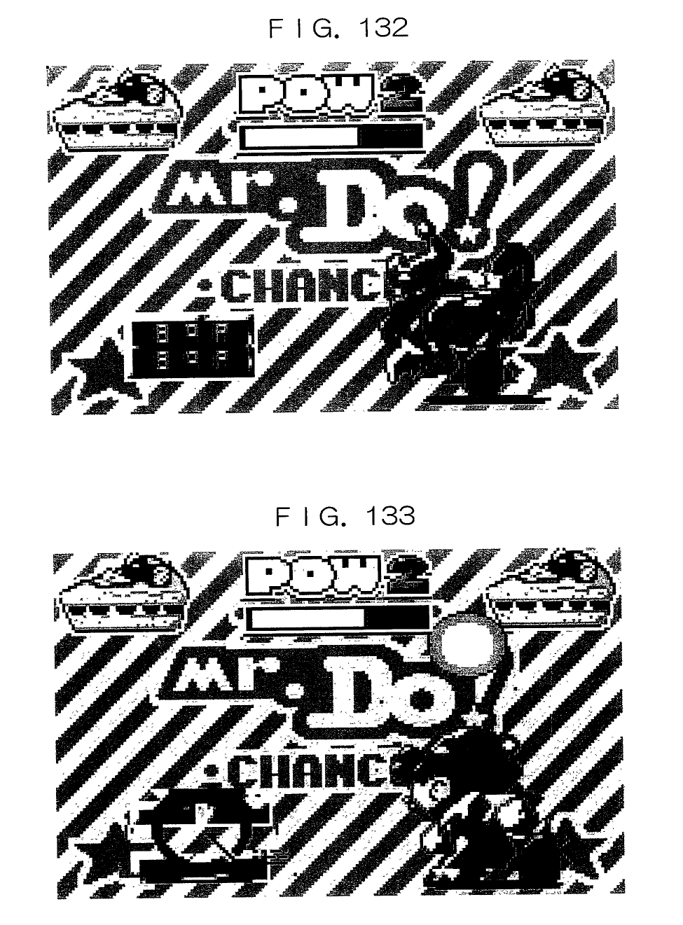

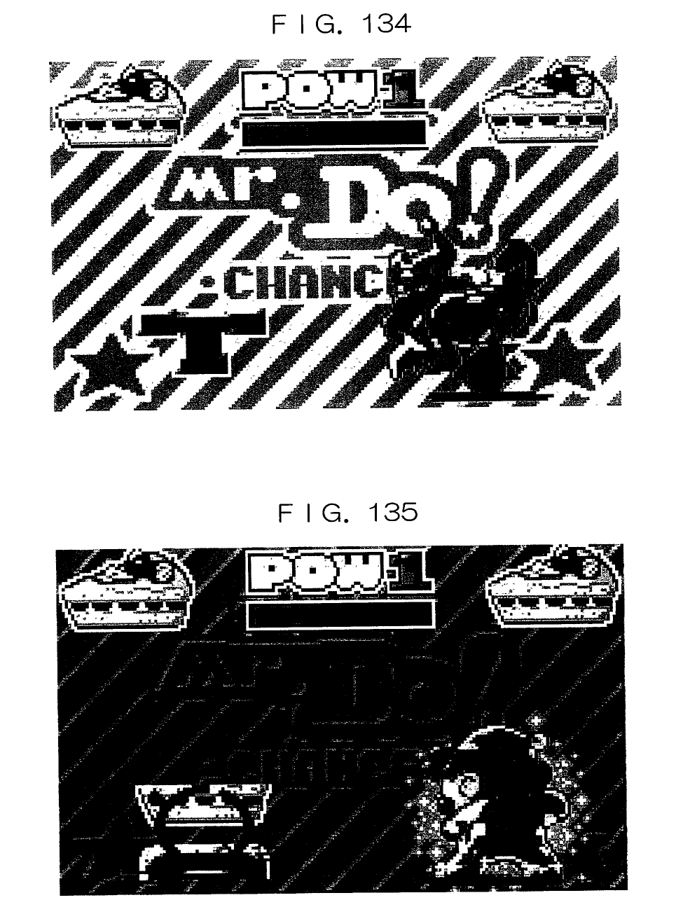

In the first pattern of hyper ready state, the leading character emerges and acts to throw balls at a target. After the first and second balls miss the target, the third ball hits the target, whereby all the three appearing symbols displayed on the screen become identical, and letters of “HIT” are displayed, so as to indicate that there is a possibility of a bonus hand being internally elected (FIGS. 129 to 136).

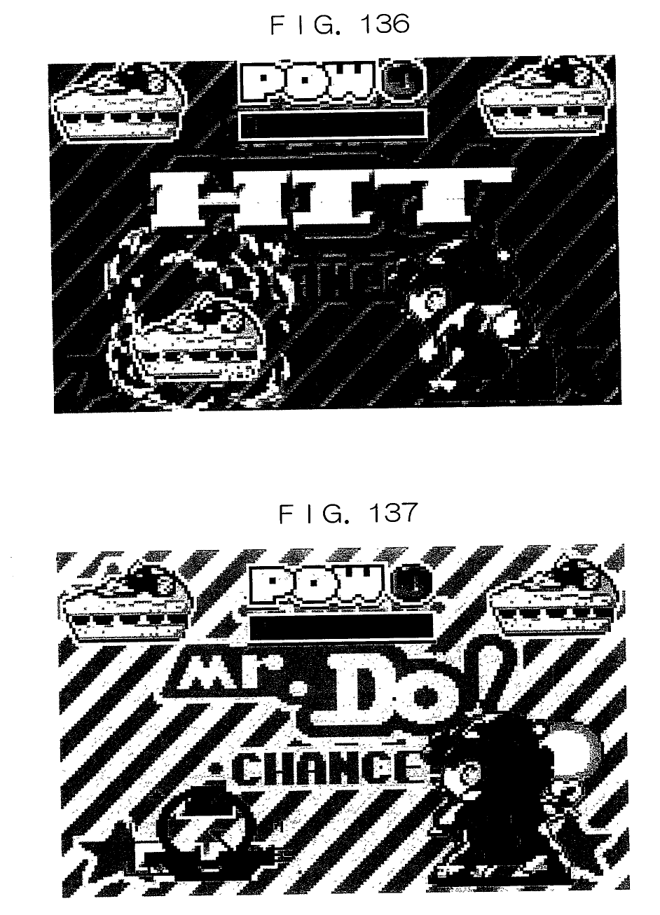

In the second pattern of hyper ready state, the leading character emerges and acts to throw balls at a target. After the first and second balls miss the target, the third ball also misses the target, and the leading character falls down, thereby indicating that the possibility of a bonus hand being internally elected is weaker (FIGS. 137 to 139).

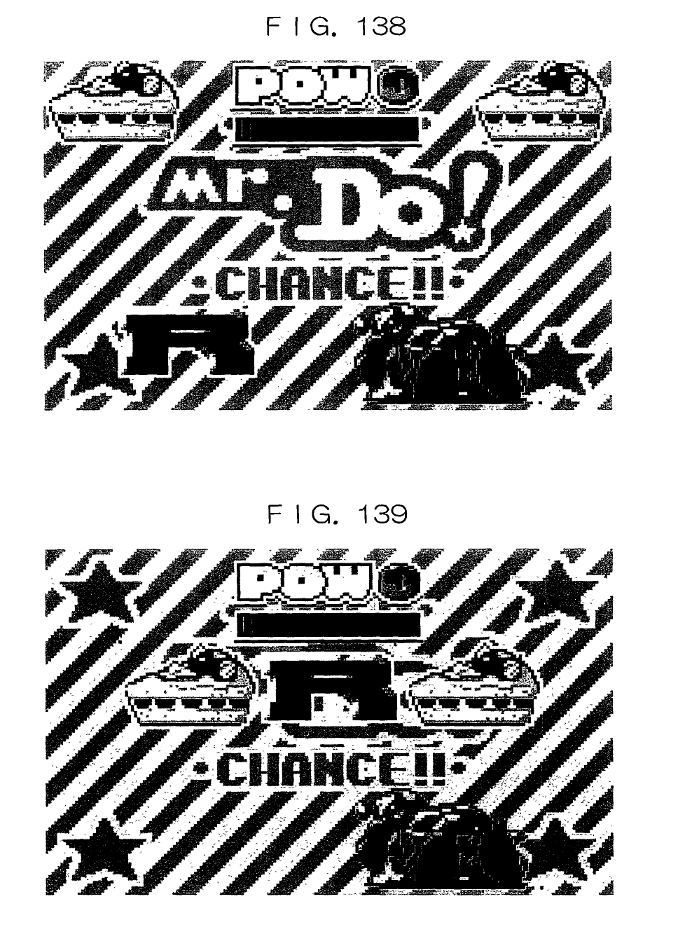

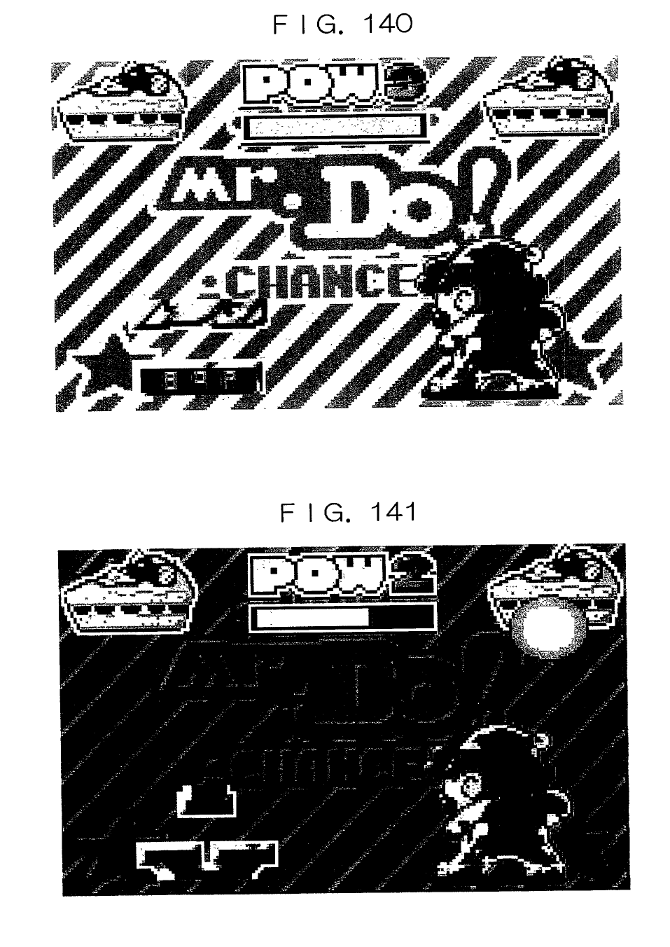

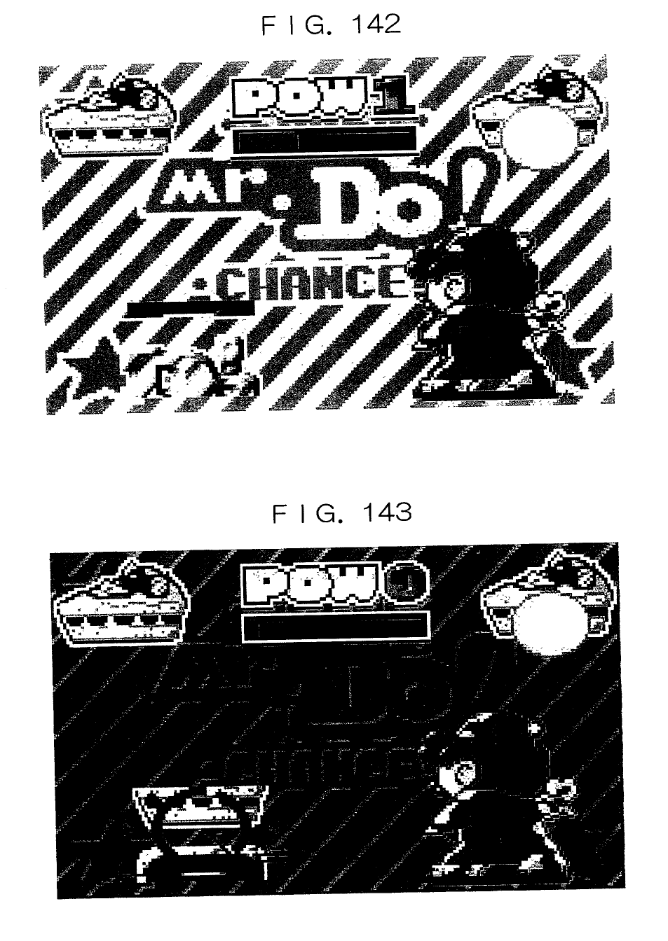

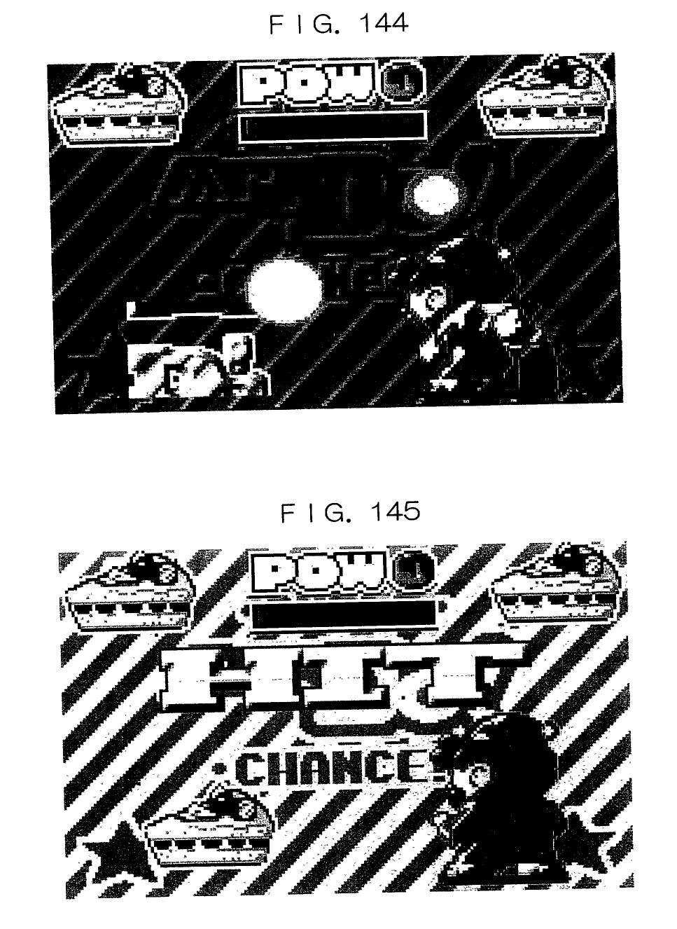

In the third pattern of hyper ready state, though the leading character emerges and acts to throw balls at a target, without three balls being thrown, powers for throwing the three balls are stored, the target is aimed at, and then a ball is thrown and hits the target. At this instant, all the three appearing symbols displayed on the screen become identical, and letters of “HIT” are displayed, whereby it is indicated that there is a possibility of a bonus hand being internally elected (FIGS. 140 to 145).

Ready-State Attraction 4

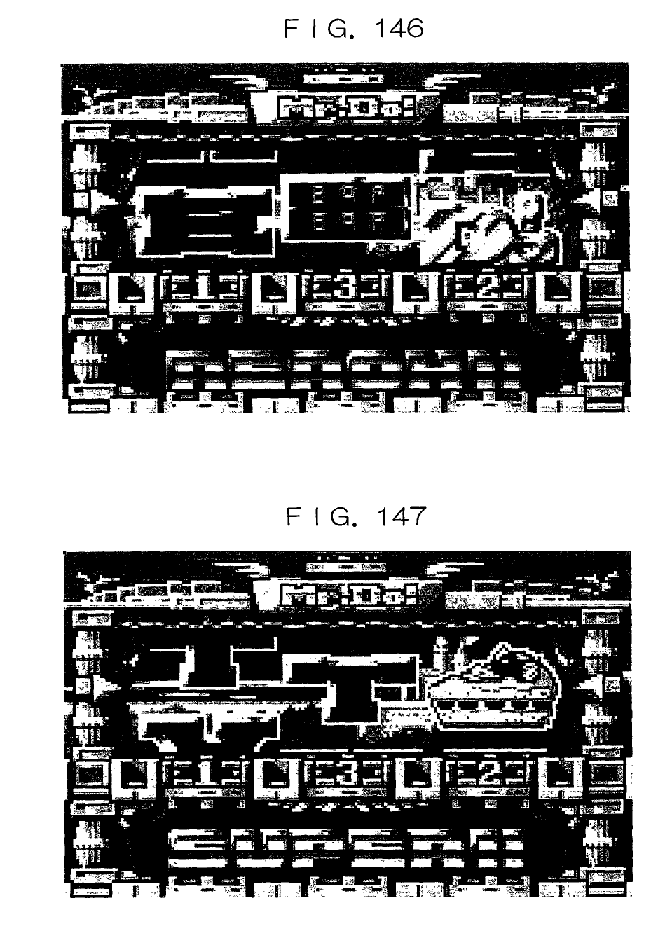

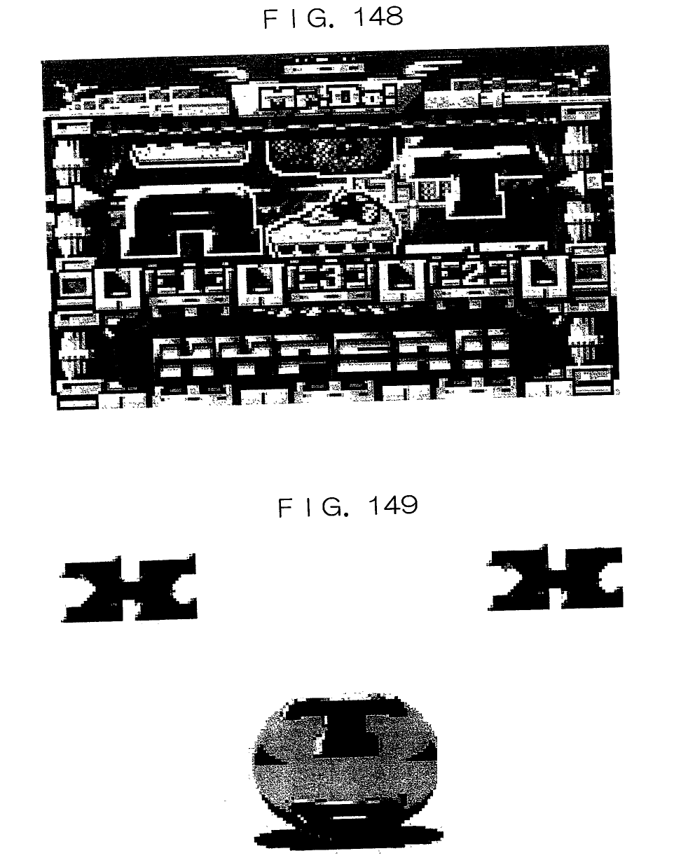

In ready-state attraction 4, letters of “REACH” are displayed on the lower side of the screen (FIG. 146). Then, letters of “SUPER” are displayed on the lower side of the screen, so as to indicate a so-called super ready state in which the reliability is higher than that in the normal ready state (FIG. 147). Further, letters of “HYPER” are displayed on the lower side of the screen, so as to indicate a so-called hyper ready state in which the reliability is higher than that in the super ready state (FIG. 148).

This hyper ready state includes four patterns.

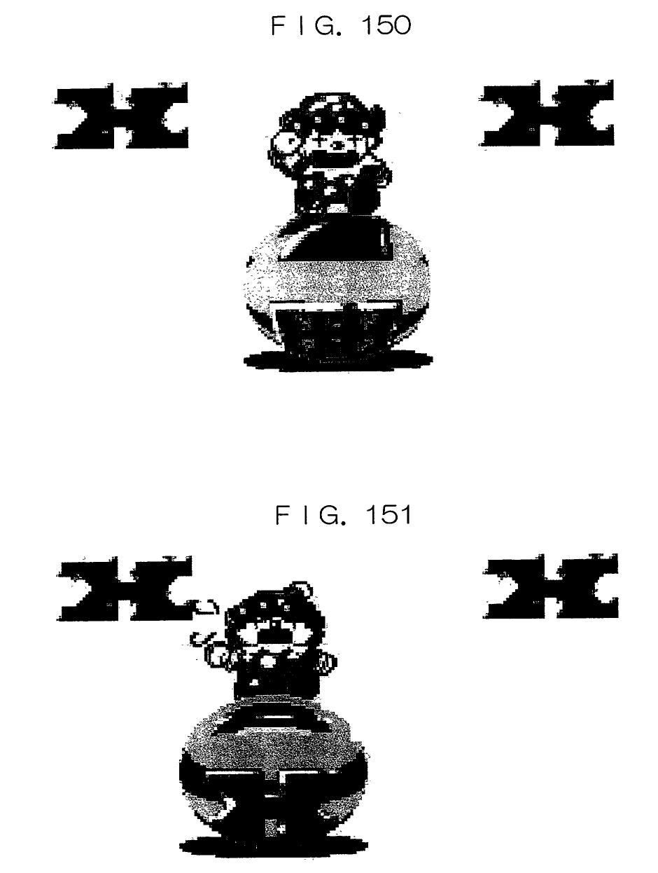

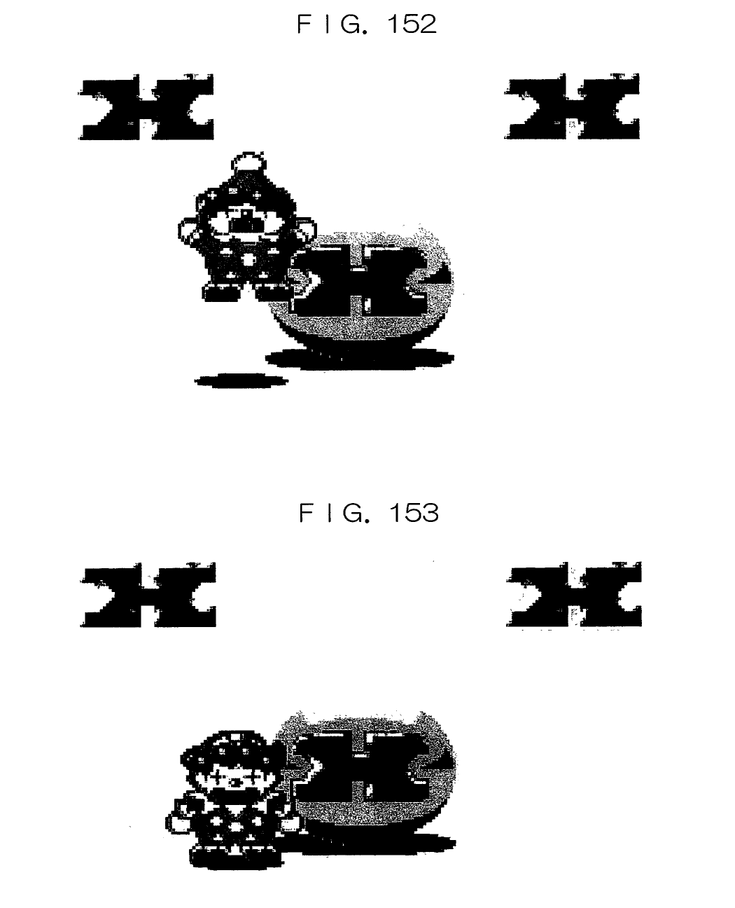

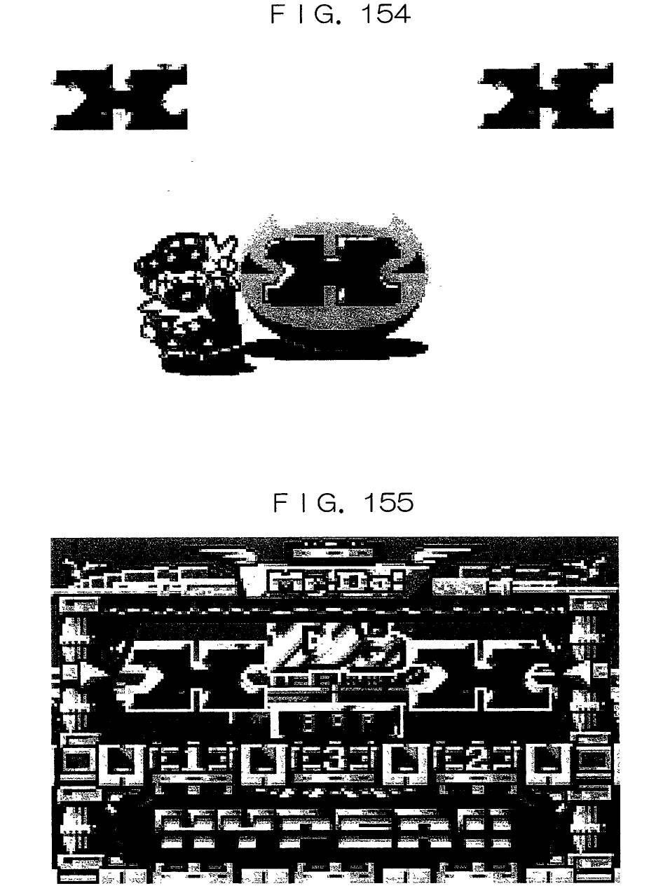

In the first pattern of hyper ready state, the leading character emerges and starts balancing itself on a ball. While almost falling down from the ball sometimes, the leading character safely lands on the ground. At this instant, all the three appearing symbols displayed on the screen become identical, and the leading character makes a V sign, so as to indicate that there is a possibility of a bonus hand being internally elected (FIGS. 149 to 154).

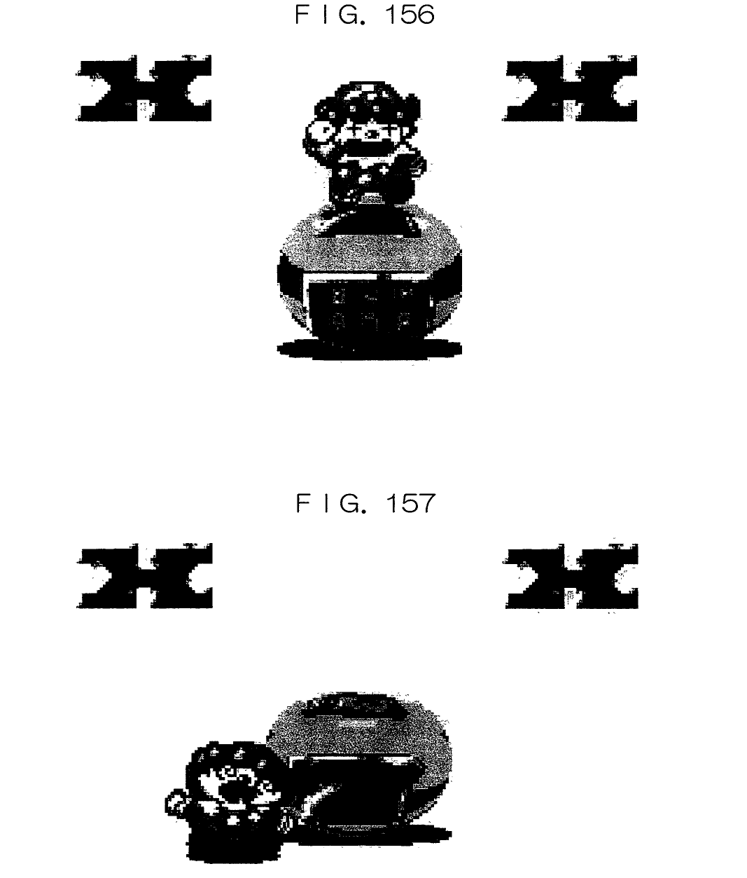

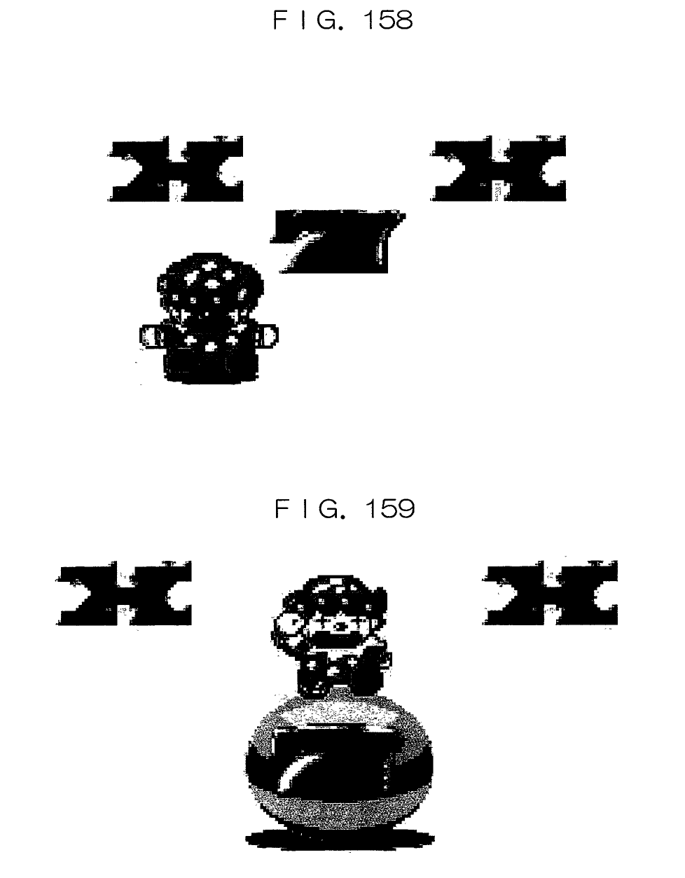

In the second pattern of hyper ready state, after the gaming state shifts to the hyper ready state (FIG. 155), the leading character emerges and starts balancing itself on a ball. Then, the leading character falls down from the ball, thereby indicating that the possibility of a bonus hand being internally elected is weaker (FIGS. 156 to 158).

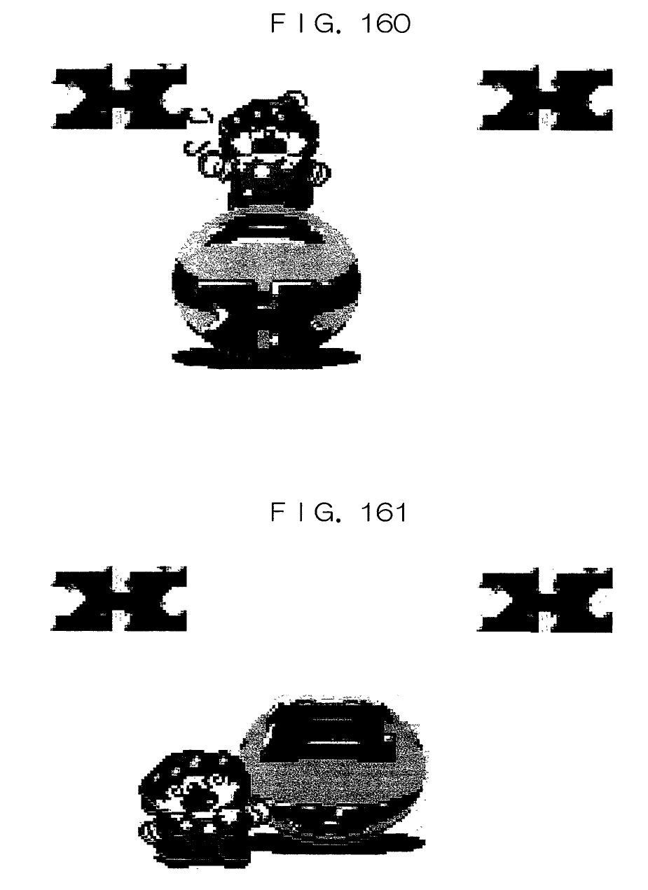

In the third pattern of hyper ready state, the leading character emerges, starts balancing itself on a ball, and then falls down from the ball. At this instant, while all the three appearing symbols displayed on the screen become identical, the leading character makes a V sign, so as to indicate that there is a possibility of a bonus hand being internally elected (FIGS. 159 to 163).

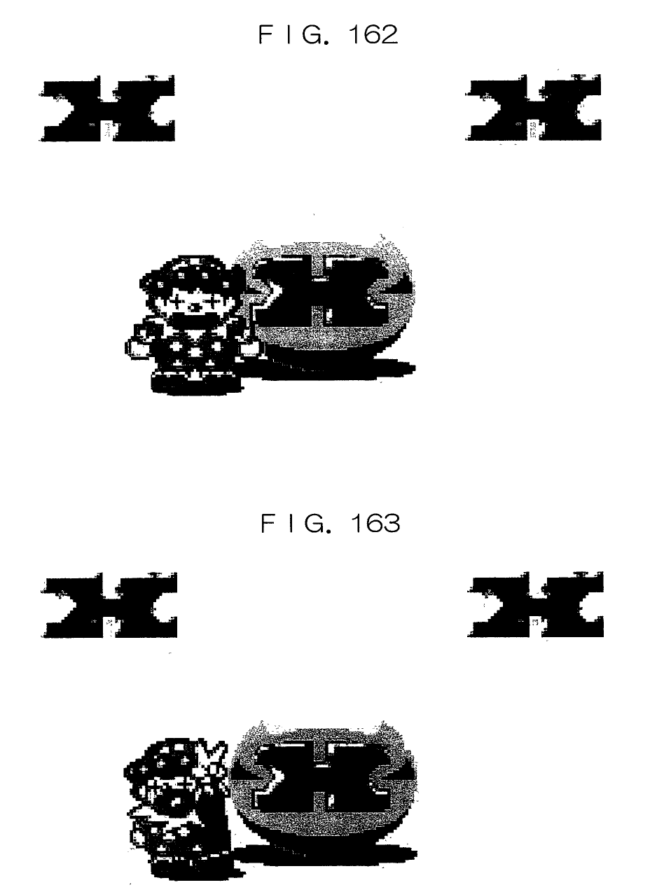

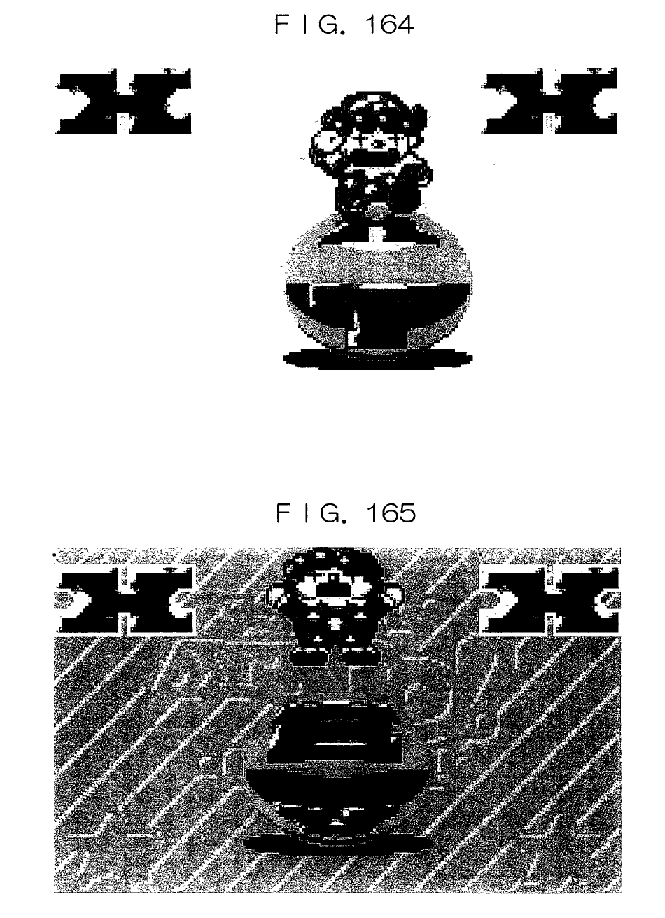

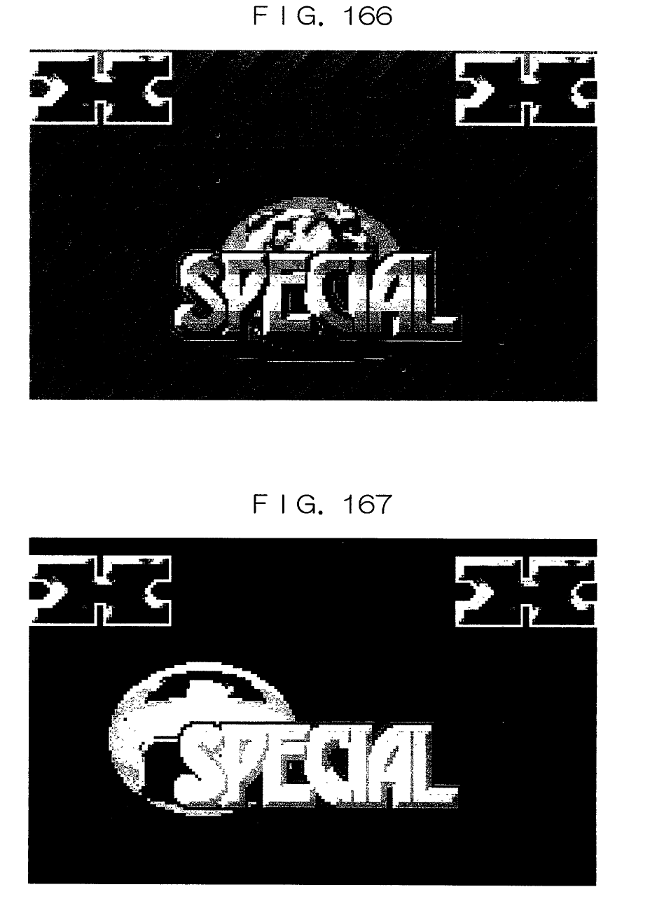

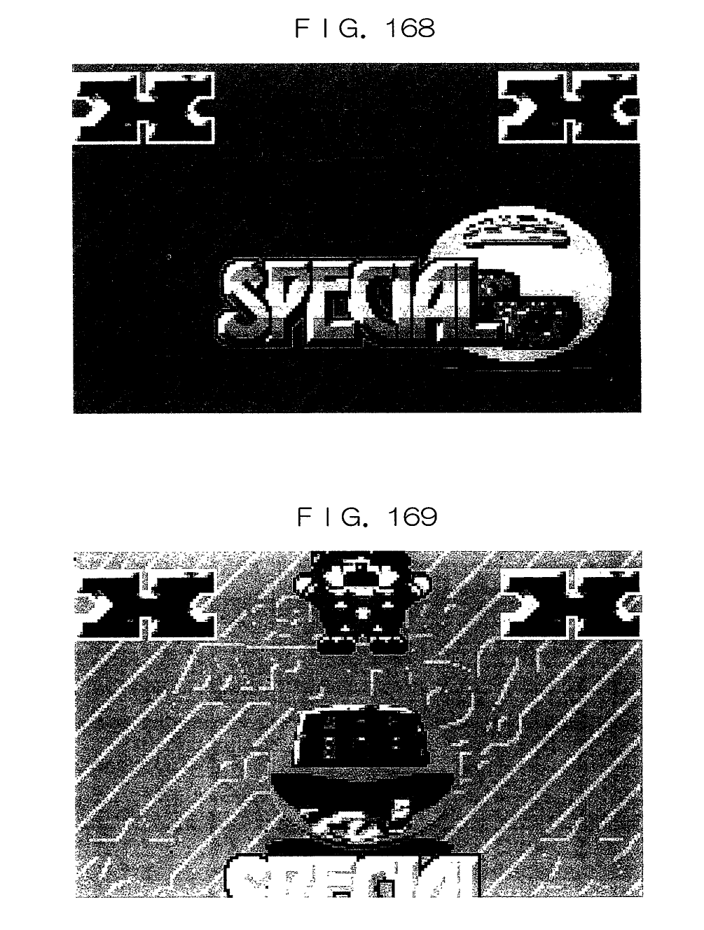

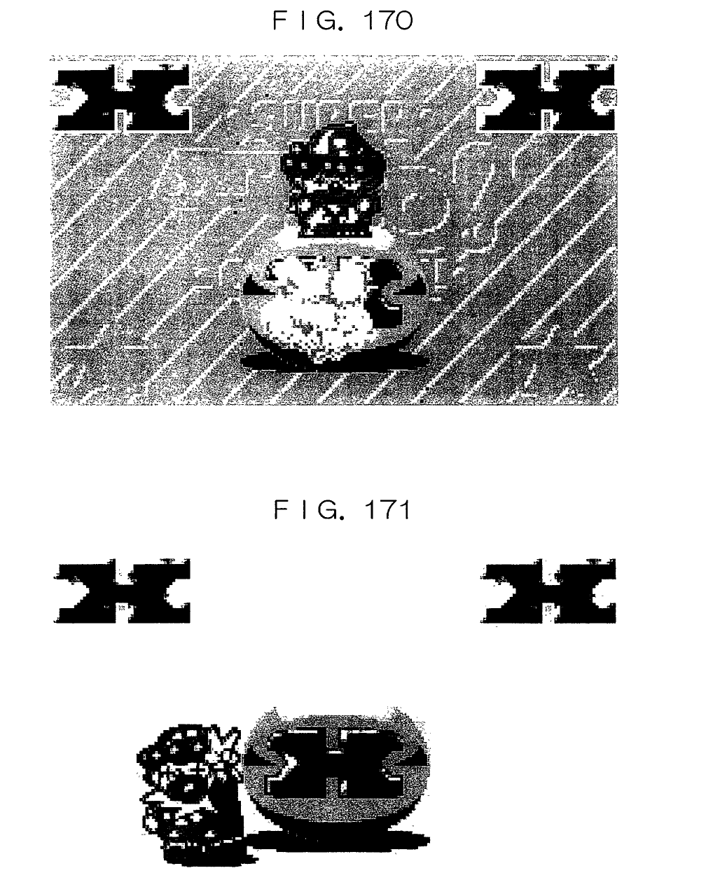

In the fourth pattern of hyper ready state, the leading character emerges, starts balancing itself on a ball, and jumps up. Then, letters of “SPECIAL” are displayed, so as to indicate that the gaming state has shifted to a so-called special ready state in which the reliability is higher than that in the hyper ready state (FIGS. 164 to 166). In this special ready state, the ball is displayed in a laterally moving state. Then, the leading character descends from thereabove, jumps on the ball, and lands on the ground. At this instant, all the three appearing symbols displayed on the screen become identical, and the leading character makes a V sign, so as to indicate that a bonus hand is internally elected (FIGS. 167 to 171).

Ready-State Attraction 5

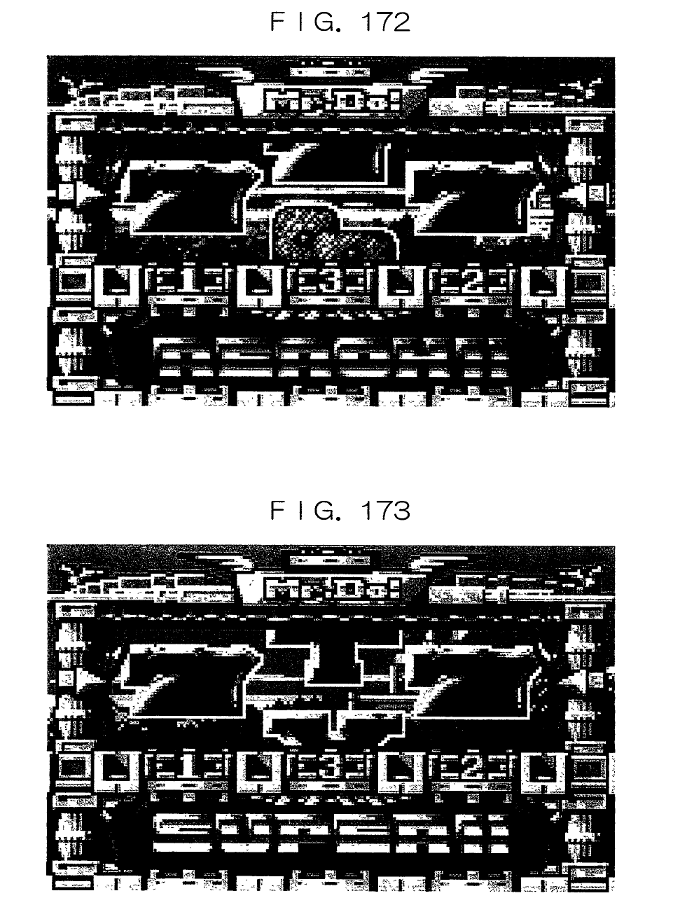

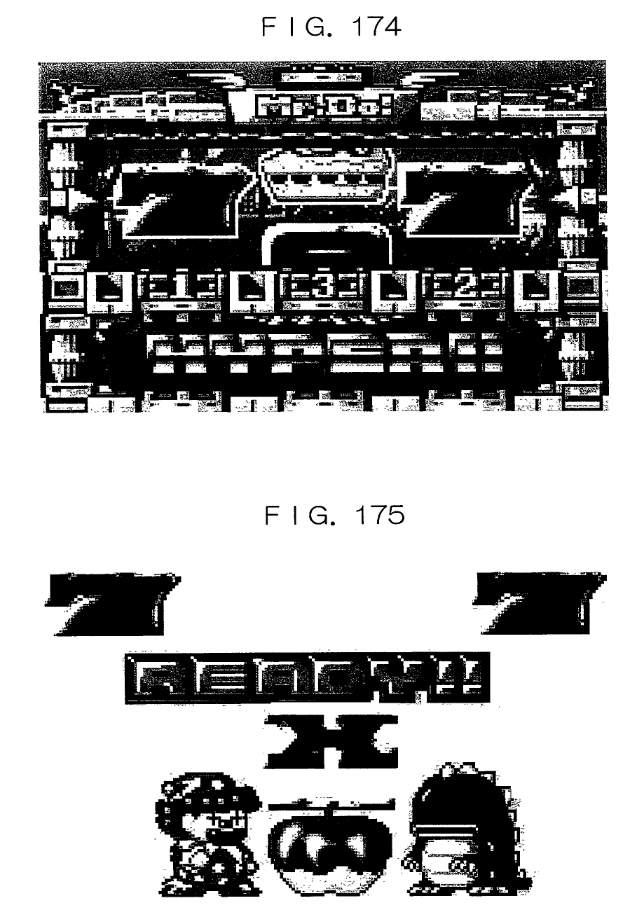

In ready-state attraction 5, of three appearing symbols displayed from side to side, identical appearing symbols “7” are initially displayed on the left and right sides in their stopped state, and then, while the appearing symbol “7” identical to the left and right is displayed at the center in its stopped state, letters of “REACH” are displayed on the lower side of the screen, so as to indicate that it is a ready state (FIG. 172). Then, letters of “SUPER” are displayed on the lower side of the screen, so as to indicate that the gaming state has shifted to a so-called super ready state in which the reliability is higher than that in the normal ready state (FIG. 173). Further, letters of “HYPER” are displayed on the lower side of the screen, so as to indicate that the gaming state has shifted to a so-called hyper ready state in which the reliability is higher than that in the super ready state (FIG. 174).

This hyper ready state includes three patterns.

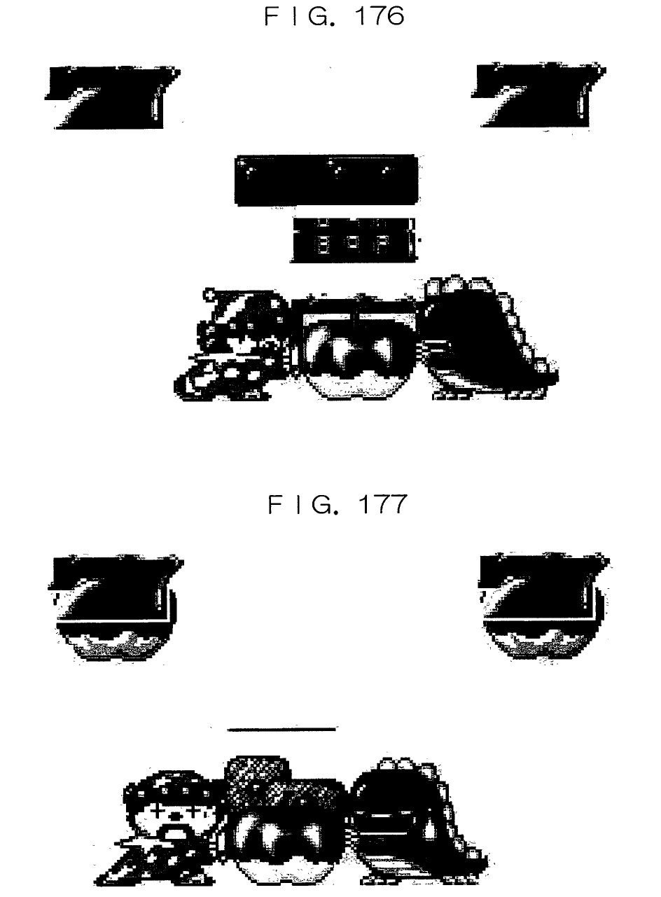

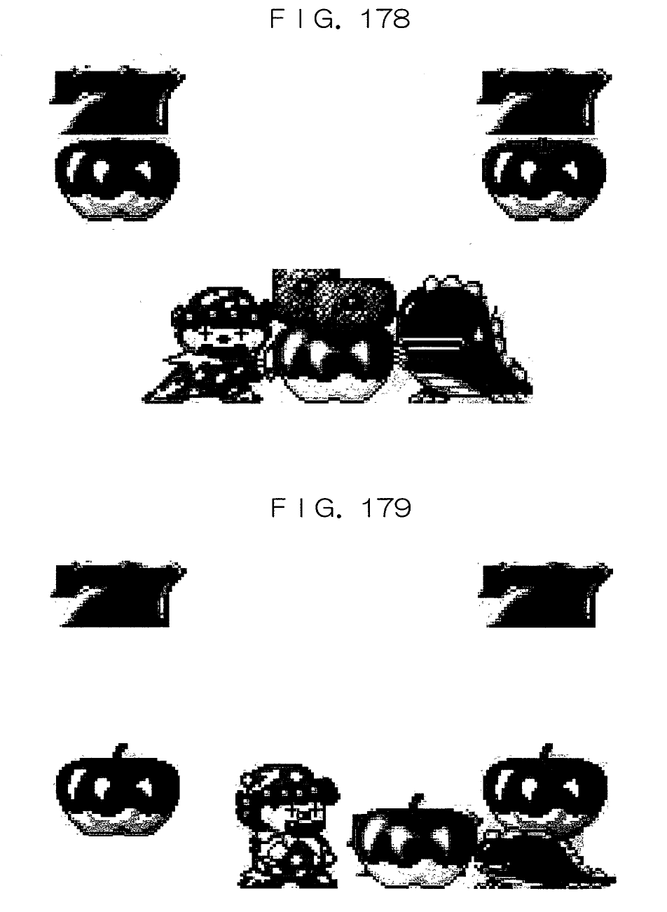

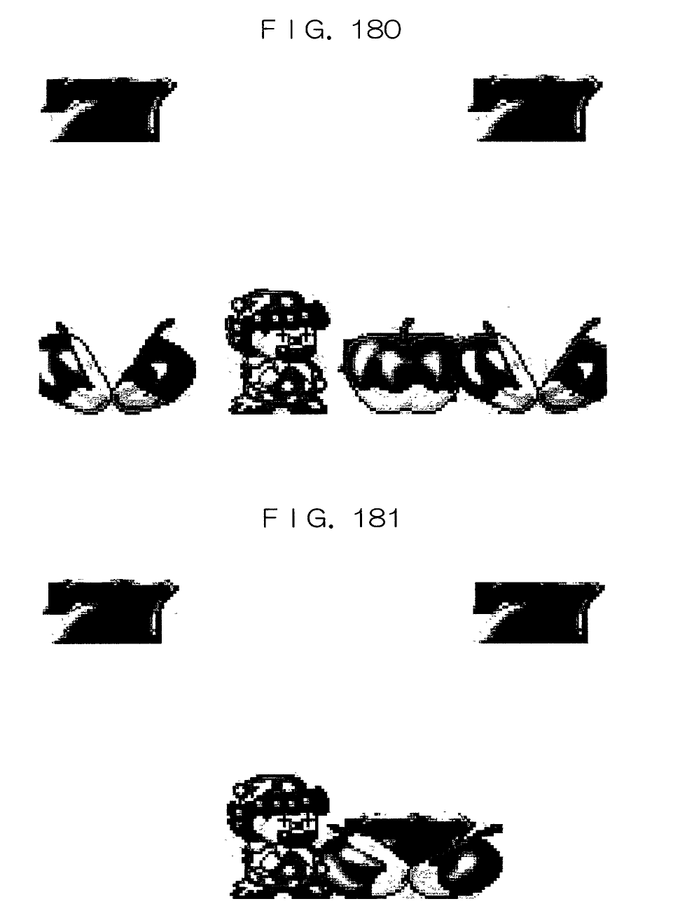

In the first pattern of hyper ready state, while letters of “READY” are displayed, the leading character and a character simulating a monster (hereinafter referred to as monster) oppose each other across an apple (FIG. 175). When letters of “GO” are displayed, they start pushing the apple against each other (FIG. 176). While they push the apple against each other, the leading character wins, and another apple falls upon and crushes down the monster and then splits itself. Subsequently, a winning appearing symbol emerges from within the split apple, whereby all the appearing symbols displayed on the screen become identical, and letters of “LUCKY” are displayed, so as to indicate that a big bonus is internally elected (FIGS. 177 to 183).

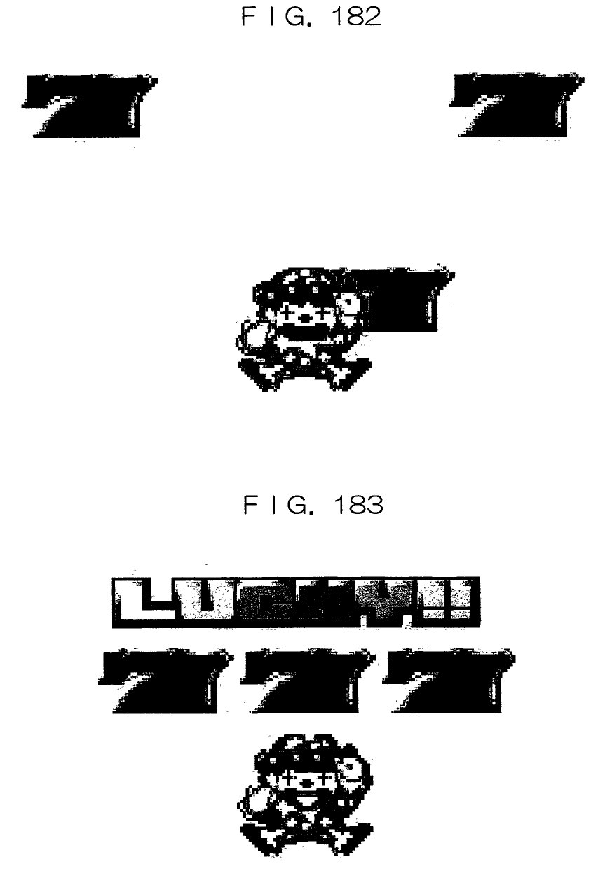

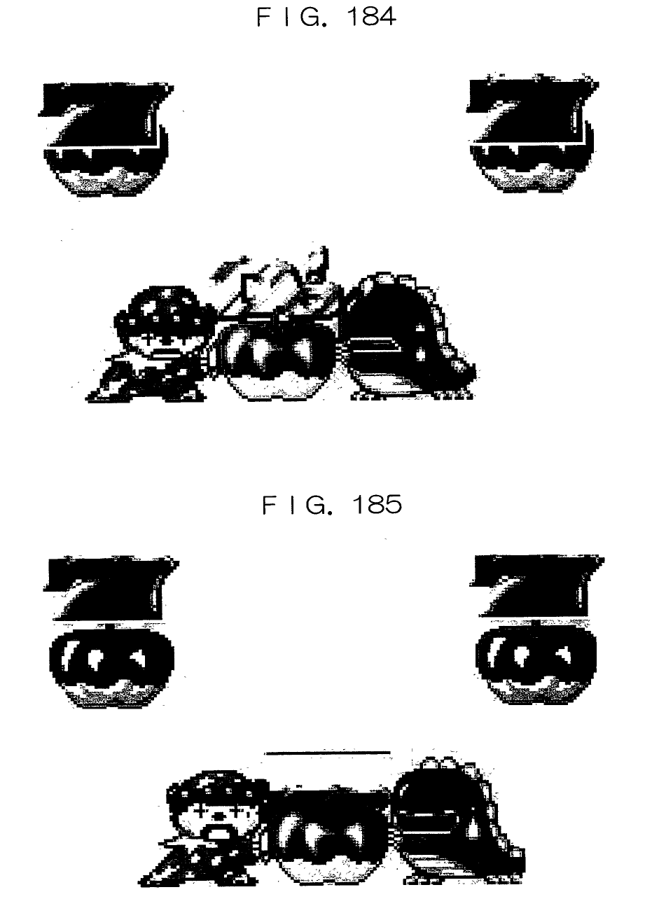

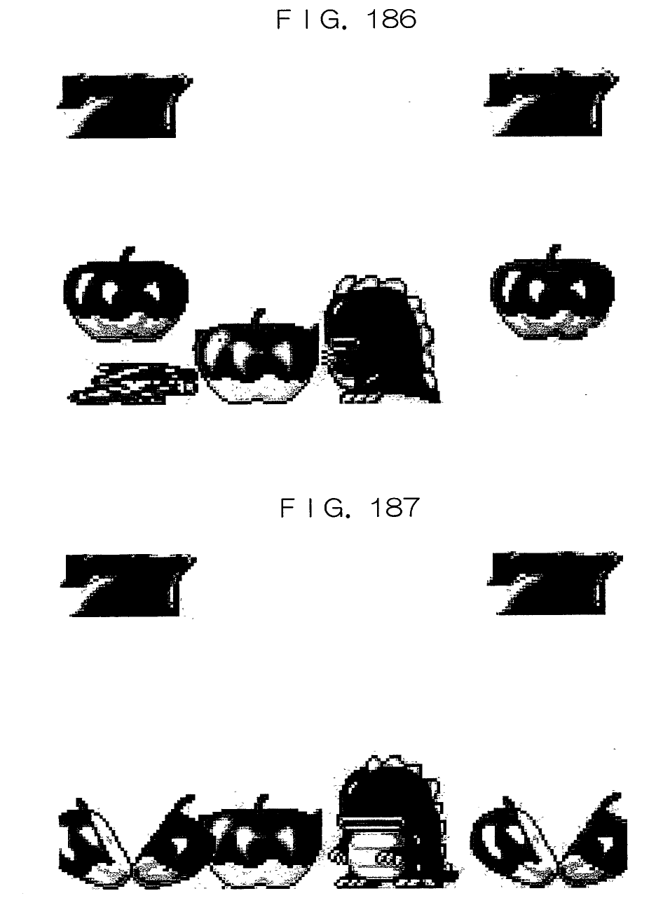

In the second pattern of hyper ready state, while the leading character and the monster push the apple against each other, the monster gains the superiority and pushes back the leading character. Subsequently, another apple falls upon and crushes down the leading character and then splits itself, and a losing appearing symbol emerges from within the split apple, so as to indicate that the possibility of a big bonus being internally elected is weaker (FIGS. 184 to 188).

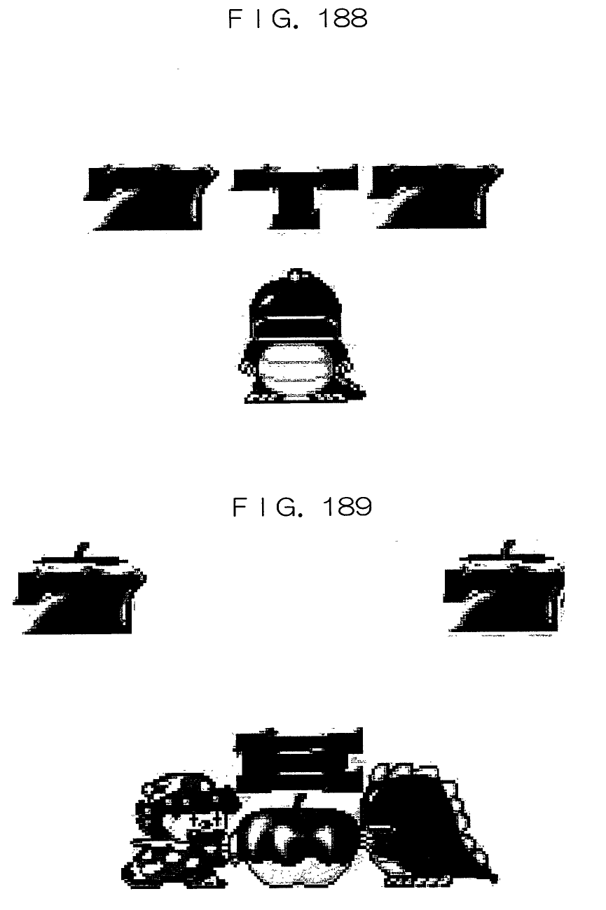

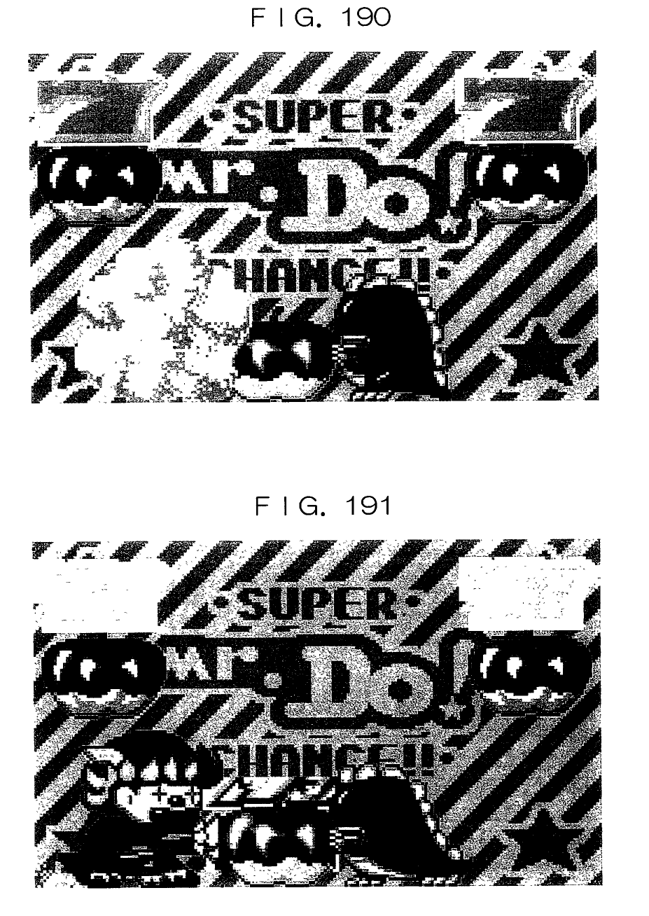

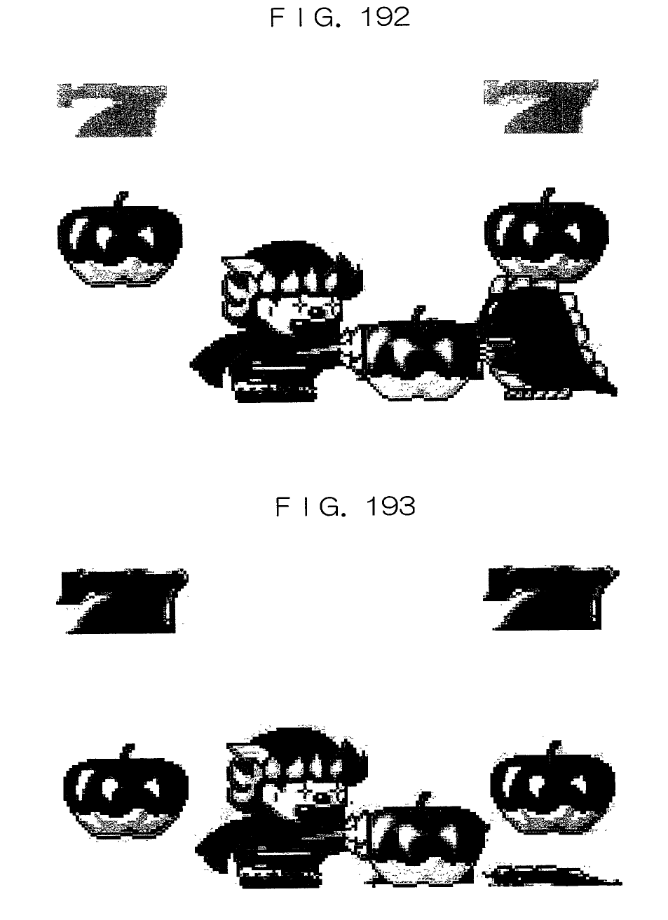

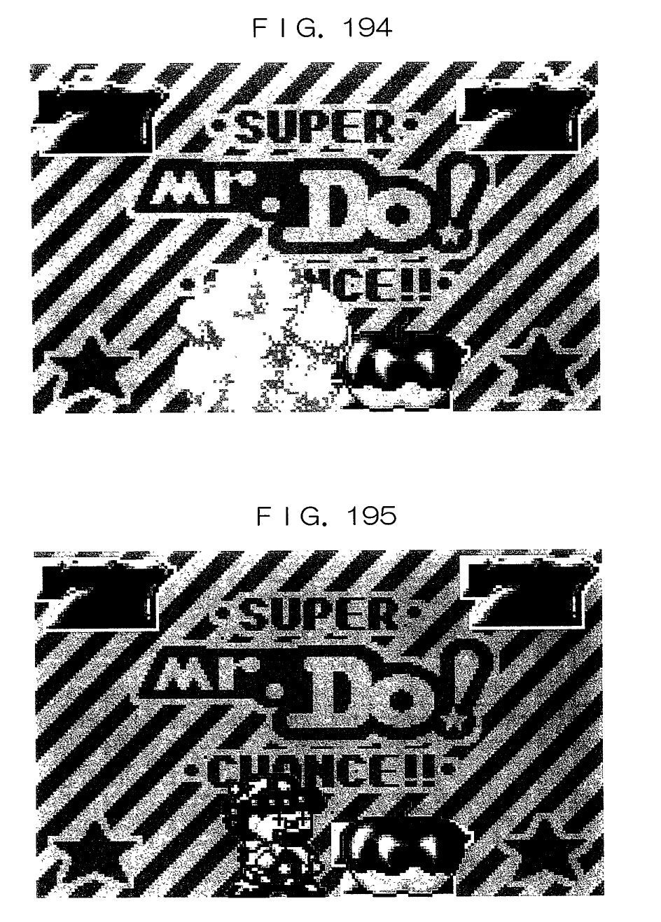

In the third pattern of hyper ready state, while the leading character and the monster push the apple against each other, the leading character transforms itself and pushes back the monster at once. Subsequently, another apple falls upon and crushes down the monster. Then, the leading character transforms itself into the original figure again, and letters of “LUCKY” are displayed, so as to indicate that a big bonus is internally elected (FIGS. 189 to 196).

Ready-State Attraction 6

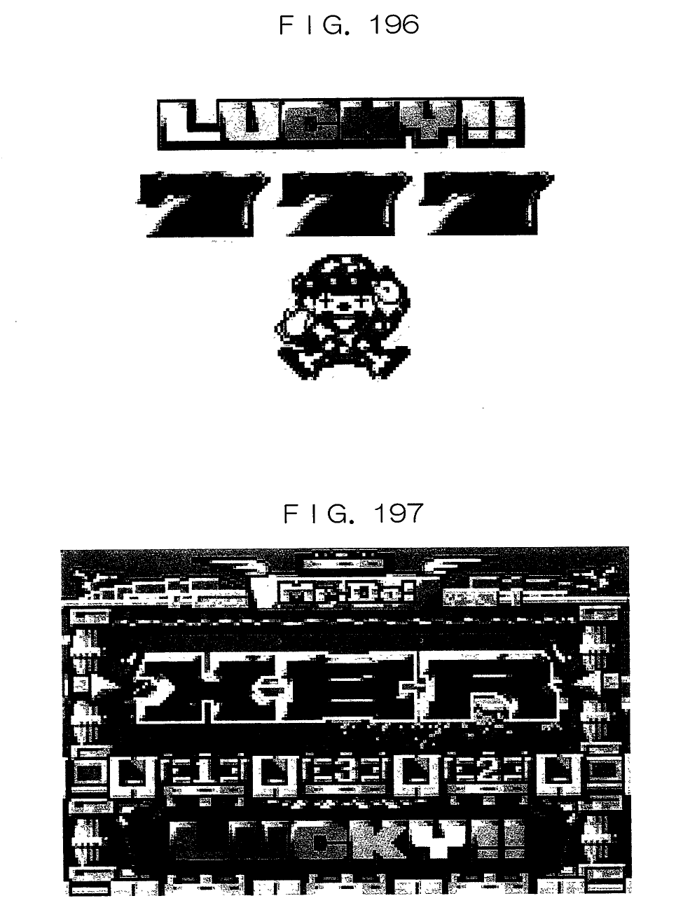

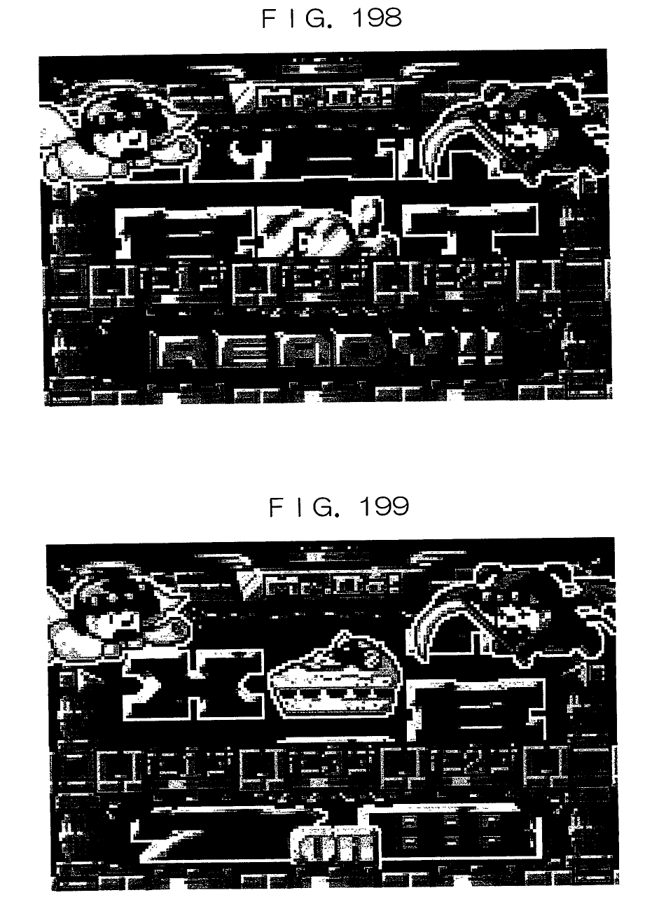

In ready-state attraction 6, though the three appearing symbols displayed on the screen in their stopped state are disordered, letters of “LUCKY” are displayed. Subsequently, while an angel character and a devil character emerge, letters of “READY” are displayed, and then letters of “7 OR BAR” are displayed, so as to indicate that there is a possibility of a bonus hand being internally elected (FIGS. 197 to 199).

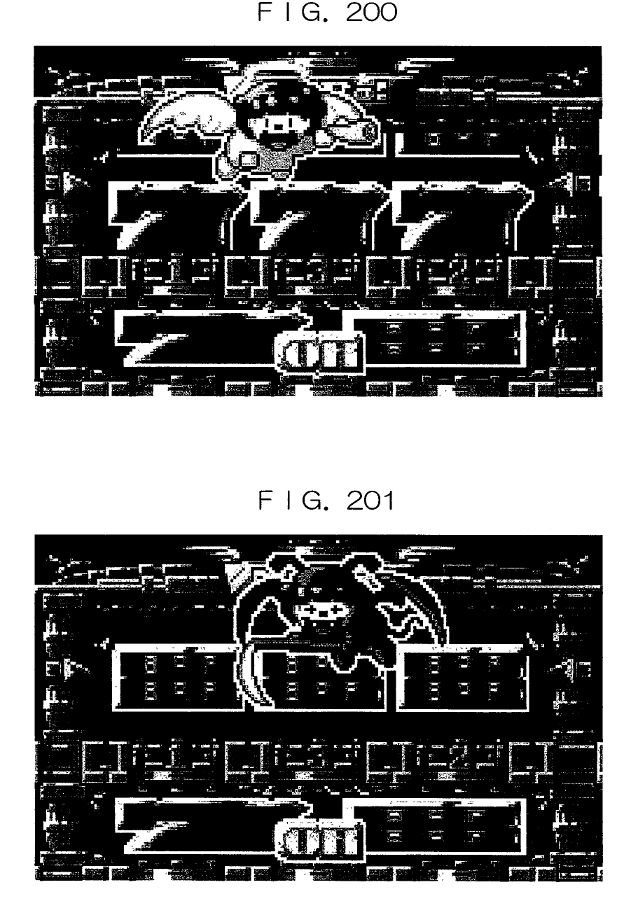

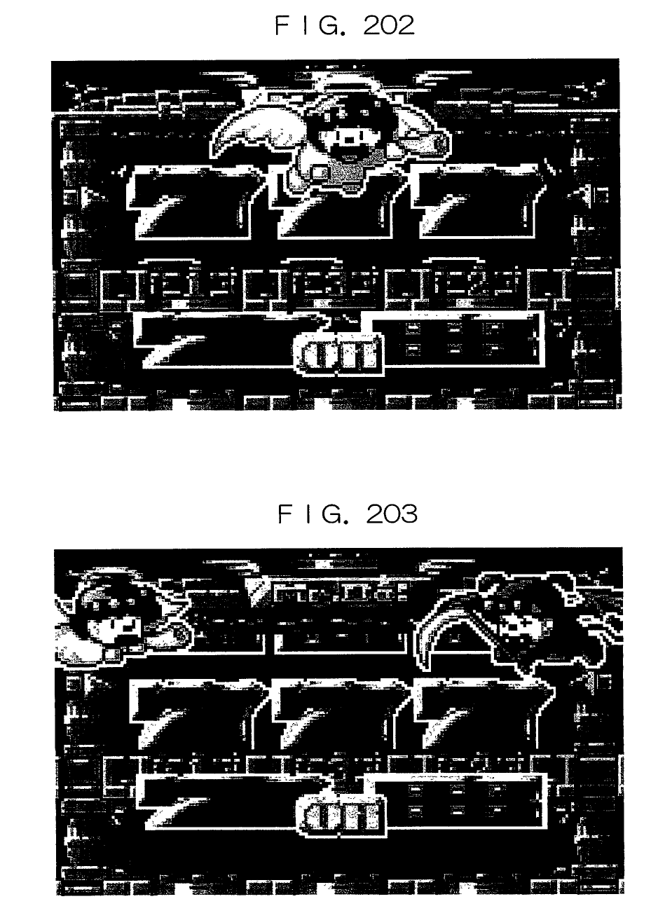

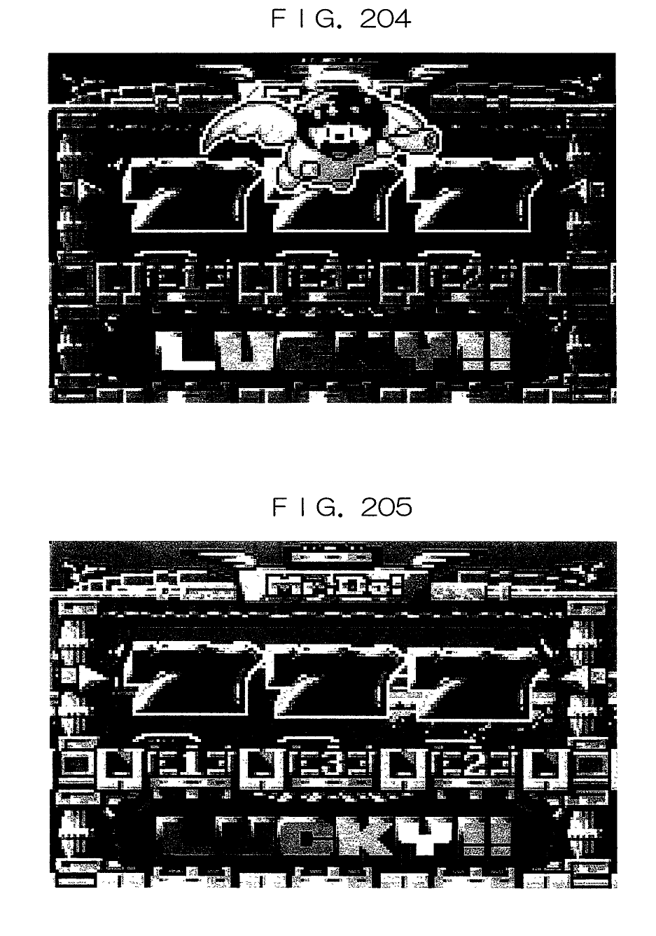

Subsequently, the angel character and the devil character emerge alternately, the angel character and “7,” “7,” and “7” are displayed at last, and letters of “LUCKY” are further displayed, so as to indicate that a big bonus is internally elected (FIGS. 200 to 205).

Ready-State Attraction 7

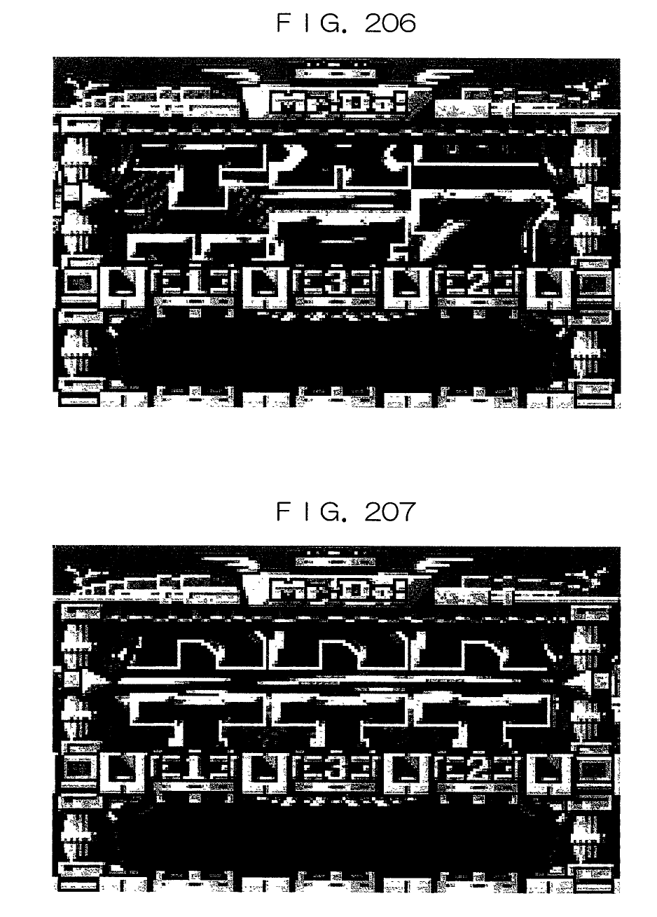

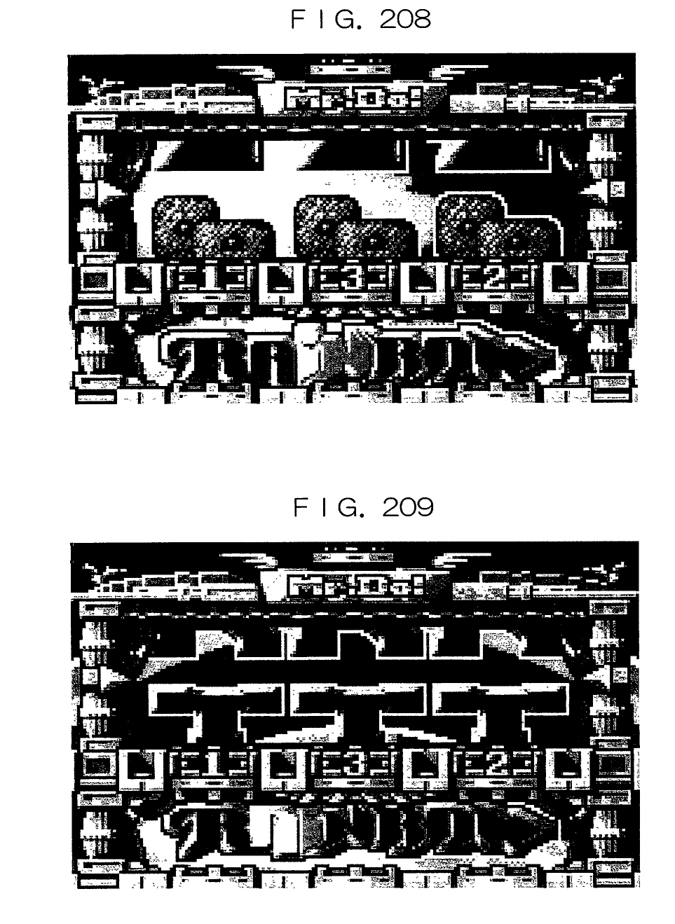

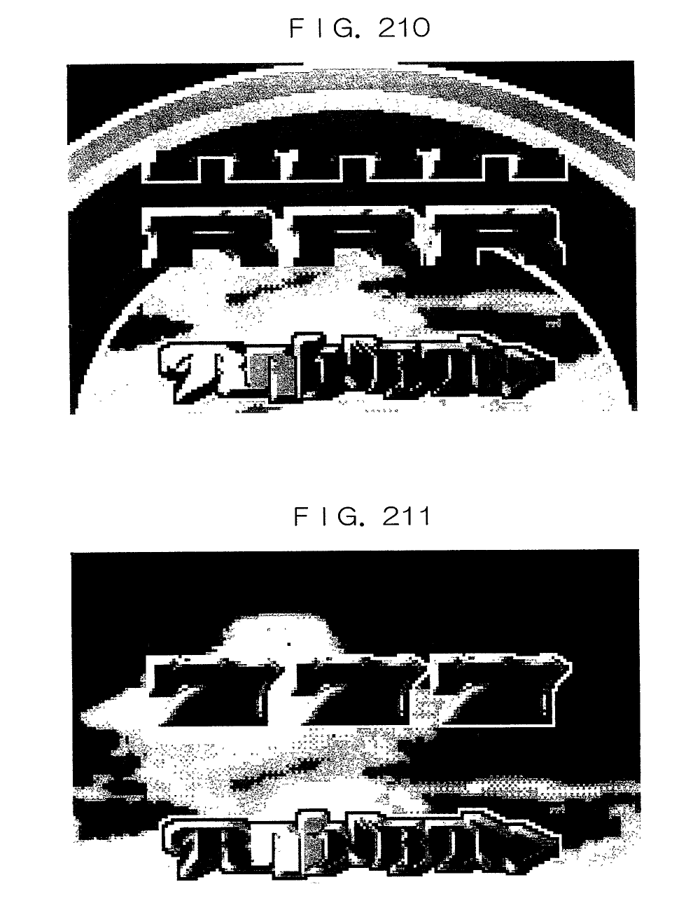

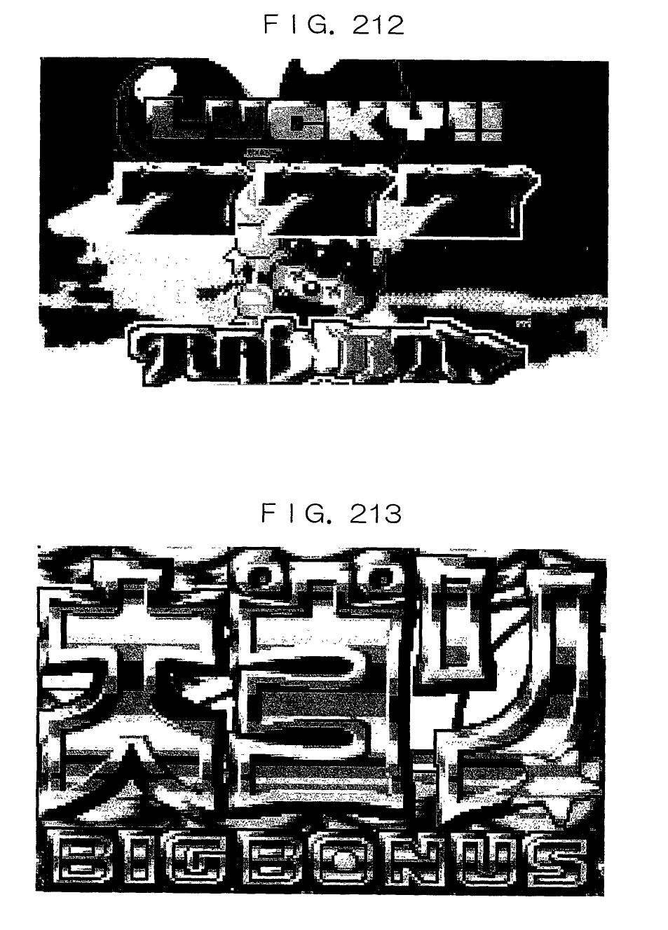

In ready-state attraction 7, after three appearing symbols are individually displayed from side to side in a changing manner, they are displayed in a vertically moving manner such that all the three appearing symbols become identical. Subsequently, while letters of “RAINBOW” are displayed, a rainbow emerges behind the appearing symbols, and a sky is further displayed on the background (FIGS. 206 to 210). Then, the displayed appearing symbols become “7,” “7,” and “7,” the main character emerges, and letters of “LUCKY” are displayed, so as to indicate that a big bonus is internally elected (FIGS. 211 and 212).

Notice of Occurrence of Ready-State Attraction

When game medals are inserted into the medal insertion slot 14 or the bet switches 16, 17, 18 are operated so that a game is ready to start, then the start switch 20 is made effective, whereby the game is started. Then, the notice of whether to carry out the above-mentioned ready-state attraction or not is effected in the image display section 13. Here, the possibility of occurrence of ready-state attraction is noticed with a predetermined reliability, so that the noticed ready-state attraction does not always occur.

As the notice of possibility of occurrence of the ready-state attraction in this embodiment, three modes of ready-state attraction notice 1 to 3 will be explained.

Ready-State Notice 1

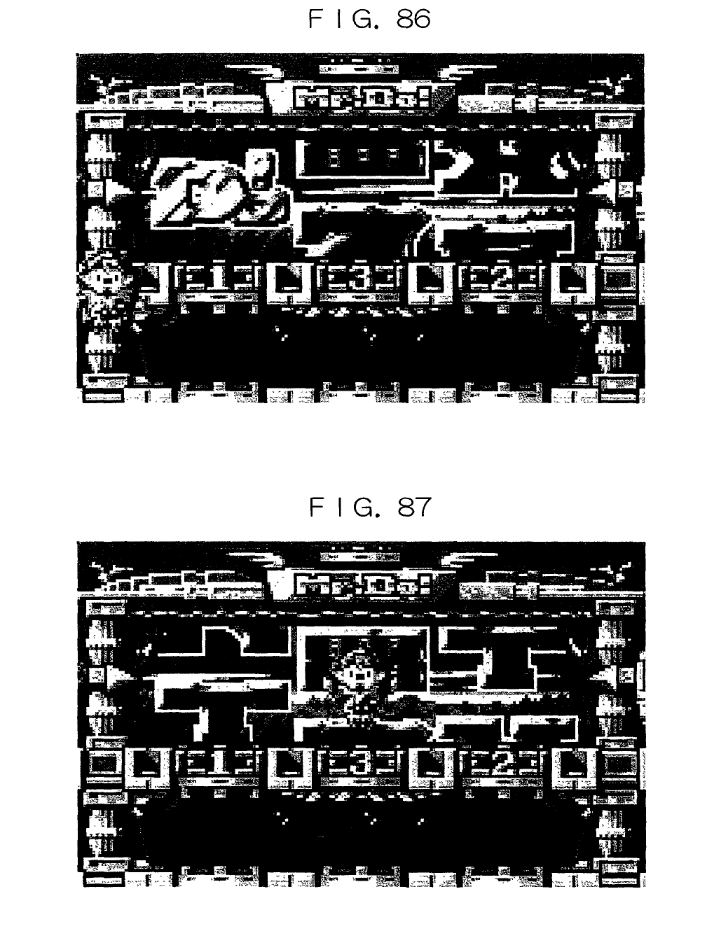

In ready-state notice 1, three appearing symbols displayed from side to side initially start changing (FIG. 85), and the leading character appears from the left side of the screen (FIG. 86). Subsequently, the leading character passes through the center part of the screen while jumping (FIG. 87) and lands on the right side of the screen (FIG. 88). Then, the leading character exits, thereby foretelling a possibility of the ready-state attraction occurring (FIG. 89).

Ready-State Notice 2

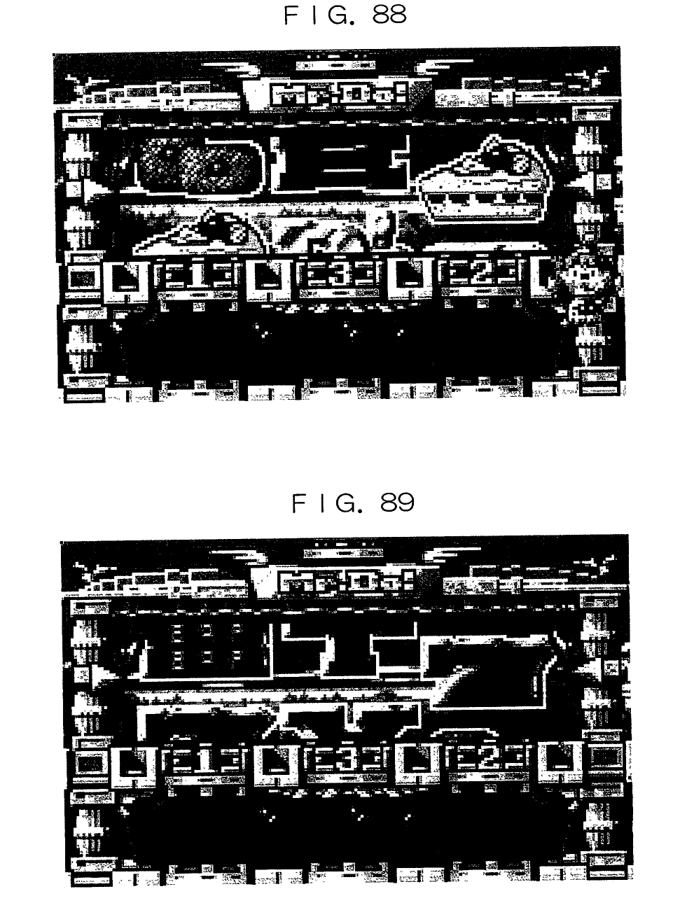

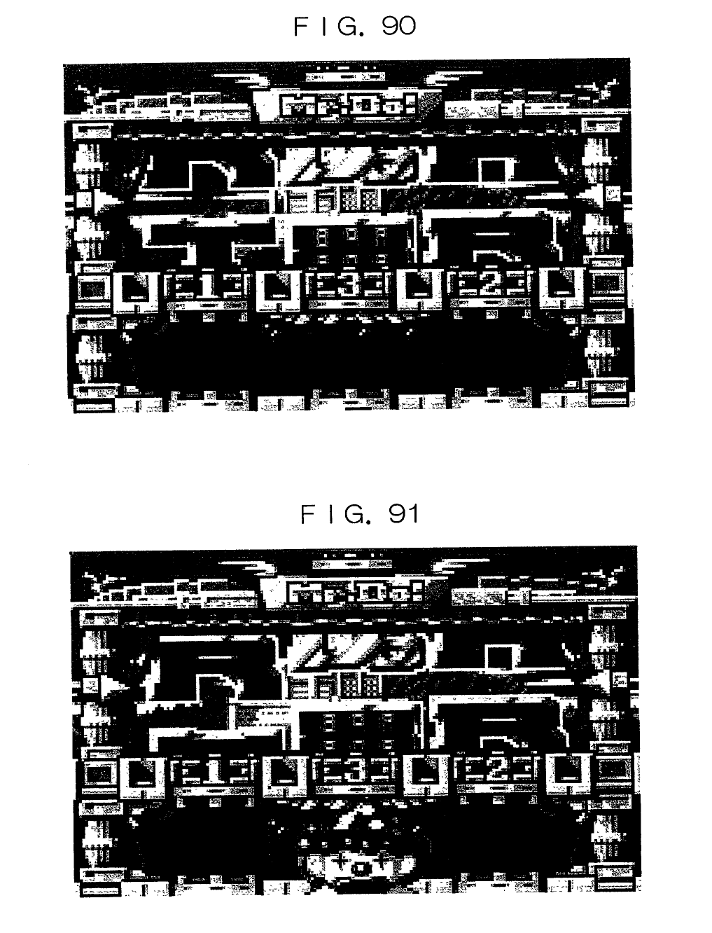

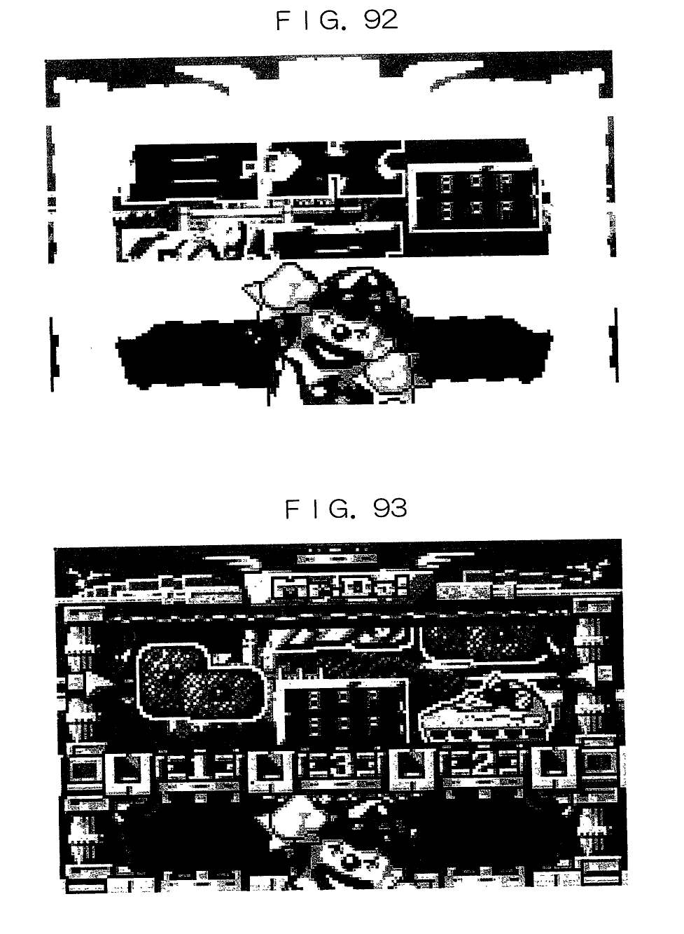

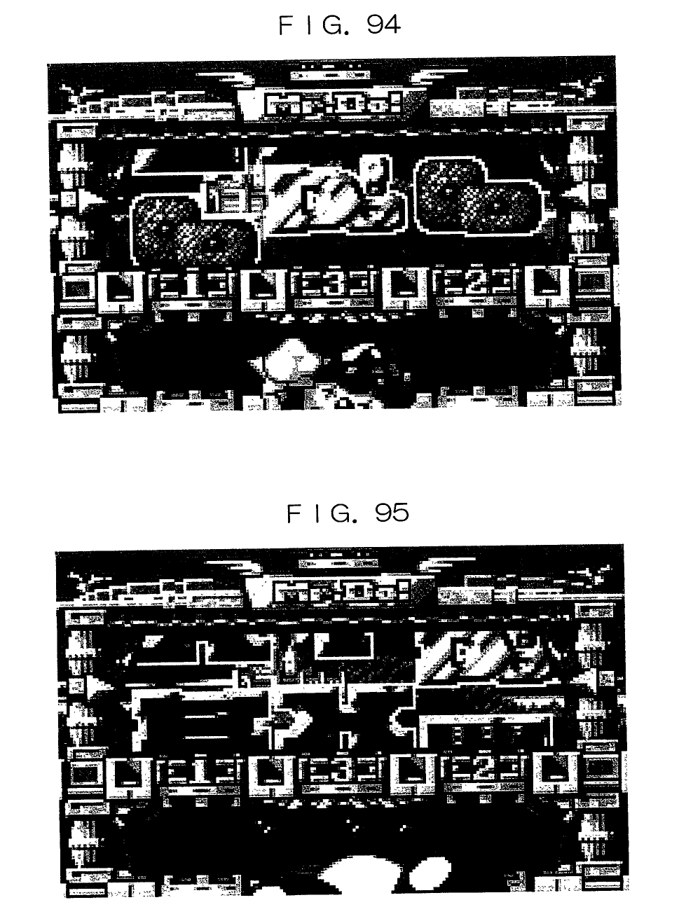

In ready-state notice 2, three appearing symbols displayed from side to side initially start changing (FIG. 90), and the leading character emerges from the lower side in the center part of the screen (FIG. 91). Subsequently, while the screen flashes, the leading character jumps up (FIG. 92), and then sinks to the lower side of the screen (FIG. 93). Thereafter, the leading character exits to the lower side, thereby foretelling a possibility of the ready-state attraction occurring (FIG. 94).

Ready-State Notice 3

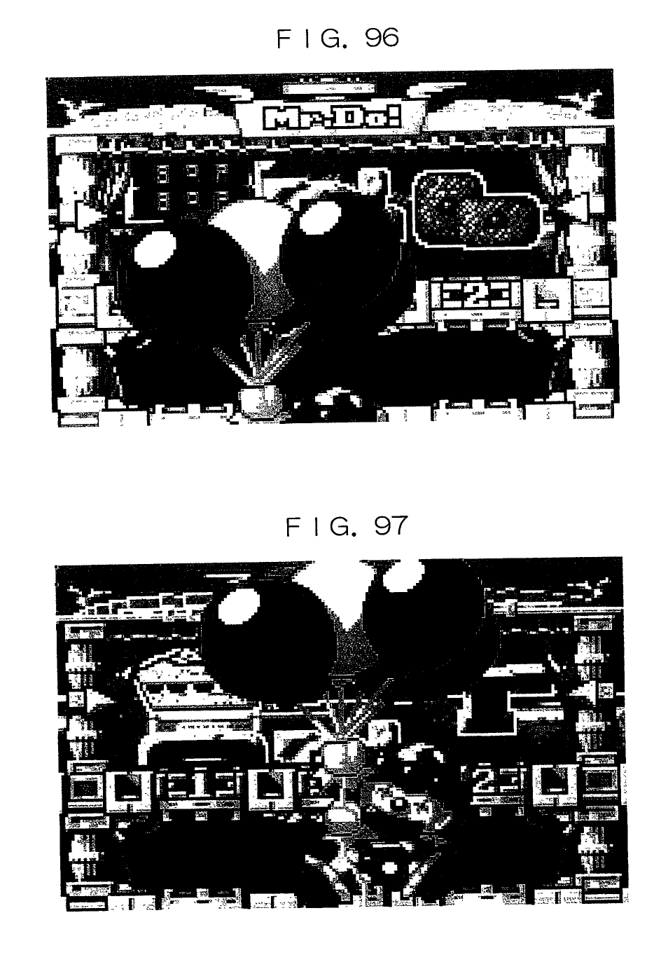

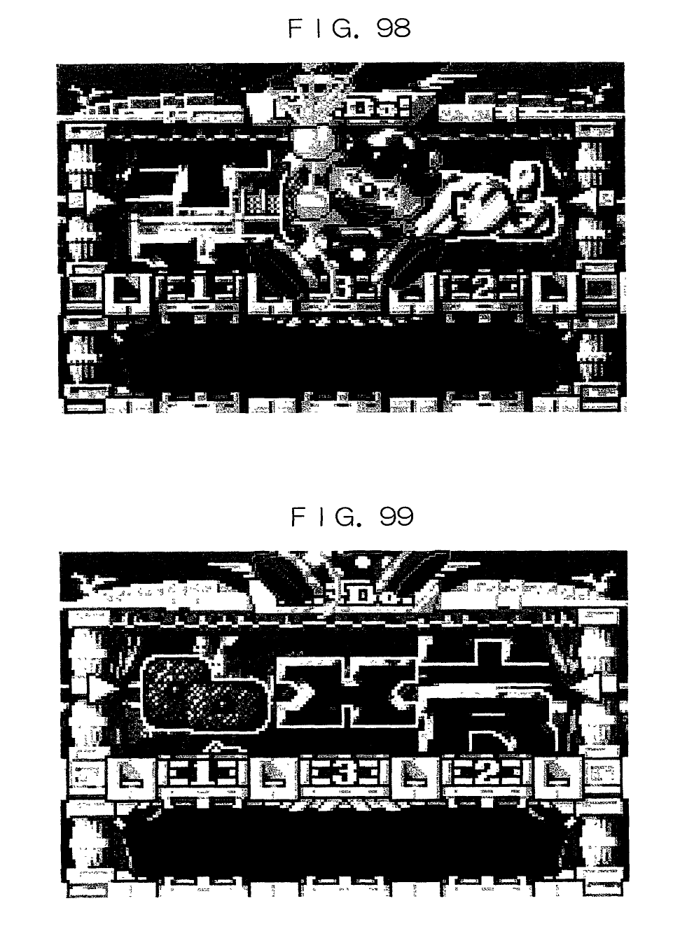

In ready-state notice 3, three appearing symbols displayed from side to side initially start changing (FIG. 95), and a balloon appears from the lower side in the center part of the screen (FIG. 96). Subsequently, as the balloon moves up, the leading character hanging on the balloon emerges (FIG. 97), and the leading character further moves up (FIG. 98). Then, the leading character exits to the upper side of the screen, thereby foretelling a possibility of the ready-state attraction occurring (FIG. 99).

Notice of Internally Elected Hand in Single Character

As the notice of an internally elected hand, there is a notice by the emergence of a single character.

Examples (a) to (g) of the single character are shown in FIGS. 291A to 291G, respectively. During the period from the starting of changes in appearing symbols to the stopping thereof, the single character is displayed at the center of the screen with a predetermined probability according to the internally elected hand, whereby a notice of the internally elected hand is given to the player.

The display of the single character is as explained with reference to the single character attraction selection tables of FIGS. 48A and 48B. For example, when “group 1 (cherry or DB)” is internally elected during a normal game, the character (a) or the character (b) is displayed or no character is displayed. Conversely, if the character (a) or the character (b) appears, any of group 1, BB, and RB is internally elected.

Thus, as the character (a) or the character (b) is displayed, the player can see that there is a possibility of any of group 1, BB, and RB being internally elected, whereby the player not only feels an expectation but also is able to operate the reels 5a to 5c to stop in response thereto.

Also, when “group 1 (cherry or DB)” is internally elected during internal election of a bonus hand, then any of the characters (a) to (e) is displayed. Therefore, if the reels 5a to 5c construct the winning mode of “group 1” although any of the characters (c), (d), and (e) is displayed, the player can see that the current state of gaming is during internal election of a bonus hand.

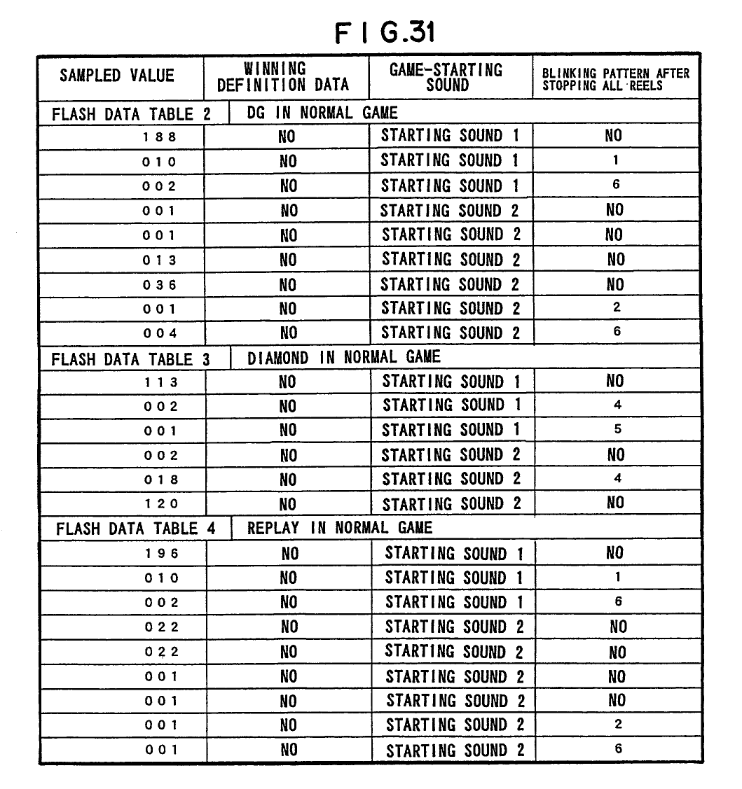

Without being restricted to the center of the screen, the single character can be displayed at any location on the screen. Also, without being restricted to the period from the starting of changes in appearing symbols to the stopping thereof, the single character can be displayed at any timing. Specific examples concerning what attractions are carried out according to various game data determined in the main control board 100 will now be explained. Explained as the first specific example will be the case where the current state is such that the gaming state is during a normal game, the internally elected hand is “diamond,” the flash data selecting random number value is 114, the ready-state attraction selecting random number value is 64500, the appearing symbol attraction selecting random number values are 5050 for left, 740 for right, and 30000 for center, and the single character attraction selecting random number value is 20000; the individual ready-state attractions described in “Notification of Internally Elected Hand by Ready-State Attraction” for ready states a to i in the ready-state attraction data selection table are ready-state attraction 2 for a, ready-state attraction 6 for b, the first pattern of ready-state attraction 3 for c, the second pattern of ready-state attraction 3 for d, the third pattern of ready-state attraction 3 for e, the first pattern of ready-state attraction 4 for f, the second pattern of ready-state attraction 4 for g, the third pattern of ready-state attraction 4 for h, and the fourth pattern of ready-state attraction 4 for i (though the above-mentioned explanation of “Notification of Internally Elected Hand by Ready-State Attraction” relates to only one of the ready-state attraction in which appearing symbols are set in order by the ready-state attraction and that in which appearing symbols are disordered, there are actually cases where the appearing symbols are in order and not in order even in the same ready-state attraction); and the respective ready-state notice attractions described in “Notice of Occurrence of Ready-State Attraction” for ready-state notices A to E are ready-state attraction notice 1 for ready-state notice A, ready-state attraction notice 2 for ready-state notice B, ready-state attraction notice 3 for ready-state notice C, ready-state attraction notice 1 and ready-state attraction notice 2 for ready-state notice D, and ready-state attraction notice 2 and ready-state attraction notice 3 for ready-state notice E. First, according to the flash data selecting random number value 114, the second flash data from the upper side in the flash data table 3 (diamond in normal game) in FIG. 31, i.e., “no winning definition data, game-starting sound 1, blinking pattern 4 after stopping all reels,” is selected. Subsequently, on the sub-control board 200 side, the flow shifts to the attraction image selecting process in the image attraction process. In its ready-state attraction selecting process, the ready-state attraction data selection table for normal game (starting sound 1) in FIG. 42 is selected; and, according to the blinking pattern 4 after stopping all reels and the ready-state attraction selecting random number value of 64500, ready-state notice B (i.e., “ready-state attraction notice 2”) and ready-state attraction d (i.e., “the second pattern of ready-state attraction 3”) are selected. Subsequently, since there is no winning definition data, the flow shifts to the losing appearing symbol selecting process for ready-state attraction. Since it is not a specific mode of ready state, in the losing ready-hand appearing symbol selection table for ready-state attraction in FIG. 29C, a ready-hand appearing symbol of “7” is selected according to the appearing symbol selecting random number value (left) of 5050, and a center appearing symbol of “Do” is selected according to the appearing symbol attraction selecting random number value (center) of 30000. Subsequently, the flow shifts to the single character attraction selecting process. Since a normal game is being played, the single character attraction selection table for normal game in FIG. 48A is selected; and, according to the internally elected hand of “diamond” and the single character attraction selecting random number value of 20000, the single character (e) is selected, and the respective attractions are carried out.

A second specific example will now be explained. Explained will be the case where the current state is such that the gaming state is during a normal game, the internally elected hand is “miss,” the flash data selecting random number value is 164, the ready-state attraction selecting random number value is 35000, the appearing symbol attraction selecting random number values are 2000 for left, 20000 for right, and 100 for center, and the single character attraction selecting random number value is 10000 (the relation of the items of ready state and ready-state notice in the ready-state attraction data selection table to the actual ready-state attraction and ready-state notice is assumed to be identical to the above-mentioned first specific example).

First, according to the flash data selecting random number value 164, the first flash data from the upper side in the flash data table 0 (miss in normal game) in FIG. 30, i.e., “no winning definition data, game-starting sound 1, no blinking pattern after stopping all reels,” is selected. Subsequently, on the sub-control board 200 side, the flow shifts to the attraction image selecting process in the image attraction process. In its ready-state attraction selecting process, the ready-state attraction data selection table for normal game (starting sound 1) in FIG. 42 is selected; and, according to the blinking pattern 0 after stopping all reels and the ready-state attraction selecting random number value of 35000, “no ready-state attraction” and “no ready-state notice” are selected. Subsequently, since there is no winning definition data, the flow shifts to the appearing symbol selecting process; and, the left appearing symbol “E” is selected according to the miss and the appearing symbol attraction selecting random number value (left) of 2000, the right appearing symbol “X” is selected according to the appearing symbol attraction selecting random number value (right) of 20000, and center appearing symbol “E” is selected according to the appearing symbol attraction selecting random number value (center) of 100. Subsequently, the flow shifts to the single character attraction selecting process. Since a normal game is being played, the single character attraction selection table for normal game in FIG. 48A is selected; and, according to the miss and the single character attraction selecting random number value of 10000, no single character is selected, and the respective attractions are carried out.

A third specific example will now be explained. Explained will be the case where the current state is such that the gaming state is during a normal game, the internally elected hand is “BB and replay,” the flash data selecting random number value is 252, the ready-state attraction selecting random number value is 18000, the appearing symbol attraction selecting random number values are 2000 for left, 10050 for right, and 4520 for center, and the single character attraction selecting random number value is 8200 (the relation of the items of ready state and ready-state notice in the ready-state attraction data selection table to the actual ready-state attraction and ready-state notice is assumed to be identical to the above-mentioned first specific example).

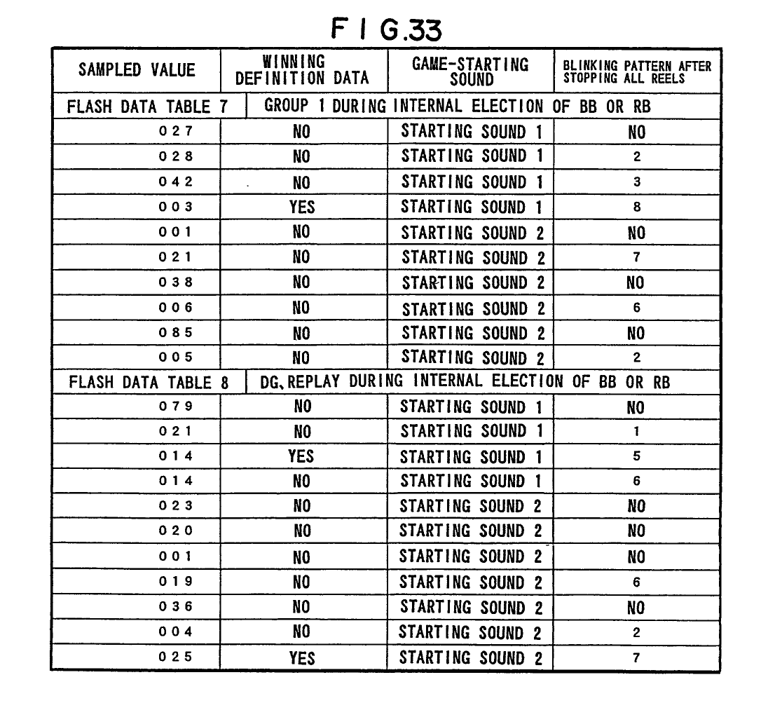

First, according to the flash data selecting random number value 252, the eleventh flash data from the upper side in the flash data table 8 (DG, replay during internal election of BB or RB) in FIG. 33, i.e., “winning definition data exist, game-starting sound 2, blinking pattern 7 after stopping all reels,” is selected. Subsequently, on the sub-control board 200 side, the flow shifts to the attraction image selecting process in the image attraction process. In its ready-state attraction selecting process, the ready-state attraction data selection table for the case with definition data (starting sound 2) in FIG. 47 is selected; and, according to the blinking pattern 7 after stopping all reels and the ready-state attraction selecting random number value of 18000, ready-state attraction g (i.e., “the second pattern of ready-state attraction 4”) and ready-state notice C (i.e., “ready-state notice 3”) are selected. Subsequently, since there are winning definition data, and BB is internally elected, appearing symbols “7-7-7” are selected according to the identical left, center, right appearing symbol selection table for ready-state attraction for internally elected BB in FIG. 29A and the appearing symbol attraction selecting random number value (left) of 2000. Then, the flow shifts to the appearing symbol selecting process. Since a bonus hand is internally elected, the single character attraction selection table for internally elected bonus hand in FIG. 48B is selected; and, according to the replay and the single character attraction selecting random number value of 8200, the single character (b) is selected, and the respective attractions are carried out.

Attraction in Special Game

When the gaming state shifts to a big bonus game or regular bonus game, which is a special game, an attraction in the special game is carried out.

As explained above, in a big bonus game, games similar to a normal game with a raised sampling probability of small hands, i.e., normal games in a big bonus game (normal games in BB), can be played up to 30 times. During the normal games in BB, if the appearing symbols displayed on an effective winning line in their stopped state constitute a predetermined combination, then a predetermined number of game medals are paid out. Also, if the appearing symbols displayed on an effective winning line in their stopped state constitute a specific combination for shifting to a JAC game, then JAC games are allowed to play up to 3 times.

First Normal Game Attraction in BB

First, the attraction in normal games played during a big bonus game will be explained. This attraction is constituted by four patterns, i.e., a first normal game attraction in BB, a second normal game attraction in BB, a third normal game attraction in BB, and a big bonus ending attraction.

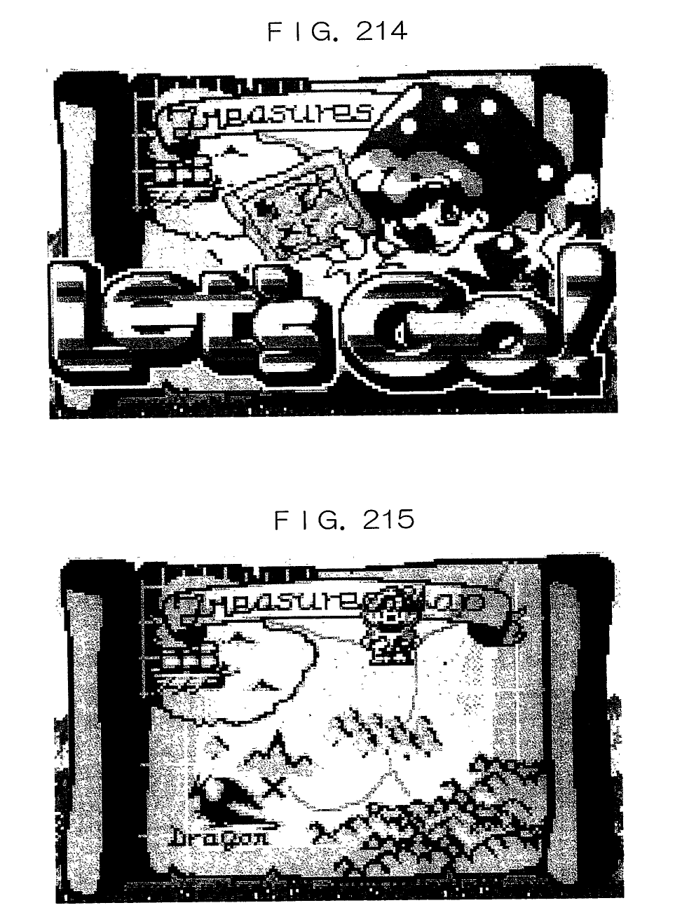

If the reels 5a to 5c attain a stop mode of “7,” “7,” and “7” or the like, so that the gaming state shifts to a big bonus, then letters of “BIG BONUS” are displayed, so as to indicate that the gaming state has shifted to a big bonus. Subsequently, letters of “Let's GO!” are displayed, and a map is displayed so as to indicate the current position of the leading character (FIGS. 213 to 215), thereby starting an adventure story of the leading character.

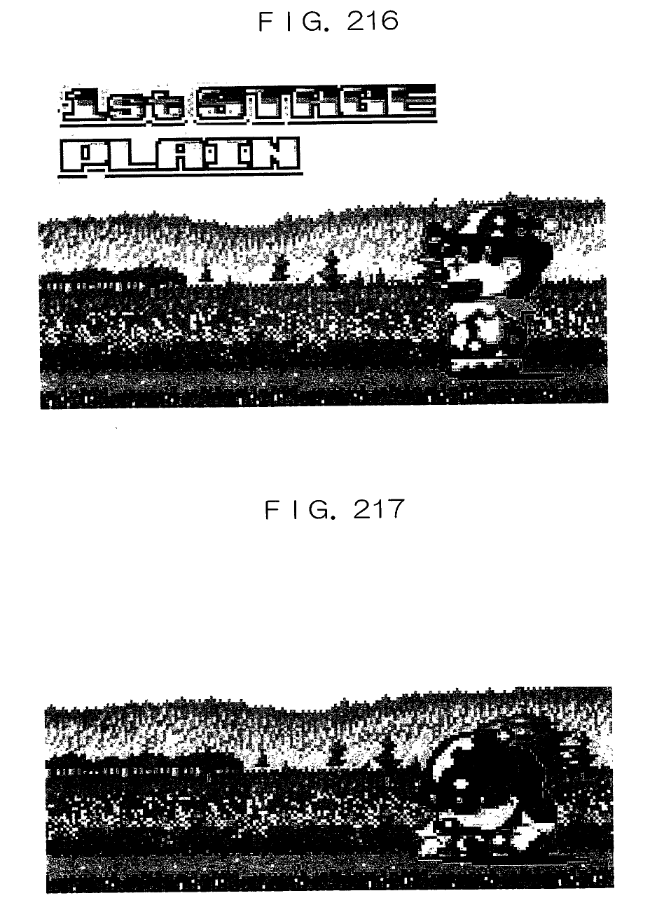

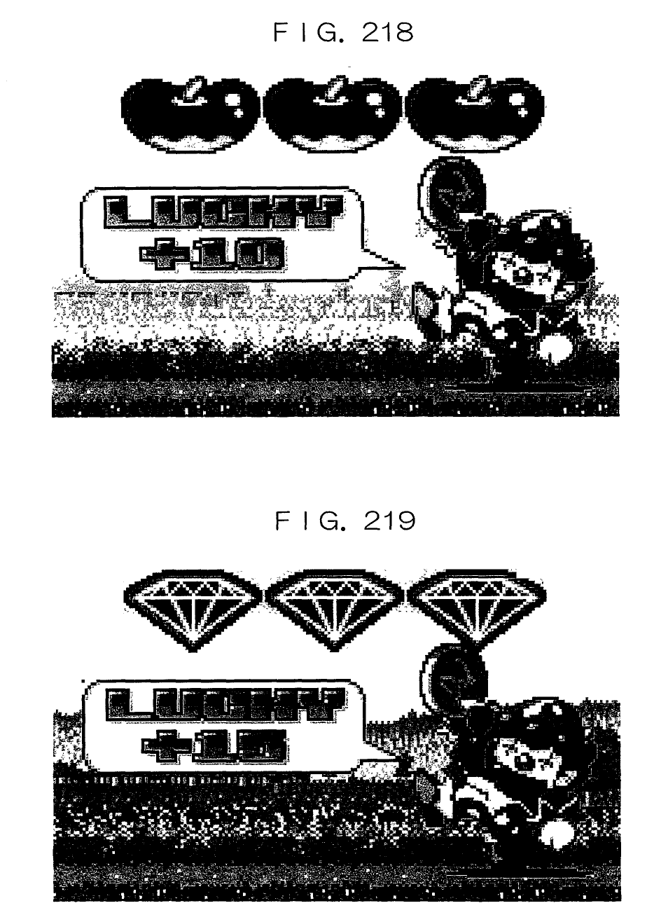

Subsequently, as the first normal game attraction, the leading character lands on a plain, and picks up an object from the ground (FIGS. 216 and 217). This action of the leading character for picking up the object from the ground corresponds to the payout of game medals when a winning mode is attained in an actual game (reels 5a to 5c ). Hence, while the number of game medals to be paid out is displayed as an image (FIGS. 218 and 219), the kind of winning hand is displayed. At this time, the number of game medals to be paid out is displayed within a speech balloon as if the leading character is speaking.

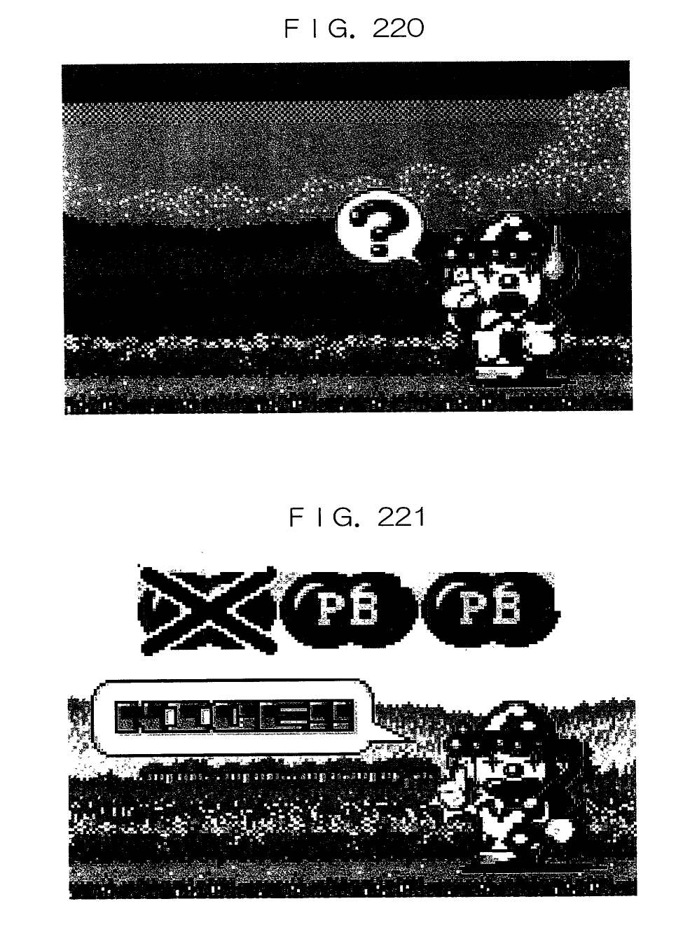

In another attraction, when a stop mode of miss is attained in an actual game (reels 5a to 5c ) although a certain winning mode is internally elected, i.e., it has failed to attain a winning mode corresponding to the internally elected hand, then “?” is displayed in a speech balloon of the leading character (FIG. 220).

Conventionally, when a winning mode is attained, a winning attraction has been effected by blinking decorating lamps, and the number of game medals to be paid out has been displayed by a seven-segment indicator or the like. In this embodiment, by contrast, winning and losing are expressed by actions of a character, messages concerning the number of winning game medals and those to the player (congratulations on winning, “LUCKY,” in this case) are spoken by the character, and the winning symbols are displayed. As a consequence, a variety of visual attractions are possible. Also, it becomes easier for novice players to grasp the results of gaming or the current gaming state. Since these displays are collectively displayed in the image display section 13, all kinds of game information can be seen from the single image display section 13. Hence, without the trouble of confirming the fact that symbols are set in order on an effective winning line by seeing the reels 5a to 5c and then confirming how many game medals are paid out at the current winning by looking at the dividend table or seven-segment indicator, the player can correctly recognize these kinds of information in the single image display section 13.

Though the speaking state of the character is expressed by speech balloons and the letters displayed therein in this embodiment, simulated voices may be employed to express: “It's a winning of 10-medal hand,” “Sorry, it's a miss,” and so forth. While the payout of game medals occurs at the time of winning, a character may be animated as the game medals are paid out.

Though no display is effected when no winning hand is internally elected, i.e., in the case of so-called miss, in this embodiment, a display may be effected so as to indicate that it is a miss.

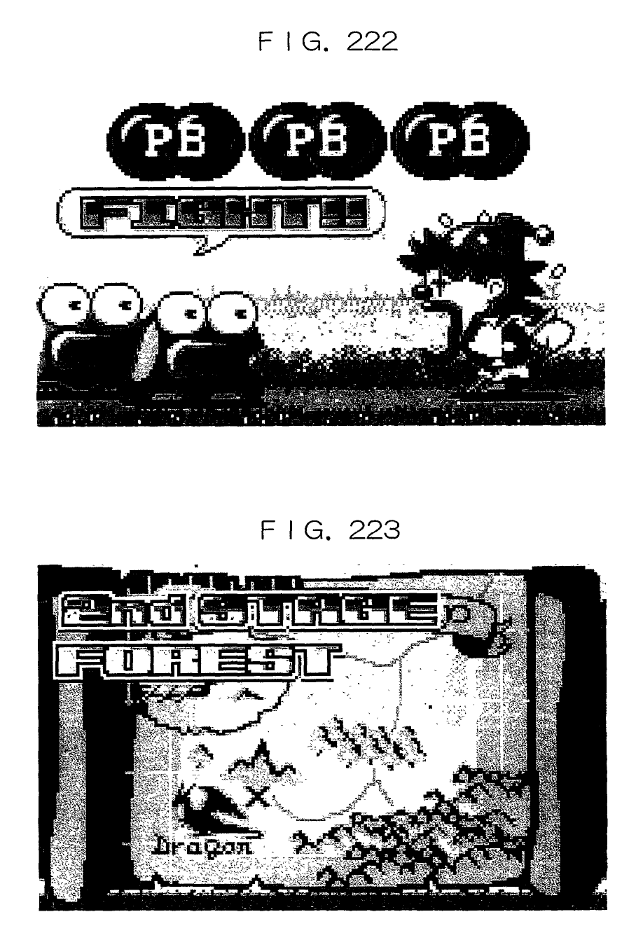

When shifting to a JAC game, letters of “FIGHT” are displayed (FIG. 222).

In another attraction, when replay symbols, which are a stop mode for shifting to the JAC game, are intentionally kept from being constructed (replay avoidance), letters of “NICE” are displayed (FIG. 221).

The replay avoidance will now be explained.

While games similar to a normal game with a raised sampling probability of small hands, i.e., normal games in a big bonus game (normal games in BB), can be played up to 30 times in a big bonus game; if a specific symbol (e.g., similar to a replay symbol) for shifting to a JAC game is constructed during this game, the gaming state shifts to a JAC game. Namely, while games similar to a normal game can be played up to the maximum permissible number (30) in a big bonus game, winning modes are often generated during these games, so that many game medals can be acquired. If a specific symbol for shifting to a JAC game is constructed so as to shift to the JAC game before the maximum permissible number (30) is attained, the number of game medals to be acquired would decrease. Therefore, before the maximum permissible number approaches, e.g., up to 25 games, notwithstanding the fact that the starting condition for shifting to the JAC game is internally elected, the so-called see-and-push technique may be fully used so as to stop the reels 5a to 5c such that the specific symbol is not attained. When the number of games is as close as possible to the maximum permissible number (30), then the reels 5a to 5c are operated to stop such that the specific symbol for shifting to the JAC game is constructed. As a consequence, the player can obtain the maximum profit.

Here, the first normal game in BB refers to a normal game from the starting of the big bonus game until the starting of the first JAC game. Similarly, the second normal game in BB refers to a normal game from the ending of the first JAC game until the starting of the second JAC game, and the third normal game in BB refers to a normal game after the ending of the second JAC game.

Conventionally, the number of consumed normal games in a big bonus game has been displayed by a seven-segment indicator or lamps. By contrast, when a background image or character which varies by a predetermined unit is used for carrying out attractions, then the player can correctly grasp the progress of gaming. Also, along therewith, the player can correctly determine whether to execute replay avoidance or enter the JAC game. (If the replay avoidance is executed so much that the big bonus game is terminated while not fully consuming the JAC games, then it is meaningless to acquire many small hands during normal games; thus making it necessary to acquire the default number of JAC games while acquiring small hands in the normal game as much as possible.) Second Normal Game Attraction in BB In the second normal game attraction in BB, a map is displayed, so as to indicate the current position of the leading character (FIG. 223), thereby starting an adventure story of the leading character.

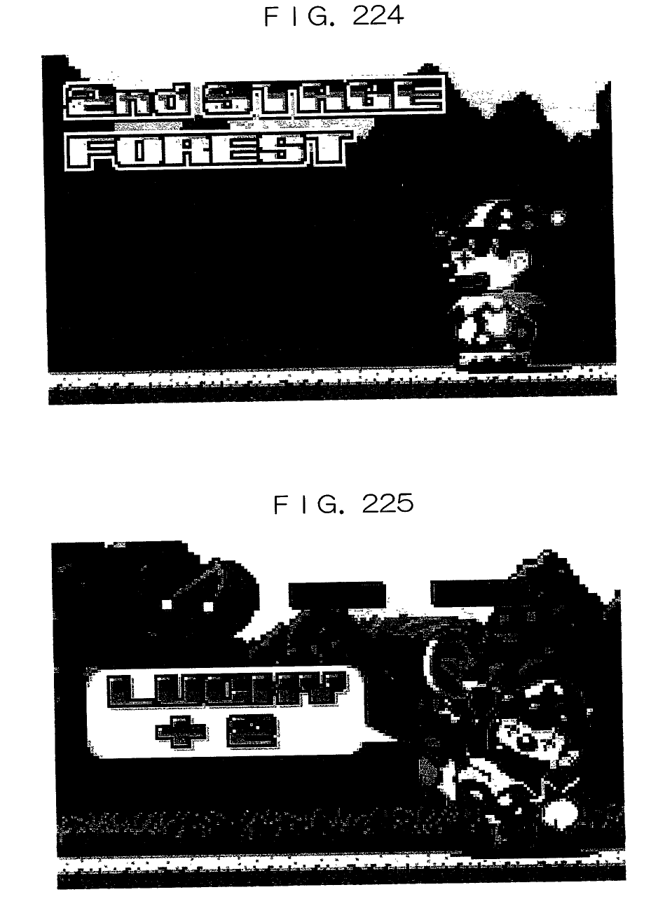

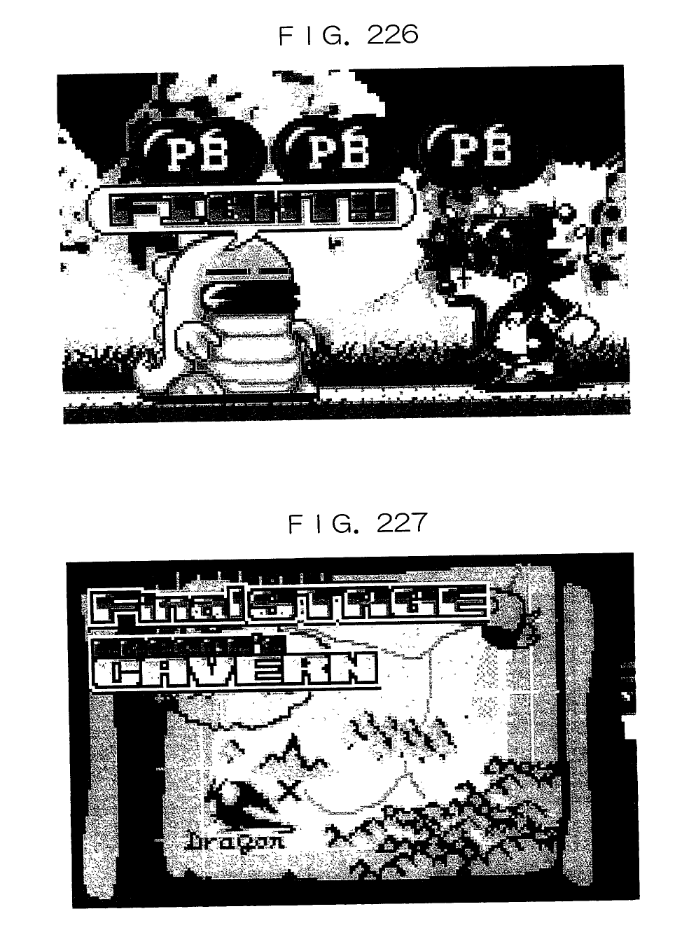

Subsequently, the leading character lands on a forest (FIG. 224), and an attraction similar to the first normal game attraction in BB is effected. When a winning mode is attained in an actual game (reels 5a to 5c ), the number of game medals to be paid out in response to thus attained winning mode is displayed as the leading character picks up an object from the ground (FIG. 225), for example, and letters of “FIGHT” are displayed when shifting to a JAC game (FIG. 226).

Third Normal Game Attraction in BB

In the third normal game attraction in BB, a map is displayed, so as to indicate the current position of the leading character (FIG. 227), thereby starting an adventure story of the leading character.

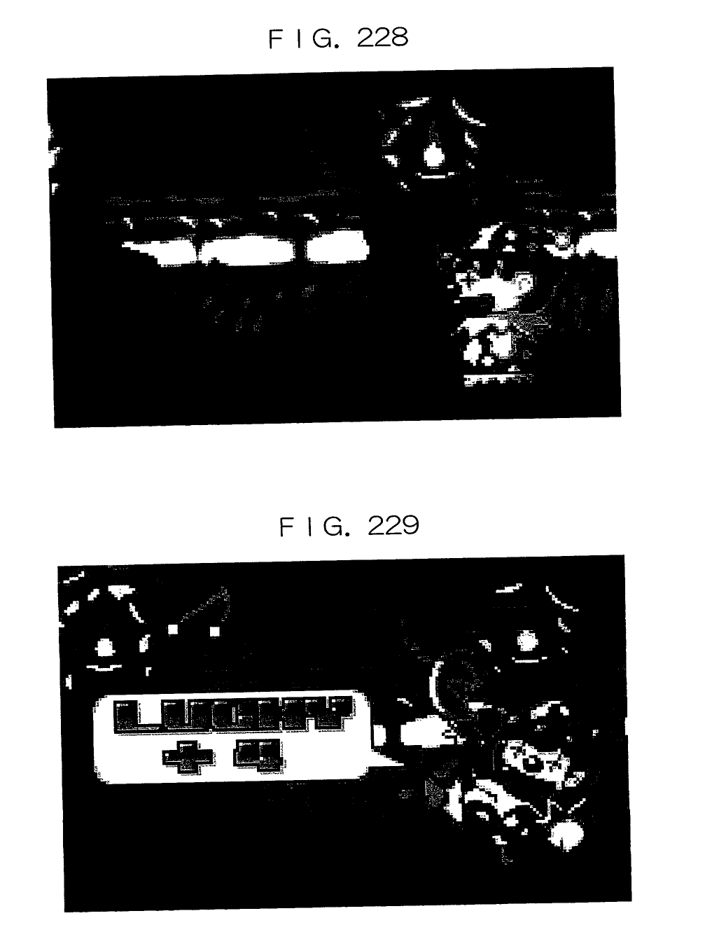

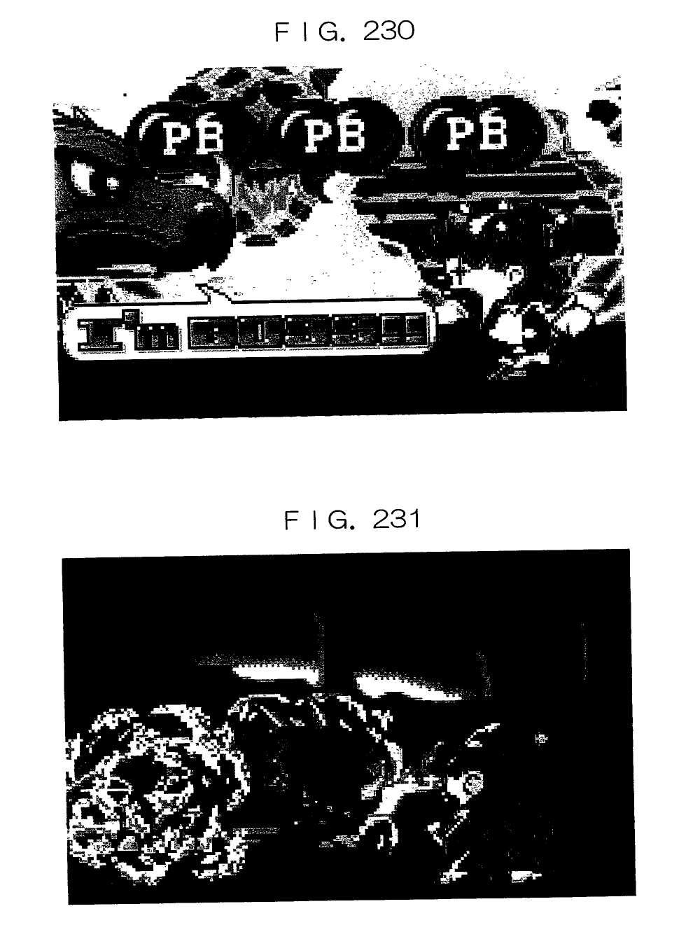

Subsequently, the leading character enters a cavern (FIG. 228), and an attraction similar to the first normal game attraction in BB is effected. When a winning mode is attained in an actual game (reels 5a to 5c ), the number of game medals to be paid out in response to thus attained winning mode is displayed as the leading character picks up an object from the ground (FIG. 229), for example, and letters of “I'm BOSS” are displayed when shifting to a JAC game so as to indicate that it is the final JAC game, together with a dragon character which is an opponent in the story (FIG. 230).

Big Bonus Ending Attraction

The big bonus ending attraction is constituted by two patterns, i.e., so-called completion attraction for the case where the player has succeeded in obtaining the acquirable profits, and so-called puncture attraction for the case where the big bonus game has ended before the player obtains the acquirable profits.

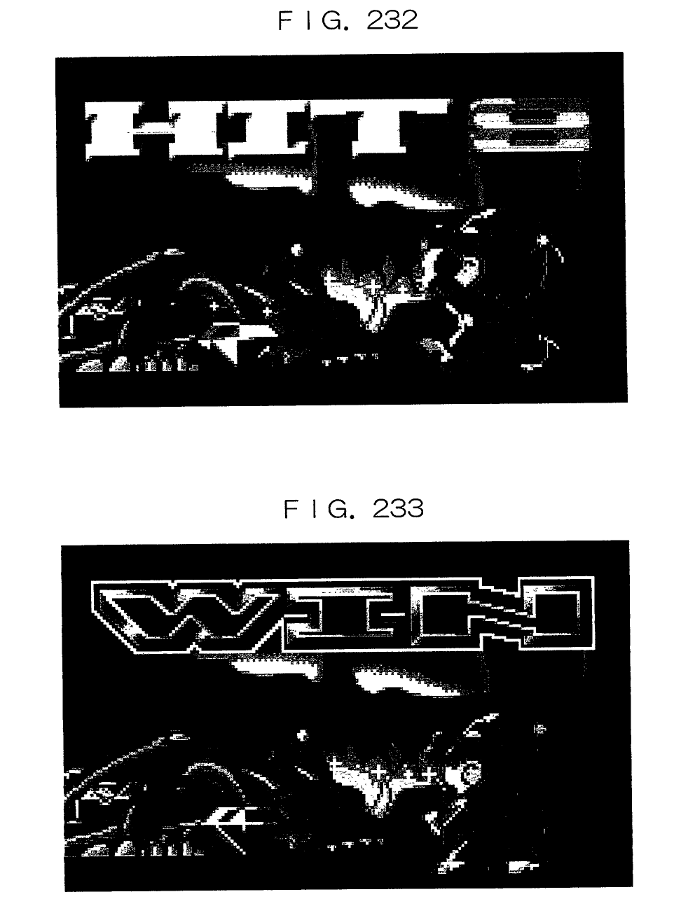

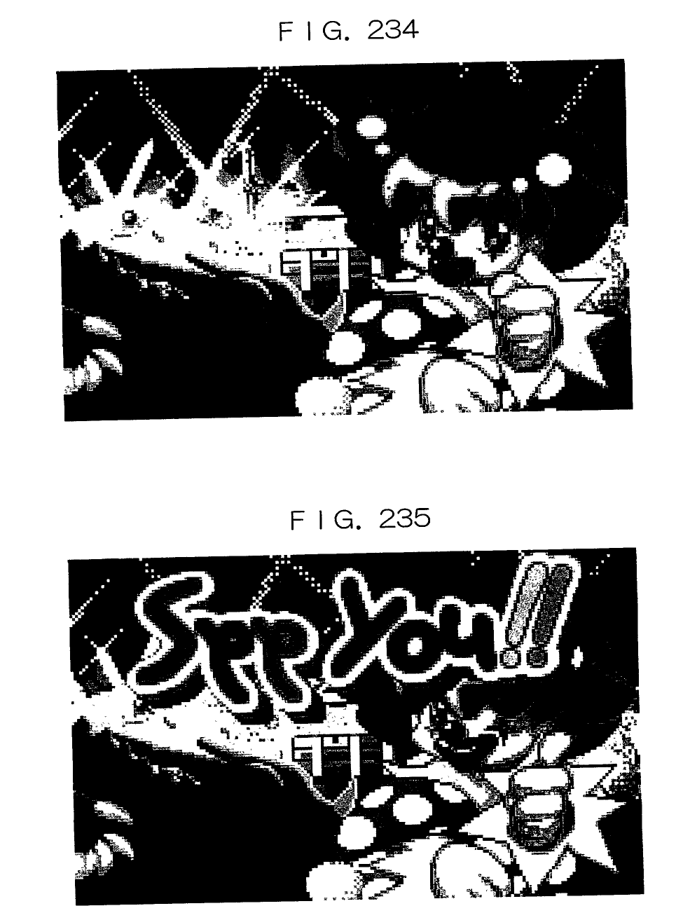

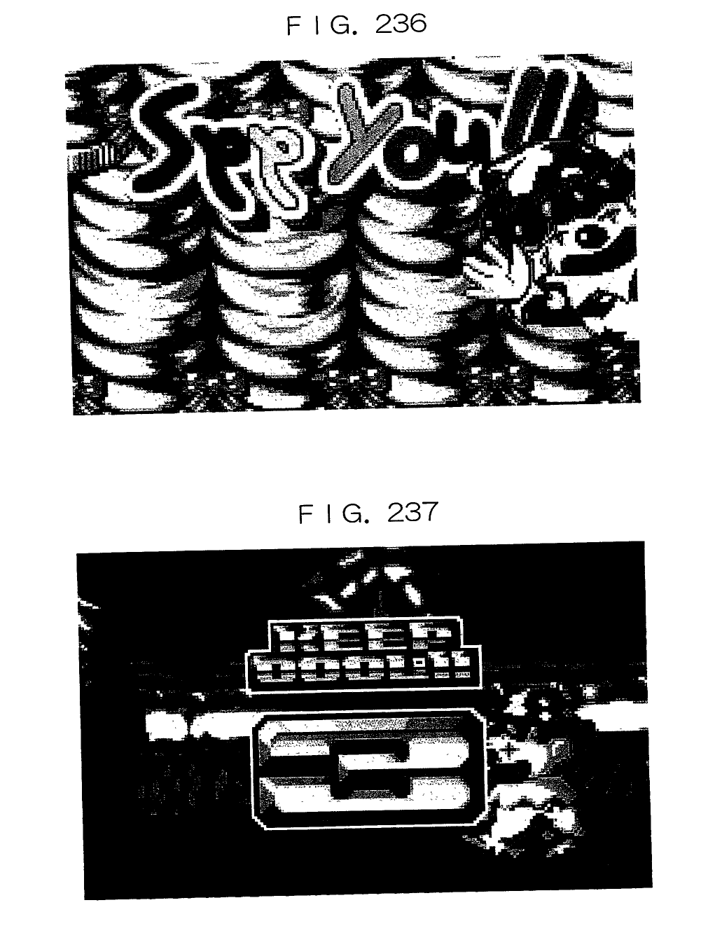

In the completion attraction, the dragon character, which is the opponent in the story, is defeated, so as to indicate that the third JAC game has completely been won, and then letters of “WIN” are displayed (FIGS. 231 to 233). Subsequently, the leading character acquires the treasure of the dragon, letters of “SEE YOU” are displayed, and a curtain falls (FIGS. 234 to 236).

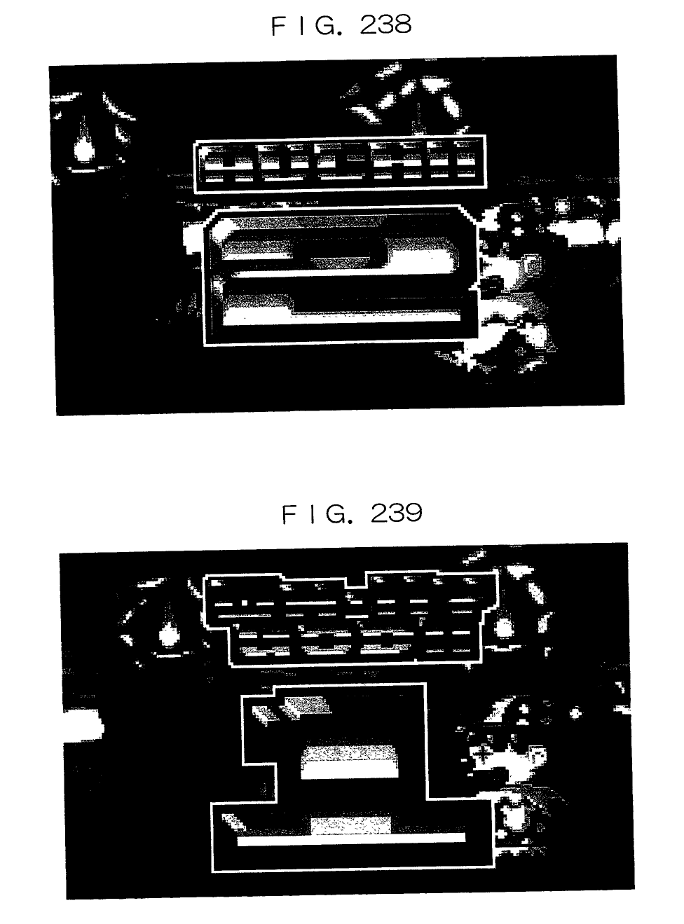

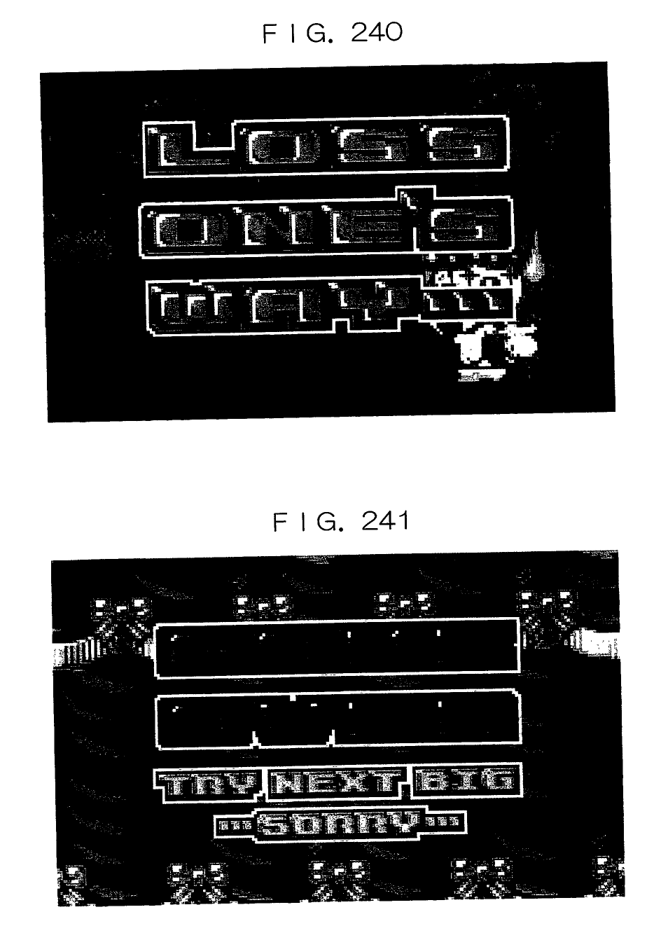

In the puncture attraction, the number of playable games is counted down as “3,” “2,” and “1” (FIGS. 237 to 239), letters of “LOSS ONE'S WAY” are displayed so as to indicate that it is so-called puncture, and letters of “GAME OVER” are eventually displayed (FIGS. 240 and 241).

When such an attraction is effected, then the player can further enhance the feeling of fretfulness and expectation so as to wish a replay symbol (JAC game actuating symbol) to be set in order soon as the puncture will occur in three games from now, for example, whereby the amusement of gaming increases.

First JAC Game Attraction

The attraction effected when shifting to a JAC game will now be explained. This attraction is constituted by three patterns, i.e., the first JAC game attraction, the second JAC game attraction, and the third JAC game attraction.

Further, each JAC game attraction is constituted by three patterns, i.e., a winning attraction in the JAC game, a losing attraction in the JAC game, and a so-called puncture attraction for the case where the JAC game has ended before the acquirable profits are obtained.

To begin with, the first JAC game attraction will be explained.

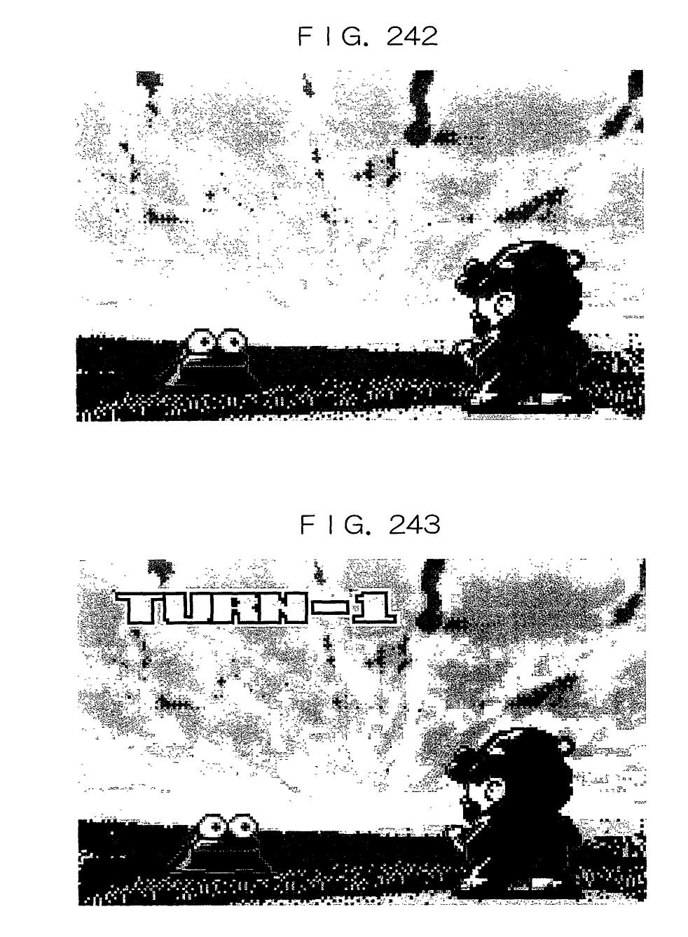

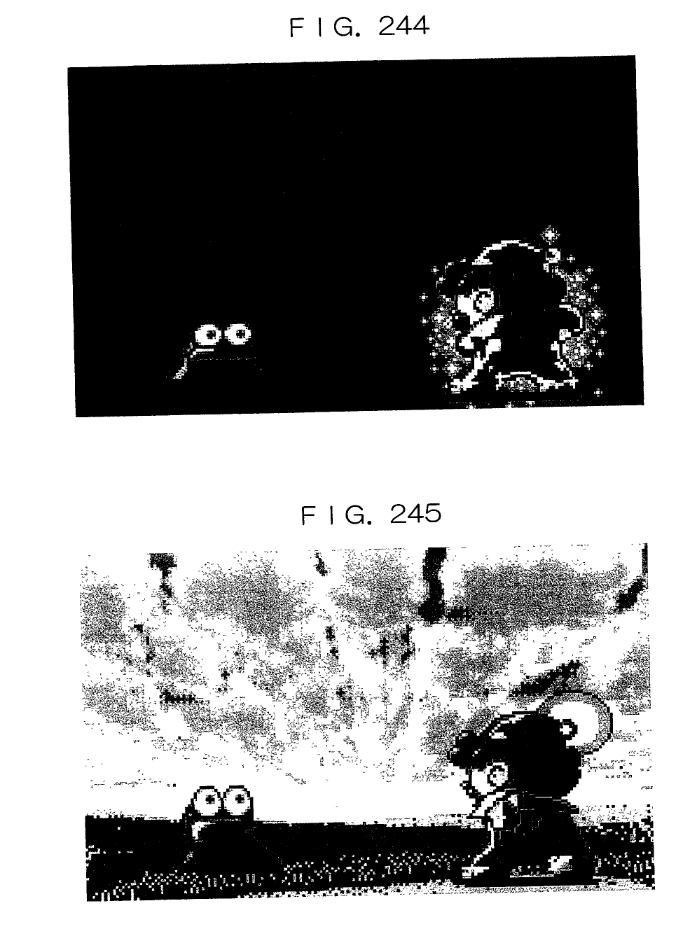

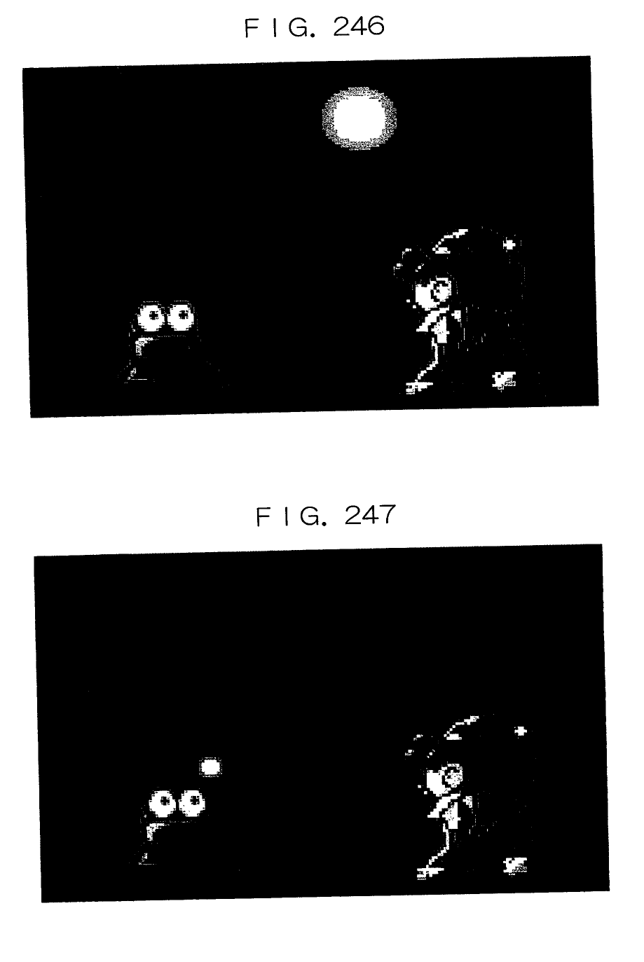

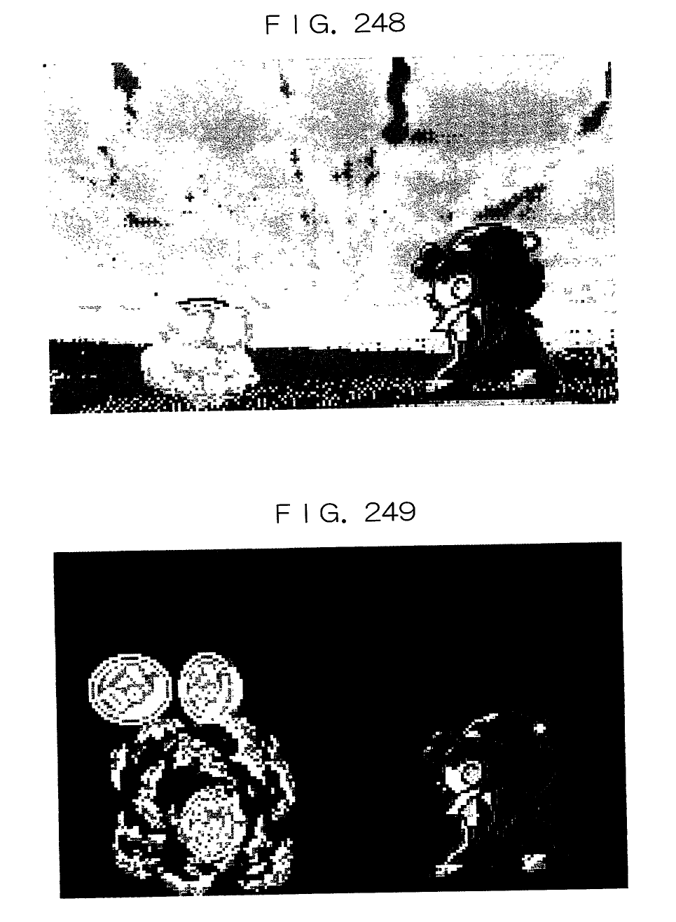

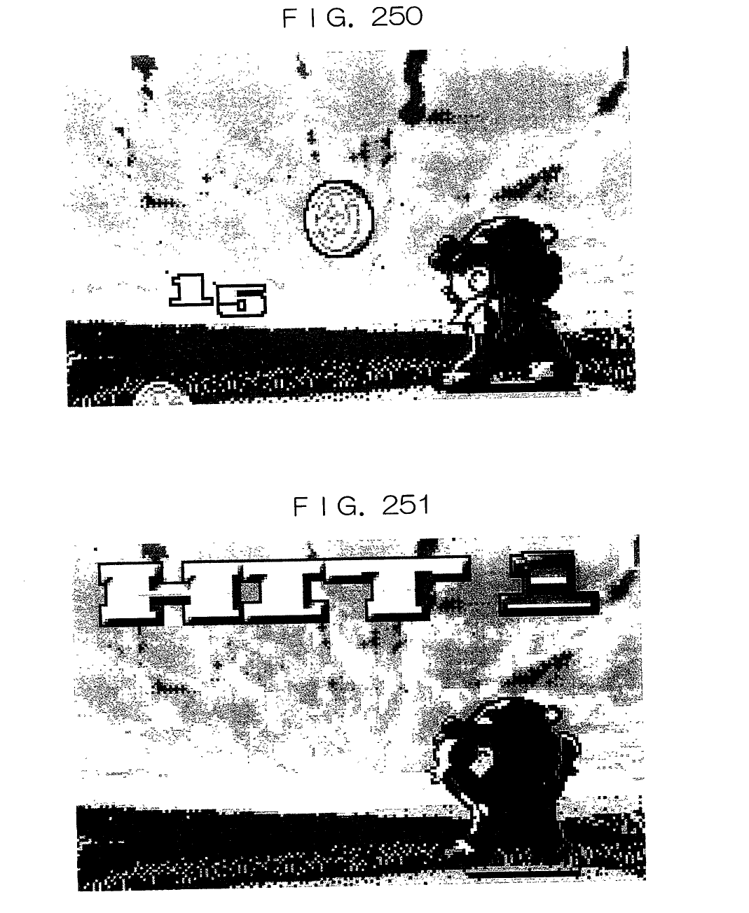

In the winning attraction in the first JAC game, the leading character and a monster oppose each other at the timing when the player operates the start switch 20, and the number of games in the JAC game is displayed (FIGS. 242 and 243). Subsequently, the leading character stores energy, and throws an energy ball at the monster at the timing when the player carries out the third stopping operation of the stop switches 21a to 21c (FIGS. 244 to 247). Then, the energy ball hits the monster, whereby the monster disappears, and coins emerge. Also, the number of acquired coins (game medals) is displayed, and the number of winnings in the JAC game is displayed (FIGS. 248 to 251).

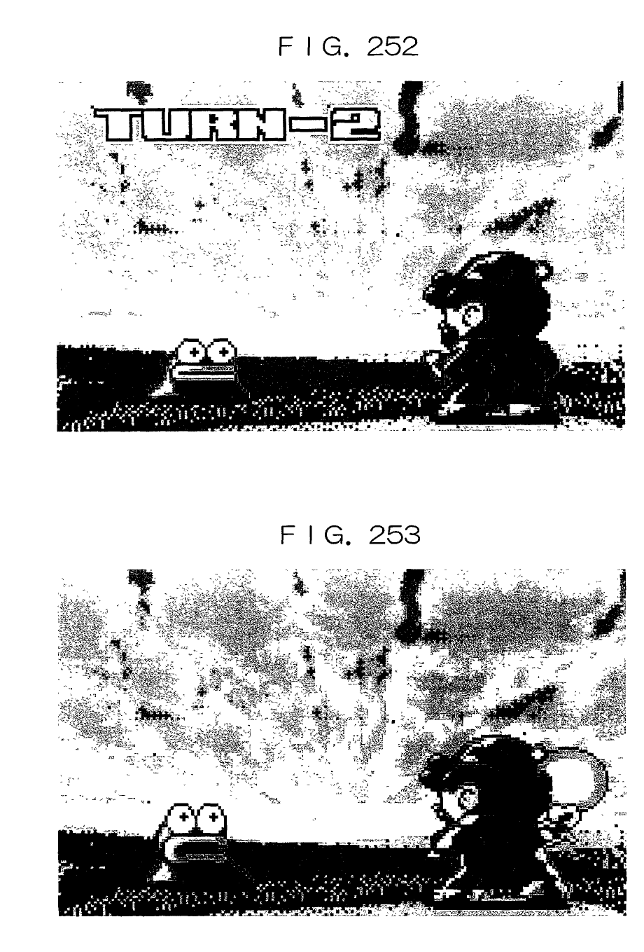

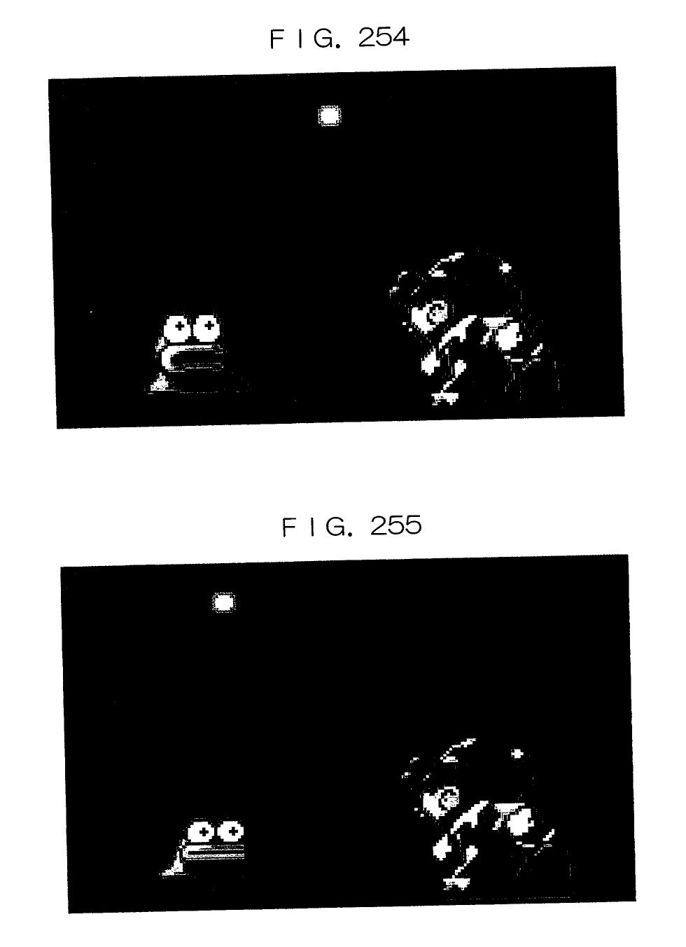

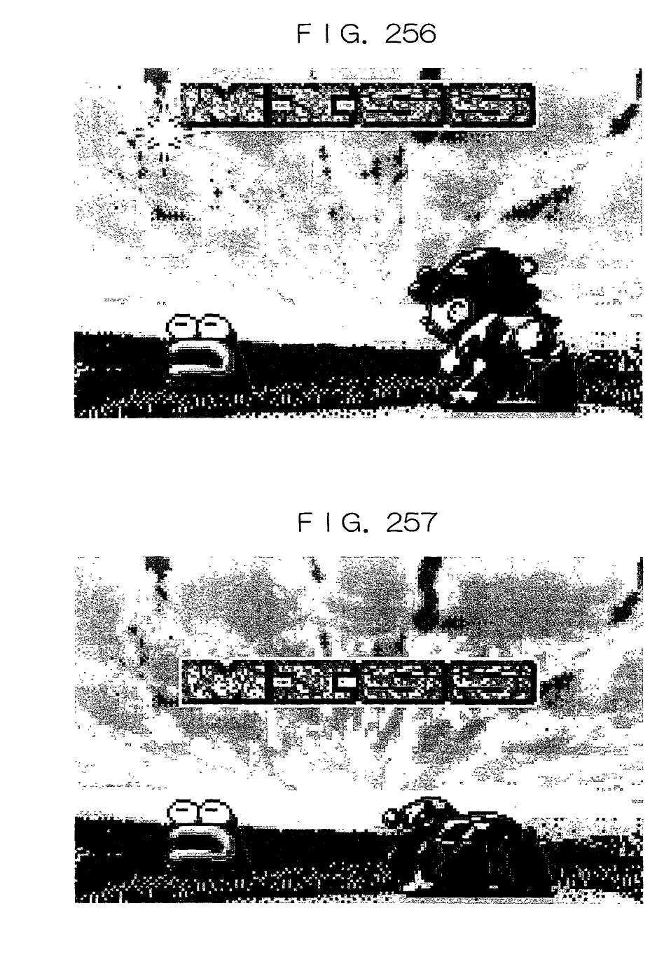

In the losing attraction in the first JAC game, the leading character and a monster 1 oppose each other, and the number of games in the JAC game is displayed (FIGS. 252 and 253). Subsequently, the leading character stores energy, and throws an energy ball at the monster 1 (FIGS. 254 and 255). Then, the energy ball misses the monster 1 with a large margin, letters of “MISS” are displayed, and the leading character falls down, so as to indicate that it is a miss (FIGS. 256 and 257).

Thus, in addition to the conventional fun of gaming in which a winning mode is constructed as the player operates the stop switches 21a to 21c to stop, the fun of visual attraction in which the opponent monster or the leading character is defeated as the stop switches 21a to 21c are operated to stop is obtained, whereby the amusement of gaming enhances.

Without being restricted to the foregoing, the stopping operations of the stop switches 21a to 21c by the player and the starting of attraction display in the image display section 13 may be carried out at any timing.

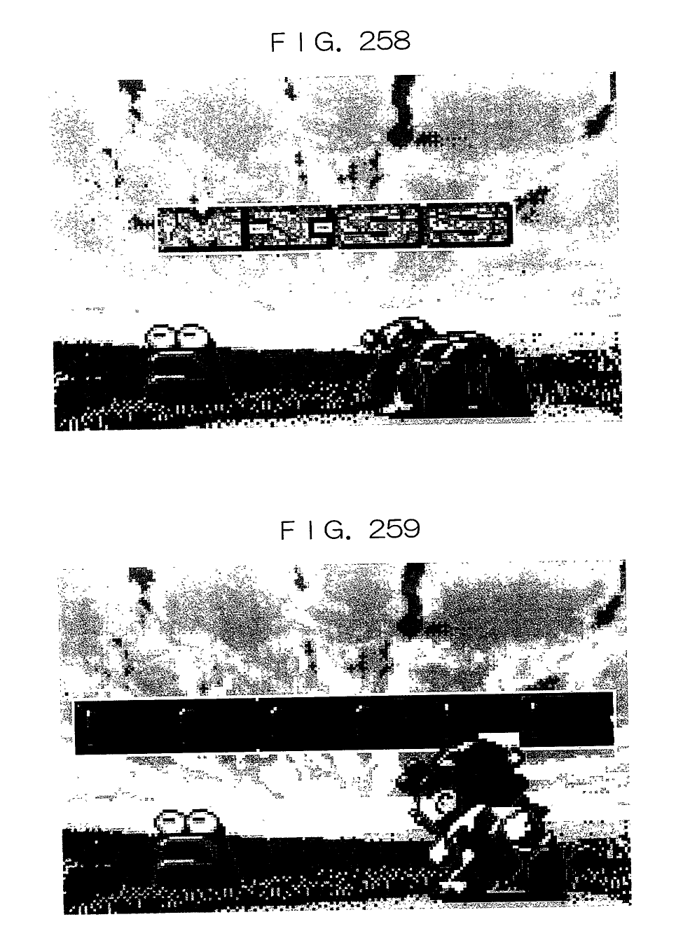

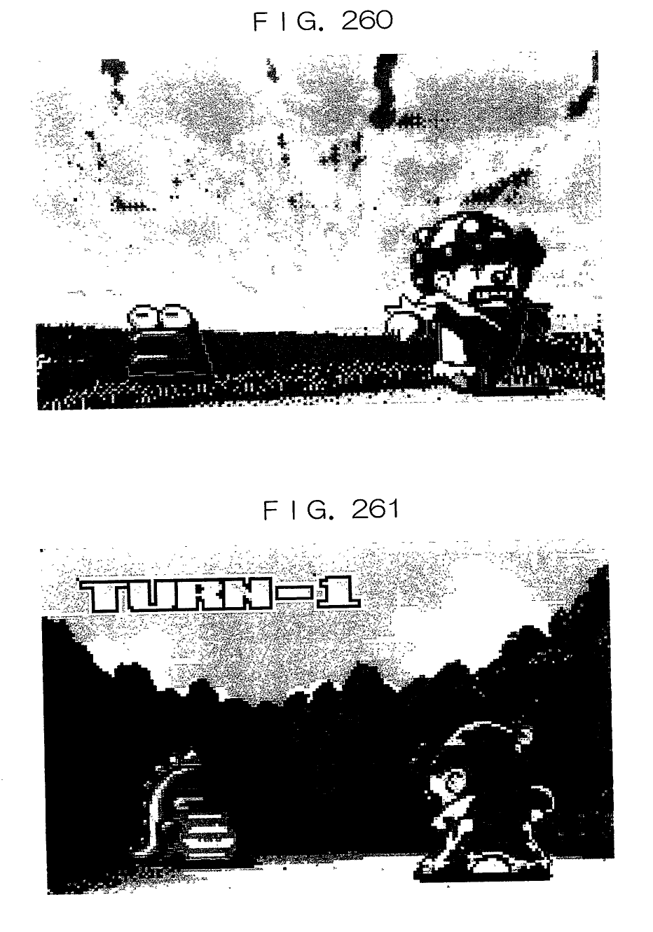

The puncture attraction in the first JAC game is effected when the maximum permissible number of (e.g., 8) winnings are not obtained at the time when the maximum number of (e.g., 12) games are consumed. After the leading character falls down, letters of “ESCAPE” are displayed, and the leading character runs away, thereby indicating that it is so-called puncture (FIGS. 258 to 260). Here, the puncture in the JAC game refers to the case where the maximum permissible number of (e.g., 8) winnings are not obtained in the maximum number of (e.g., 12) games.

In a special game, such as the above-mentioned JAC game, in which predetermined games are constructed as one set, and the number of acquirable game medals varies according to the state of gaming (they are fully acquired, puncture occurs, or the like), if an image corresponding to the winning and losing in one game is set, and the image attraction is carried out according to the result of this game, the feeling of suspense for each game can be enhanced so as to feel, for example, that “it's won now” or “oops, it's a miss.” Also, as an image attraction corresponding to the time of puncture is effected, the feeling of the player can further be enhanced, whereby the amusement of gaming can further be increased.

Second TAC Game Attraction

The second JAC game attraction will now be explained.

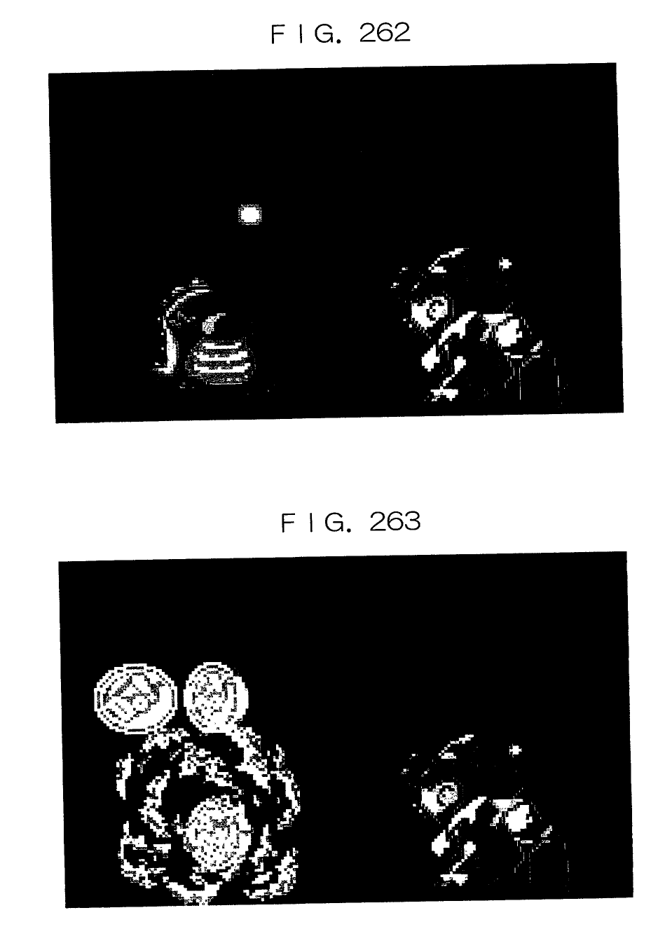

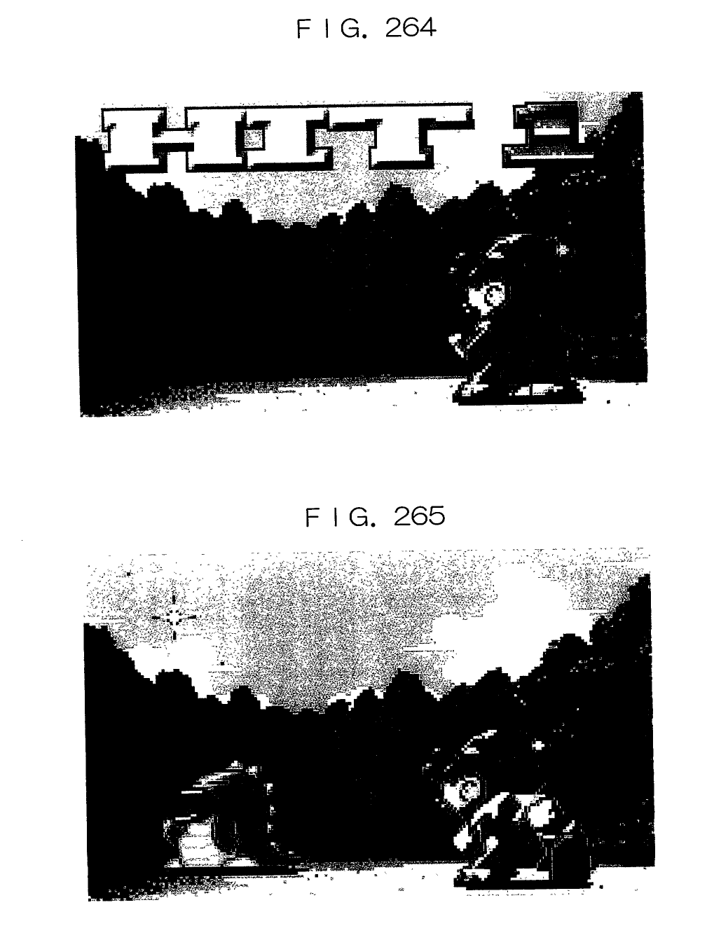

In the winning attraction in the second JAC game, an attraction substantially similar to that in the first JAC game is carried out. Namely, the leading character and a monster 2 oppose each other, and the number of games in the JAC game is displayed (FIG. 261). Subsequently, the leading character throws an energy ball at the monster 2. Then, the energy ball hits the monster 2, whereby the monster 2 disappears, coins emerge, and the number of winnings in the JAC game is displayed (FIGS. 262 to 264).

In the second JAC game attraction, not only the background image but also the opponent monster is made different from that in the first JAC game, so that the player can clearly distinguish the first and second times from each other.

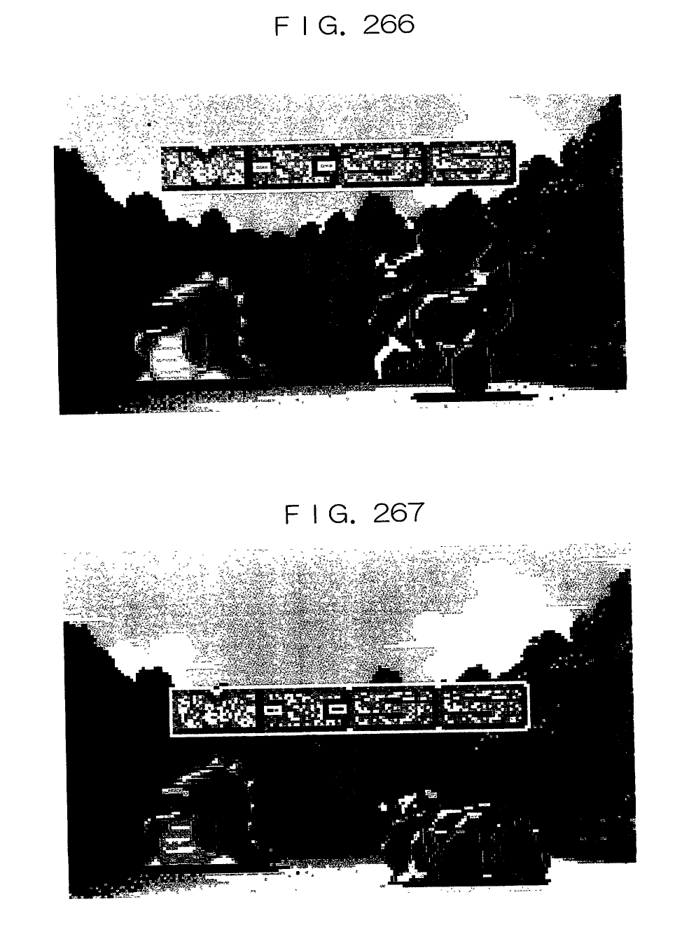

In the losing attraction in the second JAC game, an attraction substantially similar to that in the first JAC game is carried out. Namely, the leading character and the monster 2 oppose each other, the energy ball thrown at the monster 2 by the leading character misses it by a large margin, letters of “MISS” are displayed, and the leading character falls down, thereby indicating that it is a miss (FIGS. 265 and 266).

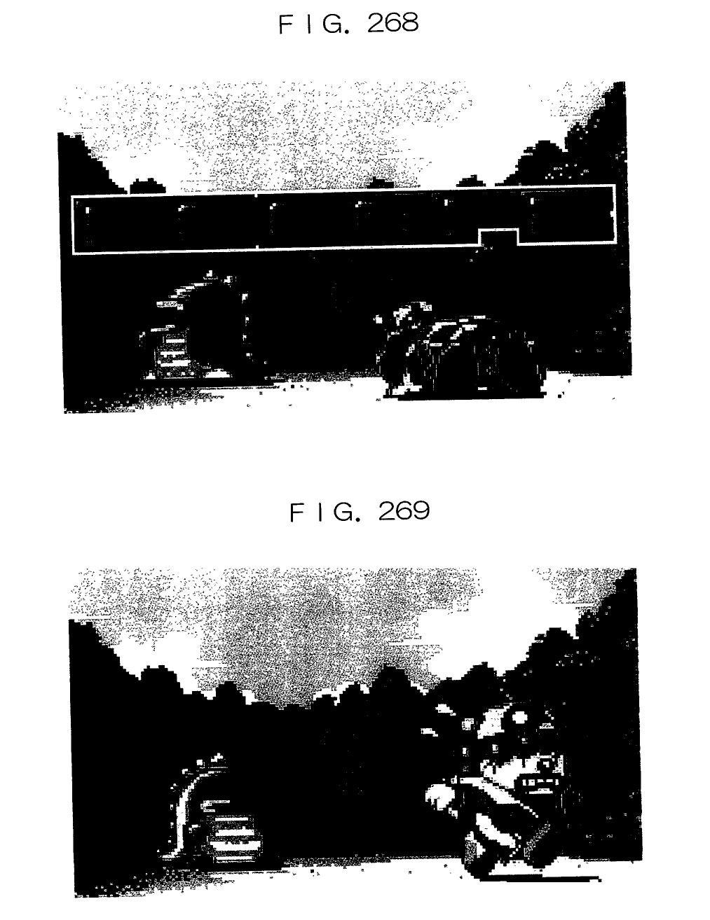

In the puncture attraction in the second JAC game, an attraction substantially similar to that in the first JAC game is carried out. Namely, after the leading character falls down, letters of “ESCAPE” are displayed, and the leading character runs away, thereby indicating that it is so-called puncture (FIGS. 267 to 269).

Third JAC Game Attraction

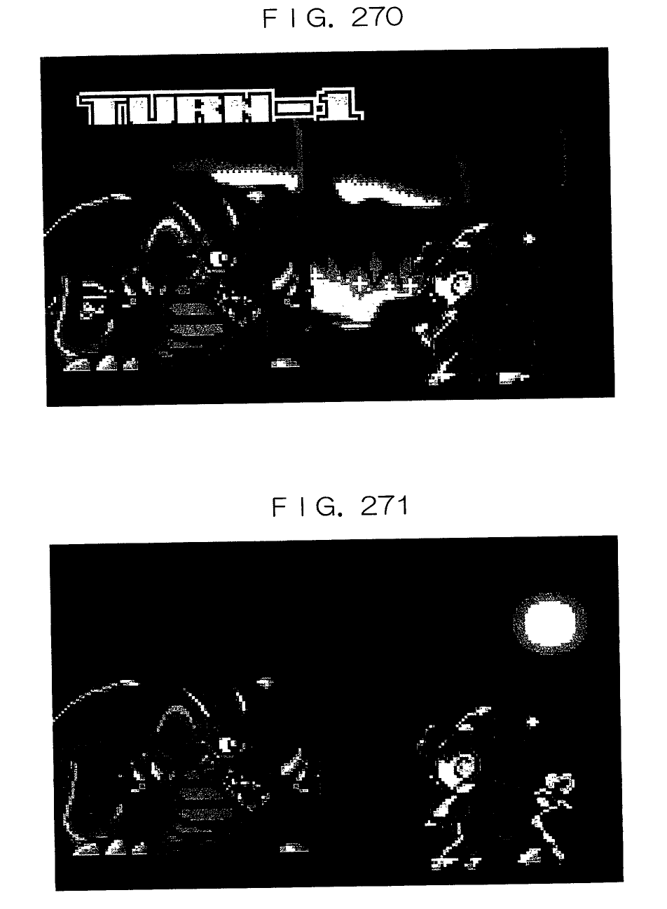

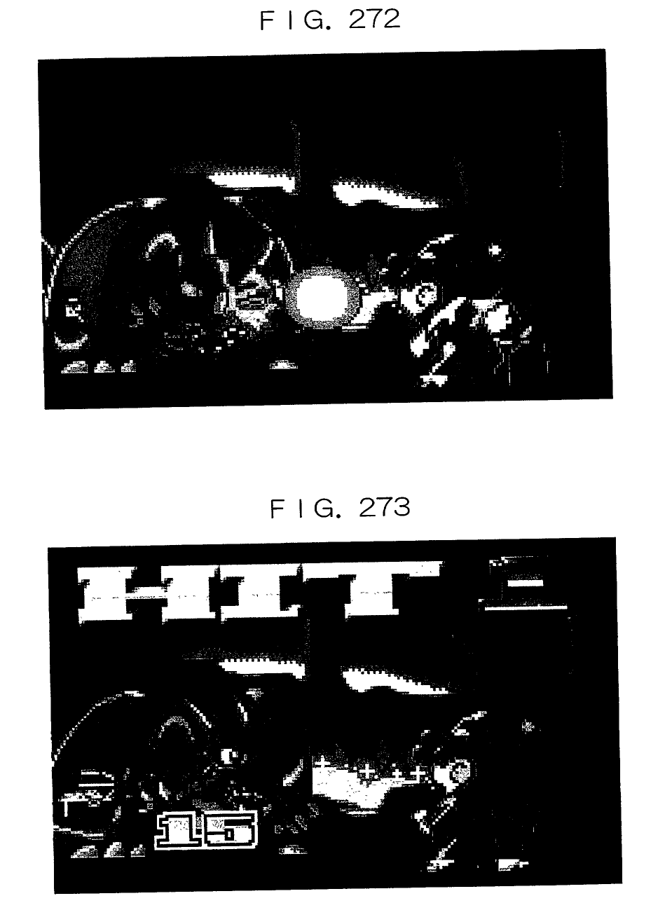

The third JAC game attraction will now be explained. In the winning attraction in the third JAC game, an attraction substantially similar to that in the first JAC game is carried out. Namely, the leading character and a dragon, which is the final opponent, oppose each other, and the number of games in the JAC game is displayed (FIG. 270). Subsequently, the leading character throws an energy ball at the dragon. Then, the energy ball hits the dragon, and the number of winnings in the JAC is displayed together with the number of acquired coins (game medals) (FIGS. 271 to 273).

If 12 games, which constitute the maximum number of games, are played, or 8 winnings, which constitute the maximum number of winnings, are attained in the third JAC game, then the completion attraction in the big bonus explained above is carried out.

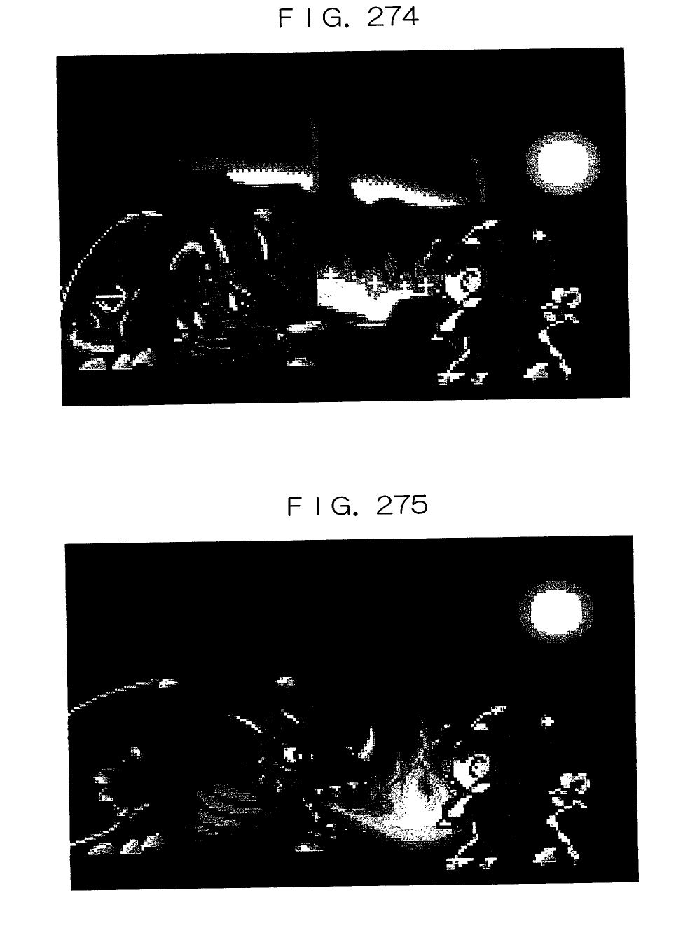

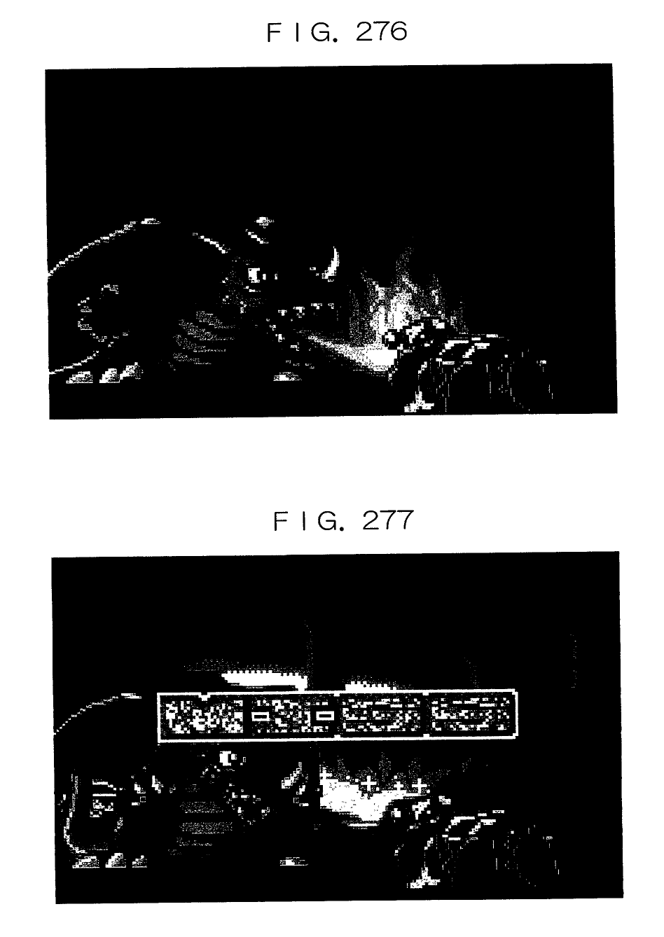

In the losing attraction in the third JAC game, an attraction substantially similar to that in the first JAC game is carried out. Namely, the leading character and the dragon oppose each other, and the leading character throws an energy ball at the dragon. Then, the dragon emits fire, the leading falls down, and letters of “MISS” are displayed, so as to indicate that it is a miss (FIGS. 274 to 277).

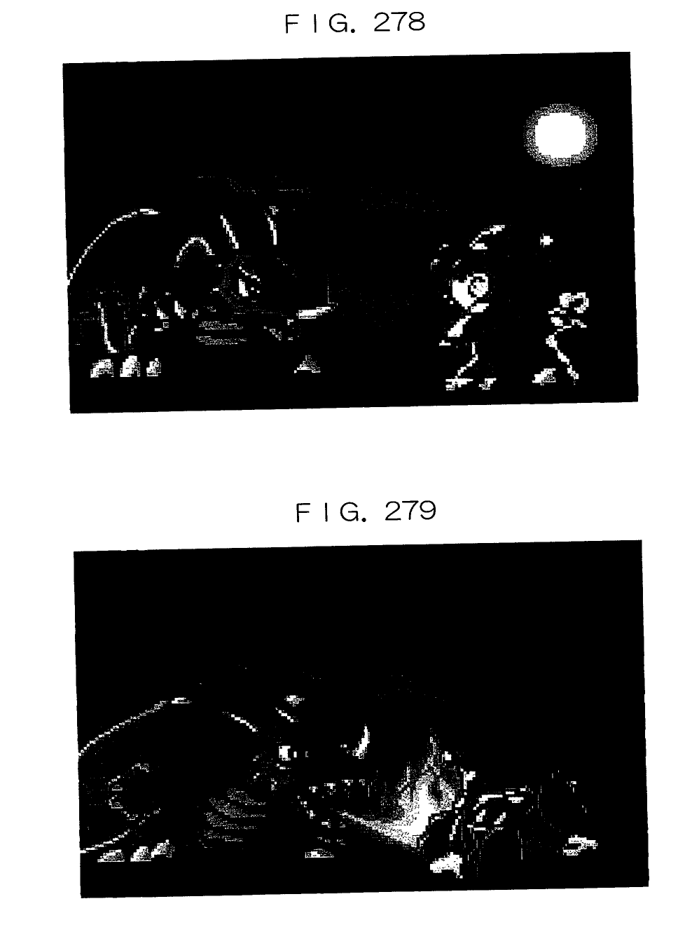

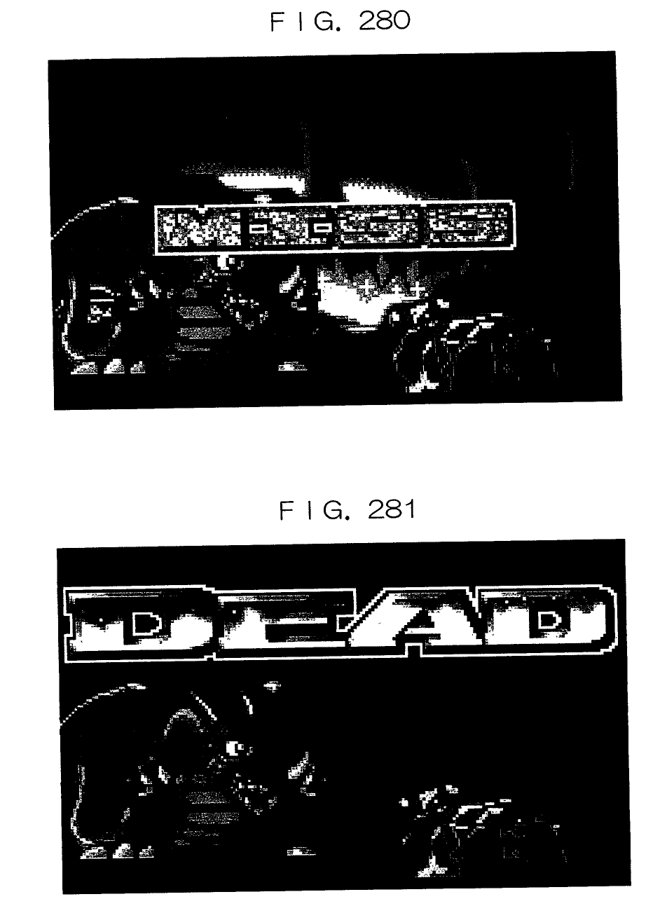

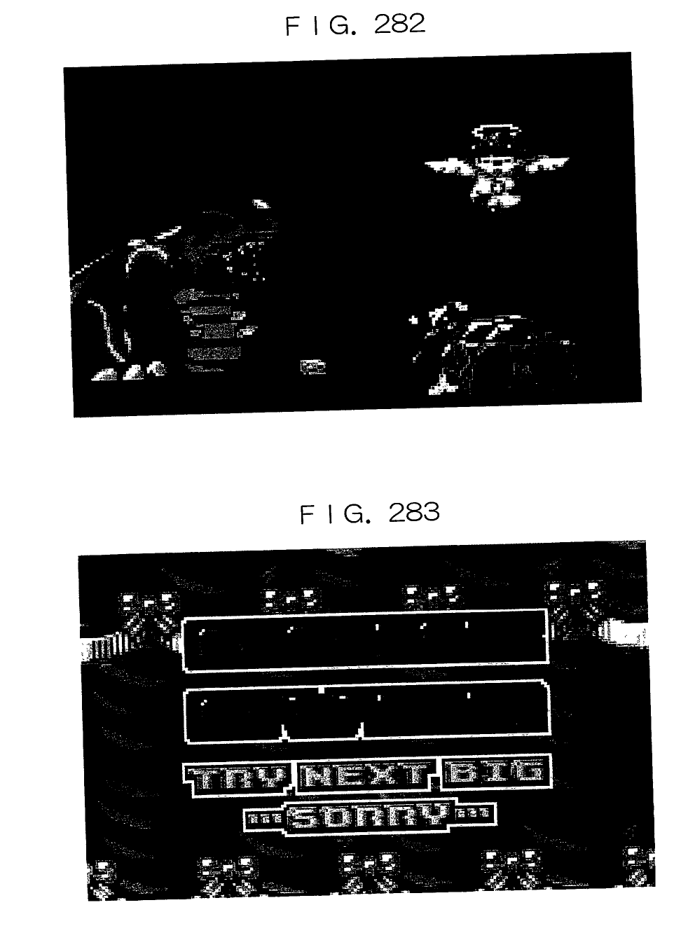

In the puncture attraction in the third JAC game, the leading character and the dragon oppose each other, and the leading character throws an energy ball at the dragon. Then, the dragon emits fire, the leading character falls down, and letters of “MISS” are displayed (FIGS. 278 to 280). Subsequently, letters of “DEAD” are displayed, the leading character is displayed to ascend to heaven as an angel, and letters of “GAME IS OVER” are finally displayed (FIGS. 281 to 283).

Conventionally, only similar attractions have been carried out in each JAC game by use of a seven-segment indicator or lamps. When different attractions are effected according to the number of JAC games, by contrast, an attraction can be represented as if the leading character leads the game according a story. In particular, in a gaming machine such as a pachislo gaming machine in which the number of acquirable game medals (i.e., the state of progress of image attraction) changes according to the stopping operation by the player, it is possible to provide not only the conventional fun of gaming of setting symbols in order, but also the fun emerging from the image attraction (story) such as a desire to see the scene in which the final dragon is defeated. As a consequence, the player enthusiastically carries out stopping operations, thus being able to further enhance the amusement of gaming.

Though this embodiment explains a so-called A-type slot machine in which JAC games can be played up to three times, the present invention is also applicable to B-type slot machines in which JAC games can be played up to two times as a matter of course.

Error Display

Indications of error information when an error occurs in the slot machine will now be explained.

When an error occurs in the slot machine, together with the character appearing in the above-mentioned story, letters of “CALL STAFF” and the contents of the error are displayed, so as to indicate how to deal with the error.

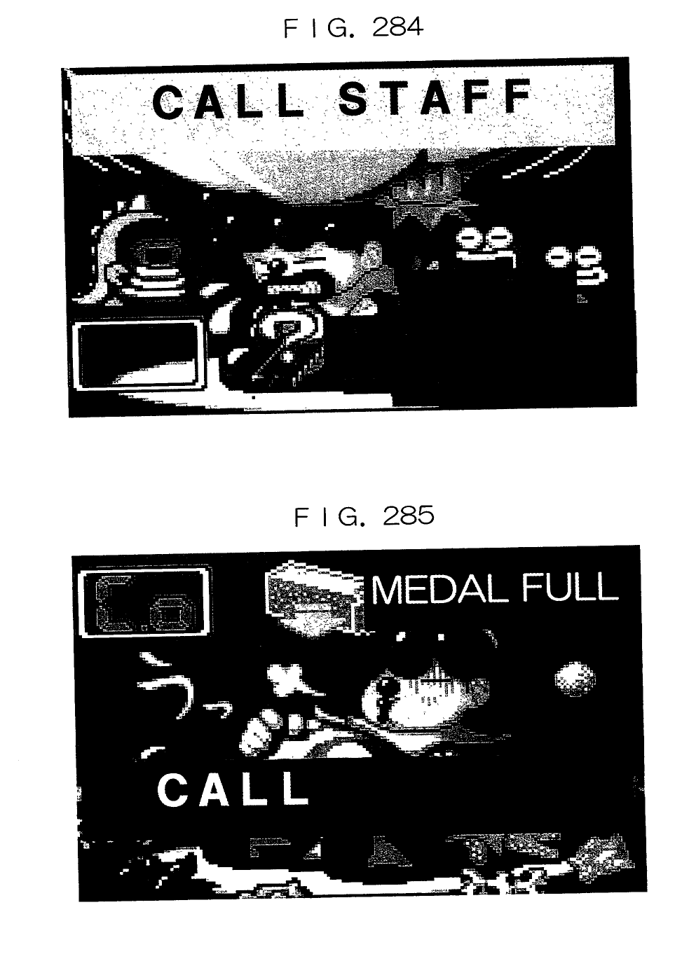

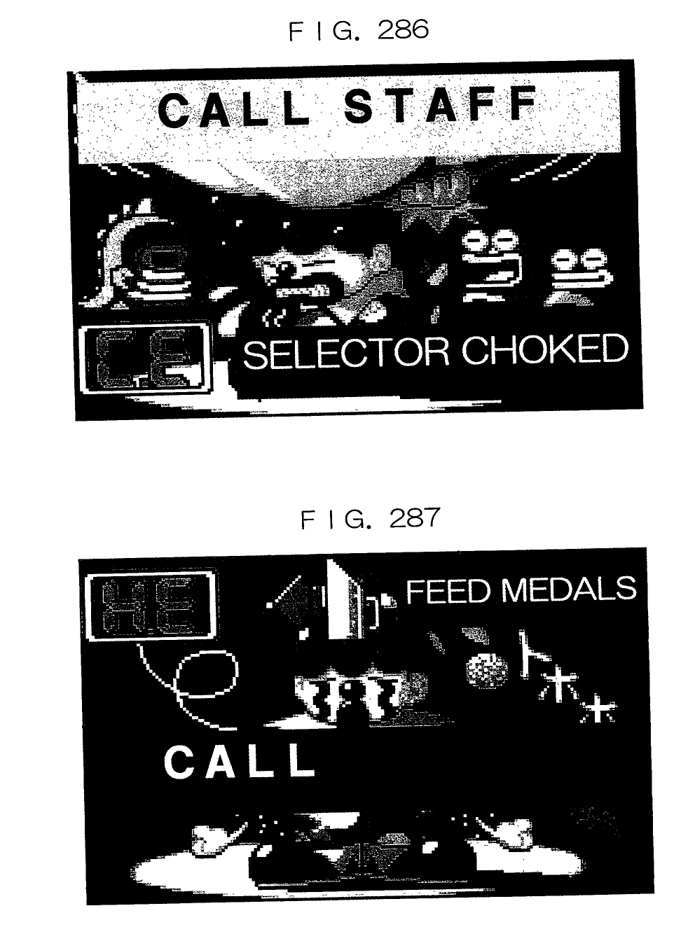

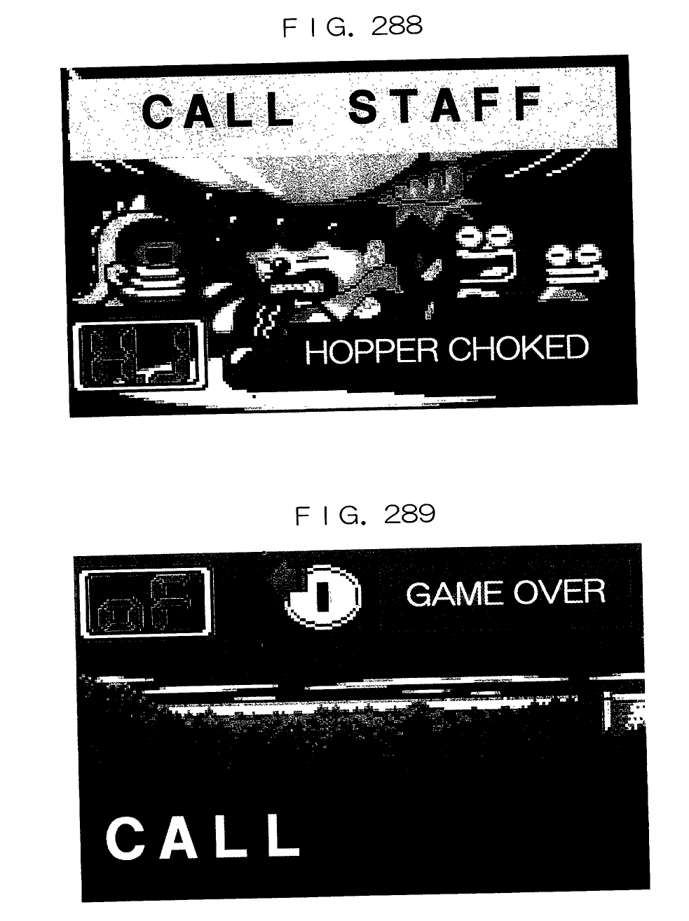

For example, in the case of an abnormality in a control board, letters of “BOARD ABNORMALITY FOUND” are displayed (FIG. 284). In the case where the medal tray is full of game medals, letters of “MEDAL FULL” is displayed (FIG. 285). In the case where the medal selector is choked, letters of “SELECTOR CHOKED” are displayed (FIG. 286). In the case where there is no more game medal stored in the hopper 122, letters of “FEED MEDALS” are displayed (FIG. 287). In the case where the hopper 122 is choked with game medals, letters of “HOPPER CHOKED” are displayed (FIG. 288). In the case of so-called play-out, letters of “GAME OVER” are displayed (FIG. 289). Also, in each error display, an error code composed of two letters corresponding to the respective error may also be displayed.

From the conventional error display effected by displaying two letters in a seven-segment indicator or the like, it has been hard to see what kind of error was generated. When the error display is effected as in this embodiment, then what kind of error has occurred can instantly be indicated to both the player and the staff of the game parlor.

The above-mentioned game information indicated in the slot machine 60 is an example of game information indicated in the gaming machine in accordance with the present invention. The gaming machine in accordance with the present invention can indicate other modes of game information. For example, the appearing characters, the progressing story, and the like can appropriately be changed, so as to indicate game information.

As a consequence of the above-mentioned configurations, the gaming machine in accordance with the present invention can achieve effects as mentioned in the following.

The gaming machine in accordance with the first aspect of the present invention comprises an image display section for displaying game information for a player, whereas game information corresponding to the state of gaming is displayed in the image display section.

Therefore, without being lost in the display by a plurality of display sections and decorating lamps provided in the gaming machine, sound effects from a speaker, and the like, the game information corresponding to the gaming state can correctly be displayed, whereby the game information can be reported to the player reliably and effectively. Therefore, according to the reported game information, the player can fully enjoy the fun of gaming.

In the second aspect of the present invention, the gaming machine is constituted by a slot machine.

Hence, the slot machine can achieve the effects of the first aspect of the present invention.

In the gaming machine in accordance with the third aspect of the present invention, its winning mode includes a special winning mode which becomes a starting condition for playing a special game which is more advantageous to the player than a normal game, and the image display section displays the game information in the normal game.

Therefore, in the normal game occupying a major portion of the gaming time, the game information corresponding to the gaming state can reliably be displayed, whereby the player can fully enjoy the fun of gaming according to the displayed game information.

In the gaming machine in accordance with the fourth aspect of the present invention, the image display section displays game information concerning the permission to input bet information.

As a consequence, the permission to input bet information can reliably be reported to the player, whereby the player is kept from feeling fretfulness by failing to recognize the permission to input bet information, and is kept from incurring a loss by lowering the total number of games without knowing the permission to insert a game medium. Hence, the player can fully enjoy the fun of gaming.

In the gaming machine in accordance with the fifth aspect of the present invention, the image display section displays game information concerning the input unit of bet information.

As a consequence, the input unit of bet information can reliably be reported to the player, whereby the player is kept from feeling fretfulness by misidentifying the input unit of bet information, and is kept from incurring a loss by lowering the unit of value information which should have been acquired. Hence, the player can fully enjoy the fun of gaming.

In the gaming machine in accordance with the sixth aspect of the present invention, the image display section displays game information concerning the unit of value information stored in the gaming machine.

As a consequence, the unit of value information stored in the gaming machine can reliably be reported to the player, whereby the player is kept from feeling fretfulness by misidentifying the unit of stored value information, and no uselessness occurs in gaming operations. Hence, the player can fully enjoy the fun of gaming.

In the gaming machine in accordance with the seventh aspect of the present invention, the image display section displays game information concerning the mode of input of bet information.

As a consequence, the currently selected mode of input of bet information can reliably be reported to the player, whereby the player is kept from feeling fretfulness by misidentifying the mode of input of bet information, and no uselessness occurs in gaming operations. Hence, the player can fully enjoy the fun of gaming.

In the gaming machine in accordance with the eighth aspect of the present invention, the image display section displays game information concerning whether a game is permitted to start or not.

In the gaming machine in accordance with the ninth aspect of the present invention, the image display section displays game information concerning the wait time until the game is permitted to start.

As a consequence, the fact that it is currently a wait time or that the wait time is over and the game is allowed to start can reliably be reported to the player, whereby the player is kept from feeling fretfulness without knowing that it is a wait time, and is kept from lowering the total number of games without knowing that the wait time is over. Hence, the player can fully enjoy the fun of gaming.

Also, when the remainder of the wait time is indicated, the end of wait time can be awaited without feeling fretfulness, whereby the fun of gaming can further be enhanced.

In the gaming machine in accordance with the tenth aspect of the present invention, the image display section displays game information concerning whether the operation of the stopping means is effective or not.

As a consequence, whether the operation of stopping means is effective or not can reliably be reported to the player, whereby the player is kept from feeling fretfulness without knowing that the operation of stopping means is not made effective, and no uselessness occurs in gaming operations. Hence, the player can fully enjoy the fun of gaming.

In the gaming machine in accordance with the eleventh aspect of the present invention, the image display section displays game information concerning the possibility of occurrence of a special winning mode.

As a consequence, the possibility of occurrence of a special winning mode can reliably be reported to the player, whereby the player is kept from failing to play the special game and thereby incurring loss by lowering the number of gaming media which should have been acquired. Hence, the player can fully enjoy the fun of gaming.

In the gaming machine in accordance with the twelfth aspect of the present invention, the image display section displays game information concerning the possibility of occurrence of a special winning mode and the reliability thereof.

As a consequence, the possibility of occurrence of a special winning mode and its reliability can reliably be reported to the player, whereby the player can intuitively recognize the reliability of the probability of occurrence of the special winning mode. As the player feels an expectation for the occurrence of the special winning mode, the fun of gaming can be enhanced. Also, the player is kept from failing to play the special game and thereby incurring loss by lowering the number of gaming media which should have been acquired. Hence, the player can fully enjoy the fun of gaming.

In the gaming machine in accordance with the thirteenth aspect of the present invention, the image display section displays game information for indicating the occurrence of a winning mode.

In the gaming machine in accordance with the fourteenth aspect of the present invention, the image display section displays game information for indicating only the occurrence of a special winning mode.

As a consequence, the occurrence of the normal winning mode or special winning mode can reliably be reported to the player, whereby the player can fully enjoy the fun of winning.

In the gaming machine in accordance with the fifteenth aspect of the present invention, the image display section displays game information for indicating the state of provision of value information provided for the player.

As a consequence, the state of provision of the value information provided for the player can reliably be reported to the player, whereby the player can fully enjoy the fun of winning.

In the gaming machine in accordance with the sixteenth aspect of the present invention, the image display section displays game information for indicating that a replay winning mode is generated.

As a consequence, the fact that the replay winning mode is generated can reliably be reported to the player, so that the player can immediately carry out a replay, whereby there is no uselessness in gaming operations, and the player can fully enjoy the fun of gaming.

In the gaming machine in accordance with the seventeenth aspect of the present invention, the image display section displays gaming machine information in the gaming machine.

As a consequence, the gaming machine information of the gaming machine can be provided for the player, whereby the player can refer to the gaming machine information for gaming, thus being able to fully enjoy the fun of gaming.

In the gaming machine in accordance with the eighteenth aspect of the present invention, the image display section displays game information concerning the unit of value information provided for the player when the winning mode is attained.

In the gaming machine in accordance with the nineteenth aspect of the present invention, the image display section selectively displays a game information item concerning the unit of value information provided for the player when the winning mode is attained in the normal game and a game information item concerning the unit of value information provided for the player when the winning mode is attained in the special game.

As a consequence, the unit of value information provided for the player can reliably be reported to the player, whereby the player can refer to the provided unit of value information for gaming, thus being able to fully enjoy the fun of gaming.

The gaming machine in accordance with the twentieth aspect of the present invention is provided with an indicating section for indicating related game information relating to the game information displayed in the image display section, so as to indicate the related game information.

Since the indication by the indicating section is carried out in addition to the display of game information in the image display section, game information corresponding to the gaming state can further reliably be reported to the player, whereby the player can fully enjoy the fun of normal games according to the indicated game information.

In the gaming machine in accordance with the twenty-first aspect of the present invention, the image display section also displays each game information item while the special game is being played.

As a consequence, even when the special game is being played, each game information item can reliably be reported to the player, whereby the player can refer to each game information item, thus being able to fully enjoy the fun of gaming.

What is claimed is:

1. A gaming machine comprising:
a variable display section for variably displaying a plurality of kinds of symbols necessary for gaming;
a starting device for starting the variably displaying of said symbols;
a stopping device, disposed so as to be operable by a player, for stopping said symbols being variably displayed; and
said gaming machine comprising an image display section for displaying game information to said player;
wherein said player is provided with a profit if a combination of symbols displayed constitutes a predetermined winning mode when said symbols are stopped.

2. A gaming machine according to claim 1, wherein said gaming machine is a slot machine comprising:
a variable display section comprising a plurality of reels displaying a plurality of symbols necessary for gaming;
a starting device comprising a start switch for starting rotating said plurality of reels; and
a stopping device comprising a stop switch for individually stopping said plurality of reels;
wherein said player is provided with a predetermined unit of value information if a combination of symbols displayed when said plurality of reels are stopped constitutes a predetermined stop mode.

3. A gaming machine according to claim 1, wherein said predetermined winning mode includes a special winning mode which becomes a starting condition for playing a special game which is more advantageous to said player than a normal game; and
wherein said image display section displays the game information in said normal game.

4. A gaming machine according to claim 1, wherein said starting device uses an input of predetermined bet information as an actuating condition; and
wherein said game information displayed in said image display section is game information concerning permission to input said bet information.

5. A gaming machine according to claim 1, wherein said starting device uses an input of predetermined bet information as an actuating condition; and
wherein said game information displayed in said image display section is game information concerning an input unit of said bet information.

6. A gaming machine according to claim 1, wherein said game information displayed in said image display section is game information concerning a unit of value information stored in said gaming machine.

7. A gaming machine according to claim 1, wherein said game information displayed in said image display section is game information concerning an input mode of bet information.

8. A gaming machine according to claim 1, wherein said game information displayed in said image display section is game information concerning whether a game is permitted to start or not.

9. A gaming machine according to claim 1, wherein said game information displayed in said image display section is game information concerning a wait time until a game is permitted to start.

10. A gaming machine according to claim 1, wherein said game displayed in said image display section is game information concerning whether an operation of said stopping device is effective or not.

11. A gaming machine according to claim 3, wherein said game information displayed in said image display section is game information concerning a possibility of occurrence of said special winning mode.

12. A gaming machine according to claim 3, wherein said game information displayed in said image display section is game information concerning a possibility of occurrence of said special winning mode and a reliability thereof.

13. A gaming machine according to claim 1, wherein said game information displayed in said image display section is game information for indicating an occurrence of said winning mode.

14. A gaming machine according to claim 3, wherein said game information displayed in said image display section is game information for indicating only an occurrence of said special winning mode.

15. A gaming machine according to claim 1, wherein said game information displayed in said image display section is game information for indicating a state of provision of value information provided for said player when said winning mode is attained.

16. A gaming machine according to claim 1, wherein said game information displayed in said image display section is game information for indicating that a replay winning mode is generated.

17. A gaming machine according to claim 1, wherein said game information displayed in said image display section is gaming machine information in said gaming machine.

18. A gaming machine according to claim 1, wherein said game information displayed in said image display section is game information concerning a unit of value information provided for said player when said winning mode is attained.

19. A gaming machine according to claim 3, wherein said game information displayed in said image display section comprises a game information item concerning a unit of value information provided for said player when said winning mode is attained in said normal game and a game information item concerning a unit of value information provided for said player when said winning mode is attained in said special game; and
wherein said game information items are selectively displayed in said image display section.

20. A gaming machine according to claim 1, further comprising an indicating section for indicating related game information relating to said game information displayed in said image display section.

21. A gaming machine according to claim 3, wherein said game information displayed in said image display section is also displayable while said special game is being played.

22. A gaming machine according to claim 1, wherein said game information displayed in said image display section is a moving image.

23. A gaming machine according to claim 2, wherein said game information displayed in said image display section is a moving image.

24. A gaming machine according to claim 3, wherein said game information displayed in said image display section is a moving image.

25. A gaming machine comprising:
variable display means for variably displaying a plurality of kinds of symbols necessary for gaming;
starting means for starting the variably displaying of said symbols;
stopping means, disposed so as to be operable by a player, for stopping said symbols being variably displayed; and
said gaming machine comprising an image display section for displaying game information to said player;
wherein said player is provided with a profit if a combination of symbols displayed constitutes a predetermined winning mode when said symbols are stopped.
